(19) United States
(12) Patent Application Publication
(10) Pub. No.: US 2026/0022257 A1
(43) Pub. Date: Jan. 22, 2026

(54) COMPOUND, SURFACE TREATMENT AGENT, ARTICLE, AND METHOD FOR MANUFACTURING ARTICLE

(71) Applicant: AGC INC., Tokyo (JP)

(72) Inventors: Yasuhiro HIRATA, Tokyo (JP); Hironobu SAKAGUCHI, Tokyo (JP); Eiichiro ANRAKU, Tokyo (JP); Hikaru ONO, Tokyo (JP); Koki WATANABE, Tokyo (JP); Shiori KAWAKAMI, Tokyo (JP); Keigo MATSUURA, Tokyo (JP); Motoshi AOYAMA, Tokyo (JP)

(73) Assignee: AGC INC., Tokyo (JP)

(21) Appl. No.: 19/339,692

(22) Filed: Sep. 25, 2025

Related U.S. Application Data
(63) Continuation of application No. PCT/JP2024/011431, filed on Mar. 22, 2024.

(30) Foreign Application Priority Data
Mar. 27, 2023 (JP) 2023-050340

(51) Int. Cl. C09D 5/16; C07F 7/18; C08G 77/24; C08G 77/50; C09D 183/08; C09D 183/14

(52) U.S. Cl. CPC C09D 5/1675; C07F 7/1804; C08G 77/24; C08G 77/50; C09D 183/08; C09D 183/14

(57) ABSTRACT

A compound capable of forming a surface layer excellent in frictional durability is provided. A compound according to the present invention is represented by R^{f1-}R¹⁻L¹⁻(R²⁻T¹)ₓ₁. R^{f1} is a fluorine-containing group; R¹ is an alkylene group in which —CH₂— may be substituted with a predetermined group and which may contain a predetermined substituent; L¹¹ is an alkylene group; L¹ is a single bond or a group having a valence of 1+x1; R² is a single bond, an alkylene group, or an alkylene group containing an etheric oxygen atom; T¹ is a reactive group; and x1 is an integer of 1 to 10. Note that when x1 is 1 and L¹ is a single bond, R² is a single bond. When R^{f1} is —SF₅, R¹ does not contain an arylene group at a position where R¹ is directly bonded to R^{f1}.

### INCORPORATION BY REFERENCE

This application is based upon and claims the benefit of priority from Japanese patent application No. 2023-50340, filed on Mar. 27, 2023, and PCT application No. PCT/JP2024/011431 filed on Mar. 22, 2024, the disclosure of which is incorporated herein in its entirety by reference.

### BACKGROUND

The present invention relates to a compound, a surface treatment agent, an article, and a method for manufacturing an article.

In various fields such as electrical and electronic materials, semiconductor materials, optical materials, building materials, and automobile parts, a method for forming a surface layer on the surface of a member (substrate) to be used in order to, for example, prevent dirt from sticking to the member is known.

For example, Patent Literature 1 shows a method for forming a film on the surface of a substrate by using a composition containing an organosilicon compound containing at least one trialkylsilyl group and two or more hydrolyzable silicon groups, and a metal compound in which at least one hydrolyzable group is bonded to a metal atom.

Further. Patent Literature 2 shows a method for forming a film containing a polydialkylsiloxane skeleton on the surface of a substrate.
[Patent Literature 1] Japanese Unexamined Patent Application Publication No. 2017-119849
[Patent Literature 2] Japanese Unexamined Patent Application Publication No. 2017-201010

### SUMMARY

In recent years, the requirements for performance for surface layers have increased. For example, there is a demand for a surface layer having excellent performance that water repellency is not lowered even when the surface layer is repeatedly rubbed (frictional durability).

The inventors of the present application have evaluated surface layers formed by using organosilicon compounds like those disclosed in Patent Literature 1, and found that there is room for improvement in the frictional durability of the surface layers.

The present invention has been made in view of the above-described problem, and an object thereof is to provide a compound capable of forming a surface layer excellent in frictional durability, a surface treatment agent containing such a compound, an article having a surface layer formed of such a compound, and a method for manufacturing such an article.

The inventors of the present application have earnestly studied the above-described problem and found that the above-described problem can be solved by compositions or the like described hereinafter.

[1] A compound represented by a below-shown Formula (1),

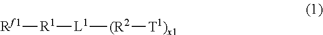

In Formula (1),
R^{f1} is a fluorine-containing group selected from the group consisting of a perfluoroalkyl group, —C(X¹⁰)F₂, —C(X¹⁰)₂F, —SF₅, —OCF₃, —SCF₃, a fluorovinyl group, a fluoroethynyl group, —NX¹¹X¹², a monovalent cyclic hydrocarbon group containing a fluorine atom, and a monovalent heterocyclic group containing a fluorine atom; X¹⁰ is H, Cl, Br, or I; X¹¹ is a fluoroalkyl group; and X¹² is an alkyl group or a fluoroalkyl group,
R¹ is an alkylene group in which —CH₂, may be substituted with an etheric oxygen atom or an arylene group and which may contain a polyoxyalkylene chain or R^{f1-}L¹¹- as a substituent, and L¹¹ is an alkylene group,
L¹ is a single bond or a group having a valence of 1+x1,
R² is a single bond, an alkylene group, or an alkylene group containing an etheric oxygen atom,
T¹ is a reactive group,
x1 is an integer of 1 to 10, and
when there are a plurality of R^{f1}, R², X¹⁰, or T¹, the plurality of R^{f1}, R², X¹⁰, or T¹ may be the same as each other or different from each other.

Note that when x1 is 1 and L¹ is a single bond, R² is a single bond.

Further, when R^{f1} is —SF₅, R¹ does not contain an arylene group at a position where R¹ is directly bonded to R^{f1}.

[2] The compound described in Item [1], wherein
The aforementioned T¹ is one of —Ar, —SR¹⁰, —NOR¹⁰, —C(═O)R¹⁰, —N(R¹⁰)₂, —N+(R¹⁰)₃X³, —C≡N, —C(═NR¹⁰)—R¹⁰, —N+═N, —N═NR¹⁰, —C(═O)OR¹⁰, —C(═O)OX², —C(═O)X⁴, —C(═O)OC(═O)R¹⁰, —SO₂R¹⁰, —SO₃H, —SO₃X², —O—P(═O)(—OR¹⁰)₂, —O—P(═O)(—OR¹⁰)(—OX²), —N═C═O, —SiR^{a1}_{z1}R^{a11}_{3-z1}, —C(R¹⁰)═C(R¹⁰)₂, —C≡C(R¹⁰), —C(═O)N(R¹⁰)₂, —N(R¹⁰)C(═O)R¹⁰, —Si(R¹⁰)₂—O—Si(R¹⁰)₃, —NH—C(═O)R¹⁰, —C(═O)NHR¹⁰, —I, and

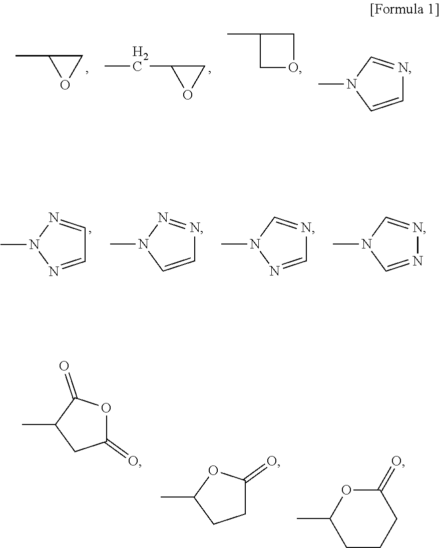

where
R¹⁰ is a hydrogen atom, an alkyl group having a carbon number of 1 to 6, which may have a substituent, a fluoroalkyl group having a carbon number of 1 to 6, which may have a substituent, or an aryl group which may have a substituent,
Ar is an aryl group which may have a substituent,
X² is an alkali metal ion or an ammonium ion,
X³ is a halide ion,
X⁴ is a halogen atom,
R^{a1} is a hydrolyzable group or a hydroxyl group,
R^{a11} is a hydrocarbon group,
z¹ is an integer of 1 to 3, and
when there are a plurality of R¹⁰, R^{a1}, or R^{a11}, the plurality of R¹⁰, R^{a1}, or R^{a11} may be the same as each other or different from each other.

[3] The compound described in Item [1] or [2], wherein T¹ is —SiR^{a1}_{z1}R^{a11}_{3-z1}.

[4] The compound described in any one of Items [1] to [3], wherein the monovalent cyclic hydrocarbon group containing a fluorine atom is a group represented by a below-shown Formula (g-1), a below-shown Formula (g-2), a below-shown Formula (g-3), or a below-shown Formula (g-4),

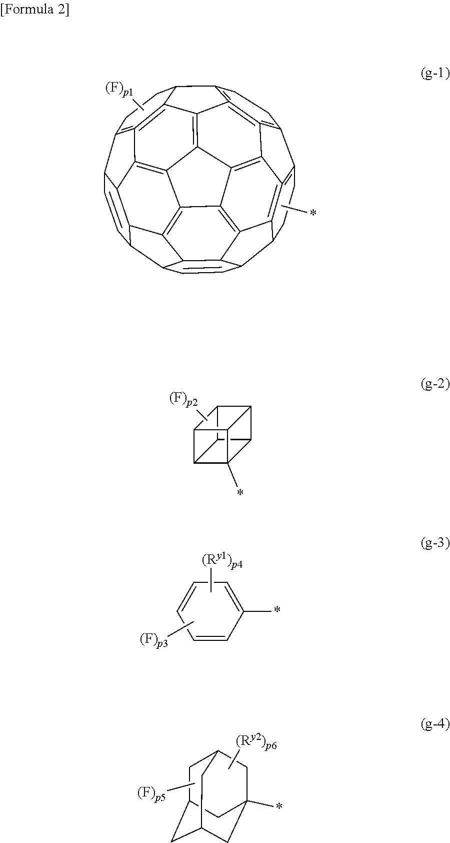

where
p1 is an integer of 1 or greater,
p2 is an integer of 1 or greater,
R^{y1} is a monovalent substituent; when R^{y1} contains a fluorine atom, each of p3 and p4 is an integer of 0 or greater, and p3+p4 is an integer of 1 or greater; and when R^{y1} does not contain a fluorine atom, p3 is an integer of 1 or greater, and p4 is an integer of 0 or greater,
R^{y2} is a monovalent substituent; when R^{y2} contains a fluorine atom, each of p5 and p6 is an integer of 0 or greater, and p5+p6 is an integer of 1 or greater; and when R^{y2} does not contain a fluorine atom, p5 is an integer of 1 or greater, and p6 is an integer of 0 or greater, and
indicates a position of a bond with R¹.

[5] The compound described in Item [4], wherein the monovalent substituents in R^{y1} and R^{y2} are each independently a halogen atom other than a fluorine atom, an alkyl group, which may have an etheric oxygen atom between carbon atoms, an alkenyl group, an alkoxy group, a perfluoroalkyl group, —C(X²⁰)F₂, —C(X²⁰)₂F, —SF₅, —OCF₃, —SCF₃, a fluorovinyl group, a fluoroethynyl group, or —NX²¹X²², and
X²⁰ is H, Cl, Br, or I; when there are a plurality of X²⁰, the plurality of X²⁰ may be the same as each other or different from each other; X²¹ is a fluoroalkyl group; and X²² is an alkyl group or a fluoroalkyl group.

[6] A surface treatment agent containing a compound described in any one of Items [1] to [5].

[7] The surface treatment agent described in Item [6], further containing a liquid medium.

[8] The surface treatment agent described in Item [6] or [7], wherein the surface treatment agent is an antifouling coating agent or a waterproof coating agent.

[9] An article comprising, on a surface of its substrate, a surface layer formed by using a compound described in any one of Items [1] to [5].

[10] The article described in Item [9], comprising the surface layer on a surface of a member constituting a surface of a touch panel which a finger touches.

[11] The article described in Item [9], wherein the article is an optical member.

[12] A method for manufacturing an article, wherein a surface layer is formed by a dry coating method by using a surface treatment agent described in any one of Items [6] to [8].

[13] A method for manufacturing an article, wherein a surface layer is formed by a wet coating method by using a surface treatment agent described in any one of Items [6] to [8].

According to the present invention, it is possible to provide a compound capable of forming a surface layer excellent in frictional durability, a surface treatment agent containing such a compound, an article having a surface layer formed of such a compound, and a method for manufacturing such an article.

The above and other objects, features and advantages of the present disclosure will become more fully understood from the detailed description given hereinbelow and the accompanying drawings.

### BRIEF DESCRIPTION OF DRAWINGS

FIG. 1 is a schematic cross-sectional diagram showing an example of an article according to the present invention.

### DESCRIPTION OF EMBODIMENT

The meanings of terms in the present invention are as follows.

In this specification, a compound represented by Formula (1) is referred to as a compound 1.

The same applies to compounds and the likes represented by other formulas.

The “fluoroalkyl group” is a generic term for perfluoroalkyl groups and partial fluoroalkyl groups.

The “perfluoroalkyl group” means a group in which all hydrogen atoms of the alkyl group are substituted with fluorine atoms.

Further, the term “partial fluoroalkyl group” means an alkyl group in which one or more hydrogen atoms are substituted with fluorine atoms and which contains one or more hydrogen atoms.

That is, the fluoroalkyl group is an alkyl group containing one or more fluorine atoms.

Note that the same applies to fluoroalkylene groups.

The “reactive silyl group” is a generic term for hydrolyzable silyl groups and silanol groups (Si—OH), and the “hydrolyzable silyl group” means a group capable of forming a silanol group through hydrolysis.

The “organic group” means a hydrocarbon group which may have a substituent and may have a heteroatom or other bonds in a carbon chain.

The “hydrocarbon group” is a group consisting of an aliphatic hydrocarbon group (such as a linear alkylene group, a branched alkylene group, or a cycloalkylene group), an aromatic hydrocarbon group (such as a phenylene group), and a combination thereof.

The “surface layer” means a layer formed on the surface of a substrate.

The “number-average molecular weight” (Mn) is a value measured by size exclusion chromatography (gel permeation chromatography) using polystyrene as a reference material.

A symbol “-”, which indicates a range of numerical values, means that values in front of and behind this symbol are included in the range as lower and upper limit values, respectively.

The bonding order of divalent groups is not limited to any particular orders, unless otherwise specified.

For example, when L¹ (which will be described later) is a group represented by —C(O)N(R²⁶)—, the bond on the left side may be bonded to R¹ side of Formula (1), and the bond on the right side may be bonded to R¹ side of Formula (1).

In this specification, when a compound or a group is represented by a specific formula (X), the compound or the group represented by this formula (X) may be expressed as a compound (X) or a compound X, and a group (X) or a group X, respectively.

In this specification, the “Me” may represent a methyl group.

Note that when there are the same symbols in one chemical formula, the same symbols may represent the same structure, or may represent different structures within a specified range.

### [Compound 1]

A compound according to the present invention is represented by the below-shown Formula (1).

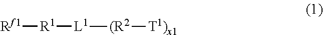

In Formula (1),
R^{f1} is a fluorine-containing group selected from the group consisting of a perfluoroalkyl group, —C(X¹⁰)F₂, —C(X¹⁰)₂F, —SF₅, —OCF₃, —SCF₃, a fluorovinyl group, a fluoroethynyl group, —NX¹¹X¹², a monovalent cyclic hydrocarbon group containing a fluorine atom, and a monovalent heterocyclic group containing a fluorine atom;
X¹⁰ is H, Cl, Br, or I; X¹¹ is a fluoroalkyl group; and X¹² is an alkyl group or a fluoroalkyl group.

### In Formula (1).

R¹ is an alkylene group in which —CH₂, may be substituted with an etheric oxygen atom or an arylene group and which may contain a polyoxyalkylene chain or R^{f1-}L¹¹- as a substituent, and L¹¹ is an alkylene group,
L¹ is a single bond or a group having a valence of 1+x1,
R² is a single bond, an alkylene group, or an alkylene group having an etheric oxygen atom,
T¹ is a reactive group,
y1 is an integer of 1 or greater,
x1 is an integer of 1 to 10, and
when there are a plurality of R^{f1}, R², X¹⁰ or T¹, the plurality of R^{f1}, R², X¹⁰ or T¹ may be the same as each other or different from each other.

Note that when x¹ is 1 and L¹ is a single bond, R² is a single bond. Further, when R^{f1} is —SF₅, R¹ does not have an arylene group at the position where R¹ is directly bonded to R^{f1}.

In the compound 1, R^{f1}, which is a fluorine-containing group containing a fluorine atom, is located at one end, and T¹, which is a reactive group, is located at the other end.

When a surface layer is formed by using the compound 1, the reactive group of the compound 1 tends to be located on the substrate side, and R^{f1}, which is a fluorine-containing group, tends to be located on the surface of the surface layer on the side opposite to the side on which the substrate is located.

By having R^{f1}, which is a fluorine-containing group, at one end of the compound 1, surprisingly, a surface layer having excellent frictional durability (performance that water repellency is not lowered even when the surface layer is repeatedly rubbed) is obtained, though the particular reason for this is unknown.

R^{f1} is a fluorine-containing group selected from the group consisting of a perfluoroalkyl group, —C(X¹⁰)F₂, —C(X¹⁰)₂F, —SF₅, —OCF₃, —SCF₃, a fluorovinyl group, a fluoroethynyl group, —NX¹¹X¹², a monovalent cyclic hydrocarbon group containing a fluorine atom, and a monovalent heterocyclic group containing a fluorine atom.

The carbon number of the perfluoroalkyl group in R^{f1} is preferably 1 to 6, more preferably 1 to 4, and still more preferably 1 to 3. When the carbon number of the perfluoroalkyl group is 3 or greater, the perfluoroalkyl group having a carbon number of 3 or greater may be linear, or may have a branched or ring structure.

In R^{f1}, X¹⁰ of —C(X¹⁰)F₂ and —C(X¹⁰)₂F is H, Cl, Br, or I. Note that in —C(X¹⁰)₂F, the two X¹⁰ may be the same as each other or different from each other.

Specific examples of the fluorovinyl group in Rf include CF₂═CF—, CF₂═CH—, CFH═CF—, CFH═CH—, and CH₂═CF—.

In —NX¹¹X¹² in R^{f1}, X¹¹ is a fluoroalkyl group, and X¹² is an alkyl group or a fluoroalkyl group. The carbon number of the fluoroalkyl group in X¹¹ and X¹² is preferably 1 to 6, more preferably 1 to 4, and still more preferably 1 to 3. When the carbon number of the fluoroalkyl group is 3 or greater, the fluoroalkyl group having a carbon number of 3 or greater may be linear, or may have a branched or ring structure. The carbon number of the alkyl group in X¹² is preferably 1 to 6, more preferably 1 to 4, and still more preferably 1 to 3. When the carbon number of the alkyl group is 3 or greater, the alkyl group having a carbon number of 3 or greater may be linear, or may have a branched or ring structure.

The monovalent cyclic hydrocarbon group containing a fluorine atom means a group in which at least one hydrogen atom contained in the cyclic hydrocarbon group is substituted with a fluorine atom or a substituent containing a fluorine atom. Note that all hydrogen atoms contained in the cyclic hydrocarbon group may be substituted with fluorine atoms or substituents containing fluorine atoms.

In the monovalent cyclic hydrocarbon group containing a fluorine atom, the cyclic hydrocarbon group may be an alicyclic hydrocarbon group or an aromatic hydrocarbon group.

The cyclic hydrocarbon constituting the monovalent cyclic hydrocarbon group containing a fluorine atom may be a monocyclic ring or a condensed ring. Alternatively, the cyclic hydrocarbon may be a bridged ring.

The cyclic hydrocarbon constituting the monovalent cyclic hydrocarbon group containing a fluorine atom may be a ring having a polyhedral structure such as tetrahedrane, cubane, dodecahedrane, or fullerene.

Examples of preferred forms of the monovalent cyclic hydrocarbon group containing a fluorine atom include groups g-1 to g-4.

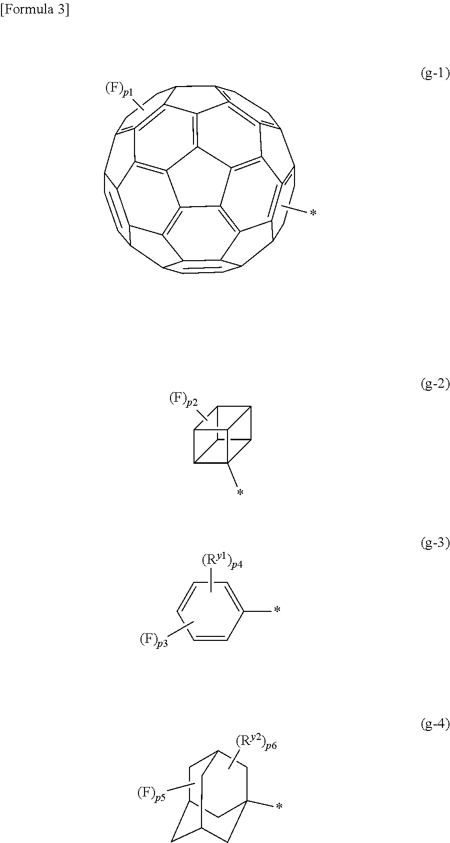

In the group g-1, p1 is an integer of 1 or greater,
In the group g-2, p2 is an integer of 1 or greater,
In the group g-3, R^{y1} is a monovalent substituent; when R^{y1} contains a fluorine atom, each of p3 and p4 is an integer of 0 or greater, and p3+p4 is an integer of 1 or greater; and when R^{y1} does not contain a fluorine atom, p3 is an integer of 1 or greater, and p4 is an integer of 0 or greater,
In the group g-4, R^{y2} is a monovalent substituent; when R^{y2} contains a fluorine atom, each of p5 and p6 is an integer of 0 or greater, and p5+p6 is an integer of 1 or greater; and when R^{y2} does not contain a fluorine atom, p5 is an integer of 1 or greater, and p6 is an integer of 0 or greater, and
In the groups g-1 to g-4, * indicates the position of a bond with R¹;

The group g-1 is a monovalent group having a fullerene C₆₀ derivative in which a hydrogen atom is substituted with p1 fluorine atoms.

p1 is an integer of 1 or greater, preferably an integer of 1 to 59, and more preferably an integer of 8 to 59.

The group g-2 is a monovalent group having a cubane ring in which a hydrogen atom is substituted with p2 fluorine atoms.

p2 is an integer of 1 or greater, preferably an integer of 1 to 7, and more preferably an integer of 4 to 7.

The group g-3 is a monovalent group having a benzene ring in which a hydrogen atom is substituted with p3 fluorine atoms and p4 R^{y1}.

Specific examples of the monovalent substituent in R^{y1} include a halogen atom other than a fluorine atom (e.g., Cl, Br, or I), an alkyl group, which may have an etheric oxygen atom between carbon atoms, an alkenyl group, an alkoxy group, a perfluoroalkyl group, —C(X²⁰)F₂, —C(X²⁰)₂F, —SF₅, —OCF₃, —SCF₃, a fluorovinyl group, a fluoroethynyl group, or —NX²¹X²².

The carbon number of each of the alkyl group, the alkenyl group, the alkoxy group, and the perfluoroalkyl group in the monovalent substituent is preferably 1 to 5, more preferably 1 to 4, and still more preferably 1 to 3. When the carbon number of these groups is 3 or greater, these groups may be linear, or may have a branched or ring structure.

Specific examples of the fluorovinyl group in the monovalent substituent are similar to those of the fluorovinyl group in R^{f1}.

In −C(X²⁰)F₂ and —C(X²⁰)₂F. X²⁰ is H, Cl, Br, or I. Note that in-C(X²⁰)₂F, the two X²⁰ may be the same as each other or different from each other.

In —NX²¹X²², X²¹ is a fluoroalkyl group, and X²² is an alkyl group or a fluoroalkyl group. The carbon number of the fluoroalkyl group in X²¹ and X²² is preferably 1 to 6, more preferably 1 to 4, and still more preferably 1 to 3. When the carbon number of the fluoroalkyl group is 3 or greater, the fluoroalkyl group having a carbon number of 3 or greater may be linear, or may have a branched or ring structure. The carbon number of the alkyl group in X²² is preferably 1 to 6, more preferably 1 to 4, and still more preferably 1 to 3. When the carbon number of the alkyl group is 3 or greater, the alkyl group having a carbon number of 3 or greater may be linear, or may have a branched or ring structure.

When R^{y1} contains a fluorine atom, each of p3 and p4 is an integer of 0 or greater, and p3+p4 is an integer of 1 or greater. In this case, p3 is preferably an integer of 0 to 5, and more preferably 2 to 5. Further, p4 is preferably an integer of 0 to 5, and more preferably 0 to 3. Further, p3+p4 is preferably 1 to 5, and more preferably 1 to 5.

When R^{y1} does not contain a fluorine atom, p3 is an integer of 1 or greater, and p4 is an integer of 0 or greater. In this case, p3 is preferably an integer of 1 to 5, and more preferably 1 to 3. Further, p4 is preferably an integer of 0 to 5, and more preferably 0 to 2. Note that p3+p4 is 5 or smaller.

The group g-4 is a monovalent group having an adamantane ring in which a hydrogen atom is substituted with p5 fluorine atoms and p6 R^{y2}.

Specific examples and preferred forms of the monovalent substituent in R^{y2} are similar to those of the monovalent substituent in R^{y1}.

When R^{y2} contains a fluorine atom, each of p5 and p6 is an integer of 0 or greater, and p5+p6 is an integer of 1 or greater. In this case, p5 is preferably an integer of 0 to 15, and more preferably an integer of 1 to 3. Further, p6 is preferably an integer of 0 to 14, and more preferably an integer of 3 to 12. Further, p5+p6 is preferably 1 to 15, and more preferably 1 to 10.

When R^{y2} does not contain a fluorine atom, p5 is an integer of 1 or greater, and p6 is an integer of 0 or greater. In this case, p5 is preferably an integer of 1 to 15, and more preferably an integer of 1 to 3. Meanwhile, p6 is preferably an integer of 0 to 14, and more preferably an integer of 3 to 12. Note that p5+p6 is 15 or smaller.

The monovalent heterocyclic group containing a fluorine atom means a group in which at least one hydrogen atom contained in the heterocyclic group is substituted with a fluorine atom or a substituent containing a fluorine atom.

In the monovalent heterocyclic group containing a fluorine atom, the heterocyclic group may be aromatic or non-aromatic.

Specific examples of heteroatoms contained in the monovalent heterocyclic group containing a fluorine atom include N, O, and S.

Specific examples of heterocycles constituting the monovalent heterocyclic group containing a fluorine atom include non-aromatic heterocycles such as pyrrolidine, piperidine, tetrahydrofuran, tetrahydropyran, dioxane, and quinuclidine, and aromatic heterocycles such as furan, pyrrole, thiophene, pyridine, triazine, triazole, pyrazole, thiazole, and benzothiazole.

R¹ is an alkylene group in which —CH₂— may be substituted with an etheric oxygen atom or an arylene group, and which may contain a polyoxyalkylene chain or R^{f1-}L¹¹- as a substituent. L¹¹ is an alkylene group.

Note that when R^{f1} is —SF₅, R¹ does not have an arylene group at the position where R¹ is directly bonded to R^{f1}.

The carbon number of the alkylene group in R¹ is preferably 1 to 30, more preferably 1 to 20, and still more preferably 1 to 15. Note that the carbon number of the alkylene group does not include carbons in the aforementioned arylene group and those in the substituent.

When the carbon number of the alkylene group in R¹ is 3 or greater, the alkylene group may be linear, or may have a branched or ring structure.

When R¹ contains an etheric oxygen atom, the etheric oxygen atom may be located at the end of the alkylene group or between carbon atoms.

When R¹ contains an arylene group, the arylene group may be located at the end of the alkylene group or between carbon atoms.

Specific examples of the arylene group include a phenylene group and a napbthylene group, and a phenylene group is preferred.

R¹ may contain a polyoxyalkylene chain (hereinafter also referred to a “chain A”) as a substituent.

When R¹ contains the chain A, the number of chains A is preferably 1 to 3, more preferably 1 or 2, and still more preferably 1.

The number of constituent atoms of the main chain in the chain A is preferably 10 or greater, more preferably 12 or greater, still more preferably 16 or greater, and particularly preferably 18 or greater in order to obtain a surface layer excellent in water repellency. Further, the number of constituent atoms of the main chain in the chain A is preferably 500 or smaller, more preferably 250 or smaller, still more preferably 100 or smaller, and particularly preferably 50 or smaller in order to obtain a surface layer excellent in frictional durability. The number of constituent atoms of the main chain in the chain A is preferably 10 to 500, more preferably 12 to 250, still more preferably 16 to 100, and particularly preferably 18 to 50.

When the compound 1 contains two or more chains A, the number of constituent atoms of the main chains in the two or more chains A may be the same as each other or different from each other.

Note that the number of constituent atoms of the main chain in the chain A means the total number of carbon atoms and oxygen atoms constituting the main chain of the polyoxyalkylene chain.

The polyoxyalkylene chain is preferably represented by the below-shown Formula (A).

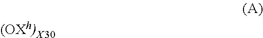

In Formula (A). X¹¹ are each independently an alkylene group, and X³⁰ is an integer of 2 or greater.

The carbon number of the alkylene group is preferably 1 to 6, more preferably 2 to 4, and still more preferably 2 in order to improve the oil repellency of the surface layer.

The alkylene group may be linear, branched, or cyclic, and in particular, is preferably linear or branched in order to improve the oil repellency of the surface layer, and more preferably linear.

Specific examples of (OX^{h}) include —OCH₂₋, —OC₂H₄₋, —OC₃H₆—, —OC₄H₈—, —OC₅H₁₀—, —OC₆H₁₂—, —OCH(CH₃)CH₂—, —OCH(CH₃)CH₂CH₂₋, —O-cycloC₄H₆—, —O-cycloC₅H₈—, and —O-cycloC₆H₁₀—.

Note that -cycloC₄H₆— represents a cyclobutanediyl group. Examples of cyclobutanediyl groups include a cyclobutane-1,2-diyl group and a cyclobutane-1,3-diyl group. -cycloC₅H₈— represents a cyclopentanediyl group. Examples of cyclopentanediyl groups include a cyclopentane-1,2-diyl group and a cyclopentane-1,3-diyl group. -cycloC₆H₁₀— represents a cyclohexanediyl group. Examples of cyclohexanediyl groups include a cyclohexane-1,2-diyl group, a cyclohexane-1,3-diyl group, and cyclohexane-1,4-diyl group.

The repetition number X30 of (OX^{h}) is an integer of 2 or greater, preferably an integer of 3 or greater, more preferably an integer of 3 to 200, still more preferably an integer of 5 to 150, particularly preferably an integer of 5 to 100, and most preferably an integer of 5 to 50.

X30 X^{h} (i.e., X30 pieces of X^{h}) included in Formula (A) may be the same as each other or different from each other. That is, (OX^{h})_{X30} may contain two or more types of (OX^{h}).

The bonding order of two or more (OX^{h}) is not limited to any particular orders, and may be arranged randomly, alternately, or on a block basis.

Containing two or more types of (OX^{h}) means that there are two or more types of (OX^{h}) having different carbon numbers in the compound, and that there are two or more types (OX^{h}) having the same carbon number, but some of them have side chains and the others do not have side chains, and that there are two or more types (OX^{h}) having the same carbon number but having different types of side chains (such as different numbers of side chains or different numbers of carbons in the side chains).

Regarding the arrangement of two or more types of (OX^{h}), for example, a structure represented by {(OCH₂)ₘ₂₁(OC₂H₄)ₘ₂₂} indicates that m21 (OCH₂) and m22 (OC₂H₄) are randomly arranged. Further, a structure represented by (OC₂H₄—OCH₆)ₘ₂₅ indicates that m25 (OC₂H₄) and m25 (OC₃H₆) are alternately arranged.

In particular, (OX^{h}) X³⁰ is preferably [(OCH₂)ₘ₁₁(OC₂H₄)ₘ₁₂(OC₃H₆)ₘ₁₃(OC₄H₈)ₘ₁₄(OC₅H₁₀)ₘ₁₅·(OC₆H₁₂)ₘ₁₆(O-cycloC₄H₆)ₘ₁₇(O-cycloC₅H₈)ₘ₁₈(O-cyclo C₆H₁₀)ₘ₁₉].

m11, m12, m13, m14, m15, m16, m17, m18, and m19 are each independently an integer of 0 or greater, and preferably 100 or smaller.

A number expressed by “m11+m12+m13+m14+m15+m16+m17+m18+m19” is an integer of 2 or greater, preferably an integer of 2 to 200, more preferably an integer of 5 to 150, still more preferably an integer of 5 to 100, and particularly preferably an integer of 10 to 50.

In particular, m12 is preferably an integer of 2 or greater, and particularly preferably an integer of 2 to 200.

Further, C₃H₆, C₄H₈, C₅H₁₀, and C₆H₁₂ may be linear or branched, and is preferably linear in order to improve the oil repellency of the surface layer.

Note that the above-shown formulae represent the types of units and numbers thereof, but do not represent the arrangements of units. That is, m11 to m19 represent the numbers of units, and for example, (OCH₂)ₘ₁₁ does not represent a block in which m11 (OCH₂) units are consecutively arranged. Similarly, the listing order of (OCH₂) to (O-cycloC₆H₁₀) does not represent that they are arranged in this listening order.

In the above-shown formula, when two or more of m11 to m19 are not 0 (i.e., when (OX^{h})_{X30} consists of two or more types of units), the arrangement of different units may be any of a random arrangement, an alternate arrangement, a block arrangement, and a combination of these arrangements.

(OX^{h})_{X30} preferably has the below-shown structure.

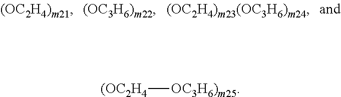

where, m21 is an integer of 2 or greater: m22 is an integer of 2 or greater; m23 and m24 are each independently an integer of 1 or greater; m25 is an integer of 1 or greater, and m26 and m27 are each independently an integer of 1 or greater.

The polyoxyalkylene chain preferably contains an oxyethylene unit represented by OC₂H₄, more preferably contains 2 or more oxyethylene units, and still more preferably contains 2 to 200 oxyethylene units in order to improve the oil repellency of the surface layer. In order to improve the oil repellency of the surface layer, the polyoxyalkylene chain preferably contains a polyoxyethylene chain, and more preferably is a polyoxyethylene chain.

When the alkylene group in R¹ contains R^{f1-}L¹¹- as a substituent, a plurality of R^{f1} contained in the compound 1 may be the same as each other or different from each other.

When the alkylene group in R¹ contains R^{f1-}L¹¹- as a substituent, the number of R^{f1-}L¹¹- is preferably 1 to 10, more preferably 1 to 6, and still more preferably 1 to 3.

The definition and preferred forms of R^{f1} in R^{f1}-L¹¹- are similar to those of R^{f1} shown by Formula (1).

L¹ in R^{f1-}L¹¹- is an alkylene group. The carbon number of this alkylene group is preferably 1 to 20, more preferably 1 to 10, and still more preferably 1 to 8. When the carbon number of the alkylene group is 3 or greater, the carbons of the alkylene group having a carbon number of 3 or greater may be linear, or may have a branched or ring structure.

When R¹ contains a substituent, it may contain at least one of a polyoxyalkylene chain and R^{f1-}L¹¹-, or may contain both of them.

R¹ is preferably an alkylene group or an alkylene group having an etheric oxygen atom because the effects of the present invention are more improved.

L¹ is a single bond or a group having a valence of 1+x1. The group having a valence of 1+x1 may have a heteroatom such as N, O, S, or Si, or may have a branch point. The atoms that are bonded to R¹ and R² in L¹ are preferably each independently N, O, S, Si, a carbon atom constituting a branch point, and a carbon atom having a hydroxyl group or an oxo group (═O). When L¹ is a single bond, R¹ and R² in Formula (1) are directly bonded to each other.

When x1 is 1 and L¹ is a single bond, R² is a single bond, and R¹ and T¹ in Formula (1) are directly bonded to each other.

When L¹ is a group having a valence of 3 or greater, L¹ has at least one type of branch point selected from the group consisting of C, N, Si, a ring structure, and an organopolysiloxane residue having a valence of (1+x1) (hereinafter also referred to as a “branch point P¹”).

When N is the branch point P¹, the branch point P¹ is expressed as, for example, *—N(—**)₂. Note that * indicates a bond on the R¹ side, and ** indicates a bond on the R² side.

When C is the branch point P¹, the branch point P¹ is expressed as, for example, *—C(—**), or *—CR²⁹ (—**)₂. Note that * and ** are similar to those when N is the branch point P¹. Further, R²⁹ is a monovalent group, and its examples includes a hydrogen atom, a hydroxyl group, an alkyl group, and an alkoxy group.

When Si is the branch point P¹, the branch point P¹ is expressed as, for example, *—Si(—**); or *—SiR²⁹(—**)₂. Note that * and ** are similar to those when N is the branch point P¹, and R²⁹ is similar to that when C is the branch point P¹.

The ring structure constituting the branch point P¹ is preferably one type of ring selected from the group consisting of a 3 to 8 membered aliphatic ring, a 3 to 8 membered aromatic ring, a 3 to 8 membered heterocycle, and a condensed ring consisting of two or more of these rings in view of the ease of synthesis and because the frictional durability, light stability, and chemical resistance of the surface layer are more improved, and is more preferably ring structures shown in the below-shown formulae.

The ring structure may contain a substituent such as a halogen atom, an alkyl group (which may contain an etheric oxygen atom between carbon atoms), a cycloalkyl group, an alkenyl group, an allyl group, an alkoxy group, or an oxo group (═O).

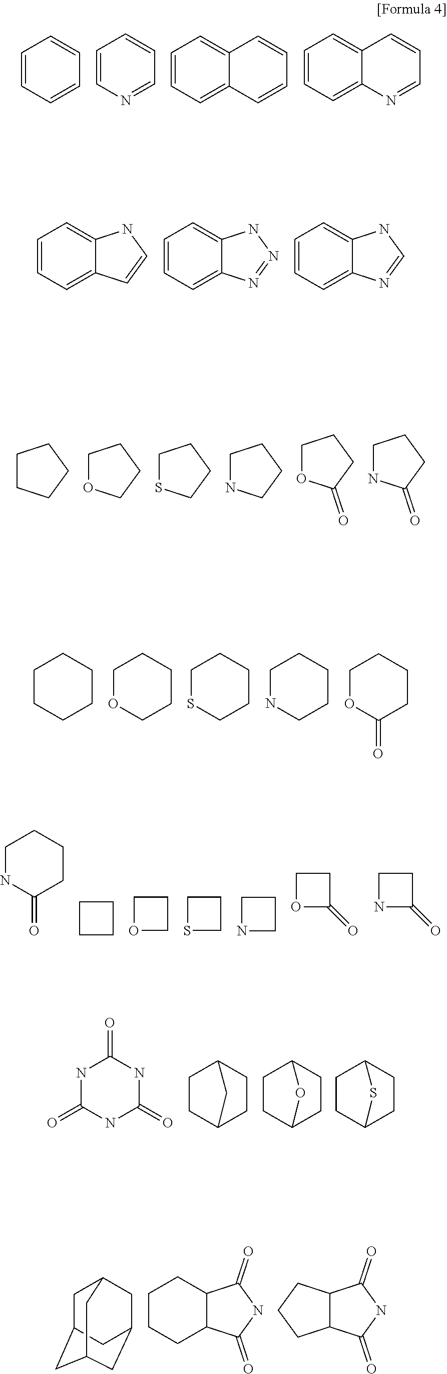

Examples of the organopolysiloxane residue constituting the branch point P¹ include groups described below. Note that R²⁵ in the below-shown formulae is a hydrogen atom, an alkyl group, an alkoxy group, or a phenyl group. The carbon number of the alkyl group and the alkoxy group of R²⁵ is preferably 1 to 10 and more preferably 1.

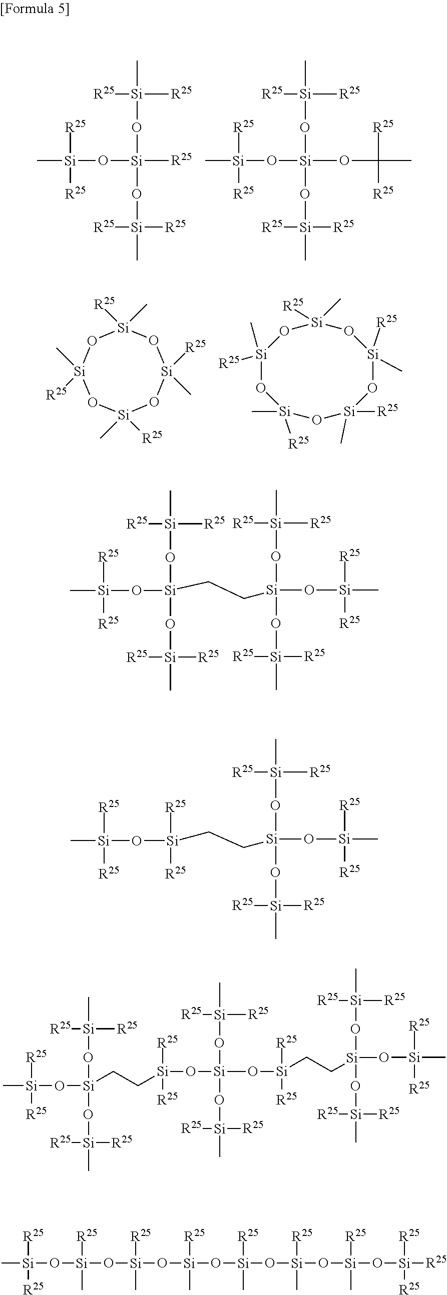

L¹ having a valence of 2 or greater may have at least one bond selected from the group consisting of —C(O)N(R²⁶)—, —C(O)O—, —C(O)—, —C(OH)—, —O—, —N(R²⁶)—, —S—, —OC(O)O—, —NHC(O)O—, —NHC(O)N(R²⁶)—, —SO₂N(R²⁶)—, —N(R²⁶) SO₂—, —Si(R²⁶)₂—, —OSi(R²⁶)₂—, —Si(CH₃)₂-Ph-Si(CH₃)₂—, and divalent organopolysiloxane residues (hereinafter also referred to as a “bond B¹”).

Note that R²⁶ is a hydrogen atom, or an alkyl group or a phenyl group having a carbon number of 1 to 6, and Ph is a phenylene group. The carbon number of the alkyl group of R²⁶ is preferably 1 to 6, more preferably 1 to 3, and still more preferably 1 to 2 in view of the ease of manufacturing of the compound 1.

Examples of divalent organopolysiloxane residues include groups shown in the below-shown formulae.

Note that R²⁷ in the below-shown formulae is a hydrogen atom, an alkyl group, an alkoxy group, or a phenyl group. The carbon number of the alkyl group and the alkoxy group of R²⁷ is preferably 1 to 10 and more preferably 1.

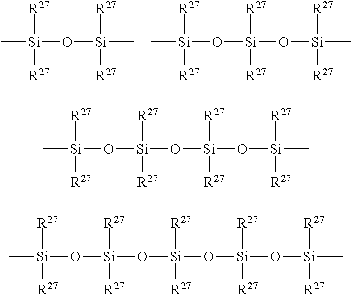

The bond B¹ is preferably at least one bond selected from the group consisting of —C(O)NR²⁶—, —C(O)—, and —NR²⁶— in view of the ease of synthesis, and more preferably —C(O)NR²⁶— or —C(O)— because the light stability and chemical resistance of the surface layer are more improved.

Regarding the divalent L¹, the atoms that are bonded to R¹ and R² are preferably each independently an N, O, S, or Si atom, or a carbon atom having a hydroxyl group or an oxo group (═O). That is, each of the atoms adjacent to R¹ and R² is preferably a constituent element of the bond B¹. Specific examples of L¹ having a valence of 2 or greater include one or more bonds B¹ (e.g., *—B¹—** or *—B¹—R²⁸—B¹—**). Note that R²⁸ is a single bond or a divalent organic group. Further, * represents a bond on the R¹ side, and ** represents a bond on the R² side.

Regarding L¹ having a valence of 3 or greater, the atoms that are bonded to R¹ and R² are N, O, S, Si, a carbon atom constituting a branch point, or a carbon atom having a hydroxyl group or an oxo group (═O). That is, each of the atoms adjacent to R¹ and R² is a constituent element of the bond B¹ or the branch point P¹. Specific examples of L¹ having a valence of 3 or greater include one or more branch points P¹ (e.g., {*—P¹(—**)ₓ₁}) and combinations of one or more branch points P¹ and one or more bonds B¹ (e.g., {*—B¹—R²⁸—P¹(—**)ₓ₁} and {*—B¹—R²⁸—P¹(—R²⁸—B¹—**)ₓ₁}). Note that R²⁸ is a single bond or a divalent organic group. Further. * represents a bond on the R¹ side, and ** represents a bond on the R² side.

Examples of the divalent organic group in the aforementioned R²⁸ include a divalent aliphatic hydrocarbon group (such as an alkylene group and a cycloalkylene group) and a divalent aromatic hydrocarbon group (such as a phenylene group). Further, the divalent organic group may have a bond B¹ between carbon atoms of a hydrocarbon group having a carbon number of 2 or greater. The carbon number of the divalent organic group is preferably 1 to 10, more preferably 1 to 6, and still more preferably 1 to 4.

The above-described L¹ is preferably a group represented by one of the below-shown Formulae (E1) to (E7) in view of the case of manufacturing of the compound 1.

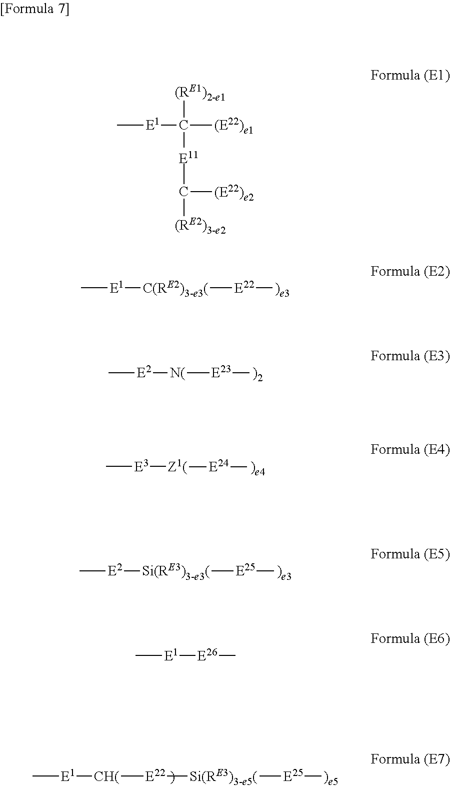

Note that in Formulae (E1) to (E7), the E¹, E², or E³ side is connected to R¹ in Formula (1), and the E²², E²³, E²⁴, E²⁵, or E²⁶ side is connected to R².

Note that E¹ is a single bond, —B⁵—, —B⁶—R⁴⁰—, or —B⁶—R⁴⁰—B⁵—; R⁴⁰ is an alkylene group or a group containing —C(O)NR^{E6}—, —C(O)—, —NR^{E6}— or —O— between carbon atoms of an alkylene group having a carbon number of 2 or greater; B⁵ is —C(O)NR^{E6}—, —C(O)—, —NR^{E6}— or —O—; and B⁶ is —C(O)NR^{E6}—, —C(O)—, or —NR^{E6}—,
E² is a single bond or —B⁶—R⁴⁰—,
when the atom in Z¹ to which E³ is bonded is a carbon atom, E³ is E¹; and when the atom in Z¹ to which E³ is bonded is a nitrogen atom, E³ is E²,
E¹¹ is a single bond, —O—, an alkylene group, or a group containing —C(O)NR^{E6}—, —C(O)—, —NR^{E6}— or —O— between carbon atoms of an alkylene group having a carbon number of 2 or greater,
E²² is a single bond, —B⁵—, —R⁴⁰—B⁶—, or —B⁵—R⁴⁰—B⁶—; and when there are two or more E²², the two or more E²² may be the same as each other or different from each other,
E²³ is a single bond or —R⁴⁰—B⁶—, and two E²³ may be the same as each other or different from each other,
when the atom in Z¹ to which E²⁴ is bonded is a carbon atom, E²⁴ is E²²; and when the atom in Z¹ to which E²⁴ is bonded is a nitrogen atom, E²⁴ is E²³. Further, when there are two or more E²⁴, the two or more E²⁴ may be the same as each other or different from each other,
E²⁵ is a single bond or —R⁴⁰—B⁶—; and when there are two or more E²⁵, the two or more E²⁵ may be the same as each other or different from each other,
E²⁶ is a single bond or —R⁴⁰—B⁶—,
Z¹ is a group containing a ring structure containing a carbon atom or a nitrogen atom to which E³ is directly bonded and containing a carbon atom or a nitrogen atom to which E²⁴ is directly bonded, and having a valence of (e4+1),
R^{E1} is a hydrogen atom or an alkyl group, and when there are two or more R^{E1}, the two or more R^{E1} may be the same as each other or different from each other,
R^{E2} is a hydrogen atom, a hydroxyl group, an alkyl group, or an acyloxy group,
R^{E3} is an alkyl group,
R^{E6} is a hydrogen atom, or an alkyl group or a phenyl group having a carbon number of 1 to 6,
e1 is an integer of 0 to 2: e2 is an integer of 0 to 3; and e1+e2 is an integer of 1 to 5,
e3 is an integer of 1 to 3,
e4 is an integer of 1 or greater, and
e5 is an integer of 1 to 3.

Note that the following relations hold: e1+e2=x¹, e3=x¹, e4=x¹, and e5+1=x¹.

The carbon number of the alkylene group of R⁴⁰ is preferably 1 to 10, more preferably 1 to 6, and still more preferably 1 to 4 in view of the ease of manufacturing of the compound 1 and because the frictional durability, light stability, and chemical resistance of the surface layer are more improved. Note that the lower limit value of the carbon number of the alkylene group when there is a specific bond between carbon atoms is 2.

Examples of the ring structure in Z¹ include those described above, and its preferred forms are also similar to those described above. Note that since E²⁴ is directly bonded to the ring structure in Z¹, for example, an alkylene group is connected to the ring structure and E²⁴ is not bonded to this alkylene group.

The number of carbon atoms of the alkyl group of R^{E1}, R^{E2}, or R^{E3} is preferably 1 to 6, more preferably 1 to 3, and still more preferably 1 to 2 in view of the ease of manufacturing of the compound 1.

The number of carbon atoms of the alkyl group part of R^{E2} is preferably 1 to 6, more preferably 1 to 3, and still more preferably 1 to 2 in view of the ease of manufacturing of the compound 1.

e4 is preferably 2 to 6, more preferably 2 to 4, and still more preferably 2 or 3 in view of the ease of manufacturing of the compound 1 and because the frictional durability and the fingerprint stain removal property of the surface layer are more improved.

Examples of other forms of L¹ include groups represented by the below-shown Formulae (E11) to (E17).

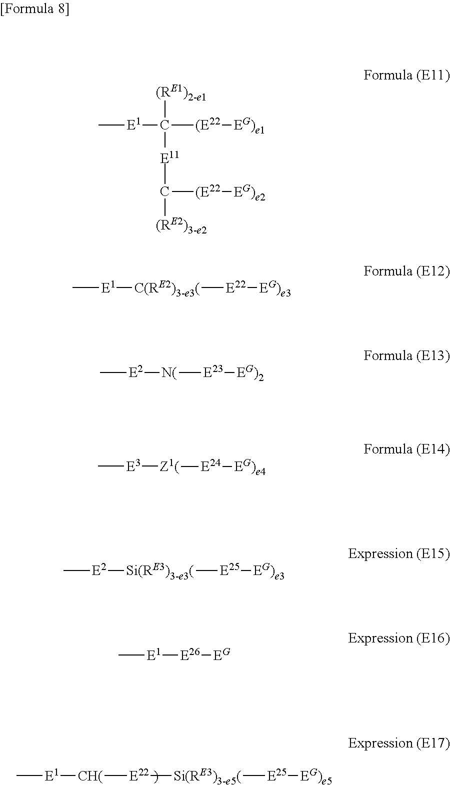

Note that in Formulae (E11) to (E17), the E¹, E², or E³ side is connected to R¹ in Formula (1), and the E²², E²³, E²⁴, E²⁵, or E²⁶ side is connected to R². E^{G} is represented by the below-shown Formula (E^{G}), and two or more E^{G} of L¹ may be the same as each other or different from each other. Symbols other than G are similar to those in Formulae (E1) to (E7).

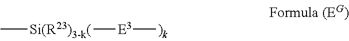

Note that in Formula (E^{G}), the Si side is connected to E²², E²³, E²⁴, E²⁵ or E²⁶, and the E³ side is connected to R². R²³ is an alkyl group. E³ is a single bond or —R⁴⁵—B⁶—; R⁴⁵ is an alkylene group, a group containing —C(O)NR⁴⁶—, —C(O)—, —NR⁴⁶— or —O— between carbon atoms of an alkylene group having a carbon number of 2 or greater, or —(OSi(R²⁴)₂)ₚ—O—; and two or more E³ may be the same as each other or different from each other. k is 2 or 3. R⁴⁶ is a hydrogen atom, or an alkyl group or a phenyl group having a carbon number of 1 to 6. R²⁴ is an alkyl group, a phenyl group, or an alkoxy group, and two or more R²⁴ may be the same as each other or different from each other. p is an integer of 0 to 5. When p is 2 or greater, two or more (OSi(R²⁴)₂) may be the same as each other or different from each other.

The carbon number of the alkylene group of E³ is preferably 1 to 10, more preferably 1 to 6, and still more preferably 1 to 4 in view of the ease of manufacturing of the compound 1 and because the frictional durability, light stability, and chemical resistance of the surface layer are more improved. Note that the lower limit value of the carbon number of the alkylene group when there is a specific bond between carbon atoms is 2.

The carbon number of the alkyl group of R²³ is preferably 1 to 6, more preferably 1 to 3, and still more preferably 1 to 2 in view of the ease of manufacturing of the compound 1.

The carbon number of the alkyl group of R²⁴ is preferably 1 to 6, more preferably 1 to 3, and still more preferably 1 to 2 in view of the ease of manufacturing of the compound 1.

The carbon number of the alkoxy group of R²⁴ is preferably 1 to 6, more preferably 1 to 3, and still more preferably 1 or 2 because the storage stability of the compound 1 is improved.

p is preferably 0 or 1.

R² is a single bond, an alkylene group, or an alkylene group having an etheric oxygen atom.

When there are a plurality of R², the plurality of R² may be the same as each other or different from each other.

The carbon number of the alkylene group and the alkylene group containing an etheric oxygen atom in R² is preferably 1 to 20, more preferably 1 to 15, and still more preferably 1 to 11. When the carbon number of the alkylene group or the alkylene group containing an etheric oxygen atom is 3 or greater, the carbon number of the alkylene group or the alkylene group containing an etheric oxygen atom having a carbon number of 3 or greater may be linear, or may have a branched or ring structure.

In the alkylene group containing an etheric oxygen atom, the atom bonded to L¹ may be an etheric oxygen atom or may have an etheric oxygen atom between carbon atoms.

R² is preferably a group represented by the below-shown Formula (H1).

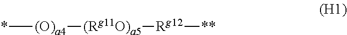

where
R^{g11} is an alkylene group having a carbon number of 1 to 12, and when there are a plurality of R^{g11}, the plurality of R^{g11} may be the same as each other or different from each other, and
R^{g12} is an alkylene group having a carbon number of 1 to 12,
a4 is 0 or 1,
a5 is an integer of 0 or greater,
* represents a bond that is bonded to L¹, and
** represents a bond that is bonded to T¹.

When a4 is 0, the atom having the bond * is a carbon atom, and when a4 is 1, the atom having the bond * is an oxygen atom. In the compound 1, a4 may be either 0 or 1, and may be selected as appropriate in view of the case of synthesis or the like.

a5 is a repetition number of R^{g11}O, and is preferably 0 to 6, more preferably 0 to 3, and still more preferably 0 or 1 in view of the durability or the like as the surface layer.

The alkylene group of R^{g11} may be an alkylene group having a carbon number of 1 to 12 and having a straight chain or a branch, and is preferably an alkylene group having a carbon number of 1 to 6, and more preferably an alkylene group having a carbon number of 1 to 3. Further, this alkylene group is preferably a linear alkylene group.

The alkylene group of R^{g12} may be an alkylene group having a carbon number of 1 to 12 and having a straight chain or a branch, and is preferably an alkylene group having a carbon number of 2 to 6, and more preferably an alkylene group having a carbon number of 2 or 3. Further, this alkylene group is preferably a linear alkylene group.

When L¹ is a single bond, —R¹-L¹-(R²-T¹)ₓ₁ can be expressed by the below-shown Formula (RL-1):

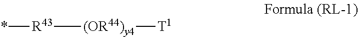

where
R⁴³ is a single bond or an alkylene group having a carbon number of 1 to 6,
R⁴⁴ is an alkylene group having a carbon number of 1 to 6. When there are a plurality of R⁴⁴, the plurality of R⁴⁴ may be the same as each other or different from each other,
y4 is an integer of 0 or greater.
* represents a bond that is bonded to R^{f1} of Formula (1).

Note that when R⁴³ is a single bond, y4 is an integer of 1 or greater.

Note that when R⁴³ is a single bond, the compound 1 has a structure in which O at the end of (OR⁴⁴)_{y4} is directly bonded to R^{f1} of Formula (1).

Further, when y4 is 0, the compound 1 has a structure in which R⁴³ is directly bonded to T¹.

T¹ is a reactive group, and the compound 1 exhibits various functions owing to the reactivity of T¹. Examples of these functions include a function of improving the adhesive property to the surface of the substrate, a function of imparting photosetting and/or thermosetting properties to the compound 1, a function of imparting acidic/alkalinity or the like to the compound 1, a function of adjusting the solubility of the compound 1 in a specific solvent, and a function of serving as a precursor for the synthesis of other compounds.

Specific examples of T¹ include —Ar, —SR¹⁰, —NOR¹⁰, —C(═O)R¹⁰, —N(R¹⁰)₂, —N+(R¹⁰)₃X³, —C≡N, —C(═NR¹⁰)—R¹⁰, —N+≡N, —N═NR¹⁰, —C(═O)OR¹⁰, —C(═O)OX², —C(═O)X⁴, —C(═O)OC(═O)R¹⁹, —SO₂R¹⁹, —SO₃H, —SO₃X², —O—P(═O)(—OR¹⁰)₂, —O—P(═O)(—OR¹⁰)(—OX²), —N═C═O, —SiR^{a1}_{z1}R^{a11}_{3-z1}, —C(R¹⁰)═C(R¹⁰)₂, —C≡C(R¹⁰), —C(═O)N(R¹⁰)₂, —N(R¹⁰)C(═O)R¹⁰, —Si(R¹⁰)₂—O—Si(R¹⁰)₃, —NH—C(═O)R¹⁰, —C(═O)NHR¹⁰, —I, and groups represented by the below-shown formulae.

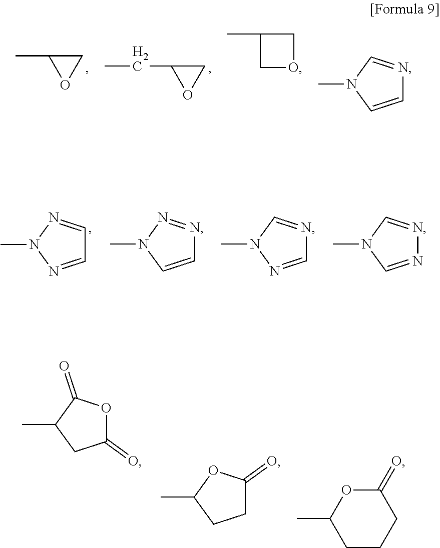

where
R¹⁰ is a hydrogen atom, an alkyl group having a carbon number of 1 to 6, which may have a substituent, or a fluoroalkyl group having a carbon number of 1 to 6, which may have a substituent, or an aryl group, which may have a substituent,
Ar is an aryl group which may have a substituent.
X² is an alkali metal ion or an ammonium ion,
X³ is a halide ion,
X⁴ is a halogen atom.
R^{a1} is a hydrolyzable group or a hydroxyl group.
R^{a11} is a hydrocarbon group,
z¹ is an integer of 1 to 3, and
when there are a plurality of R¹⁰, R^{a1} or R^{a11}, the plurality of R¹⁰, R^{a1} or R^{a11} may be the same as each other or different from each other.

The carbon number of the fluoroalkyl group in R¹⁰ is 1 to 6, and preferably 1 to 3. This fluoroalkyl group may contain other substituents. A compound 1 containing a fluoroalkyl group as T¹ becomes a compound of which the content of fluorine is high, and has various excellent properties such as a low refractive index, a low dielectric constant, water/oil repellency, heat resistance, chemical resistance, chemical stability, and transparency. Examples of substituents that the fluoroalkyl group may contain include a halogen atom such as a chlorine atom, and those that are shown as examples of a function-imparting group T (which will be describe later).

Examples of the aryl group in Ar and R¹⁰ include a phenyl group and a naphthyl group, and the aryl group may further contain a substituent. Examples of substituents that the aryl group may contain include a fluorine atom, a halogen atom such as a chlorine atom, an alkyl group having a carbon number of 1 to 6, and those that are shown as examples of the function-imparting group T.

The carbon number of the alkyl group in R¹⁰ is 1 to 6, and preferably 1 to 3. This alkyl group may contain other substituents. Substituents that the alkyl group may contain include a halogen atom such as a chlorine atom, and those that are shown as examples of the function-imparting group T (which will be described later).

Compounds 1 containing, as the reactive group T¹, a hydroxy group, an N-hydroxy group, an aldehyde group, a ketone group, an amino group, a quaternary ammonium group, a nitrile group, an imino group, a diazo group, a carboxy group, a carboxylate group, an acid anhydride group, a sulfo group, a sulfonate group, a phosphate group, and a phosphate group (hereinafter, these groups are also referred to as “function-imparting groups T”) are given, by this function-imparting groups T, various properties such as acidity, alkalinity, and hydrophilicity, and impart, for example, functions such as improved solubility in a specific solvent and an improved adhesive property to a specific substrate. Examples of counterions of quaternary ammonium groups include halide ions. Examples of counterions of carboxylate, sulfonate, and phosphate include alkali metal ions and ammonium ions.

A compound 1 containing a group containing a carbon-carbon double bond as the reactive group T¹ can make it possible to prepare a photocurable composition by combining it with a photo-initiator or the like, and a cured coating film obtained by this composition has both water/oil repellency and a hard coating property. Examples of groups having a carbon-carbon double bond include acryloyl groups, methacryloyl groups, vinyl groups, allyl groups, acryloyloxy groups, methacryloyloxy groups, and olefins.

Further, compounds 1 containing, as the reactive group T¹, an isocyanate group, an epoxy group, a glycidyl group, an oxetanyl group, and a mercapto group can make it possible to prepare a photocurable composition by combining it with a poxy curing agent, and a cured coating film obtained by this composition has both water/oil repellency and a hard coating property.

The amide bond, ester bond, ether bond, thioether bond, siloxane bond, and urea bond in the reactive group T¹ are bonded to the alkyl group, fluoroalkyl group, aryl group, heteroaryl group, and the like contained in T¹. It is also possible to have other function-imparting groups through these bonds.

The reactive group T¹ of the compound 1 is preferably a group containing a hydroxy group, an amino group, or a carbon-carbon double bond in view of the synthesis, the chemical stability, and the adhesive property to the substrate. Further, among the groups having a carbon-carbon double bond, an acryloyl group, a methacryloyl group, a vinyl group, an allyl group, or an olefin is preferred.

Further, when the compound 1 is used as a surface treatment agent for forming a surface layer having excellent durability such as frictional durability, T¹ is preferably a group containing a reactive silyl group. The reactive silyl group is preferably a group represented by the below-shown Formula (2).

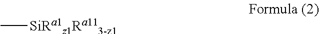

In Formula (2),
R^{a1} is a hydrolyzable group or a hydroxyl group,
R^{a11} is a hydrocarbon group,
z¹ is an integer of 1 to 3, and
when there are a plurality of R^{a1} or R^{a11}, the plurality of R^{a1} or R^{a11} may be the same as each other or different from each other.

When R^{a1} is a hydroxyl group, it constitutes a silanol (Si—OH) group with an Si atom. Further, the hydrolyzable group is a group that becomes a hydroxyl group through a hydrolysis reaction. The silanol group further reacts between molecules, and thereby forms an Si—O—Si bond. Further, the silanol group has a dehydration condensation reaction with a hydroxyl group present on the surface of the substrate (substrate-OH), and thereby forms a chemical bond (substrate-O—Si). As the compound 1 contains one or more T′, it has excellent frictional durability after the surface layer is formed.

Examples of the hydrolyzable group of R^{a1} include alkoxy groups, aryloxy groups, halogen atoms, acyl groups, acyloxy groups, and isocyanate groups (—NCO). As the alkoxy group, an alkoxy group having a carbon number of 1 to 4 is preferred. As the acyl group, an acyl group having a carbon number of 1 to 6 is preferred. As the acyloxy group, an acyloxy group having a carbon number of 1 to 6 is preferred.

R^{a1} is preferably an alkoxy group having a carbon number of 1 to 4 or a halogen atom in view of the ease of synthesis. The alkoxy group in R^{a1} is preferably an alkoxy group having a carbon number of 1 to 4 because the storage stability of the compound 1 is improved and the outgassing during the reaction is suppressed, and more preferably an ethoxy group in view of the long-term storage stability, and is preferably a methoxy group in order to shorten the hydrolysis reaction time. Alternatively, as the halogen atom, a chlorine atom is particularly preferred.

R^{a11} is a hydrocarbon group. Examples of hydrocarbon groups include alkyl groups, cycloalkyl groups, alkenyl groups, and allyl groups, and alkyl groups are preferred in view of the ease of synthesis or the like. Further, the carbon number of the hydrocarbon group is preferably 1 to 6, more preferably 1 to 3, and still more preferably 1 or 2 in view of the ease of synthesis or the like.

The number z¹ of R^{a1} in the group represented by Formula (2) may be 1 to 3, and is preferably 2 or 3, and more preferably 3 in view of the adhesive property to the substrate.

Specific examples of groups represented by Formula (2) include —Si(OCH₃)₃, —SiCH₃(OCH₃)₂, —Si(OCH₂CH₃)₃, —SiCL₃, —Si(OCOCH₃)₃, and —Si(NCO)₃, —Si(OCH₃)₃ is preferred in view of ease of the handling in the manufacturing process.

The number x1 of T¹ in one molecule of the compound 1 may be 1 to 10, and x1 is preferably 1 to 6 and more preferably 1 to 3 in view of the ease of synthesis and the ease of handling of the compound 1. When there are two or more T¹ in one molecule of the compound 1, these T¹ may have structures identical to each other or different from each other.

Specific examples where T¹ does not have a reactive silyl group include the below-shown structures. Note that in the formula, R^{a} represents an alkyl group, which may have a substituent, a fluoroalkyl group, or an aryl group; R^{b} represents a fluoroalkyl group, which may have a substituent, or an aryl group; R represents an alkyl group having a carbon number of 1 to 6, which may have a substituent, or a fluoroalkyl group having a carbon number of 1 to 6, which may have a substituent; L represents an aryl group, which may have a substituent, or a fluoroaryl group, which may have a substituent; c represents an integer of 0 to 3; and * represents a bond.

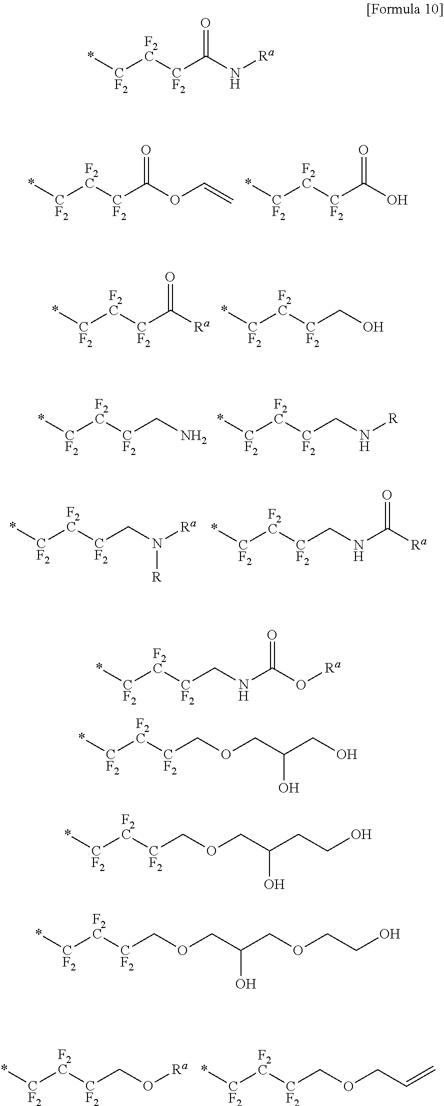

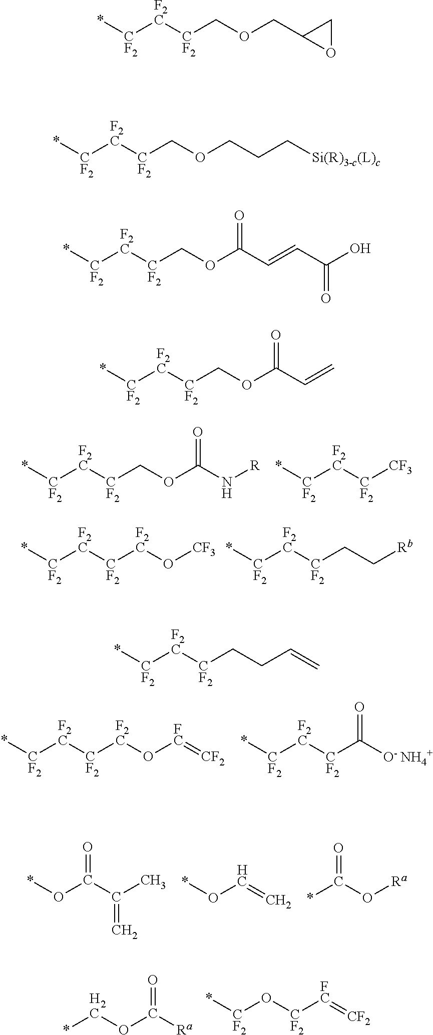

Further, specific examples of L¹-(R¹-T¹)ₓ₁ include groups represented by the below-shown formulae.

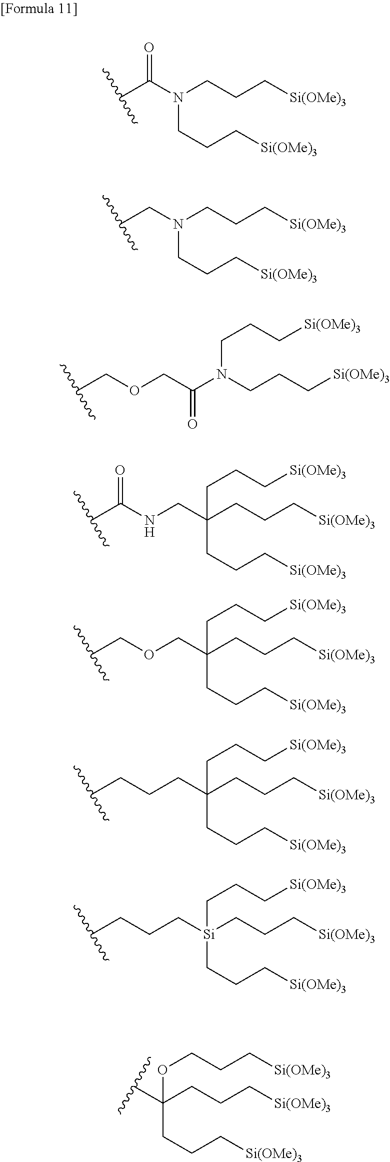

In Formula (1), —R¹-L¹-(R²-T¹)ₓ₁ preferably does not contain a fluorine atom because the effects of the present invention are more improved.

Specific examples of the compound 1 include, for example, compounds represented in the below-shown table. Note that in the below-shown table, for example, a compound of “No. 1” means a compound of the above-shown Formula (1) in which: R^{f1} is CF₃; R¹ is (CH₂)ₙ; L¹ is C(═O)NH; R² is (CH₂)_{C}; T¹ is Si(OMe)₃; x1 is 1; a of (CH₂)ₐ in R¹ is 0 to 20; and C of (CH₂)_{C} in R² is 1 to 20.

TABLE 1

| No. | R^{f1} | R¹ | a | L¹ | R² | c | T¹ | x1 | R³⁶ |
|---|---|---|---|---|---|---|---|---|---|
| 1 | CF₃ | (CH₂)ₐ | 0 to 20 | C(═O)NH | (CH₂)_{c} | 1 to 20 | Si(OMe)₃ | 1 | Me |
| 2 | (CF₃)₂CF | (CH₂)ₐ | 0 to 20 | C(═O)NH | (CH₂)_{c} | 1 to 20 | Si(OMe)₃ | 1 | Me |
| 3 | (CF₃)₃C | (CH₂)ₐ | 0 to 20 | C(═O)NH | (CH₂)_{c} | 1 to 20 | Si(OMe)₃ | 1 | Me |
| 4 | C₄F₉ | (CH₂)ₐ | 0 to 20 | C(═O)NH | (CH₂)_{c} | 1 to 20 | Si(OMe)₃ | 1 | Me |
| 5 | C₈F₁₇ | (CH₂)ₐ | 0 to 20 | C(═O)NH | (CH₂)_{c} | 1 to 20 | Si(OMe)₃ | 1 | Me |
| 6 | c-C₆F₁₁ | (CH₂)ₐ | 0 to 20 | C(═O)NH | (CH₂)_{c} | 1 to 20 | Si(OMe)₃ | 1 | Me |
| 7 | CHF₂ | (CH₂)ₐ | 0 to 20 | C(═O)NH | (CH₂)_{c} | 1 to 20 | Si(OMe)₃ | 1 | Me |
| 8 | CClF₂ | (CH₂)ₐ | 0 to 20 | C(═O)NH | (CH₂)_{c} | 1 to 20 | Si(OMe)₃ | 1 | Me |
| 9 | CBrF₂ | (CH₂)ₐ | 0 to 20 | C(═O)NH | (CH₂)_{c} | 1 to 20 | Si(OMe)₃ | 1 | Me |
| 10 | CIF₂ | (CH₂)ₐ | 0 to 20 | C(═O)NH | (CH₂)_{c} | 1 to 20 | Si(OMe)₃ | 1 | Me |
| 11 | CF═CF₂ | (CH₂)ₐ | 0 to 20 | C(═O)NH | (CH₂)_{c} | 1 to 20 | Si(OMe)₃ | 1 | Me |
| 12 | CF═CFCF₃ | (CH₂)ₐ | 0 to 20 | C(═O)NH | (CH₂)_{c} | 1 to 20 | Si(OMe)₃ | 1 | Me |
| 13 | CF═CFCF═CF₂ | (CH₂)ₐ | 0 to 20 | C(═O)NH | (CH₂)_{c} | 1 to 20 | Si(OMe)₃ | 1 | Me |
| 14 | C≡CCF₃ | (CH₂)ₐ | 0 to 20 | C(═O)NH | (CH₂)_{c} | 1 to 20 | Si(OMe)₃ | 1 | Me |
| 15 | CF₂CH₃ | (CH₂)ₐ | 0 to 20 | C(═O)NH | (CH₂)_{c} | 1 to 20 | Si(OMe)₃ | 1 | Me |

TABLE 2

| No. | R^{f1} | R¹ | a | L¹ | R² | c | T¹ | x1 | R³⁶ |
|---|---|---|---|---|---|---|---|---|---|
| 16 | (CF₂)₂H | (CH₂)ₐ | 0 to 20 | C(═O)NH | (CH₂)_{c} | 1 to 20 | Si(OMe)₃ | 1 | Me |
| 17 | (CF₂)₂CH₃ | (CH₂)ₐ | 0 to 20 | C(═O)NH | (CH₂)_{c} | 1 to 20 | Si(OMe)₃ | 1 | Me |
| 18 | (CF₂)₄H | (CH₂)ₐ | 0 to 20 | C(═O)NH | (CH₂)_{c} | 1 to 20 | Si(OMe)₃ | 1 | Me |
| 19 | C₆F₅ | (CH₂)ₐ | 0 to 20 | C(═O)NH | (CH₂)_{c} | 1 to 20 | Si(OMe)₃ | 1 | Me |
| 20 | 4-CF₃C₅F₄ | (CH₂)ₐ | 0 to 20 | C(═O)NH | (CH₂)_{c} | 1 to 20 | Si(OMe)₃ | 1 | Me |
| 21 | 4-SF₅C₆F₄ | (CH₂)ₐ | 0 to 20 | C(═O)NH | (CH₂)_{c} | 1 to 20 | Si(OMe)₃ | 1 | Me |
| 22 | 3,5-CF₃C₆F₃ | (CH₂)ₐ | 0 to 20 | C(═O)NH | (CH₂)_{c} | 1 to 20 | Si(OMe)₃ | 1 | Me |
| 23 | 3,5-SF₅C₆F₃ | (CH₂)ₐ | 0 to 20 | C(═O)NH | (CH₂)_{c} | 1 to 20 | Si(OMe)₃ | 1 | Me |
| 24 | 4-CF₃C₆H₄ | (CH₂)ₐ | 0 to 20 | C(═O)NH | (CH₂)_{c} | 1 to 20 | Si(OMe)₃ | 1 | Me |
| 25 | 4-SF₅C₆H₄ | (CH₂)ₐ | 0 to 20 | C(═O)NH | (CH₂)_{c} | 1 to 20 | Si(OMe)₃ | 1 | Me |
| 26 | 3,5-CF₃C₆H₃ | (CH₂)ₐ | 0 to 20 | C(═O)NH | (CH₂)_{c} | 1 to 20 | Si(OMe)₃ | 1 | Me |
| 27 | 3,5-SF₅C₆H₃ | (CH₂)ₐ | 0 to 20 | C(═O)NH | (CH₂)_{c} | 1 to 20 | Si(OMe)₃ | 1 | Me |
| 28 | 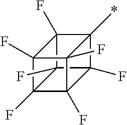 [SMILES: *C12C3(F)C4(F)C1(F)C1(F)C2(F)C3(F)C41F] | (CH₂)ₐ | 0 to 20 | C(═O)NH | (CH₂)_{c} | 1 to 20 | Si(OMe)₃ | 1 | Me |
| 29 | 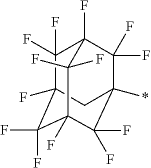 [SMILES: *C12CC3(F)C(F)(F)C(F)(C1(F)F)C(F)(F)C(F)(C2(F)F)C3(F)F] | (CH₂)ₐ | 0 to 20 | C(═O)NH | (CH₂)_{c} | 1 to 20 | Si(OMe)₃ | 1 | Me |
| 30 | 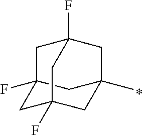 | (CH₂)ₐ | 0 to 20 | C(═O)NH | (CH₂)_{c} | 1 to 20 | Si(OMe)₃ | 1 | Me |

TABLE 3

| No. | R^{f1} | R¹ | a | L¹ | R² | c | T¹ | x1 | R³⁶ |
|---|---|---|---|---|---|---|---|---|---|
| 31 | CH₂F | (CH₂)ₐ | 0 to 20 | C(═O)NH | (CH₂)_{c} | 1 to 20 | Si(OMe)₃ | 1 | Me |
| 32 | SF₅ | (CH₂)ₐ | 0 to 20 | C(═O)NH | (CH₂)_{c} | 1 to 20 | Si(OMe)₃ | 1 | Me |
| 33 | OCF₃ | (CH₂)ₐ | 0 to 20 | C(═O)NH | (CH₂)_{c} | 1 to 20 | Si(OMe)₃ | 1 | Me |
| 34 | SCF₃ | (CH₂)ₐ | 0 to 20 | C(═O)NH | (CH₂)_{c} | 1 to 20 | Si(OMe)₃ | 1 | Me |
| 35 | N(CH₂CF₃)₂ | (CH₂)ₐ | 0 to 20 | C(═O)NH | (CH₂)_{c} | 1 to 20 | Si(OMe)₃ | 1 | Me |
| 36 | N(CF₃)₂ | (CH₂)ₐ | 0 to 20 | C(═O)NH | (CH₂)_{c} | 1 to 20 | Si(OMe)₃ | 1 | Me |
| 37 | CF₃ | (CH₂)ₐ | 0 to 20 | NHC(═O) | (CH₂)_{c} | 1 to 20 | Si(OMe)₃ | 1 | Me |
| 38 | (CF₃)₂CF | (CH₂)ₐ | 0 to 20 | NHC(═O) | (CH₂)_{c} | 1 to 20 | Si(OMe)₃ | 1 | Me |
| 39 | (CF₃)₃C | (CH₂)ₐ | 0 to 20 | NHC(═O) | (CH₂)_{c} | 1 to 20 | Si(OMe)₃ | 1 | Me |
| 40 | C₄F₉ | (CH₂)ₐ | 0 to 20 | NHC(═O) | (CH₂)_{c} | 1 to 20 | Si(OMe)₃ | 1 | Me |
| 41 | C₈F₁₇ | (CH₂)ₐ | 0 to 20 | NHC(═O) | (CH₂)_{c} | 1 to 20 | Si(OMe)₃ | 1 | Me |
| 42 | c-C₆F₁₁ | (CH₂)ₐ | 0 to 20 | NHC(═O) | (CH₂)_{c} | 1 to 20 | Si(OMe)₃ | 1 | Me |
| 43 | CHF₂ | (CH₂)ₐ | 0 to 20 | NHC(═O) | (CH₂)_{c} | 1 to 20 | Si(OMe)₃ | 1 | Me |
| 44 | CClF₂ | (CH₂)ₐ | 0 to 20 | NHC(═O) | (CH₂)_{c} | 1 to 20 | Si(OMe)₃ | 1 | Me |
| 45 | CBrF₂ | (CH₂)ₐ | 0 to 20 | NHC(═O) | (CH₂)_{c} | 1 to 20 | Si(OMe)₃ | 1 | Me |

TABLE 4

| No. | R^{f1} | R¹ | a | L¹ | R² | c | T¹ | x1 | R³⁶ |
|---|---|---|---|---|---|---|---|---|---|
| 46 | ClF₂ | (CH₂)ₐ | 0 to 20 | NHC(═O) | (CH₂)_{c} | 1 to 20 | Si(OMe)₃ | 1 | Me |
| 47 | CF═CF₂ | (CH₂)ₐ | 0 to 20 | NHC(═O) | (CH₂)_{c} | 1 to 20 | Si(OMe)₃ | 1 | Me |
| 48 | CF═CFCF₃ | (CH₂)ₐ | 0 to 20 | NHC(═O) | (CH₂)_{c} | 1 to 20 | Si(OMe)₃ | 1 | Me |
| 49 | CF═CFCF═CF₂ | (CH₂)ₐ | 0 to 20 | NHC(═O) | (CH₂)_{c} | 1 to 20 | Si(OMe)₃ | 1 | Me |
| 50 | C≡CCF₃ | (CH₂)ₐ | 0 to 20 | NHC(═O) | (CH₂)_{c} | 1 to 20 | Si(OMe)₃ | 1 | Me |
| 51 | CF₂CH₃ | (CH₂)ₐ | 0 to 20 | NHC(═O) | (CH₂)_{c} | 1 to 20 | Si(OMe)₃ | 1 | Me |
| 52 | (CF₂)₂H | (CH₂)ₐ | 0 to 20 | NHC(═O) | (CH₂)_{c} | 1 to 20 | Si(OMe)₃ | 1 | Me |
| 53 | (CF₂)₂CH₃ | (CH₂)ₐ | 0 to 20 | NHC(═O) | (CH₂)_{c} | 1 to 20 | Si(OMe)₃ | 1 | Me |
| 54 | (CF₂)₄H | (CH₂)ₐ | 0 to 20 | NHC(═O) | (CH₂)_{c} | 1 to 20 | Si(OMe)₃ | 1 | Me |
| 55 | C₆F₅ | (CH₂)ₐ | 0 to 20 | NHC(═O) | (CH₂)_{c} | 1 to 20 | Si(OMe)₃ | 1 | Me |
| 56 | 4-CF₃C₆F₄ | (CH₂)ₐ | 0 to 20 | NHC(═O) | (CH₂)_{c} | 1 to 20 | Si(OMe)₃ | 1 | Me |
| 57 | 4-SF₅C₆F₄ | (CH₂)ₐ | 0 to 20 | NHC(═O) | (CH₂)_{c} | 1 to 20 | Si(OMe)₃ | 1 | Me |
| 58 | 3,5-CF₃C₆F₃ | (CH₂)ₐ | 0 to 20 | NHC(═O) | (CH₂)_{c} | 1 to 20 | Si(OMe)₃ | 1 | Me |
| 59 | 3,5-SF₅C₆F₃ | (CH₂)ₐ | 0 to 20 | NHC(═O) | (CH₂)_{c} | 1 to 20 | Si(OMe)₃ | 1 | Me |
| 60 | 4-CF₃C₆H₄ | (CH₂)ₐ | 0 to 20 | NHC(═O) | (CH₂)_{c} | 1 to 20 | Si(OMe)₃ | 1 | Me |

TABLE 5

| No. | R^{f1} | R¹ | a | L¹ | R² | c | T¹ | x1 | R³⁶ |
|---|---|---|---|---|---|---|---|---|---|
| 63. | 4-SF₅C₆H₄ | (CH₂)ₐ | 0 to 20 | NHC(═O) | (CH₂)_{c} | 1 to 20 | Si(OMe)₃ | 1 | Me |
| 62 | 3,5-CF₃C₆H₃ | (CH₂)ₐ | 0 to 20 | NHC(═O) | (CH₂)_{c} | 1 to 20 | Si(OMe)₃ | 1 | Me |
| 63 | 3,5-SF₅C₆H₃ | (CH₂)ₐ | 0 to 20 | NHC(═O) | (CH₂)_{c} | 1 to 20 | Si(OMe)₃ | 1 | Me |
| 64 | 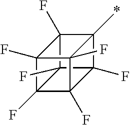 [SMILES: *C12C3(F)C4(F)C1(F)C1(F)C2(F)C3(F)C41F] | (CH₂)ₐ | 0 to 20 | NHC(═O) | (CH₂)_{c} | 1 to 20 | Si(OMe)₃ | 1 | Me |
| 65 | 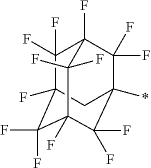 [SMILES: *C12CC3(F)C(F)(F)C(F)(C1(F)F)C(F)(F)C(F)(C2(F)F)C3(F)F] | (CH₂)ₐ | 0 to 20 | NHC(═O) | (CH₂)_{c} | 1 to 20 | Si(OMe)₃ | 1 | Me |
| 66 | 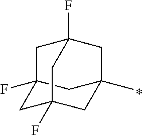 | (CH₂)ₐ | 0 to 20 | NHC(═O) | (CH₂)_{c} | 1 to 20 | Si(OMe)₃ | 1 | Me |
| 67 | CH₂F | (CH₂)ₐ | 0 to 20 | NHC(═O) | (CH₂)_{c} | 1 to 20 | Si(OMe)₃ | 1 | Me |
| 68 | SF₅ | (CH₂)ₐ | 0 to 20 | NHC(═O) | (CH₂)_{c} | 1 to 20 | Si(OMe)₃ | 1 | Me |
| 69 | OCF₃ | (CH₂)ₐ | 0 to 20 | NHC(═O) | (CH₂)_{c} | 1 to 20 | Si(OMe)₃ | 1 | Me |
| 70 | SCF₃ | (CH₂)ₐ | 0 to 20 | NHC(═O) | (CH₂)_{c} | 1 to 20 | Si(OMe)₃ | 1 | Me |
| 71 | N(CH₂CF₃)₂ | (CH₂)ₐ | 0 to 20 | NHC(═O) | (CH₂)_{c} | 1 to 20 | Si(OMe)₃ | 1 | Me |
| 72 | N(CF₃)₂ | (CH₂)ₐ | 0 to 20 | NHC(═O) | (CH₂)_{c} | 1 to 20 | Si(OMe)₃ | 1 | Me |
| 73 | CF₃ | (CH₂)ₐ | 0 to 20 | OC(═O)CH₂ | (CH₂)_{c} | 1 to 20 | Si(OMe)₃ | 1 | Me |
| 74 | (CF₃)₂CF | (CH₂)ₐ | 0 to 20 | OC(═O)CH₂ | (CH₂)_{c} | 1 to 20 | Si(OMe)₃ | 1 | Me |
| 75 | (CF₃)₃C | (CH₂)ₐ | 0 to 20 | OC(═O)CH₂ | (CH₂)_{c} | 1 to 20 | Si(OMe)₃ | 1 | Me |

TABLE 6

| No. | R^{f1} | R¹ | a | L¹ | R² | c | T¹ | x1 | R³⁶ |
|---|---|---|---|---|---|---|---|---|---|
| 76 | C₄F₉ | (CH₂)ₐ | 0 to 20 | OC(═O)CH₂ | (CH₂)_{c} | 1 to 20 | Si(OMe)₃ | 1 | Me |
| 77 | C₈F₁₇ | (CH₂)ₐ | 0 to 20 | OC(═O)CH₂ | (CH₂)_{c} | 1 to 20 | Si(OMe)₃ | 1 | Me |
| 78 | c-C₆F₁₁ | (CH₂)ₐ | 0 to 20 | OC(═O)CH₂ | (CH₂)_{c} | 1 to 20 | Si(OMe)₃ | 1 | Me |
| 79 | CHF₂ | (CH₂)ₐ | 0 to 20 | OC(═O)CH₂ | (CH₂)_{c} | 1 to 20 | Si(OMe)₃ | 1 | Me |
| 80 | CClF₂ | (CH₂)ₐ | 0 to 20 | OC(═O)CH₂ | (CH₂)_{c} | 1 to 20 | Si(OMe)₃ | 1 | Me |
| 81 | CBrF₂ | (CH₂)ₐ | 0 to 20 | OC(═O)CH₂ | (CH₂)_{c} | 1 to 20 | Si(OMe)₃ | 1 | Me |
| 82 | ClF₂ | (CH₂)ₐ | 0 to 20 | OC(═O)CH₂ | (CH₂)_{c} | 1 to 20 | Si(OMe)₃ | 1 | Me |
| 83 | CF═CF₂ | (CH₂)ₐ | 0 to 20 | OC(═O)CH₂ | (CH₂)_{c} | 1 to 20 | Si(OMe)₃ | 1 | Me |
| 84 | CF═CFCF₃ | (CH₂)ₐ | 0 to 20 | OC(═O)CH₂ | (CH₂)_{c} | 1 to 20 | Si(OMe)₃ | 1 | Me |
| 85 | CF═CFCF═CF₂ | (CH₂)ₐ | 0 to 20 | OC(═O)CH₂ | (CH₂)_{c} | 1 to 20 | Si(OMe)₃ | 1 | Me |
| 86 | C≡CCF₃ | (CH₂)ₐ | 0 to 20 | OC(═O)CH₂ | (CH₂)_{c} | 1 to 20 | Si(OMe)₃ | 1 | Me |
| 87 | CF₂CH₃ | (CH₂)ₐ | 0 to 20 | OC(═O)CH₂ | (CH₂)_{c} | 1 to 20 | Si(OMe)₃ | 1 | Me |
| 88 | (CF₂)₂H | (CH₂)ₐ | 0 to 20 | OC(═O)CH₂ | (CH₂)_{c} | 1 to 20 | Si(OMe)₃ | 1 | Me |
| 89 | (CF₂)₂CH₃ | (CH₂)ₐ | 0 to 20 | OC(═O)CH₂ | (CH₂)_{c} | 1 to 20 | Si(OMe)₃ | 1 | Me |
| 90 | (CF₂)₄H | (CH₂)ₐ | 0 to 20 | OC(═O)CH₂ | (CH₂)_{c} | 1 to 20 | Si(OMe)₃ | 1 | Me |

TABLE 7

| No. | R^{f1} | R¹ | a | L¹ | R² | c | T¹ | x1 | R³⁶ |
|---|---|---|---|---|---|---|---|---|---|
| 91 | C₆F₅ | (CH₂)ₐ | 0 to 20 | OC(═O)CH₂ | (CH₂)_{c} | 1 to 20 | Si(OMe)₃ | 1 | Me |
| 92 | 4-CF₃C₆F₄ | (CH₂)ₐ | 0 to 20 | OC(═O)CH₂ | (CH₂)_{c} | 1 to 20 | Si(OMe)₃ | 1 | Me |
| 93 | 4-SF₅C₆F₄ | (CH₂)ₐ | 0 to 20 | OC(═O)CH₂ | (CH₂)_{c} | 1 to 20 | Si(OMe)₃ | 1 | Me |
| 94 | 3,5-CF₃C₆F₃ | (CH₂)ₐ | 0 to 20 | OC(═O)CH₂ | (CH₂)_{c} | 1 to 20 | Si(OMe)₃ | 1 | Me |
| 95 | 3,5-SF₅C₆F₃ | (CH₂)ₐ | 0 to 20 | OC(═O)CH₂ | (CH₂)_{c} | 1 to 20 | Si(OMe)₃ | 1 | Me |
| 96 | 4-CF₃C₆H₄ | (CH₂)ₐ | 0 to 20 | OC(═O)CH₂ | (CH₂)_{c} | 1 to 20 | Si(OMe)₃ | 1 | Me |
| 97 | 4-SF₅C₆H₄ | (CH₂)ₐ | 0 to 20 | OC(═O)CH₂ | (CH₂)_{c} | 1 to 20 | Si(OMe)₃ | 1 | Me |
| 98 | 3,5-CF₃C₆H₃ | (CH₂)ₐ | 0 to 20 | OC(═O)CH₂ | (CH₂)_{c} | 1 to 20 | Si(OMe)₃ | 1 | Me |
| 99 | 3,5-SF₅C₆H₃ | (CH₂)ₐ | 0 to 20 | OC(═O)CH₂ | (CH₂)_{c} | 1 to 20 | Si(OMe)₃ | 1 | Me |
| 100 | 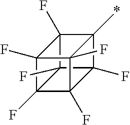 [SMILES: *C12C3(F)C4(F)C1(F)C1(F)C2(F)C3(F)C41F] | (CH₂)ₐ | 0 to 20 | OC(═O)CH₂ | (CH₂)_{c} | 1 to 20 | Si(OMe)₃ | 1 | Me |
| 101 | 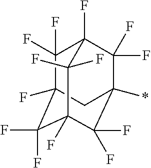 [SMILES: *C12CC3(F)C(F)(F)C(F)(C1(F)F)C(F)(F)C(F)(C2(F)F)C3(F)F] | (CH₂)ₐ | 0 to 20 | OC(═O)CH₂ | (CH₂)_{c} | 1 to 20 | Si(OMe)₃ | 1 | Me |
| 102 | 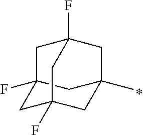 | (CH₂)ₐ | 0 to 20 | OC(═O)CH₂ | (CH₂)_{c} | 1 to 20 | Si(OMe)₃ | 1 | Me |
| 103 | CH₂F | (CH₂)ₐ | 0 to 20 | OC(═O)CH₂ | (CH₂)_{c} | 1 to 20 | Si(OMe)₃ | 1 | Me |
| 104 | SF₅ | (CH₂)ₐ | 0 to 20 | OC(═O)CH₂ | (CH₂)_{c} | 1 to 20 | Si(OMe)₃ | 1 | Me |
| 105 | OCF₃ | (CH₂)ₐ | 0 to 20 | OC(═O)CH₂ | (CH₂)_{c} | 1 to 20 | Si(OMe)₃ | 1 | Me |

TABLE 8

| No. | R^{f1} | R¹ | a | L¹ | R² | c | T¹ | x1 | R³⁶ |
|---|---|---|---|---|---|---|---|---|---|
| 106 | SCF₃ | (CH₂)ₐ | 0 to 20 | OC(═O)CH₂ | (CH₂)_{c} | 1 to 20 | Si(OMe)₃ | 1 | Me |
| 107 | N(CH₂CF₃)₂ | (CH₂)ₐ | 0 to 20 | OC(═O)CH₂ | (CH₂)_{c} | 1 to 20 | Si(OMe)₃ | 1 | Me |
| 108 | N(CF₃)₂ | (CH₂)ₐ | 0 to 20 | OC(═O)CH₂ | (CH₂)_{c} | 1 to 20 | Si(OMe)₃ | 1 | Me |
| 109 | CF₃ | (CH₂)ₐ | 0 to 20 | SiMe₂ | (CH₂)_{c} | 1 to 20 | Si(OMe)₃ | 1 | Me |
| 110 | (CF₃)₂CF | (CH₂)ₐ | 0 to 20 | SiMe₂ | (CH₂)_{c} | 1 to 20 | Si(OMe)₃ | 1 | Me |
| 111 | (CF₃)₃C | (CH₂)ₐ | 0 to 20 | SiMe₂ | (CH₂)_{c} | 1 to 20 | Si(OMe)₃ | 1 | Me |
| 112 | C₄F₉ | (CH₂)ₐ | 0 to 20 | SiMe₂ | (CH₂)_{c} | 1 to 20 | Si(OMe)₃ | 1 | Me |
| 113 | C₈F₁₇ | (CH₂)ₐ | 0 to 20 | SiMe₂ | (CH₂)_{c} | 1 to 20 | Si(OMe)₃ | 1 | Me |
| 114 | c-C₆F₁₁ | (CH₂)ₐ | 0 to 20 | SiMe₂ | (CH₂)_{c} | 1 to 20 | Si(OMe)₃ | 1 | Me |
| 115 | CHF₂ | (CH₂)ₐ | 0 to 20 | SiMe₂ | (CH₂)_{c} | 1 to 20 | Si(OMe)₃ | 1 | Me |
| 116 | CClF₂ | (CH₂)ₐ | 0 to 20 | SiMe₂ | (CH₂)_{c} | 1 to 20 | Si(OMe)₃ | 1 | Me |
| 117 | CBrF₂ | (CH₂)ₐ | 0 to 20 | SiMe₂ | (CH₂)_{c} | 1 to 20 | Si(OMe)₃ | 1 | Me |
| 118 | ClF₂ | (CH₂)ₐ | 0 to 20 | SiMe₂ | (CH₂)_{c} | 1 to 20 | Si(OMe)₃ | 1 | Me |
| 119 | CF═CF₂ | (CH₂)ₐ | 0 to 20 | SiMe₂ | (CH₂)_{c} | 1 to 20 | Si(OMe)₃ | 1 | Me |
| 120 | CF═CFCF₃ | (CH₂)ₐ | 0 to 20 | SiMe₂ | (CH₂)_{c} | 1 to 20 | Si(OMe)₃ | 1 | Me |

TABLE 9

| No. | R^{f1} | R¹ | a | L¹ | R² | c | T¹ | x1 | R³⁶ |
|---|---|---|---|---|---|---|---|---|---|
| 121 | CF═CFCF═CF₂ | (CH₂)ₐ | 0 to 20 | SiMe₂ | (CH₂)_{c} | 1 to 20 | Si(OMe)₃ | 1 | Me |
| 122 | C≡CCF₃ | (CH₂)ₐ | 0 to 20 | SiMe₂ | (CH₂)_{c} | 1 to 20 | Si(OMe)₃ | 1 | Me |
| 123 | CF₂CH₃ | (CH₂)ₐ | 0 to 20 | SiMe₂ | (CH₂)_{c} | 1 to 20 | Si(OMe)₃ | 1 | Me |
| 124 | (CF₂)₂H | (CH₂)ₐ | 0 to 20 | SiMe₂ | (CH₂)_{c} | 1 to 20 | Si(OMe)₃ | 1 | Me |
| 125 | (CF₂)₂CH₃ | (CH₂)ₐ | 0 to 20 | SiMe₂ | (CH₂)_{c} | 1 to 20 | Si(OMe)₃ | 1 | Me |
| 126 | (CF₂)₄H | (CH₂)ₐ | 0 to 20 | SiMe₂ | (CH₂)_{c} | 1 to 20 | Si(OMe)₃ | 1 | Me |
| 127 | C₆F₅ | (CH₂)ₐ | 0 to 20 | SiMe₂ | (CH₂)_{c} | 1 to 20 | Si(OMe)₃ | 1 | Me |
| 128 | 4-CF₃C₆F₄ | (CH₂)ₐ | 0 to 20 | SiMe₂ | (CH₂)_{c} | 1 to 20 | Si(OMe)₃ | 1 | Me |
| 129 | 4-SF₅C₆F₄ | (CH₂)ₐ | 0 to 20 | SiMe₂ | (CH₂)_{c} | 1 to 20 | Si(OMe)₃ | 1 | Me |
| 130 | 3,5-CF₃C₆F₃ | (CH₂)ₐ | 0 to 20 | SiMe₂ | (CH₂)_{c} | 1 to 20 | Si(OMe)₃ | 1 | Me |
| 131 | 3,5-SF₅C₆F₃ | (CH₂)ₐ | 0 to 20 | SiMe₂ | (CH₂)_{c} | 1 to 20 | Si(OMe)₃ | 1 | Me |
| 132 | 4-CF₃C₆H₄ | (CH₂)ₐ | 0 to 20 | SiMe₂ | (CH₂)_{c} | 1 to 20 | Si(OMe)₃ | 1 | Me |
| 133 | 4-SF₅C₆H₄ | (CH₂)ₐ | 0 to 20 | SiMe₂ | (CH₂)_{c} | 1 to 20 | Si(OMe)₃ | 1 | Me |
| 134 | 3,5-CF₃C₆H₃ | (CH₂)ₐ | 0 to 20 | SiMe₂ | (CH₂)_{c} | 1 to 20 | Si(OMe)₃ | 1 | Me |
| 135 | 3,5-SF₅C₆H₃ | (CH₂)ₐ | 0 to 20 | SiMe₂ | (CH₂)_{c} | 1 to 20 | Si(OMe)₃ | 1 | Me |

TABLE 10

| No. | R^{f1} | R¹ | a | L¹ | R² | c | T¹ | x1 | R³⁶ |
|---|---|---|---|---|---|---|---|---|---|
| 136 | 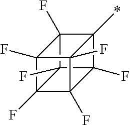 [SMILES: *C12C3(F)C4(F)C1(F)C1(F)C2(F)C3(F)C41F] | (CH₂)ₐ | 0 to 20 | SiMe₂ | (CH₂)_{c} | 1 to 20 | Si(OMe)₃ | 1 | Me |
| 137 | 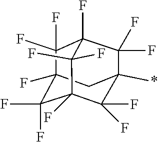 [SMILES: *C12C[C@@]3(F)C(F)(F)[C@](F)(C1(F)F)C(F)(F)[C@](F)(C2(F)F)C3(F)F] | (CH₂)ₐ | 0 to 20 | SiMe₂ | (CH₂)_{c} | 1 to 20 | Si(OMe)₃ | 1 | Me |
| 138 | 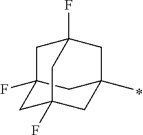 | (CH₂)ₐ | 0 to 20 | SiMe₂ | (CH₂)_{c} | 1 to 20 | Si(OMe)₃ | 1 | Me |
| 139 | CH₂F | (CH₂)ₐ | 0 to 20 | SiMe₂ | (CH₂)_{c} | 1 to 20 | Si(OMe)₃ | 1 | Me |
| 140 | SF₅ | (CH₂)ₐ | 0 to 20 | SiMe₂ | (CH₂)_{c} | 1 to 20 | Si(OMe)₃ | 1 | Me |
| 141 | OCF₃ | (CH₂)ₐ | 0 to 20 | SiMe₂ | (CH₂)_{c} | 1 to 20 | Si(OMe)₃ | 1 | Me |
| 142 | SCF₃ | (CH₂)ₐ | 0 to 20 | SiMe₂ | (CH₂)_{c} | 1 to 20 | Si(OMe)₃ | 1 | Me |
| 143 | N(CH₂CF₃)₂ | (CH₂)ₐ | 0 to 20 | SiMe₂ | (CH₂)_{c} | 1 to 20 | Si(OMe)₃ | 1 | Me |
| 144 | N(CF₃)₂ | (CH₂)ₐ | 0 to 20 | SiMe₂ | (CH₂)_{c} | 1 to 20 | Si(OMe)₃ | 1 | Me |
| 145 | CF₃ | (CH₂)ₐ | 0 to 20 | CH₂ | (CH₂)_{c} | 1 to 20 | Si(OMe)₃ | 1 | Me |
| 146 | (CF₃)₂CF | (CH₂)ₐ | 0 to 20 | CH₂ | (CH₂)_{c} | 1 to 20 | Si(OMe)₃ | 1 | Me |
| 147 | (CF₃)₃C | (CH₂)ₐ | 0 to 20 | CH₂ | (CH₂)_{c} | 1 to 20 | Si(OMe)₃ | 1 | Me |
| 148 | C₄F₉ | (CH₂)ₐ | 0 to 20 | CH₂ | (CH₂)_{c} | 1 to 20 | Si(OMe)₃ | 1 | Me |
| 149 | C₈F₁₇ | (CH₂)ₐ | 0 to 20 | CH₂ | (CH₂)_{c} | 1 to 20 | Si(OMe)₃ | 1 | Me |
| 150 | c-C₆F₁₁ | (CH₂)ₐ | 0 to 20 | CH₂ | (CH₂)_{c} | 1 to 20 | Si(OMe)₃ | 1 | Me |

TABLE 11

| No. | R^{f1} | R¹ | a | L¹ | R² | c | T¹ | x1 | R³⁶ |
|---|---|---|---|---|---|---|---|---|---|
| 151 | CHF₂ | (CH₂)ₐ | 0 to 20 | CH₂ | (CH₂)_{c} | 1 to 20 | Si(OMe)₃ | 1 | Me |
| 152 | CClF₂ | (CH₂)ₐ | 0 to 20 | CH₂ | (CH₂)_{c} | 1 to 20 | Si(OMe)₃ | 1 | Me |
| 153 | CBrF₂ | (CH₂)ₐ | 0 to 20 | CH₂ | (CH₂)_{c} | 1 to 20 | Si(OMe)₃ | 1 | Me |
| 154 | ClF₂ | (CH₂)ₐ | 0 to 20 | CH₂ | (CH₂)_{c} | 1 to 20 | Si(OMe)₃ | 1 | Me |
| 155 | CF═CF₂ | (CH₂)ₐ | 0 to 20 | CH₂ | (CH₂)_{c} | 1 to 20 | Si(OMe)₃ | 1 | Me |
| 156 | CF═CFCF₃ | (CH₂)ₐ | 0 to 20 | CH₂ | (CH₂)_{c} | 1 to 20 | Si(OMe)₃ | 1 | Me |
| 157 | CF═CFCF═CF₂ | (CH₂)ₐ | 0 to 20 | CH₂ | (CH₂)_{c} | 1 to 20 | Si(OMe)₃ | 1 | Me |
| 158 | C≡CCF₃ | (CH₂)ₐ | 0 to 20 | CH₂ | (CH₂)_{c} | 1 to 20 | Si(OMe)₃ | 1 | Me |
| 159 | CF₂CH₃ | (CH₂)ₐ | 0 to 20 | CH₂ | (CH₂)_{c} | 1 to 20 | Si(OMe)₃ | 1 | Me |
| 160 | (CF₂)₂H | (CH₂)ₐ | 0 to 20 | CH₂ | (CH₂)_{c} | 1 to 20 | Si(OMe)₃ | 1 | Me |
| 161 | (CF₂)₂CH₃ | (CH₂)ₐ | 0 to 20 | CH₂ | (CH₂)_{c} | 1 to 20 | Si(OMe)₃ | 1 | Me |
| 162 | (CF₂)₄H | (CH₂)ₐ | 0 to 20 | CH₂ | (CH₂)_{c} | 1 to 20 | Si(OMe)₃ | 1 | Me |
| 163 | C₆F₅ | (CH₂)ₐ | 0 to 20 | CH₂ | (CH₂)_{c} | 1 to 20 | Si(OMe)₃ | 1 | Me |
| 164 | 4-CF₃C₆F₄ | (CH₂)ₐ | 0 to 20 | CH₂ | (CH₂)_{c} | 1 to 20 | Si(OMe)₃ | 1 | Me |
| 165 | 4-SF₅C₆F₄ | (CH₂)ₐ | 0 to 20 | CH₂ | (CH₂)_{c} | 1 to 20 | Si(OMe)₃ | 1 | Me |

TABLE 12

| No. | R^{f1} | R¹ | a | L¹ | R² | c | T¹ | x1 | R³⁶ |
|---|---|---|---|---|---|---|---|---|---|
| 166 | 3,5-CF₃C₆F₃ | (CH₂)ₐ | 0 to 20 | CH₂ | (CH₂)_{c} | 1 to 20 | Si(OMe)₃ | 1 | Me |
| 167 | 3,5-SF₅C₆F₃ | (CH₂)ₐ | 0 to 20 | CH₂ | (CH₂)_{c} | 1 to 20 | Si(OMe)₃ | 1 | Me |
| 168 | 4-CF₃C₆H₄ | (CH₂)ₐ | 0 to 20 | CH₂ | (CH₂)_{c} | 1 to 20 | Si(OMe)₃ | 1 | Me |
| 169 | 4-SF₅C₆H₄ | (CH₂)ₐ | 0 to 20 | CH₂ | (CH₂)_{c} | 1 to 20 | Si(OMe)₃ | 1 | Me |
| 170 | 3,5-CF₃C₆H₃ | (CH₂)ₐ | 0 to 20 | CH₂ | (CH₂)_{c} | 1 to 20 | Si(OMe)₃ | 1 | Me |
| 171 | 3,5-SF₅C₆H₃ | (CH₂)ₐ | 0 to 20 | CH₂ | (CH₂)_{c} | 1 to 20 | Si(OMe)₃ | 1 | Me |
| 172 | 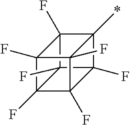 [SMILES: *C12C3(F)C4(F)C1(F)C1(F)C2(F)C3(F)C41F] | (CH₂)ₐ | 0 to 20 | CH₂ | (CH₂)_{c} | 1 to 20 | Si(OMe)₃ | 1 | Me |
| 173 | 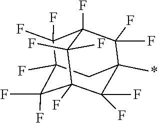 [SMILES: *C12CC3(F)C(F)(F)C(F)(C1(F)F)C(F)(F)C(F)(C2(F)F)C3(F)F] | (CH₂)ₐ | 0 to 20 | CH₂ | (CH₂)_{c} | 1 to 20 | Si(OMe)₃ | 1 | Me |
| 174 | 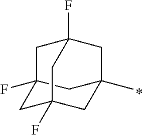 | (CH₂)ₐ | 0 to 20 | CH₂ | (CH₂)_{c} | 1 to 20 | Si(OMe)₃ | 1 | Me |
| 175 | CH₂F | (CH₂)ₐ | 0 to 20 | CH₂ | (CH₂)_{c} | 1 to 20 | Si(OMe)₃ | 1 | Me |
| 176 | SF₅ | (CH₂)ₐ | 0 to 20 | CH₂ | (CH₂)_{c} | 1 to 20 | Si(OMe)₃ | 1 | Me |
| 177 | OCF₃ | (CH₂)ₐ | 0 to 20 | CH₂ | (CH₂)_{c} | 1 to 20 | Si(OMe)₃ | 1 | Me |
| 178 | SCF₃ | (CH₂)ₐ | 0 to 20 | CH₂ | (CH₂)_{c} | 1 to 20 | Si(OMe)₃ | 1 | Me |
| 179 | N(CH₂CF₃)₂ | (CH₂)ₐ | 0 to 20 | CH₂ | (CH₂)_{c} | 1 to 20 | Si(OMe)₃ | 1 | Me |
| 180 | N(CF₃)₂ | (CH₂)ₐ | 0 to 20 | CH₂ | (CH₂)_{c} | 1 to 20 | Si(OMe)₃ | 1 | Me |

TABLE 13

| No. | R^{f1} | R¹ | a | L¹ | R² | c | T¹ | x1 | R³⁶ |
|---|---|---|---|---|---|---|---|---|---|
| 181 | CF₃ | (CH₂)ₐ | 0 to 20 | C(═O)NHCH₂CH | (CH₂)_{c} | 1 to 20 | Si(OMe)₃ | 2 | Me |
| 182 | (CF₃)₂CF | (CH₂)ₐ | 0 to 20 | C(═O)NHCH₂CH | (CH₂)_{c} | 1 to 20 | Si(OMe)₃ | 2 | Me |
| 183 | (CF₃)₃C | (CH₂)ₐ | 0 to 20 | C(═O)NHCH₂CH | (CH₂)_{c} | 1 to 20 | Si(OMe)₃ | 2 | Me |
| 184 | C₄F₉ | (CH₂)ₐ | 0 to 20 | C(═O)NHCH₂CH | (CH₂)_{c} | 1 to 20 | Si(OMe)₃ | 2 | Me |
| 185 | C₈F₁₇ | (CH₂)ₐ | 0 to 20 | C(═O)NHCH₂CH | (CH₂)_{c} | 1 to 20 | Si(OMe)₃ | 2 | Me |
| 186 | c-C₆F₁₁ | (CH₂)ₐ | 0 to 20 | C(═O)NHCH₂CH | (CH₂)_{c} | 1 to 20 | Si(OMe)₃ | 2 | Me |
| 187 | CHF₂ | (CH₂)ₐ | 0 to 20 | C(═O)NHCH₂CH | (CH₂)_{c} | 1 to 20 | Si(OMe)₃ | 2 | Me |
| 188 | CClF₂ | (CH₂)ₐ | 0 to 20 | C(═O)NHCH₂CH | (CH₂)_{c} | 1 to 20 | Si(OMe)₃ | 2 | Me |
| 189 | CBrF₂ | (CH₂)ₐ | 0 to 20 | C(═O)NHCH₂CH | (CH₂)_{c} | 1 to 20 | Si(OMe)₃ | 2 | Me |
| 190 | ClF₂ | (CH₂)ₐ | 0 to 20 | C(═O)NHCH₂CH | (CH₂)_{c} | 1 to 20 | Si(OMe)₃ | 2 | Me |
| 191 | CF═CF₂ | (CH₂)ₐ | 0 to 20 | C(═O)NHCH₂CH | (CH₂)_{c} | 1 to 20 | Si(OMe)₃ | 2 | Me |
| 192 | CF═CFCF₃ | (CH₂)ₐ | 0 to 20 | C(═O)NHCH₂CH | (CH₂)_{c} | 1 to 20 | Si(OMe)₃ | 2 | Me |
| 193 | CF═CFCF═CF₂ | (CH₂)ₐ | 0 to 20 | C(═O)NHCH₂CH | (CH₂)_{c} | 1 to 20 | Si(OMe)₃ | 2 | Me |
| 194 | C≡CCF₃ | (CH₂)ₐ | 0 to 20 | C(═O)NHCH₂CH | (CH₂)_{c} | 1 to 20 | Si(OMe)₃ | 2 | Me |
| 195 | CF₂CH₃ | (CH₂)ₐ | 0 to 20 | C(═O)NHCH₂CH | (CH₂)_{c} | 1 to 20 | Si(OMe)₃ | 2 | Me |

TABLE 14

| No. | R^{f1} | R¹ | a | L¹ | R² | c | T¹ | x1 | R³⁶ |
|---|---|---|---|---|---|---|---|---|---|
| 196 | (CF₂)₂H | (CH₂)ₐ | 0 to 20 | C(═O)NHCH₂CH | (CH₂)_{c} | 1 to 20 | Si(OMe)₃ | 2 | Me |
| 197 | (CF₂)₂CH₃ | (CH₂)ₐ | 0 to 20 | C(═O)NHCH₂CH | (CH₂)_{c} | 1 to 20 | Si(OMe)₃ | 2 | Me |
| 198 | (CF₂)₄H | (CH₂)ₐ | 0 to 20 | C(═O)NHCH₂CH | (CH₂)_{c} | 1 to 20 | Si(OMe)₃ | 2 | Me |
| 199 | C₆F₅ | (CH₂)ₐ | 0 to 20 | C(═O)NHCH₂CH | (CH₂)_{c} | 1 to 20 | Si(OMe)₃ | 2 | Me |
| 200 | 4-CF₃C₆F₄ | (CH₂)ₐ | 0 to 20 | C(═O)NHCH₂CH | (CH₂)_{c} | 1 to 20 | Si(OMe)₃ | 2 | Me |
| 201 | 4-SF₅C₆F₄ | (CH₂)ₐ | 0 to 20 | C(═O)NHCH₂CH | (CH₂)_{c} | 1 to 20 | Si(OMe)₃ | 2 | Me |
| 202 | 3,5-CF₃C₆F₃ | (CH₂)ₐ | 0 to 20 | C(═O)NHCH₂CH | (CH₂)_{c} | 1 to 20 | Si(OMe)₃ | 2 | Me |
| 203 | 3,5-SF₅C₆F₃ | (CH₂)ₐ | 0 to 20 | C(═O)NHCH₂CH | (CH₂)_{c} | 1 to 20 | Si(OMe)₃ | 2 | Me |
| 204 | 4-CF₃C₆H₄ | (CH₂)ₐ | 0 to 20 | C(═O)NHCH₂CH | (CH₂)_{c} | 1 to 20 | Si(OMe)₃ | 2 | Me |
| 205 | 4-SF₅C₆H₄ | (CH₂)ₐ | 0 to 20 | C(═O)NHCH₂CH | (CH₂)_{c} | 1 to 20 | Si(OMe)₃ | 2 | Me |
| 206 | 3,5-CF₃C₆H₃ | (CH₂)ₐ | 0 to 20 | C(═O)NHCH₂CH | (CH₂)_{c} | 1 to 20 | Si(OMe)₃ | 2 | Me |
| 207 | 3,5-SF₅C₆H₃ | (CH₂)ₐ | 0 to 20 | C(═O)NHCH₂CH | (CH₂)_{c} | 1 to 20 | Si(OMe)₃ | 2 | Me |
| 208 | 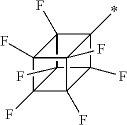 [SMILES: *C12C3(F)C4(F)C1(F)C1(F)C2(F)C3(F)C41F] | (CH₂)ₐ | 0 to 20 | C(═O)NHCH₂CH | (CH₂)_{c} | 1 to 20 | Si(OMe)₃ | 2 | Me |
| 209 | 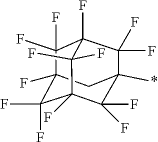 [SMILES: *C12C[C@@]3(F)C(F)(F)[C@](F)(C1(F)F)C(F)(F)[C@](F)(C2(F)F)C3(F)F] | (CH₂)ₐ | 0 to 20 | C(═O)NHCH₂CH | (CH₂)_{c} | 1 to 20 | Si(OMe)₃ | 2 | Me |
| 210 | 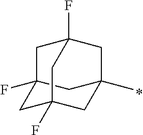 | (CH₂)ₐ | 0 to 20 | C(═O)NHCH₂CH | (CH₂)_{c} | 1 to 20 | Si(OMe)₃ | 2 | Me |

TABLE 15

| No. | R^{f1} | R¹ | a | L¹ | R² | c | T¹ | x1 | R³⁶ |
|---|---|---|---|---|---|---|---|---|---|
| 211 | CH₂F | (CH₂)ₐ | 0 to 20 | C(═O)NHCH₂CH | (CH₂)_{c} | 1 to 20 | Si(OMe)₃ | 2 | Me |
| 212 | SF₅ | (CH₂)ₐ | 0 to 20 | C(═O)NHCH₂CH | (CH₂)_{c} | 1 to 20 | Si(OMe)₃ | 2 | Me |
| 213 | OCF₃ | (CH₂)ₐ | 0 to 20 | C(═O)NHCH₂CH | (CH₂)_{c} | 1 to 20 | Si(OMe)₃ | 2 | Me |
| 214 | SCF₃ | (CH₂)ₐ | 0 to 20 | C(═O)NHCH₂CH | (CH₂)_{c} | 1 to 20 | Si(OMe)₃ | 2 | Me |
| 215 | N(CH₂CF₃)₂ | (CH₂)ₐ | 0 to 20 | C(═O)NHCH₂CH | (CH₂)_{c} | 1 to 20 | Si(OMe)₃ | 2 | Me |
| 216 | N(CF₃)₂ | (CH₂)ₐ | 0 to 20 | C(═O)NHCH₂CH | (CH₂)_{c} | 1 to 20 | Si(OMe)₃ | 2 | Me |
| 217 | CF₃ | (CH₂)ₐ | 0 to 20 | NHC(═O)CH₂CH | (CH₂)_{c} | 1 to 20 | Si(OMe)₃ | 2 | Me |
| 218 | (CF₃)₂CF | (CH₂)ₐ | 0 to 20 | NHC(═O)CH₂CH | (CH₂)_{c} | 1 to 20 | Si(OMe)₃ | 2 | Me |
| 219 | (CF₃)₃C | (CH₂)ₐ | 0 to 20 | NHC(═O)CH₂CH | (CH₂)_{c} | 1 to 20 | Si(OMe)₃ | 2 | Me |
| 220 | C₄F₃ | (CH₂)ₐ | 0 to 20 | NHC(═O)CH₂CH | (CH₂)_{c} | 1 to 20 | Si(OMe)₃ | 2 | Me |
| 221 | C₈F₁₇ | (CH₂)ₐ | 0 to 20 | NHC(═O)CH₂CH | (CH₂)_{c} | 1 to 20 | Si(OMe)₃ | 2 | Me |
| 222 | c-C₆F₁₁ | (CH₂)ₐ | 0 to 20 | NHC(═O)CH₂CH | (CH₂)_{c} | 1 to 20 | Si(OMe)₃ | 2 | Me |
| 223 | CHF₂ | (CH₂)ₐ | 0 to 20 | NHC(═O)CH₂CH | (CH₂)_{c} | 1 to 20 | Si(OMe)₃ | 2 | Me |
| 224 | CClF₂ | (CH₂)ₐ | 0 to 20 | NHC(═O)CH₂CH | (CH₂)_{c} | 1 to 20 | Si(OMe)₃ | 2 | Me |
| 225 | CBrF₂ | (CH₂)ₐ | 0 to 20 | NHC(═O)CH₂CH | (CH₂)_{c} | 1 to 20 | Si(OMe)₃ | 2 | Me |

TABLE 16

| No. | R^{f1} | R¹ | a | L¹ | R² | c | T¹ | x1 | R³⁶ |
|---|---|---|---|---|---|---|---|---|---|
| 226 | ClF₂ | (CH₂)ₐ | 0 to 20 | NHC(═O)CH₂CH | (CH₂)_{c} | 1 to 20 | Si(OMe)₃ | 2 | Me |
| 227 | CF═CF₂ | (CH₂)ₐ | 0 to 20 | NHC(═O)CH₂CH | (CH₂)_{c} | 1 to 20 | Si(OMe)₃ | 2 | Me |
| 228 | CF═CFCF₃ | (CH₂)ₐ | 0 to 20 | NHC(═O)CH₂CH | (CH₂)_{c} | 1 to 20 | Si(OMe)₃ | 2 | Me |
| 229 | CF═CFCF═CF₂ | (CH₂)ₐ | 0 to 20 | NHC(═O)CH₂CH | (CH₂)_{c} | 1 to 20 | Si(OMe)₃ | 2 | Me |
| 230 | C≡CCF₃ | (CH₂)ₐ | 0 to 20 | NHC(═O)CH₂CH | (CH₂)_{c} | 1 to 20 | Si(OMe)₃ | 2 | Me |
| 231 | CF₂CH₃ | (CH₂)ₐ | 0 to 20 | NHC(═O)CH₂CH | (CH₂)_{c} | 1 to 20 | Si(OMe)₃ | 2 | Me |
| 232 | (CF₂)₂H | (CH₂)ₐ | 0 to 20 | NHC(═O)CH₂CH | (CH₂)_{c} | 1 to 20 | Si(OMe)₃ | 2 | Me |
| 233 | (CF₂)₂CH₃ | (CH₂)ₐ | 0 to 20 | NHC(═O)CH₂CH | (CH₂)_{c} | 1 to 20 | Si(OMe)₃ | 2 | Me |
| 234 | (CF₂)₄H | (CH₂)ₐ | 0 to 20 | NHC(═O)CH₂CH | (CH₂)_{c} | 1 to 20 | Si(OMe)₃ | 2 | Me |
| 235 | C₆F₅ | (CH₂)ₐ | 0 to 20 | NHC(═O)CH₂CH | (CH₂)_{c} | 1 to 20 | Si(OMe)₃ | 2 | Me |
| 236 | 4-CF₃C₆F₄ | (CH₂)ₐ | 0 to 20 | NHC(═O)CH₂CH | (CH₂)_{c} | 1 to 20 | Si(OMe)₃ | 2 | Me |
| 237 | 4-SF₅C₆F₄ | (CH₂)ₐ | 0 to 20 | NHC(═O)CH₂CH | (CH₂)_{c} | 1 to 20 | Si(OMe)₃ | 2 | Me |
| 238 | 3,5-CF₃C₆F₃ | (CH₂)ₐ | 0 to 20 | NHC(═O)CH₂CH | (CH₂)_{c} | 1 to 20 | Si(OMe)₃ | 2 | Me |
| 239 | 3,5-SF₅C₆F₃ | (CH₂)ₐ | 0 to 20 | NHC(═O)CH₂CH | (CH₂)_{c} | 1 to 20 | Si(OMe)₃ | 2 | Me |
| 240 | 4-CF₃C₆H₄ | (CH₂)ₐ | 0 to 20 | NHC(═O)CH₂CH | (CH₂)_{c} | 1 to 20 | Si(OMe)₃ | 2 | Me |

TABLE 17

| No. | R^{f1} | R¹ | a | L¹ | R² | c | T¹ | x1 | R³⁶ |
|---|---|---|---|---|---|---|---|---|---|
| 241 | 4-SF₅C₆H₄ | (CH₂)ₐ | 0 to 20 | NHC(═O)CH₂CH | (CH₂)_{c} | 1 to 20 | Si(OMe)₃ | 2 | Me |
| 242 | 3,5-CF₃C₆H₃ | (CH₂)ₐ | 0 to 20 | NHC(═O)CH₂CH | (CH₂)_{c} | 1 to 20 | Si(OMe)₃ | 2 | Me |
| 243 | 3,5-SF₅C₆H₃ | (CH₂)ₐ | 0 to 20 | NHC(═O)CH₂CH | (CH₂)_{c} | 1 to 20 | Si(OMe)₃ | 2 | Me |
| 244 | 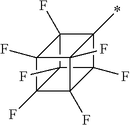 [SMILES: *C12C3(F)C4(F)C1(F)C1(F)C2(F)C3(F)C41F] | (CH₂)ₐ | 0 to 20 | NHC(═O)CH₂CH | (CH₂)_{c} | 1 to 20 | Si(OMe)₃ | 2 | Me |
| 245 | 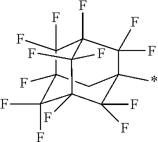 [SMILES: *C12C[C@@]3(F)C(F)(F)[C@](F)(C1(F)F)C(F)(F)[C@](F)(C2(F)F)C3(F)F] | (CH₂)ₐ | 0 to 20 | NHC(═O)CH₂CH | (CH₂)_{c} | 1 to 20 | Si(OMe)₃ | 2 | Me |
| 246 | 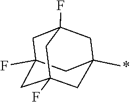 [SMILES: *C12CC3(F)CC(F)(C1)CC(F)(C2)C3] | (CH₂)ₐ | 0 to 20 | NHC(═O)CH₂CH | (CH₂)_{c} | 1 to 20 | Si(OMe)₃ | 2 | Me |
| 247 | CH₂F | (CH₂)ₐ | 0 to 20 | NHC(═O)CH₂CH | (CH₂)_{c} | 1 to 20 | Si(OMe)₃ | 2 | Me |
| 248 | SF₅ | (CH₂)ₐ | 0 to 20 | NHC(═O)CH₂CH | (CH₂)_{c} | 1 to 20 | Si(OMe)₃ | 2 | Me |
| 249 | OCF₃ | (CH₂)ₐ | 0 to 20 | NHC(═O)CH₂CH | (CH₂)_{c} | 1 to 20 | Si(OMe)₃ | 2 | Me |
| 250 | SCF₃ | (CH₂)ₐ | 0 to 20 | NHC(═O)CH₂CH | (CH₂)_{c} | 1 to 20 | Si(OMe)₃ | 2 | Me |
| 251 | N(CH₂CF₃)₂ | (CH₂)ₐ | 0 to 20 | NHC(═O)CH₂CH | (CH₂)_{c} | 1 to 20 | Si(OMe)₃ | 2 | Me |
| 252 | N(CF₃)₂ | (CH₂)ₐ | 0 to 20 | NHC(═O)CH₂CH | (CH₂)_{c} | 1 to 20 | Si(OMe)₃ | 2 | Me |
| 253 | CF₃ | (CH₂)ₐ | 0 to 20 | OC(═O)CH | (CH₂)_{c} | 1 to 20 | Si(OMe)₃ | 2 | Me |
| 254 | (CF₃)₂CF | (CH₂)ₐ | 0 to 20 | OC(═O)CH | (CH₂)_{c} | 1 to 20 | Si(OMe)₃ | 2 | Me |
| 255 | (CF₃)₃C | (CH₂)ₐ | 0 to 20 | OC(═O)CH | (CH₂)_{c} | 1 to 20 | Si(OMe)₃ | 2 | Me |

TABLE 18

| No. | R^{f1} | R¹ | a | L¹ | R² | c | T¹ | x1 | R³⁶ |
|---|---|---|---|---|---|---|---|---|---|
| 256 | C₄F₉ | (CH₂)ₐ | 0 to 20 | OC(═O)CH | (CH₂)_{c} | 1 to 20 | Si(OMe)₃ | 2 | Me |
| 257 | C₈F₁₇ | (CH₂)ₐ | 0 to 20 | OC(═O)CH | (CH₂)_{c} | 1 to 20 | Si(OMe)₃ | 2 | Me |
| 258 | c-C₆F₁₁ | (CH₂)ₐ | 0 to 20 | OC(═O)CH | (CH₂)_{c} | 1 to 20 | Si(OMe)₃ | 2 | Me |
| 259 | CHF₂ | (CH₂)ₐ | 0 to 20 | OC(═O)CH | (CH₂)_{c} | 1 to 20 | Si(OMe)₃ | 2 | Me |
| 260 | CClF₂ | (CH₂)ₐ | 0 to 20 | OC(═O)CH | (CH₂)_{c} | 1 to 20 | Si(OMe)₃ | 2 | Me |
| 261 | CBrF₂ | (CH₂)ₐ | 0 to 20 | OC(═O)CH | (CH₂)_{c} | 1 to 20 | Si(OMe)₃ | 2 | Me |
| 262 | ClF₂ | (CH₂)ₐ | 0 to 20 | OC(═O)CH | (CH₂)_{c} | 1 to 20 | Si(OMe)₃ | 2 | Me |
| 263 | CF═CF₂ | (CH₂)ₐ | 0 to 20 | OC(═O)CH | (CH₂)_{c} | 1 to 20 | Si(OMe)₃ | 2 | Me |
| 264 | CF═CFCF₃ | (CH₂)ₐ | 0 to 20 | OC(═O)CH | (CH₂)_{c} | 1 to 20 | Si(OMe)₃ | 2 | Me |
| 265 | CF═CFCF═CF₂ | (CH₂)ₐ | 0 to 20 | OC(═O)CH | (CH₂)_{c} | 1 to 20 | Si(OMe)₃ | 2 | Me |
| 266 | C≡CCF₃ | (CH₂)ₐ | 0 to 20 | OC(═O)CH | (CH₂)_{c} | 1 to 20 | Si(OMe)₃ | 2 | Me |
| 267 | CF₂CH₃ | (CH₂)ₐ | 0 to 20 | OC(═O)CH | (CH₂)_{c} | 1 to 20 | Si(OMe)₃ | 2 | Me |
| 268 | (CF₂)₂H | (CH₂)ₐ | 0 to 20 | OC(═O)CH | (CH₂)_{c} | 1 to 20 | Si(OMe)₃ | 2 | Me |
| 269 | (CF₂)₂CH₃ | (CH₂)ₐ | 0 to 20 | OC(═O)CH | (CH₂)_{c} | 1 to 20 | Si(OMe)₃ | 2 | Me |
| 270 | (CF₂)₄H | (CH₂)ₐ | 0 to 20 | OC(═O)CH | (CH₂)_{c} | 1 to 20 | Si(OMe)₃ | 2 | Me |

TABLE 19

| No. | R^{f1} | R¹ | a | L¹ | R² | c | T¹ | x1 | R³⁶ |
|---|---|---|---|---|---|---|---|---|---|
| 271 | C₆F₅ | (CH₂)ₐ | 0 to 20 | OC(═O)CH | (CH₂)_{c} | 1 to 20 | Si(OMe)₃ | 2 | Me |
| 272 | 4-CF₃C₆F₄ | (CH₂)ₐ | 0 to 20 | OC(═O)CH | (CH₂)_{c} | 1 to 20 | Si(OMe)₃ | 2 | Me |
| 273 | 4-SF₅C₆F₄ | (CH₂)ₐ | 0 to 20 | OC(═O)CH | (CH₂)_{c} | 1 to 20 | Si(OMe)₃ | 2 | Me |
| 274 | 3,5-CF₃C₆F₃ | (CH₂)ₐ | 0 to 20 | OC(═O)CH | (CH₂)_{c} | 1 to 20 | Si(OMe)₃ | 2 | Me |
| 275 | 3,5-SF₅C₆F₃ | (CH₂)ₐ | 0 to 20 | OC(═O)CH | (CH₂)_{c} | 1 to 20 | Si(OMe)₃ | 2 | Me |
| 276 | 4-CF₃C₆H₄ | (CH₂)ₐ | 0 to 20 | OC(═O)CH | (CH₂)_{c} | 1 to 20 | Si(OMe)₃ | 2 | Me |
| 277 | 4-SF₅C₆H₄ | (CH₂)ₐ | 0 to 20 | OC(═O)CH | (CH₂)_{c} | 1 to 20 | Si(OMe)₃ | 2 | Me |
| 278 | 3,5-CF₃C₆H₃ | (CH₂)ₐ | 0 to 20 | OC(═O)CH | (CH₂)_{c} | 1 to 20 | Si(OMe)₃ | 2 | Me |
| 279 | 3,5-SF₅C₆H₃ | (CH₂)ₐ | 0 to 20 | OC(═O)CH | (CH₂)_{c} | 1 to 20 | Si(OMe)₃ | 2 | Me |
| 280 | 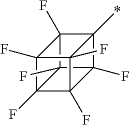 [SMILES: *C12C3(F)C4(F)C1(F)C1(F)C2(F)C3(F)C41F] | (CH₂)ₐ | 0 to 20 | OC(═O)CH | (CH₂)_{c} | 1 to 20 | Si(OMe)₃ | 2 | Me |
| 281 | 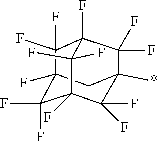 [SMILES: *C12C[C@@]3(F)C(F)(F)[C@](F)(C1(F)F)C(F)(F)[C@](F)(C2(F)F)C3(F)F] | (CH₂)ₐ | 0 to 20 | OC(═O)CH | (CH₂)_{c} | 1 to 20 | Si(OMe)₃ | 2 | Me |
| 282 | 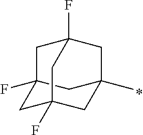 | (CH₂)ₐ | 0 to 20 | OC(═O)CH | (CH₂)_{c} | 1 to 20 | Si(OMe)₃ | 2 | Me |
| 283 | CH₂F | (CH₂)ₐ | 0 to 20 | OC(═O)CH | (CH₂)_{c} | 1 to 20 | Si(OMe)₃ | 2 | Me |
| 284 | SF₅ | (CH₂)ₐ | 0 to 20 | OC(═O)CH | (CH₂)_{c} | 1 to 20 | Si(OMe)₃ | 2 | Me |
| 285 | OCF₃ | (CH₂)ₐ | 0 to 20 | OC(═O)CH | (CH₂)_{c} | 1 to 20 | Si(OMe)₃ | 2 | Me |

TABLE 20

| No. | R^{f1} | R¹ | a | L¹ | R² | c | T¹ | x1 | R³⁶ |
|---|---|---|---|---|---|---|---|---|---|
| 286 | SCF₃ | (CH₂)ₐ | 0 to 20 | OC(═O)CH | (CH₂)_{c} | 1 to 20 | Si(OMe)₃ | 2 | Me |
| 287 | N(CH₂CF₃)₂ | (CH₂)ₐ | 0 to 20 | OC(═O)CH | (CH₂)_{c} | 1 to 20 | Si(OMe)₃ | 2 | Me |
| 288 | N(CF₃)₂ | (CH₂)ₐ | 0 to 20 | OC(═O)CH | (CH₂)_{c} | 1 to 20 | Si(OMe)₃ | 2 | Me |
| 289 | CF₃ | (CH₂)ₐ | 0 to 20 | SiMe | (CH₂)_{c} | 1 to 20 | Si(OMe)₃ | 2 | Me |
| 290 | (CF₃)₂CF | (CH₂)ₐ | 0 to 20 | SiMe | (CH₂)_{c} | 1 to 20 | Si(OMe)₃ | 2 | Me |
| 291 | (CF₃)₃C | (CH₂)ₐ | 0 to 20 | SiMe | (CH₂)_{c} | 1 to 20 | Si(OMe)₃ | 2 | Me |
| 292 | C₄F₉ | (CH₂)ₐ | 0 to 20 | SiMe | (CH₂)_{c} | 1 to 20 | Si(OMe)₃ | 2 | Me |
| 293 | C₈F₁₇ | (CH₂)ₐ | 0 to 20 | SiMe | (CH₂)_{c} | 1 to 20 | Si(OMe)₃ | 2 | Me |
| 294 | c-C₆F₁₁ | (CH₂)ₐ | 0 to 20 | SiMe | (CH₂)_{c} | 1 to 20 | Si(OMe)₃ | 2 | Me |
| 295 | CHF₂ | (CH₂)ₐ | 0 to 20 | SiMe | (CH₂)_{c} | 1 to 20 | Si(OMe)₃ | 2 | Me |
| 296 | CClF₂ | (CH₂)ₐ | 0 to 20 | SiMe | (CH₂)_{c} | 1 to 20 | Si(OMe)₃ | 2 | Me |
| 297 | CBrF₂ | (CH₂)ₐ | 0 to 20 | SiMe | (CH₂)_{c} | 1 to 20 | Si(OMe)₃ | 2 | Me |
| 298 | ClF₂ | (CH₂)ₐ | 0 to 20 | SiMe | (CH₂)_{c} | 1 to 20 | Si(OMe)₃ | 2 | Me |
| 299 | CF═CF₂ | (CH₂)ₐ | 0 to 20 | SiMe | (CH₂)_{c} | 1 to 20 | Si(OMe)₃ | 2 | Me |
| 300 | CF═CFCF₃ | (CH₂)ₐ | 0 to 20 | SiMe | (CH₂)_{c} | 1 to 20 | Si(OMe)₃ | 2 | Me |

TABLE 21

| No. | R^{f1} | R¹ | a | L¹ | R² | c | T¹ | x1 | R³⁶ |
|---|---|---|---|---|---|---|---|---|---|
| 301 | CF═CFCF═CF₂ | (CH₂)ₐ | 0 to 20 | SiMe | (CH₂)_{c} | 1 to 20 | Si(OMe)₃ | 2 | Me |
| 302 | C≡CCF₃ | (CH₂)ₐ | 0 to 20 | SiMe | (CH₂)_{c} | 1 to 20 | Si(OMe)₃ | 2 | Me |
| 303 | CF₂CH₃ | (CH₂)ₐ | 0 to 20 | SiMe | (CH₂)_{c} | 1 to 20 | Si(OMe)₃ | 2 | Me |
| 304 | (CF₂)₂H | (CH₂)ₐ | 0 to 20 | SiMe | (CH₂)_{c} | 1 to 20 | Si(OMe)₃ | 2 | Me |
| 305 | (CF₂)₂CH₃ | (CH₂)ₐ | 0 to 20 | SiMe | (CH₂)_{c} | 1 to 20 | Si(OMe)₃ | 2 | Me |
| 306 | (CF₂)₄H | (CH₂)ₐ | 0 to 20 | SiMe | (CH₂)_{c} | 1 to 20 | Si(OMe)₃ | 2 | Me |
| 307 | C₆F₅ | (CH₂)ₐ | 0 to 20 | SiMe | (CH₂)_{c} | 1 to 20 | Si(OMe)₃ | 2 | Me |
| 308 | 4-CF₃C₆F₄ | (CH₂)ₐ | 0 to 20 | SiMe | (CH₂)_{c} | 1 to 20 | Si(OMe)₃ | 2 | Me |
| 309 | 4-SF₅C₆F₄ | (CH₂)ₐ | 0 to 20 | SiMe | (CH₂)_{c} | 1 to 20 | Si(OMe)₃ | 2 | Me |
| 310 | 3,5-CF₃C₆F₃ | (CH₂)ₐ | 0 to 20 | SiMe | (CH₂)_{c} | 1 to 20 | Si(OMe)₃ | 2 | Me |
| 311 | 3,5-SF₅C₆F₃ | (CH₂)ₐ | 0 to 20 | SiMe | (CH₂)_{c} | 1 to 20 | Si(OMe)₃ | 2 | Me |
| 312 | 4-CF₃C₆H₄ | (CH₂)ₐ | 0 to 20 | SiMe | (CH₂)_{c} | 1 to 20 | Si(OMe)₃ | 2 | Me |
| 313 | 4-SF₅C₆H₄ | (CH₂)ₐ | 0 to 20 | SiMe | (CH₂)_{c} | 1 to 20 | Si(OMe)₃ | 2 | Me |
| 314 | 3,5-CF₃C₆H₃ | (CH₂)ₐ | 0 to 20 | SiMe | (CH₂)_{c} | 1 to 20 | Si(OMe)₃ | 2 | Me |
| 315 | 3,5-SF₅C₆H₃ | (CH₂)ₐ | 0 to 20 | SiMe | (CH₂)_{c} | 1 to 20 | Si(OMe)₃ | 2 | Me |

TABLE 22

| No. | R^{f1} | R¹ | a | L¹ | R² | c | T¹ | x1 | R³⁶ |
|---|---|---|---|---|---|---|---|---|---|
| 316 | 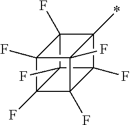 [SMILES: *C12C3(F)C4(F)C1(F)C1(F)C2(F)C3(F)C41F] | (CH₂)ₐ | 0 to 20 | SiMe | (CH₂)_{c} | 1 to 20 | Si(OMe)₃ | 2 | Me |
| 317 | 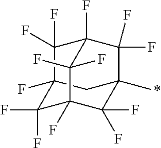 | (CH₂)ₐ | 0 to 20 | SiMe | (CH₂)_{c} | 1 to 20 | Si(OMe)₃ | 2 | Me |
| 318 | 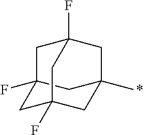 | (CH₂)ₐ | 0 to 20 | SiMe | (CH₂)_{c} | 1 to 20 | Si(OMe)₃ | 2 | Me |
| 319 | CH₂F | (CH₂)ₐ | 0 to 20 | SiMe | (CH₂)_{c} | 1 to 20 | Si(OMe)₃ | 2 | Me |
| 320 | SF₅ | (CH₂)ₐ | 0 to 20 | SiMe | (CH₂)_{c} | 1 to 20 | Si(OMe)₃ | 2 | Me |
| 321 | OCF₃ | (CH₂)ₐ | 0 to 20 | SiMe | (CH₂)_{c} | 1 to 20 | Si(OMe)₃ | 2 | Me |
| 322 | SCF₃ | (CH₂)ₐ | 0 to 20 | SiMe | (CH₂)_{c} | 1 to 20 | Si(OMe)₃ | 2 | Me |
| 323 | N(CH₂CF₃)₂ | (CH₂)ₐ | 0 to 20 | SiMe | (CH₂)_{c} | 1 to 20 | Si(OMe)₃ | 2 | Me |
| 324 | N(CF₃)₂ | (CH₂)ₐ | 0 to 20 | SiMe | (CH₂)_{c} | 1 to 20 | Si(OMe)₃ | 2 | Me |
| 325 | CF₃ | (CH₂)ₐ | 0 to 20 | CH | (CH₂)_{c} | 1 to 20 | Si(OMe)₃ | 2 | Me |
| 326 | (CF₃)₂CF | (CH₂)ₐ | 0 to 20 | CH | (CH₂)_{c} | 1 to 20 | Si(OMe)₃ | 2 | Me |
| 327 | (CF₃)₃C | (CH₂)ₐ | 0 to 20 | CH | (CH₂)_{c} | 1 to 20 | Si(OMe)₃ | 2 | Me |
| 328 | C₄F₉ | (CH₂)ₐ | 0 to 20 | CH | (CH₂)_{c} | 1 to 20 | Si(OMe)₃ | 2 | Me |
| 329 | C₈F₁₇ | (CH₂)ₐ | 0 to 20 | CH | (CH₂)_{c} | 1 to 20 | Si(OMe)₃ | 2 | Me |
| 330 | c-C₆F₁₁ | (CH₂)ₐ | 0 to 20 | CH | (CH₂)_{c} | 1 to 20 | Si(OMe)₃ | 2 | Me |

TABLE 23

| No. | R^{f1} | R¹ | a | L¹ | R² | c | T¹ | x1 | R³⁶ |
|---|---|---|---|---|---|---|---|---|---|
| 331 | CHF₂ | (CH₂)ₐ | 0 to 20 | CH | (CH₂)_{c} | 1 to 20 | Si(OMe)₃ | 2 | Me |
| 332 | CClF₂ | (CH₂)ₐ | 0 to 20 | CH | (CH₂)_{c} | 1 to 20 | Si(OMe)₃ | 2 | Me |
| 333 | CBrF₂ | (CH₂)ₐ | 0 to 20 | CH | (CH₂)_{c} | 1 to 20 | Si(OMe)₃ | 2 | Me |
| 334 | ClF₂ | (CH₂)ₐ | 0 to 20 | CH | (CH₂)_{c} | 1 to 20 | Si(OMe)₃ | 2 | Me |
| 335 | CF═CF₂ | (CH₂)ₐ | 0 to 20 | CH | (CH₂)_{c} | 1 to 20 | Si(OMe)₃ | 2 | Me |
| 336 | CF═CFCF₃ | (CH₂)ₐ | 0 to 20 | CH | (CH₂)_{c} | 1 to 20 | Si(OMe)₃ | 2 | Me |
| 337 | CF═CFCF═CF₂ | (CH₂)ₐ | 0 to 20 | CH | (CH₂)_{c} | 1 to 20 | Si(OMe)₃ | 2 | Me |
| 338 | C≡CCF₃ | (CH₂)ₐ | 0 to 20 | CH | (CH₂)_{c} | 1 to 20 | Si(OMe)₃ | 2 | Me |
| 339 | CF₂CH₃ | (CH₂)ₐ | 0 to 20 | CH | (CH₂)_{c} | 1 to 20 | Si(OMe)₃ | 2 | Me |
| 340 | (CF₂)₂H | (CH₂)ₐ | 0 to 20 | CH | (CH₂)_{c} | 1 to 20 | Si(OMe)₃ | 2 | Me |
| 341 | (CF₂)₂CH₃ | (CH₂)ₐ | 0 to 20 | CH | (CH₂)_{c} | 1 to 20 | Si(OMe)₃ | 2 | Me |
| 342 | (CF₂)₄H | (CH₂)ₐ | 0 to 20 | CH | (CH₂)_{c} | 1 to 20 | Si(OMe)₃ | 2 | Me |
| 343 | C₆F₅ | (CH₂)ₐ | 0 to 20 | CH | (CH₂)_{c} | 1 to 20 | Si(OMe)₃ | 2 | Me |
| 344 | 4-CF₃C₆F₄ | (CH₂)ₐ | 0 to 20 | CH | (CH₂)_{c} | 1 to 20 | Si(OMe)₃ | 2 | Me |
| 345 | 4-SF₅C₆F₄ | (CH₂)ₐ | 0 to 20 | CH | (CH₂)_{c} | 1 to 20 | Si(OMe)₃ | 2 | Me |

TABLE 24

| No. | R^{f1} | R¹ | a | L¹ | R² | c | T¹ | x1 | R³⁶ |
|---|---|---|---|---|---|---|---|---|---|
| 346 | 3,5-CF₃C₆F₃ | (CH₂)ₐ | 0 to 20 | CH | (CH₂)_{c} | 1 to 20 | Si(OMe)₃ | 2 | Me |
| 347 | 3,5-SF₅C₆F₃ | (CH₂)ₐ | 0 to 20 | CH | (CH₂)_{c} | 1 to 20 | Si(OMe)₃ | 2 | Me |
| 348 | 4-CF₃C₆H₄ | (CH₂)ₐ | 0 to 20 | CH | (CH₂)_{c} | 1 to 20 | Si(OMe)₃ | 2 | Me |
| 349 | 4-SF₅C₆H₄ | (CH₂)ₐ | 0 to 20 | CH | (CH₂)_{c} | 1 to 20 | Si(OMe)₃ | 2 | Me |
| 350 | 3,5-CF₃C₆H₃ | (CH₂)ₐ | 0 to 20 | CH | (CH₂)_{c} | 1 to 20 | Si(OMe)₃ | 2 | Me |
| 351 | 3,5-SF₅C₆H₃ | (CH₂)ₐ | 0 to 20 | CH | (CH₂)_{c} | 1 to 20 | Si(OMe)₃ | 2 | Me |
| 352 | 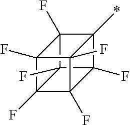 [SMILES: *C12C3(F)C4(F)C1(F)C1(F)C2(F)C3(F)C41F] | (CH₂)ₐ | 0 to 20 | CH | (CH₂)_{c} | 1 to 20 | Si(OMe)₃ | 2 | Me |
| 353 | 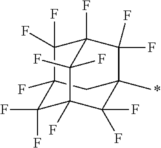 | (CH₂)ₐ | 0 to 20 | CH | (CH₂)_{c} | 1 to 20 | Si(OMe)₃ | 2 | Me |
| 354 | 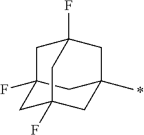 | (CH₂)ₐ | 0 to 20 | CH | (CH₂)_{c} | 1 to 20 | Si(OMe)₃ | 2 | Me |
| 355 | CH₂F | (CH₂)ₐ | 0 to 20 | CH | (CH₂)_{c} | 1 to 20 | Si(OMe)₃ | 2 | Me |
| 356 | SF₅ | (CH₂)ₐ | 0 to 20 | CH | (CH₂)_{c} | 1 to 20 | Si(OMe)₃ | 2 | Me |
| 357 | OCF₃ | (CH₂)ₐ | 0 to 20 | CH | (CH₂)_{c} | 1 to 20 | Si(OMe)₃ | 2 | Me |
| 358 | SCF₃ | (CH₂)ₐ | 0 to 20 | CH | (CH₂)_{c} | 1 to 20 | Si(OMe)₃ | 2 | Me |
| 359 | N(CH₂CF₃)₂ | (CH₂)ₐ | 0 to 20 | CH | (CH₂)_{c} | 1 to 20 | Si(OMe)₃ | 2 | Me |
| 360 | N(CF₃)₂ | (CH₂)ₐ | 0 to 20 | CH | (CH₂)_{c} | 1 to 20 | Si(OMe)₃ | 2 | Me |

TABLE 25

| No. | R^{f1} | R¹ | a | L¹ | R² | c | T¹ | x1 | R³⁶ |
|---|---|---|---|---|---|---|---|---|---|
| 361 | CF₃ | (CH₂)ₐ | 0 to 20 | C(═O)NHCH₂C | (CH₂)_{c} | 1 to 20 | Si(OMe)₃ | 3 | Me |
| 362 | (CF₃)₂CF | (CH₂)ₐ | 0 to 20 | C(═O)NHCH₂C | (CH₂)_{c} | 1 to 20 | Si(OMe)₃ | 3 | Me |
| 363 | (CF₃)₃C | (CH₂)ₐ | 0 to 20 | C(═O)NHCH₂C | (CH₂)_{c} | 1 to 20 | Si(OMe)₃ | 3 | Me |
| 364 | C₄F₉ | (CH₂)ₐ | 0 to 20 | C(═O)NHCH₂C | (CH₂)_{c} | 1 to 20 | Si(OMe)₃ | 3 | Me |
| 365 | C₈F₁₇ | (CH₂)ₐ | 0 to 20 | C(═O)NHCH₂C | (CH₂)_{c} | 1 to 20 | Si(OMe)₃ | 3 | Me |
| 366 | c-C₆F₁₁ | (CH₂)ₐ | 0 to 20 | C(═O)NHCH₂C | (CH₂)_{c} | 1 to 20 | Si(OMe)₃ | 3 | Me |
| 367 | CHF₂ | (CH₂)ₐ | 0 to 20 | C(═O)NHCH₂C | (CH₂)_{c} | 1 to 20 | Si(OMe)₃ | 3 | Me |
| 368 | CClF₂ | (CH₂)ₐ | 0 to 20 | C(═O)NHCH₂C | (CH₂)_{c} | 1 to 20 | Si(OMe)₃ | 3 | Me |
| 369 | CBrF₂ | (CH₂)ₐ | 0 to 20 | C(═O)NHCH₂C | (CH₂)_{c} | 1 to 20 | Si(OMe)₃ | 3 | Me |
| 370 | ClF₂ | (CH₂)ₐ | 0 to 20 | C(═O)NHCH₂C | (CH₂)_{c} | 1 to 20 | Si(OMe)₃ | 3 | Me |
| 371 | CF═CF₂ | (CH₂)ₐ | 0 to 20 | C(═O)NHCH₂C | (CH₂)_{c} | 1 to 20 | Si(OMe)₃ | 3 | Me |
| 372 | CF═CFCF₃ | (CH₂)ₐ | 0 to 20 | C(═O)NHCH₂C | (CH₂)_{c} | 1 to 20 | Si(OMe)₃ | 3 | Me |
| 373 | CF═CFCF═CF₂ | (CH₂)ₐ | 0 to 20 | C(═O)NHCH₂C | (CH₂)_{c} | 1 to 20 | Si(OMe)₃ | 3 | Me |
| 374 | C≡CCF₃ | (CH₂)ₐ | 0 to 20 | C(═O)NHCH₂C | (CH₂)_{c} | 1 to 20 | Si(OMe)₃ | 3 | Me |
| 375 | CF₂CH₃ | (CH₂)ₐ | 0 to 20 | C(═O)NHCH₂C | (CH₂)_{c} | 1 to 20 | Si(OMe)₃ | 3 | Me |

TABLE 26

| No. | R^{f1} | R¹ | a | L¹ | R² | c | T¹ | x1 | R³⁶ |
|---|---|---|---|---|---|---|---|---|---|
| 376 | (CF₂)₂H | (CH₂)ₐ | 0 to 20 | C(═O)NHCH₂C | (CH₂)_{c} | 1 to 20 | Si(OMe)₃ | 3 | Me |
| 377 | (CF₂)₂CH₃ | (CH₂)ₐ | 0 to 20 | C(═O)NHCH₂C | (CH₂)_{c} | 1 to 20 | Si(OMe)₃ | 3 | Me |
| 378 | (CF₂)₄H | (CH₂)ₐ | 0 to 20 | C(═O)NHCH₂C | (CH₂)_{c} | 1 to 20 | Si(OMe)₃ | 3 | Me |
| 379 | C₆F₅ | (CH₂)ₐ | 0 to 20 | C(═O)NHCH₂C | (CH₂)_{c} | 1 to 20 | Si(OMe)₃ | 3 | Me |
| 380 | 4-CF₃C₆F₄ | (CH₂)ₐ | 0 to 20 | C(═O)NHCH₂C | (CH₂)_{c} | 1 to 20 | Si(OMe)₃ | 3 | Me |
| 381 | 4-SF₅C₆F₄ | (CH₂)ₐ | 0 to 20 | C(═O)NHCH₂C | (CH₂)_{c} | 1 to 20 | Si(OMe)₃ | 3 | Me |
| 382 | 3,5-CF₃C₆F₃ | (CH₂)ₐ | 0 to 20 | C(═O)NHCH₂C | (CH₂)_{c} | 1 to 20 | Si(OMe)₃ | 3 | Me |
| 383 | 3,5-SF₅C₆F₃ | (CH₂)ₐ | 0 to 20 | C(═O)NHCH₂C | (CH₂)_{c} | 1 to 20 | Si(OMe)₃ | 3 | Me |
| 384 | 4-CF₃C₆H₄ | (CH₂)ₐ | 0 to 20 | C(═O)NHCH₂C | (CH₂)_{c} | 1 to 20 | Si(OMe)₃ | 3 | Me |
| 385 | 4-SF₅C₆H₄ | (CH₂)ₐ | 0 to 20 | C(═O)NHCH₂C | (CH₂)_{c} | 1 to 20 | Si(OMe)₃ | 3 | Me |
| 386 | 3,5-CF₃C₆H₃ | (CH₂)ₐ | 0 to 20 | C(═O)NHCH₂C | (CH₂)_{c} | 1 to 20 | Si(OMe)₃ | 3 | Me |
| 387 | 3,5-SF₅C₆H₃ | (CH₂)ₐ | 0 to 20 | C(═O)NHCH₂C | (CH₂)_{c} | 1 to 20 | Si(OMe)₃ | 3 | Me |
| 388 | 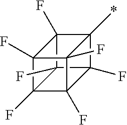 [SMILES: *C12C3(F)C4(F)C1(F)C1(F)C2(F)C3(F)C41F] | (CH₂)ₐ | 0 to 20 | C(═O)NHCH₂C | (CH₂)_{c} | 1 to 20 | Si(OMe)₃ | 3 | Me |
| 389 | 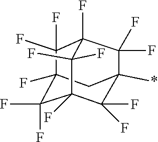 [SMILES: *C12C[C@@]3(F)C(F)(F)[C@](F)(C1(F)F)C(F)(F)[C@](F)(C2(F)F)C3(F)F] | (CH₂)ₐ | 0 to 20 | C(═O)NHCH₂C | (CH₂)_{c} | 1 to 20 | Si(OMe)₃ | 3 | Me |
| 390 | 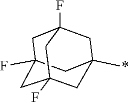 [SMILES: *C12CC3(F)CC(F)(C1)CC(F)(C2)C3] | (CH₂)ₐ | 0 to 20 | C(═O)NHCH₂C | (CH₂)_{c} | 1 to 20 | Si(OMe)₃ | 3 | Me |

TABLE 27

| No. | R^{f1} | R¹ | a | L¹ | R² | c | T¹ | x1 | R³⁶ |
|---|---|---|---|---|---|---|---|---|---|
| 391 | CH₂F | (CH₂)ₐ | 0 to 20 | C(═O)NHCH₂C | (CH₂)_{c} | 1 to 20 | Si(OMe)₃ | 2 | Me |
| 392 | SF₅ | (CH₂)ₐ | 0 to 20 | C(═O)NHCH₂C | (CH₂)_{c} | 1 to 20 | Si(OMe)₃ | 3 | Me |
| 393 | OCF₃ | (CH₂)ₐ | 0 to 20 | C(═O)NHCH₂C | (CH₂)_{c} | 1 to 20 | Si(OMe)₃ | 3 | Me |
| 394 | SCF₃ | (CH₂)ₐ | 0 to 20 | C(═O)NHCH₂C | (CH₂)_{c} | 1 to 20 | Si(OMe)₃ | 3 | Me |
| 395 | N(CH₂CF₃)₂ | (CH₂)ₐ | 0 to 20 | C(═O)NHCH₂C | (CH₂)_{c} | 1 to 20 | Si(OMe)₃ | 3 | Me |
| 396 | N(CF₃)₂ | (CH₂)ₐ | 0 to 20 | C(═O)NHCH₂C | (CH₂)_{c} | 1 to 20 | Si(OMe)₃ | 3 | Me |
| 397 | CF₃ | (CH₂)ₐ | 0 to 20 | NHC(═O)CH₂C | (CH₂)_{c} | 1 to 20 | Si(OMe)₃ | 3 | Me |
| 398 | (CF₃)₂CF | (CH₂)ₐ | 0 to 20 | NHC(═O)CH₂C | (CH₂)_{c} | 1 to 20 | Si(OMe)₃ | 3 | Me |
| 399 | (CF₃)₃C | (CH₂)ₐ | 0 to 20 | NHC(═O)CH₂C | (CH₂)_{c} | 1 to 20 | Si(OMe)₃ | 3 | Me |
| 400 | C₄F₉ | (CH₂)ₐ | 0 to 20 | NHC(═O)CH₂C | (CH₂)_{c} | 1 to 20 | Si(OMe)₃ | 3 | Me |
| 401 | C₈F₁₇ | (CH₂)ₐ | 0 to 20 | NHC(═O)CH₂C | (CH₂)_{c} | 1 to 20 | Si(OMe)₃ | 3 | Me |
| 402 | c-C₆F₁₁ | (CH₂)ₐ | 0 to 20 | NHC(═O)CH₂C | (CH₂)_{c} | 1 to 20 | Si(OMe)₃ | 3 | Me |
| 403 | CHF₂ | (CH₂)ₐ | 0 to 20 | NHC(═O)CH₂C | (CH₂)_{c} | 1 to 20 | Si(OMe)₃ | 3 | Me |
| 404 | CClF₂ | (CH₂)ₐ | 0 to 20 | NHC(═O)CH₂C | (CH₂)_{c} | 1 to 20 | Si(OMe)₃ | 3 | Me |
| 405 | CBrF₂ | (CH₂)ₐ | 0 to 20 | NHC(═O)CH₂C | (CH₂)_{c} | 1 to 20 | Si(OMe)₃ | 3 | Me |

TABLE 28

| No. | R^{f1} | R¹ | a | L¹ | R² | c | T¹ | x1 | R³⁶ |
|---|---|---|---|---|---|---|---|---|---|
| 406 | ClF₂ | (CH₂)ₐ | 0 to 20 | NHC(═O)CH₂C | (CH₂)_{c} | 1 to 20 | Si(OMe)₃ | 3 | Me |
| 407 | CF═CF₂ | (CH₂)ₐ | 0 to 20 | NHC(═O)CH₂C | (CH₂)_{c} | 1 to 20 | Si(OMe)₃ | 3 | Me |
| 408 | CF═CFCF₃ | (CH₂)ₐ | 0 to 20 | NHC(═O)CH₂C | (CH₂)_{c} | 1 to 20 | Si(OMe)₃ | 3 | Me |
| 409 | CF═CFCF═CF₂ | (CH₂)ₐ | 0 to 20 | NHC(═O)CH₂C | (CH₂)_{c} | 1 to 20 | Si(OMe)₃ | 3 | Me |
| 410 | C≡CCF₃ | (CH₂)ₐ | 0 to 20 | NHC(═O)CH₂C | (CH₂)_{c} | 1 to 20 | Si(OMe)₃ | 3 | Me |
| 411 | CF₂CH₃ | (CH₂)ₐ | 0 to 20 | NHC(═O)CH₂C | (CH₂)_{c} | 1 to 20 | Si(OMe)₃ | 3 | Me |
| 412 | (CF₂)₂H | (CH₂)ₐ | 0 to 20 | NHC(═O)CH₂C | (CH₂)_{c} | 1 to 20 | Si(OMe)₃ | 3 | Me |
| 413 | (CF₂)₂CH₃ | (CH₂)ₐ | 0 to 20 | NHC(═O)CH₂C | (CH₂)_{c} | 1 to 20 | Si(OMe)₃ | 3 | Me |
| 414 | (CF₂)₄H | (CH₂)ₐ | 0 to 20 | NHC(═O)CH₂C | (CH₂)_{c} | 1 to 20 | Si(OMe)₃ | 3 | Me |
| 415 | C₆F₅ | (CH₂)ₐ | 0 to 20 | NHC(═O)CH₂C | (CH₂)_{c} | 1 to 20 | Si(OMe)₃ | 3 | Me |
| 416 | 4-CF₃C₆FA | (CH₂)ₐ | 0 to 20 | NHC(═O)CH₂C | (CH₂)_{c} | 1 to 20 | Si(OMe)₃ | 3 | Me |
| 417 | 14-SF₅C₆F₄ | (CH₂)ₐ | 0 to 20 | NHC(═O)CH₂C | (CH₂)_{c} | 1 to 20 | Si(OMe)₃ | 3 | Me |
| 418 | 3,5-CF₃C₆F₃ | (CH₂)ₐ | 0 to 20 | NHC(═O)CH₂C | (CH₂)_{c} | 1 to 20 | Si(OMe)₃ | 3 | Me |
| 419 | 3,5-SF₅C₆F₃ | (CH₂)ₐ | 0 to 20 | NHC(═O)CH₂C | (CH₂)_{c} | 1 to 20 | Si(OMe)₃ | 3 | Me |
| 420 | 14-CF₃C₆H₄ | (CH₂)ₐ | 0 to 20 | NHC(═O)CH₂C | (CH₂)_{c} | 1 to 20 | Si(OMe)₃ | 3 | Me |

TABLE 29

| No. | R^{f1} | R¹ | a | L¹ | R² | c | T¹ | x1 | R³⁶ |
|---|---|---|---|---|---|---|---|---|---|
| 421 | 4-SF₅C₆H₄ | (CH₂)ₐ | 0 to 20 | NHC(═O)CH₂C | (CH₂)_{c} | 1 to 20 | Si(OMe)₃ | 3 | Me |
| 422 | 3,5-CF₃C₆H₃ | (CH₂)ₐ | 0 to 20 | NHC(═O)CH₂C | (CH₂)_{c} | 1 to 20 | Si(OMe)₃ | 3 | Me |
| 423 | 3,5-SF₅C₆H₃ | (CH₂)ₐ | 0 to 20 | NHC(═O)CH₂C | (CH₂)_{c} | 1 to 20 | Si(OMe)₃ | 3 | Me |
| 424 | 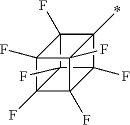 [SMILES: *C12C3(F)C4(F)C1(F)C1(F)C2(F)C3(F)C41F] | (CH₂)ₐ | 0 to 20 | NHC(═O)CH₂C | (CH₂)_{c} | 1 to 20 | Si(OMe)₃ | 3 | Me |
| 425 | 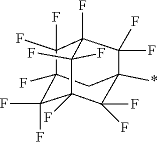 [SMILES: *C12C[C@@]3(F)C(F)(F)[C@](F)(C1(F)F)C(F)(F)[C@](F)(C2(F)F)C3(F)F] | (CH₂)ₐ | 0 to 20 | NHC(═O)CH₂C | (CH₂)_{c} | 1 to 20 | Si(OMe)₃ | 3 | Me |
| 426 | 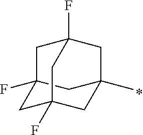 | (CH₂)ₐ | 0 to 20 | NHC(═O)CH₂C | (CH₂)_{c} | 1 to 20 | Si(OMe)₃ | 3 | Me |
| 427 | CH₂F | (CH₂)ₐ | 0 to 20 | NHC(═O)CH₂C | (CH₂)_{c} | 1 to 20 | Si(OMe)₃ | 3 | Me |
| 428 | SF₅ | (CH₂)ₐ | 0 to 20 | NHC(═O)CH₂C | (CH₂)_{c} | 1 to 20 | Si(OMe)₃ | 3 | Me |
| 429 | OCF₃ | (CH₂)ₐ | 0 to 20 | NHC(═O)CH₂C | (CH₂)_{c} | 1 to 20 | Si(OMe)₃ | 3 | Me |
| 430 | SCF₃ | (CH₂)ₐ | 0 to 20 | NHC(═O)CH₂C | (CH₂)_{c} | 1 to 20 | Si(OMe)₃ | 3 | Me |
| 431 | N(CH₂CF₃)₂ | (CH₂)ₐ | 0 to 20 | NHC(═O)CH₂C | (CH₂)_{c} | 1 to 20 | Si(OMe)₃ | 3 | Me |
| 432 | N(CF₃)₂ | (CH₂)ₐ | 0 to 20 | NHC(═O)CH₂C | (CH₂)_{c} | 1 to 20 | Si(OMe)₃ | 3 | Me |
| 433 | CF₃ | (CH₂)ₐ | 0 to 20 | OC(═O)C | (CH₂)_{c} | 1 to 20 | Si(OMe)₃ | 3 | Me |
| 434 | (CF₃)₂CF | (CH₂)ₐ | 0 to 20 | OC(═O)C | (CH₂)_{c} | 1 to 20 | Si(OMe)₃ | 3 | Me |
| 435 | (CF₃)₃C | (CH₂)ₐ | 0 to 20 | OC(═O)C | (CH₂)_{c} | 1 to 20 | Si(OMe)₃ | 3 | Me |

TABLE 30

| No. | R^{f1} | R¹ | a | L¹ | R² | c | T¹ | x1 | R³⁶ |
|---|---|---|---|---|---|---|---|---|---|
| 436 | C₄F₉ | (CH₂)ₐ | 0 to 20 | OC(═O)C | (CH₂)_{c} | 1 to 20 | Si(OMe)₃ | 3 | Me |
| 437 | C₈F₁₇ | (CH₂)ₐ | 0 to 20 | OC(═O)C | (CH₂)_{c} | 1 to 20 | Si(OMe)₃ | 3 | Me |
| 438 | c-C₆F₁₁ | (CH₂)ₐ | 0 to 20 | OC(═O)C | (CH₂)_{c} | 1 to 20 | Si(OMe)₃ | 3 | Me |
| 439 | CHF₂ | (CH₂)ₐ | 0 to 20 | OC(═O)C | (CH₂)_{c} | 1 to 20 | Si(OMe)₃ | 3 | Me |
| 440 | CClF₂ | (CH₂)ₐ | 0 to 20 | OC(═O)C | (CH₂)_{c} | 1 to 20 | Si(OMe)₃ | 3 | Me |
| 441 | CBrF₂ | (CH₂)ₐ | 0 to 20 | OC(═O)C | (CH₂)_{c} | 1 to 20 | Si(OMe)₃ | 3 | Me |
| 442 | ClF₂ | (CH₂)ₐ | 0 to 20 | OC(═O)C | (CH₂)_{c} | 1 to 20 | Si(OMe)₃ | 3 | Me |
| 443 | CF═CF₂ | (CH₂)ₐ | 0 to 20 | OC(═O)C | (CH₂)_{c} | 1 to 20 | Si(OMe)₃ | 3 | Me |
| 444 | CF═CFCF₃ | (CH₂)ₐ | 0 to 20 | OC(═O)C | (CH₂)_{c} | 1 to 20 | Si(OMe)₃ | 3 | Me |
| 445 | CF═CFCF═CF₂ | (CH₂)ₐ | 0 to 20 | OC(═O)C | (CH₂)_{c} | 1 to 20 | Si(OMe)₃ | 3 | Me |
| 446 | C≡CCF₃ | (CH₂)ₐ | 0 to 20 | OC(═O)C | (CH₂)_{c} | 1 to 20 | Si(OMe)₃ | 3 | Me |
| 447 | CF₂CH₃ | (CH₂)ₐ | 0 to 20 | OC(═O)C | (CH₂)_{c} | 1 to 20 | Si(OMe)₃ | 3 | Me |
| 448 | (CF₂)₂H | (CH₂)ₐ | 0 to 20 | OC(═O)C | (CH₂)_{c} | 1 to 20 | Si(OMe)₃ | 3 | Me |
| 449 | (CF₂)₂CH₃ | (CH₂)ₐ | 0 to 20 | OC(═O)C | (CH₂)_{c} | 1 to 20 | Si(OMe)₃ | 3 | Me |
| 450 | (CF₂)₄H | (CH₂)ₐ | 0 to 20 | OC(═O)C | (CH₂)_{c} | 1 to 20 | Si(OMe)₃ | 3 | Me |

TABLE 31

| No. | R^{f1} | R¹ | a | L¹ | R² | c | T¹ | x1 | R³⁶ |
|---|---|---|---|---|---|---|---|---|---|
| 451 | C₆F₅ | (CH₂)ₐ | 0 to 20 | OC(═O)C | (CH₂)_{c} | 1 to 20 | Si(OMe)₃ | 3 | Me |
| 452 | 4-CF₃C₆F₄ | (CH₂)ₐ | 0 to 20 | OC(═O)C | (CH₂)_{c} | 1 to 20 | Si(OMe)₃ | 3 | Me |
| 453 | 4-SF₅C₆F₄ | (CH₂)ₐ | 0 to 20 | OC(═O)C | (CH₂)_{c} | 1 to 20 | Si(OMe)₃ | 3 | Me |
| 454 | 3,5-CF₃C₆F₃ | (CH₂)ₐ | 0 to 20 | OC(═O)C | (CH₂)_{c} | 1 to 20 | Si(OMe)₃ | 3 | Me |
| 455 | 3,5-SF₅C₆F₃ | (CH₂)ₐ | 0 to 20 | OC(═O)C | (CH₂)_{c} | 1 to 20 | Si(OMe)₃ | 3 | Me |
| 456 | 4-CF₃C₆H₄ | (CH₂)ₐ | 0 to 20 | OC(═O)C | (CH₂)_{c} | 1 to 20 | Si(OMe)₃ | 3 | Me |
| 457 | 4-SF₅C₆H₄ | (CH₂)ₐ | 0 to 20 | OC(═O)C | (CH₂)_{c} | 1 to 20 | Si(OMe)₃ | 3 | Me |
| 458 | 3,5-CF₃C₆H₃ | (CH₂)ₐ | 0 to 20 | OC(═O)C | (CH₂)_{c} | 1 to 20 | Si(OMe)₃ | 3 | Me |
| 459 | 3,5-SF₅C₆H₃ | (CH₂)ₐ | 0 to 20 | OC(═O)C | (CH₂)_{c} | 1 to 20 | Si(OMe)₃ | 3 | Me |
| 460 | 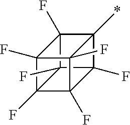 [SMILES: *C12C3(F)C4(F)C1(F)C1(F)C2(F)C3(F)C41F] | (CH₂)ₐ | 0 to 20 | OC(═O)C | (CH₂)_{c} | 1 to 20 | Si(OMe)₃ | 3 | Me |
| 461 | 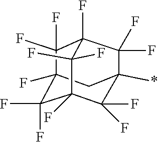 [SMILES: *C12C[C@@]3(F)C(F)(F)[C@](F)(C1(F)F)C(F)(F)[C@](F)(C2(F)F)C3(F)F] | (CH₂)ₐ | 0 to 20 | OC(═O)C | (CH₂)_{c} | 1 to 20 | Si(OMe)₃ | 3 | Me |
| 462 | 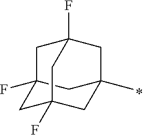 | (CH₂)ₐ | 0 to 20 | OC(═O)C | (CH₂)_{c} | 1 to 20 | Si(OMe)₃ | 3 | Me |
| 463 | CH₂F | (CH₂)ₐ | 0 to 20 | OC(═O)C | (CH₂)_{c} | 1 to 20 | Si(OMe)₃ | 3 | Me |
| 464 | SF₅ | (CH₂)ₐ | 0 to 20 | OC(═O)C | (CH₂)_{c} | 1 to 20 | Si(OMe)₃ | 3 | Me |
| 465 | OCF₃ | (CH₂)ₐ | 0 to 20 | OC(═O)C | (CH₂)_{c} | 1 to 20 | Si(OMe)₃ | 3 | Me |

TABLE 32

| No. | R^{f1} | R¹ | a | L¹ | R² | c | T¹ | x1 | R³⁶ |
|---|---|---|---|---|---|---|---|---|---|
| 466 | SCF₃ | (CH₂)ₐ | 0 to 20 | OC(═O)C | (CH₂)_{c} | 1 to 20 | Si(OMe)₃ | 3 | Me |
| 467 | N(CH₂CF₃)₂ | (CH₂)ₐ | 0 to 20 | OC(═O)C | (CH₂)_{c} | 1 to 20 | Si(OMe)₃ | 3 | Me |
| 468 | N(CF₃)₂ | (CH₂)ₐ | 0 to 20 | OC(═O)C | (CH₂)_{c} | 1 to 20 | Si(OMe)₃ | 3 | Me |
| 469 | CF₃ | (CH₂)ₐ | 0 to 20 | Si | (CH₂)_{c} | 1 to 20 | Si(OMe)₃ | 3 | Me |
| 470 | (CF₃)₂CF | (CH₂)ₐ | 0 to 20 | Si | (CH₂)_{c} | 1 to 20 | Si(OMe)₃ | 3 | Me |
| 471 | (CF₃)₃C | (CH₂)ₐ | 0 to 20 | Si | (CH₂)_{c} | 1 to 20 | Si(OMe)₃ | 3 | Me |
| 472 | C₄F₉ | (CH₂)ₐ | 0 to 20 | Si | (CH₂)_{c} | 1 to 20 | Si(OMe)₃ | 3 | Me |
| 473 | C₈F₁₇ | (CH₂)ₐ | 0 to 20 | Si | (CH₂)_{c} | 1 to 20 | Si(OMe)₃ | 3 | Me |
| 474 | c-C₆F₁₁ | (CH₂)ₐ | 0 to 20 | Si | (CH₂)_{c} | 1 to 20 | Si(OMe)₃ | 3 | Me |
| 475 | CHF₂ | (CH₂)ₐ | 0 to 20 | Si | (CH₂)_{c} | 1 to 20 | Si(OMe)₃ | 3 | Me |
| 476 | CClF₂ | (CH₂)ₐ | 0 to 20 | Si | (CH₂)_{c} | 1 to 20 | Si(OMe)₃ | 3 | Me |
| 477 | CBrF₂ | (CH₂)ₐ | 0 to 20 | Si | (CH₂)_{c} | 1 to 20 | Si(OMe)₃ | 3 | Me |
| 478 | ClF₂ | (CH₂)ₐ | 0 to 20 | Si | (CH₂)_{c} | 1 to 20 | Si(OMe)₃ | 3 | Me |
| 479 | CF═CF₂ | (CH₂)ₐ | 0 to 20 | Si | (CH₂)_{c} | 1 to 20 | Si(OMe)₃ | 3 | Me |
| 480 | CF═CFCF₃ | (CH₂)ₐ | 0 to 20 | Si | (CH₂)_{c} | 1 to 20 | Si(OMe)₃ | 3 | Me |

TABLE 33

| No. | R^{f1} | R¹ | a | L¹ | R² | c | T¹ | x1 | R³⁶ |
|---|---|---|---|---|---|---|---|---|---|
| 481 | CF═CFCF═CF₂ | (CH₂)ₐ | 0 to 20 | Si | (CH₂)_{c} | 1 to 20 | Si(OMe)₃ | 3 | Me |
| 482 | C≡CCF₃ | (CH₂)ₐ | 0 to 20 | Si | (CH₂)_{c} | 1 to 20 | Si(OMe)₃ | 3 | Me |
| 483 | CF₂CH₃ | (CH₂)ₐ | 0 to 20 | Si | (CH₂)_{c} | 1 to 20 | Si(OMe)₃ | 3 | Me |
| 484 | (CF₂)₂H | (CH₂)ₐ | 0 to 20 | Si | (CH₂)_{c} | 1 to 20 | Si(OMe)₃ | 3 | Me |
| 485 | (CF₂)₂CH₃ | (CH₂)ₐ | 0 to 20 | Si | (CH₂)_{c} | 1 to 20 | Si(OMe)₃ | 3 | Me |
| 486 | (CF₂)₄H | (CH₂)ₐ | 0 to 20 | Si | (CH₂)_{c} | 1 to 20 | Si(OMe)₃ | 3 | Me |
| 487 | C₆F₅ | (CH₂)ₐ | 0 to 20 | Si | (CH₂)_{c} | 1 to 20 | Si(OMe)₃ | 3 | Me |
| 488 | 4-CF₃C₆F₄ | (CH₂)ₐ | 0 to 20 | Si | (CH₂)_{c} | 1 to 20 | Si(OMe)₃ | 3 | Me |
| 489 | 4-SF₅C₆F₄ | (CH₂)ₐ | 0 to 20 | Si | (CH₂)_{c} | 1 to 20 | Si(OMe)₃ | 3 | Me |
| 490 | 3,5-CF₃C₆F₃ | (CH₂)ₐ | 0 to 20 | Si | (CH₂)_{c} | 1 to 20 | Si(OMe)₃ | 3 | Me |
| 491 | 3,5-SF₅C₆F₃ | (CH₂)ₐ | 0 to 20 | Si | (CH₂)_{c} | 1 to 20 | Si(OMe)₃ | 3 | Me |
| 492 | 4-CF₃C₆H₄ | (CH₂)ₐ | 0 to 20 | Si | (CH₂)_{c} | 1 to 20 | Si(OMe)₃ | 3 | Me |
| 493 | 4-SF₅C₆H₄ | (CH₂)ₐ | 0 to 20 | Si | (CH₂)_{c} | 1 to 20 | Si(OMe)₃ | 3 | Me |
| 494 | 3,5-CF₃C₆H₃ | (CH₂)ₐ | 0 to 20 | Si | (CH₂)_{c} | 1 to 20 | Si(OMe)₃ | 3 | Me |
| 495 | 3,5-SF₅C₆H₃ | (CH₂)ₐ | 0 to 20 | Si | (CH₂)_{c} | 1 to 20 | Si(OMe)₃ | 3 | Me |

TABLE 34

| No. | R^{f1} | R¹ | a | L¹ | R² | c | T¹ | x1 | R³⁶ |
|---|---|---|---|---|---|---|---|---|---|
| 496 | 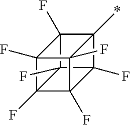 [SMILES: *C12C3(F)C4(F)C1(F)C1(F)C2(F)C3(F)C41F] | (CH₂)ₐ | 0 to 20 | Si | (CH₂)_{c} | 1 to 20 | Si(OMe)₃ | 3 | Me |
| 497 | 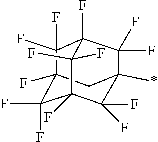 [SMILES: *C12C[C@@]3(F)C(F)(F)[C@](F)(C1(F)F)C(F)(F)[C@](F)(C2(F)F)C3(F)F] | (CH₂)ₐ | 0 to 20 | Si | (CH₂)_{c} | 1 to 20 | Si(OMe)₃ | 3 | Me |
| 498 | 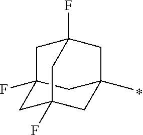 | (CH₂)ₐ | 0 to 20 | Si | (CH₂)_{c} | 1 to 20 | Si(OMe)₃ | 3 | Me |
| 499 | CH₂F | (CH₂)ₐ | 0 to 20 | Si | (CH₂)_{c} | 1 to 20 | Si(OMe)₃ | 3 | Me |
| 500 | SF₅ | (CH₂)ₐ | 0 to 20 | Si | (CH₂)_{c} | 1 to 20 | Si(OMe)₃ | 3 | Me |
| 501 | OCF₃ | (CH₂)ₐ | 0 to 20 | Si | (CH₂)_{c} | 1 to 20 | Si(OMe)₃ | 3 | Me |
| 502 | SCF₃ | (CH₂)ₐ | 0 to 20 | Si | (CH₂)_{c} | 1 to 20 | Si(OMe)₃ | 3 | Me |
| 503 | N(CH₂CF₃)₂ | (CH₂)ₐ | 0 to 20 | Si | (CH₂)_{c} | 1 to 20 | Si(OMe)₃ | 3 | Me |
| 504 | N(CF₃)₂ | (CH₂)ₐ | 0 to 20 | Si | (CH₂)_{c} | 1 to 20 | Si(OMe)₃ | 3 | Me |
| 505 | CF₃ | (CH₂)ₐ | 0 to 20 | C | (CH₂)_{c} | 1 to 20 | Si(OMe)₃ | 3 | Me |
| 506 | (CF₃)₂CF | (CH₂)ₐ | 0 to 20 | C | (CH₂)_{c} | 1 to 20 | Si(OMe)₃ | 3 | Me |
| 507 | (CF₃)₃C | (CH₂)ₐ | 0 to 20 | C | (CH₂)_{c} | 1 to 20 | Si(OMe)₃ | 3 | Me |
| 508 | C₄F₉ | (CH₂)ₐ | 0 to 20 | C | (CH₂)_{c} | 1 to 20 | Si(OMe)₃ | 3 | Me |
| 509 | C₈F₁₇ | (CH₂)ₐ | 0 to 20 | C | (CH₂)_{c} | 1 to 20 | Si(OMe)₃ | 3 | Me |
| 510 | c-C₆F₁₁ | (CH₂)ₐ | 0 to 20 | C | (CH₂)_{c} | 1 to 20 | Si(OMe)₃ | 3 | Me |

TABLE 35

| No. | R^{f1} | R¹ | a | L¹ | R² | c | T¹ | x1 | R³⁶ |
|---|---|---|---|---|---|---|---|---|---|
| 511 | CHF₂ | (CH₂)ₐ | 0 to 20 | C | (CH₂)_{c} | 1 to 20 | Si(OMe)₃ | 3 | Me |
| 512 | CClF₂ | (CH₂)ₐ | 0 to 20 | C | (CH₂)_{c} | 1 to 20 | Si(OMe)₃ | 3 | Me |
| 513 | CBrF₂ | (CH₂)ₐ | 0 to 20 | C | (CH₂)_{c} | 1 to 20 | Si(OMe)₃ | 3 | Me |
| 514 | ClF₂ | (CH₂)ₐ | 0 to 20 | C | (CH₂)_{c} | 1 to 20 | Si(OMe)₃ | 3 | Me |
| 515 | CF═CF₂ | (CH₂)ₐ | 0 to 20 | C | (CH₂)_{c} | 1 to 20 | Si(OMe)₃ | 3 | Me |
| 516 | CF═CFCF₃ | (CH₂)ₐ | 0 to 20 | C | (CH₂)_{c} | 1 to 20 | Si(OMe)₃ | 3 | Me |
| 517 | CF═CFCF═CF₂ | (CH₂)ₐ | 0 to 20 | C | (CH₂)_{c} | 1 to 20 | Si(OMe)₃ | 3 | Me |
| 518 | C≡CCF₃ | (CH₂)ₐ | 0 to 20 | C | (CH₂)_{c} | 1 to 20 | Si(OMe)₃ | 3 | Me |
| 519 | CF₂CH₃ | (CH₂)ₐ | 0 to 20 | C | (CH₂)_{c} | 1 to 20 | Si(OMe)₃ | 3 | Me |
| 520 | (CF₂)₂H | (CH₂)ₐ | 0 to 20 | C | (CH₂)_{c} | 1 to 20 | Si(OMe)₃ | 3 | Me |
| 521 | (CF₂)₂CH₃ | (CH₂)ₐ | 0 to 20 | C | (CH₂)_{c} | 1 to 20 | Si(OMe)₃ | 3 | Me |
| 522 | (CF₂)₄H | (CH₂)ₐ | 0 to 20 | C | (CH₂)_{c} | 1 to 20 | Si(OMe)₃ | 3 | Me |
| 523 | C₆F₅ | (CH₂)ₐ | 0 to 20 | C | (CH₂)_{c} | 1 to 20 | Si(OMe)₃ | 3 | Me |
| 524 | 4-CF₃C₆F₄ | (CH₂)ₐ | 0 to 20 | C | (CH₂)_{c} | 1 to 20 | Si(OMe)₃ | 3 | Me |
| 525 | 4-SF₅C₆F₄ | (CH₂)ₐ | 0 to 20 | C | (CH₂)_{c} | 1 to 20 | Si(OMe)₃ | 3 | Me |

TABLE 36

| No. | R^{f1} | R¹ | a | L¹ | R² | c | T¹ | x1 | R³⁶ |
|---|---|---|---|---|---|---|---|---|---|
| 526 | 3,5-CF₃C₆F₃ | (CH₂)ₐ | 0 to 20 | C | (CH₂)_{c} | 1 to 20 | Si(OMe)₃ | 3 | Me |
| 527 | 3,5-SF₅C₆F₃ | (CH₂)ₐ | 0 to 20 | C | (CH₂)_{c} | 1 to 20 | Si(OMe)₃ | 3 | Me |
| 528 | 4-CF₃CH₄ | (CH₂)ₐ | 0 to 20 | C | (CH₂)_{c} | 1 to 20 | Si(OMe)₃ | 3 | Me |
| 529 | 4-SF₅C₆H₄ | (CH₂)ₐ | 0 to 20 | C | (CH₂)_{c} | 1 to 20 | Si(OMe)₃ | 3 | Me |
| 530 | 3,5-CF₃C₆H₃ | (CH₂)ₐ | 0 to 20 | C | (CH₂)_{c} | 1 to 20 | Si(OMe)₃ | 3 | Me |
| 531 | 3,5-SF₅C₆H₃ | (CH₂)ₐ | 0 to 20 | C | (CH₂)_{c} | 1 to 20 | Si(OMe)₃ | 3 | Me |
| 532 | 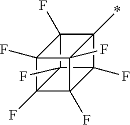 [SMILES: *C12C3(F)C4(F)C1(F)C1(F)C2(F)C3(F)C41F] | (CH₂)ₐ | 0 to 20 | C | (CH₂)_{c} | 1 to 20 | Si(OMe)₃ | 3 | Me |
| 533 | 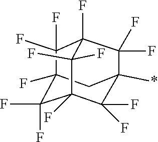 [SMILES: *C12C[C@@]3(F)C(F)(F)[C@](F)(C1(F)F)C(F)(F)[C@](F)(C2(F)F)C3(F)F] | (CH₂)ₐ | 0 to 20 | C | (CH₂)_{c} | 1 to 20 | Si(OMe)₃ | 3 | Me |
| 534 | 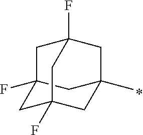 | (CH₂)ₐ | 0 to 20 | C | (CH₂)_{c} | 1 to 20 | Si(OMe)₃ | 3 | Me |
| 535 | CH₂F | (CH₂)ₐ | 0 to 20 | C | (CH₂)_{c} | 1 to 20 | Si(OMe)₃ | 3 | Me |
| 536 | SF₅ | (CH₂)ₐ | 0 to 20 | C | (CH₂)_{c} | 1 to 20 | Si(OMe)₃ | 3 | Me |
| 537 | OCF₃ | (CH₂)ₐ | 0 to 20 | C | (CH₂)_{c} | 1 to 20 | Si(OMe)₃ | 3 | Me |
| 538 | SCF₃ | (CH₂)ₐ | 0 to 20 | C | (CH₂)_{c} | 1 to 20 | Si(OMe)₃ | 3 | Me |
| 539 | N(CH₂CF₃)₂ | (CH₂)ₐ | 0 to 20 | C | (CH₂)_{c} | 1 to 20 | Si(OMe)₃ | 3 | Me |
| 540 | N(CF₃)₂ | (CH₂)ₐ | 0 to 20 | C | (CH₂)_{c} | 1 to 20 | Si(OMe)₃ | 3 | Me |

TABLE 37

| No. | R^{f1} | R¹ | a | L¹ | R² | c | T¹ | x1 | R³⁶ |
|---|---|---|---|---|---|---|---|---|---|
| 541 | CF₃ | (CH₂CH₂O)ₐ | 0 to 20 | C(═O)NH | (CH₂)_{c} | 1 to 20 | Si(OMe)₃ | 1 | Me |
| 542 | (CF₃)₂CF | (CH₂CH₂O)ₐ | 0 to 20 | C(═O)NH | (CH₂)_{c} | 1 to 20 | Si(OMe)₃ | 1 | Me |
| 543 | (CF₃)₃C | (CH₂CH₂O)ₐ | 0 to 20 | C(═O)NH | (CH₂)_{c} | 1 to 20 | Si(OMe)₃ | 1 | Me |
| 544 | C₄F₉ | (CH₂CH₂O)ₐ | 0 to 20 | C(═O)NH | (CH₂)_{c} | 1 to 20 | Si(OMe)₃ | 1 | Me |
| 545 | C₈F₁₇ | (CH₂CH₂O)ₐ | 0 to 20 | C(═O)NH | (CH₂)_{c} | 1 to 20 | Si(OMe)₃ | 1 | Me |
| 546 | c-C₆F₁₁ | (CH₂CH₂O)ₐ | 0 to 20 | C(═O)NH | (CH₂)_{c} | 1 to 20 | Si(OMe)₃ | 1 | Me |
| 547 | CHF₂ | (CH₂CH₂O)ₐ | 0 to 20 | C(═O)NH | (CH₂)_{c} | 1 to 20 | Si(OMe)₃ | 1 | Me |
| 548 | CClF₂ | (CH₂CH₂O)ₐ | 0 to 20 | C(═O)NH | (CH₂)_{c} | 1 to 20 | Si(OMe)₃ | 1 | Me |
| 549 | CBrF₂ | (CH₂CH₂O)ₐ | 0 to 20 | C(═O)NH | (CH₂)_{c} | 1 to 20 | Si(OMe)₃ | 1 | Me |
| 550 | ClF₂ | (CH₂CH₂O)ₐ | 0 to 20 | C(═O)NH | (CH₂)_{c} | 1 to 20 | Si(OMe)₃ | 1 | Me |
| 551 | CF═CF₂ | (CH₂CH₂O)ₐ | 0 to 20 | C(═O)NH | (CH₂)_{c} | 1 to 20 | Si(OMe)₃ | 1 | Me |
| 552 | CF═CFCF₃ | (CH₂CH₂O)ₐ | 0 to 20 | C(═O)NH | (CH₂)_{c} | 1 to 20 | Si(OMe)₃ | 1 | Me |
| 553 | CF═CFCF═CF₂ | (CH₂CH₂O)ₐ | 0 to 20 | C(═O)NH | (CH₂)_{c} | 1 to 20 | Si(OMe)₃ | 1 | Me |
| 554 | C≡CCF₃ | (CH₂CH₂O)ₐ | 0 to 20 | C(═O)NH | (CH₂)_{c} | 1 to 20 | Si(OMe)₃ | 1 | Me |
| 555 | CF₂CH₃ | (CH₂CH₂O)ₐ | 0 to 20 | C(═O)NH | (CH₂)_{c} | 1 to 20 | Si(OMe)₃ | 1 | Me |

TABLE 38

| No. | R^{f1} | R¹ | a | L¹ | R² | c | T¹ | x1 | R³⁶ |
|---|---|---|---|---|---|---|---|---|---|
| 556 | (CF₂)₂H | (CH₂CH₂O)ₐ | 0 to 20 | C(═O)NH | (CH₂)_{c} | 1 to 20 | Si(OMe)₃ | 1 | Me |
| 557 | (CF₂)₂CH₃ | (CH₂CH₂O)ₐ | 0 to 20 | C(═O)NH | (CH₂)_{c} | 1 to 20 | Si(OMe)₃ | 1 | Me |
| 558 | (CF₂)₄H | (CH₂CH₂O)ₐ | 0 to 20 | C(═O)NH | (CH₂)_{c} | 1 to 20 | Si(OMe)₃ | 1 | Me |
| 559 | C₆F₅ | (CH₂CH₂O)ₐ | 0 to 20 | C(═O)NH | (CH₂)_{c} | 1 to 20 | Si(OMe)₃ | 1 | Me |
| 560 | 4-CF₃C₆F₄ | (CH₂CH₂O)ₐ | 0 to 20 | C(═O)NH | (CH₂)_{c} | 1 to 20 | Si(OMe)₃ | 1 | Me |
| 561 | 4-SF₅C₆F₄ | (CH₂CH₂O)ₐ | 0 to 20 | C(═O)NH | (CH₂)_{c} | 1 to 20 | Si(OMe)₃ | 1 | Me |
| 562 | 3,5-CF₃C₆F₃ | (CH₂CH₂O)ₐ | 0 to 20 | C(═O)NH | (CH₂)_{c} | 1 to 20 | Si(OMe)₃ | 1 | Me |
| 563 | 3,5-SF₅C₆F₃ | (CH₂CH₂O)ₐ | 0 to 20 | C(═O)NH | (CH₂)_{c} | 1 to 20 | Si(OMe)₃ | 1 | Me |
| 564 | 4-CF₃C₆H₄ | (CH₂CH₂O)ₐ | 0 to 20 | C(═O)NH | (CH₂)_{c} | 1 to 20 | Si(OMe)₃ | 1 | Me |
| 565 | 4-SF₅C₆H₄ | (CH₂CH₂O)ₐ | 0 to 20 | C(═O)NH | (CH₂)_{c} | 1 to 20 | Si(OMe)₃ | 1 | Me |
| 566 | 3,5-CF₃C₆H₃ | (CH₂CH₂O)ₐ | 0 to 20 | C(═O)NH | (CH₂)_{c} | 1 to 20 | Si(OMe)₃ | 1 | Me |
| 567 | 3,5-SF₅C₆H₃ | (CH₂CH₂O)ₐ | 0 to 20 | C(═O)NH | (CH₂)_{c} | 1 to 20 | Si(OMe)₃ | 1 | Me |
| 568 | 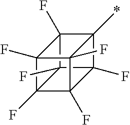 [SMILES: *C12C3(F)C4(F)C1(F)C1(F)C2(F)C3(F)C41F] | (CH₂CH₂O)ₐ | 0 to 20 | C(═O)NH | (CH₂)_{c} | 1 to 20 | Si(OMe)₃ | 1 | Me |
| 569 | 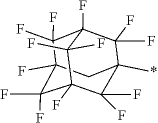 [SMILES: *C12CC3(F)C(F)(F)C(F)(C1(F)F)C(F)(F)C(F)(C2(F)F)C3(F)F] | (CH₂CH₂O)ₐ | 0 to 20 | C(═O)NH | (CH₂)_{c} | 1 to 20 | Si(OMe)₃ | 1 | Me |
| 570 | 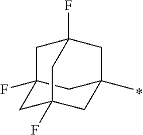 | (CH₂CH₂O)ₐ | 0 to 20 | C(═O)NH | (CH₂)_{c} | 1 to 20 | Si(OMe)₃ | 1 | Me |

TABLE 39

| No. | R^{f1} | R¹ | a | L¹ | R² | c | T¹ | x1 | R³⁶ |
|---|---|---|---|---|---|---|---|---|---|
| 571 | CH₂F | (CH₂CH₂O)ₐ | 0 to 20 | C(═O)NH | (CH₂)_{c} | 1 to 20 | Si(OMe)₃ | 1 | Me |
| 572 | SF₅ | (CH₂CH₂O)ₐ | 0 to 20 | C(═O)NH | (CH₂)_{c} | 1 to 20 | Si(OMe)₃ | 1 | Me |
| 573 | OCF₃ | (CH₂CH₂O)ₐ | 0 to 20 | C(═O)NH | (CH₂)_{c} | 1 to 20 | Si(OMe)₃ | 1 | Me |
| 574 | SCF₃ | (CH₂CH₂O)ₐ | 0 to 20 | C(═O)NH | (CH₂)_{c} | 1 to 20 | Si(OMe)₃ | 1 | Me |
| 575 | N(CH₂CF₃)₂ | (CH₂CH₂O)ₐ | 0 to 20 | C(═O)NH | (CH₂)_{c} | 1 to 20 | Si(OMe)₃ | 1 | Me |
| 576 | N(CF₃)₂ | (CH₂CH₂O)ₐ | 0 to 20 | C(═O)NH | (CH₂)_{c} | 1 to 20 | Si(OMe)₃ | 1 | Me |
| 577 | CF₃ | (CH₂CH₂O)ₐ | 0 to 20 | NHC(═O) | (CH₂)_{c} | 1 to 20 | Si(OMe)₃ | 1 | Me |
| 578 | (CF₃)₂CF | (CH₂CH₂O)ₐ | 0 to 20 | NHC(═O) | (CH₂)_{c} | 1 to 20 | Si(OMe)₃ | 1 | Me |
| 579 | (CF₃)₃C | (CH₂CH₂O)ₐ | 0 to 20 | NHC(═O) | (CH₂)_{c} | 1 to 20 | Si(OMe)₃ | 1 | Me |
| 580 | C₄F₉ | (CH₂CH₂O)ₐ | 0 to 20 | NHC(═O) | (CH₂)_{c} | 1 to 20 | Si(OMe)₃ | 1 | Me |
| 581 | C₈F₁₇ | (CH₂CH₂O)ₐ | 0 to 20 | NHC(═O) | (CH₂)_{c} | 1 to 20 | Si(OMe)₃ | 1 | Me |
| 582 | c-C₆F₁₁ | (CH₂CH₂O)ₐ | 0 to 20 | NHC(═O) | (CH₂)_{c} | 1 to 20 | Si(OMe)₃ | 1 | Me |
| 583 | CHF₂ | (CH₂CH₂O)ₐ | 0 to 20 | NHC(═O) | (CH₂)_{c} | 1 to 20 | Si(OMe)₃ | 1 | Me |
| 584 | CClF₂ | (CH₂CH₂O)ₐ | 0 to 20 | NHC(═O) | (CH₂)_{c} | 1 to 20 | Si(OMe)₃ | 1 | Me |
| 585 | CBrF₂ | (CH₂CH₂O)ₐ | 0 to 20 | NHC(═O) | (CH₂)_{c} | 1 to 20 | Si(OMe)₃ | 1 | Me |

TABLE 40

| No. | R^{f1} | R¹ | a | L¹ | R² | c | T¹ | x1 | R³⁶ |
|---|---|---|---|---|---|---|---|---|---|
| 586 | ClF₂ | (CH₂CH₂O)ₐ | 0 to 20 | NHC(═O) | (CH₂)_{c} | 1 to 20 | Si(OMe)₃ | 1 | Me |
| 587 | CF═CF₂ | (CH₂CH₂O)ₐ | 0 to 20 | NHC(═O) | (CH₂)_{c} | 1 to 20 | Si(OMe)₃ | 1 | Me |
| 588 | CF═CFCF₃ | (CH₂CH₂O)ₐ | 0 to 20 | NHC(═O) | (CH₂)_{c} | 1 to 20 | Si(OMe)₃ | 1 | Me |
| 589 | CF═CFCF═CF₂ | (CH₂CH₂O)ₐ | 0 to 20 | NHC(═O) | (CH₂)_{c} | 1 to 20 | Si(OMe)₃ | 1 | Me |
| 590 | C═CCF₃ | (CH₂CH₂O)ₐ | 0 to 20 | NHC(═O) | (CH₂)_{c} | 1 to 20 | Si(OMe)₃ | 1 | Me |
| 591 | CF₂CH₃ | (CH₂CH₂O)ₐ | 0 to 20 | NHC(═O) | (CH₂)_{c} | 1 to 20 | Si(OMe)₃ | 1 | Me |
| 592 | (CF₂)₂H | (CH₂CH₂O)ₐ | 0 to 20 | NHC(═O) | (CH₂)_{c} | 1 to 20 | Si(OMe)₃ | 1 | Me |
| 593 | (CF₂)₂CH₃ | (CH₂CH₂O)ₐ | 0 to 20 | NHC(═O) | (CH₂)_{c} | 1 to 20 | Si(OMe)₃ | 1 | Me |
| 594 | (CF₂)₄H | (CH₂CH₂O)ₐ | 0 to 20 | NHC(═O) | (CH₂)_{c} | 1 to 20 | Si(OMe)₃ | 1 | Me |
| 595 | C₆F₅ | (CH₂CH₂O)ₐ | 0 to 20 | NHC(═O) | (CH₂)_{c} | 1 to 20 | Si(OMe)₃ | 1 | Me |
| 596 | 4-CF₃C₆F₄ | (CH₂CH₂O)ₐ | 0 to 20 | NHC(═O) | (CH₂)_{c} | 1 to 20 | Si(OMe)₃ | 1 | Me |
| 597 | 4-SF₅C₆F₄ | (CH₂CH₂O)ₐ | 0 to 20 | NHC(═O) | (CH₂)_{c} | 1 to 20 | Si(OMe)₃ | 1 | Me |
| 598 | 3,5-CF₃C₆F₃ | (CH₂CH₂O)ₐ | 0 to 20 | NHC(═O) | (CH₂)_{c} | 1 to 20 | Si(OMe)₃ | 1 | Me |
| 599 | 3,5-SF₅C₆F₃ | (CH₂CH₂O)ₐ | 0 to 20 | NHC(═O) | (CH₂)_{c} | 1 to 20 | Si(OMe)₃ | 1 | Me |
| 600 | 4-CF₃C₆H₄ | (CH₂CH₂O)ₐ | 0 to 20 | NHC(═O) | (CH₂)_{c} | 1 to 20 | Si(OMe)₃ | 1 | Me |

TABLE 41

| No. | R^{f1} | R¹ | a | L¹ | R² | c | T¹ | x1 | R³⁶ |
|---|---|---|---|---|---|---|---|---|---|
| 601 | 4-SF₅C₆H₄ | (CH₂CH₂O)ₐ | 0 to 20 | NHC(═O) | (CH₂)_{c} | 1 to 20 | Si(OMe)₃ | 1 | Me |
| 602 | 3,5-CF₃C₆H₃ | (CH₂CH₂O)ₐ | 0 to 20 | NHC(═O) | (CH₂)_{c} | 1 to 20 | Si(OMe)₃ | 1 | Me |
| 603 | 3,5-SF₅C₆H₃ | (CH₂CH₂O)ₐ | 0 to 20 | NHC(═O) | (CH₂)_{c} | 1 to 20 | Si(OMe)₃ | 1 | Me |
| 604 | 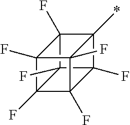 [SMILES: *C12C3(F)C4(F)C1(F)C1(F)C2(F)C3(F)C41F] | (CH₂CH₂O)ₐ | 0 to 20 | NHC(═O) | (CH₂)_{c} | 1 to 20 | Si(OMe)₃ | 1 | Me |
| 605 | 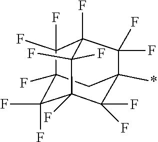 [SMILES: *C12C[C@@]3(F)C(F)(F)[C@](F)(C1(F)F)C(F)(F)[C@](F)(C2(F)F)C3(F)F] | (CH₂CH₂O)ₐ | 0 to 20 | NHC(═O) | (CH₂)_{c} | 1 to 20 | Si(OMe)₃ | 1 | Me |
| 606 | 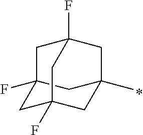 | (CH₂CH₂O)ₐ | 0 to 20 | NHC(═O) | (CH₂)_{c} | 1 to 20 | Si(OMe)₃ | 1 | Me |
| 607 | CH₂F | (CH₂CH₂O)ₐ | 0 to 20 | NHC(═O) | (CH₂)_{c} | 1 to 20 | Si(OMe)₃ | 1 | Me |
| 608 | SF₅ | (CH₂CH₂O)ₐ | 0 to 20 | NHC(═O) | (CH₂)_{c} | 1 to 20 | Si(OMe)₃ | 1 | Me |
| 609 | OCF₃ | (CH₂CH₂O)ₐ | 0 to 20 | NHC(═O) | (CH₂)_{c} | 1 to 20 | Si(OMe)₃ | 1 | Me |
| 610 | SCF₃ | (CH₂CH₂O)ₐ | 0 to 20 | NHC(═O) | (CH₂)_{c} | 1 to 20 | Si(OMe)₃ | 1 | Me |
| 611 | N(CH₂CF₃)₂ | (CH₂CH₂O)ₐ | 0 to 20 | NHC(═O) | (CH₂)_{c} | 1 to 20 | Si(OMe)₃ | 1 | Me |
| 612 | N(CF₃)₂ | (CH₂CH₂O)ₐ | 0 to 20 | NHC(═O) | (CH₂)_{c} | 1 to 20 | Si(OMe)₃ | 1 | Me |
| 613 | CF₃ | (CH₂CH₂O)ₐ | 0 to 20 | OC(═O)CH₂ | (CH₂)_{c} | 1 to 20 | Si(OMe)₃ | 1 | Me |
| 614 | (CF₃)₂CF | (CH₂CH₂O)ₐ | 0 to 20 | OC(═O)CH₂ | (CH₂)_{c} | 1 to 20 | Si(OMe)₃ | 1 | Me |
| 615 | (CF₃)₃C | (CH₂CH₂O)ₐ | 0 to 20 | OC(═O)CH₂ | (CH₂)_{c} | 1 to 20 | Si(OMe)₃ | 1 | Me |

TABLE 42

| No. | R^{f1} | R¹ | a | L¹ | R² | c | T¹ | x1 | R³⁶ |
|---|---|---|---|---|---|---|---|---|---|
| 616 | C₄F₉ | (CH₂CH₂O)ₐ | 0 to 20 | OC(═O)CH₂ | (CH₂)_{c} | 1 to 20 | Si(OMe)₃ | 1 | Me |
| 617 | C₈F₁₇ | (CH₂CH₂O)ₐ | 0 to 20 | OC(═O)CH₂ | (CH₂)_{c} | 1 to 20 | Si(OMe)₃ | 1 | Me |
| 618 | c-C₆F₁₁ | (CH₂CH₂O)ₐ | 0 to 20 | OC(═O)CH₂ | (CH₂)_{c} | 1 to 20 | Si(OMe)₃ | 1 | Me |
| 619 | CHF₂ | (CH₂CH₂O)ₐ | 0 to 20 | OC(═O)CH₂ | (CH₂)_{c} | 1 to 20 | Si(OMe)₃ | 1 | Me |
| 620 | CClF₂ | (CH₂CH₂O)ₐ | 0 to 20 | OC(═O)CH₂ | (CH₂)_{c} | 1 to 20 | Si(OMe)₃ | 1 | Me |
| 621 | CBrF₂ | (CH₂CH₂O)ₐ | 0 to 20 | OC(═O)CH₂ | (CH₂)_{c} | 1 to 20 | Si(OMe)₃ | 1 | Me |
| 622 | ClF₂ | (CH₂CH₂O)ₐ | 0 to 20 | OC(═O)CH₂ | (CH₂)_{c} | 1 to 20 | Si(OMe)₃ | 1 | Me |
| 623 | CF═CF₂ | (CH₂CH₂O)ₐ | 0 to 20 | OC(═O)CH₂ | (CH₂)_{c} | 1 to 20 | Si(OMe)₃ | 1 | Me |
| 624 | CF═CFCF₃ | (CH₂CH₂O)ₐ | 0 to 20 | OC(═O)CH₂ | (CH₂)_{c} | 1 to 20 | Si(OMe)₃ | 1 | Me |
| 625 | CF═CFCF═CF₂ | (CH₂CH₂O)ₐ | 0 to 20 | OC(═O)CH₂ | (CH₂)_{c} | 1 to 20 | Si(OMe)₃ | 1 | Me |
| 626 | C≡CCF₃ | (CH₂CH₂O)ₐ | 0 to 20 | OC(═O)CH₂ | (CH₂)_{c} | 1 to 20 | Si(OMe)₃ | 1 | Me |
| 627 | CF₂CH₃ | (CH₂CH₂O)ₐ | 0 to 20 | OC(═O)CH₂ | (CH₂)_{c} | 1 to 20 | Si(OMe)₃ | 1 | Me |
| 628 | (CF₂)₂H | (CH₂CH₂O)ₐ | 0 to 20 | OC(═O)CH₂ | (CH₂)_{c} | 1 to 20 | Si(OMe)₃ | 1 | Me |
| 629 | (CF₂)₂CH₃ | (CH₂CH₂O)ₐ | 0 to 20 | OC(═O)CH₂ | (CH₂)_{c} | 1 to 20 | Si(OMe)₃ | 1 | Me |
| 630 | (CF₂)₄H | (CH₂CH₂O)ₐ | 0 to 20 | OC(═O)CH₂ | (CH₂)_{c} | 1 to 20 | Si(OMe)₃ | 1 | Me |

TABLE 43

| No. | R^{f1} | R¹ | a | L¹ | R² | c | T¹ | x1 | R³⁶ |
|---|---|---|---|---|---|---|---|---|---|
| 631 | C₆F₅ | (CH₂CH₂O)ₐ | 0 to 20 | OC(═O)CH₂ | (CH₂)_{c} | 1 to 20 | Si(OMe)₃ | 1 | Me |
| 632 | 4-CF₃C₆F₄ | (CH₂CH₂O)ₐ | 0 to 20 | OC(═O)CH₂ | (CH₂)_{c} | 1 to 20 | Si(OMe)₃ | 1 | Me |
| 633 | 4-SF₅C₆F₄ | (CH₂CH₂O)ₐ | 0 to 20 | OC(═O)CH₂ | (CH₂)_{c} | 1 to 20 | Si(OMe)₃ | 1 | Me |
| 634 | 3,5-CF₃C₆F₃ | (CH₂CH₂O)ₐ | 0 to 20 | OC(═O)CH₂ | (CH₂)_{c} | 1 to 20 | Si(OMe)₃ | 1 | Me |
| 635 | 3,5-SF₅C₆F₃ | (CH₂CH₂O)ₐ | 0 to 20 | OC(═O)CH₂ | (CH₂)_{c} | 1 to 20 | Si(OMe)₃ | 1 | Me |
| 636 | 4-CF₃C₆H₄ | (CH₂CH₂O)ₐ | 0 to 20 | OC(═O)CH₂ | (CH₂)_{c} | 1 to 20 | Si(OMe)₃ | 1 | Me |
| 637 | 4-SF₅C₆H₄ | (CH₂CH₂O)ₐ | 0 to 20 | OC(═O)CH₂ | (CH₂)_{c} | 1 to 20 | Si(OMe)₃ | 1 | Me |
| 638 | 3,5-CF₃C₆H₃ | (CH₂CH₂O)ₐ | 0 to 20 | OC(═O)CH₂ | (CH₂)_{c} | 1 to 20 | Si(OMe)₃ | 1 | Me |
| 639 | 3,5-SF₅C₆H₃ | (CH₂CH₂O)ₐ | 0 to 20 | OC(═O)CH₂ | (CH₂)_{c} | 1 to 20 | Si(OMe)₃ | 1 | Me |
| 640 | 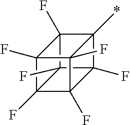 [SMILES: *C12C3(F)C4(F)C1(F)C1(F)C2(F)C3(F)C41F] | (CH₂CH₂O)ₐ | 0 to 20 | OC(═O)CH₂ | (CH₂)_{c} | 1 to 20 | Si(OMe)₃ | 1 | Me |
| 641 | 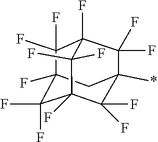 [SMILES: *C12C[C@@]3(F)C(F)(F)[C@](F)(C1(F)F)C(F)(F)[C@](F)(C2(F)F)C3(F)F] | (CH₂CH₂O)ₐ | 0 to 20 | OC(═O)CH₂ | (CH₂)_{c} | 1 to 20 | Si(OMe)₃ | 1 | Me |
| 642 | 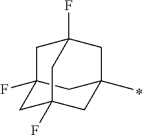 | (CH₂CH₂O)ₐ | 0 to 20 | OC(═O)CH₂ | (CH₂)_{c} | 1 to 20 | Si(OMe)₃ | 1 | Me |
| 643 | CH₂F | (CH₂CH₂O)ₐ | 0 to 20 | OC(═O)CH₂ | (CH₂)_{c} | 1 to 20 | Si(OMe)₃ | 1 | Me |
| 644 | SF₅ | (CH₂CH₂O)ₐ | 0 to 20 | OC(═O)CH₂ | (CH₂)_{c} | 1 to 20 | Si(OMe)₃ | 1 | Me |
| 645 | OCF₃ | (CH₂CH₂O)ₐ | 0 to 20 | OC(═O)CH₂ | (CH₂)_{c} | 1 to 20 | Si(OMe)₃ | 1 | Me |

TABLE 44

| No. | R^{f1} | R¹ | a | L¹ | R² | c | T¹ | x1 | R³⁶ |
|---|---|---|---|---|---|---|---|---|---|
| 646 | SCF₃ | (CH₂CH₂O)ₐ | 0 to 20 | OC(═O)CH₂ | (CH₂)_{c} | 1 to 20 | Si(OMe)₃ | 1 | Me |
| 647 | N(CH₂CF₃)₂ | (CH₂CH₂O)ₐ | 0 to 20 | OC(═O)CH₂ | (CH₂)_{c} | 1 to 20 | Si(OMe)₃ | 1 | Me |
| 648 | N(CF₃)₂ | (CH₂CH₂O)ₐ | 0 to 20 | OC(═O)CH₂ | (CH₂)_{c} | 1 to 20 | Si(OMe)₃ | 1 | Me |
| 649 | CF₃ | (CH₂CH₂O)ₐ | 0 to 20 | SiMe₂ | (CH₂)_{c} | 1 to 20 | Si(OMe)₃ | 1 | Me |
| 650 | (CF₃)₂CF | (CH₂CH₂O)ₐ | 0 to 20 | SiMe₂ | (CH₂)_{c} | 1 to 20 | Si(OMe)₃ | 1 | Me |
| 651 | (CF₃)₃C | (CH₂CH₂O)ₐ | 0 to 20 | SiMe₂ | (CH₂)_{c} | 1 to 20 | Si(OMe)₃ | 1 | Me |
| 652 | C₄F₉ | (CH₂CH₂O)ₐ | 0 to 20 | SiMe₂ | (CH₂)_{c} | 1 to 20 | Si(OMe)₃ | 1 | Me |
| 653 | C₈F₁₇ | (CH₂CH₂O)ₐ | 0 to 20 | SiMe₂ | (CH₂)_{c} | 1 to 20 | Si(OMe)₃ | 1 | Me |
| 654 | c-C₆F₁₁ | (CH₂CH₂O)ₐ | 0 to 20 | SiMe₂ | (CH₂)_{c} | 1 to 20 | Si(OMe)₃ | 1 | Me |
| 655 | CHF₂ | (CH₂CH₂O)ₐ | 0 to 20 | SiMe₂ | (CH₂)_{c} | 1 to 20 | Si(OMe)₃ | 1 | Me |
| 656 | CClF₂ | (CH₂CH₂O)ₐ | 0 to 20 | SiMe₂ | (CH₂)_{c} | 1 to 20 | Si(OMe)₃ | 1 | Me |
| 657 | CBrF₂ | (CH₂CH₂O)ₐ | 0 to 20 | SiMe₂ | (CH₂)_{c} | 1 to 20 | Si(OMe)₃ | 1 | Me |
| 658 | ClF₂ | (CH₂CH₂O)ₐ | 0 to 20 | SiMe₂ | (CH₂)_{c} | 1 to 20 | Si(OMe)₃ | 1 | Me |
| 659 | CF═CF₂ | (CH₂CH₂O)ₐ | 0 to 20 | SiMe₂ | (CH₂)_{c} | 1 to 20 | Si(OMe)₃ | 1 | Me |
| 660 | CF═CFCF₃ | (CH₂CH₂O)ₐ | 0 to 20 | SiMe₂ | (CH₂)_{c} | 1 to 20 | Si(OMe)₃ | 1 | Me |

TABLE 45

| No. | R^{f1} | R¹ | a | L¹ | R² | c | T¹ | x1 | R³⁶ |
|---|---|---|---|---|---|---|---|---|---|
| 661 | CF═CFCF═CF₂ | (CH₂CH₂O)ₐ | 0 to 20 | SiMe₂ | (CH₂)_{c} | 1 to 20 | Si(OMe)₃ | 1 | Me |
| 662 | C≡CCF₃ | (CH₂CH₂O)ₐ | 0 to 20 | SiMe₂ | (CH₂)_{c} | 1 to 20 | Si(OMe)₃ | 1 | Me |
| 663 | CF₂CH₃ | (CH₂CH₂O)ₐ | 0 to 20 | SiMe₂ | (CH₂)_{c} | 1 to 20 | Si(OMe)₃ | 1 | Me |
| 664 | (CF₂)₂H | (CH₂CH₂O)ₐ | 0 to 20 | SiMe₂ | (CH₂)_{c} | 1 to 20 | Si(OMe)₃ | 1 | Me |
| 665 | (CF₂)₂CH₃ | (CH₂CH₂O)ₐ | 0 to 20 | SiMe₂ | (CH₂)_{c} | 1 to 20 | Si(OMe)₃ | 1 | Me |
| 666 | (CF₂)₄H | (CH₂CH₂O)ₐ | 0 to 20 | SiMe₂ | (CH₂)_{c} | 1 to 20 | Si(OMe)₃ | 1 | Me |
| 667 | C₆F₅ | (CH₂CH₂O)ₐ | 0 to 20 | SiMe₂ | (CH₂)_{c} | 1 to 20 | Si(OMe)₃ | 1 | Me |
| 668 | 4-CF₃C₆F₄ | (CH₂CH₂O)ₐ | 0 to 20 | SiMe₂ | (CH₂)_{c} | 1 to 20 | Si(OMe)₃ | 1 | Me |
| 669 | 4-SF₅C₆F₄ | (CH₂CH₂O)ₐ | 0 to 20 | SiMe₂ | (CH₂)_{c} | 1 to 20 | Si(OMe)₃ | 1 | Me |
| 670 | 3,5-CF₃C₆F₃ | (CH₂CH₂O)ₐ | 0 to 20 | SiMe₂ | (CH₂)_{c} | 1 to 20 | Si(OMe)₃ | 1 | Me |
| 671 | 3,5-SF₅C₆F₃ | (CH₂CH₂O)ₐ | 0 to 20 | SiMe₂ | (CH₂)_{c} | 1 to 20 | Si(OMe)₃ | 1 | Me |
| 672 | 4-CF₃C₆H₄ | (CH₂CH₂O)ₐ | 0 to 20 | SiMe₂ | (CH₂)_{c} | 1 to 20 | Si(OMe)₃ | 1 | Me |
| 673 | 4-SF₅C₆H₄ | (CH₂CH₂O)ₐ | 0 to 20 | SiMe₂ | (CH₂)_{c} | 1 to 20 | Si(OMe)₃ | 1 | Me |
| 674 | 3,5-CF₃C₆H₃ | (CH₂CH₂O)ₐ | 0 to 20 | SiMe₂ | (CH₂)_{c} | 1 to 20 | Si(OMe)₃ | 1 | Me |
| 675 | 3,5-SF₅C₆H₃ | (CH₂CH₂O)ₐ | 0 to 20 | SiMe₂ | (CH₂)_{c} | 1 to 20 | Si(OMe)₃ | 1 | Me |

TABLE 46

| No. | R^{f1} | R¹ | a | L¹ | R² | c | T¹ | x1 | R³⁶ |
|---|---|---|---|---|---|---|---|---|---|
| 676 | 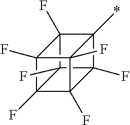 [SMILES: *C12C3(F)C4(F)C1(F)C1(F)C2(F)C3(F)C41F] | (CH₂CH₂O)ₐ | 0 to 20 | SiMe₂ | (CH₂)_{c} | 1 to 20 | Si(OMe)₃ | 1 | Me |
| 677 | 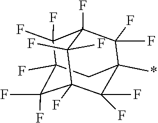 [SMILES: *C12CC3(F)C(F)(F)C(F)(C1(F)F)C(F)(F)C(F)(C2(F)F)C3(F)F] | (CH₂CH₂O)ₐ | 0 to 20 | SiMe₂ | (CH₂)_{c} | 1 to 20 | Si(OMe)₃ | 1 | Me |
| 678 | 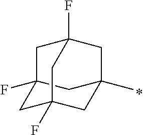 | (CH₂CH₂O)ₐ | 0 to 20 | SiMe₂ | (CH₂)_{c} | 1 to 20 | Si(OMe)₃ | 1 | Me |
| 679 | CH₂F | (CH₂CH₂O)ₐ | 0 to 20 | SiMe₂ | (CH₂)_{c} | 1 to 20 | Si(OMe)₃ | 1 | Me |
| 680 | SF₅ | (CH₂CH₂O)ₐ | 0 to 20 | SiMe₂ | (CH₂)_{c} | 1 to 20 | Si(OMe)₃ | 1 | Me |
| 681 | OCF₃ | (CH₂CH₂O)ₐ | 0 to 20 | SiMe₂ | (CH₂)_{c} | 1 to 20 | Si(OMe)₃ | 1 | Me |
| 682 | SCF₃ | (CH₂CH₂O)ₐ | 0 to 20 | SiMe₂ | (CH₂)_{c} | 1 to 20 | Si(OMe)₃ | 1 | Me |
| 683 | N(CH₂CF₃)₂ | (CH₂CH₂O)ₐ | 0 to 20 | SiMe₂ | (CH₂)_{c} | 1 to 20 | Si(OMe)₃ | 1 | Me |
| 684 | N(CF₃)₂ | (CH₂CH₂O)ₐ | 0 to 20 | SiMe₂ | (CH₂)_{c} | 1 to 20 | Si(OMe)₃ | 1 | Me |
| 685 | CF₃ | (CH₂CH₂O)ₐ | 0 to 20 | CH₂ | (CH₂)_{c} | 1 to 20 | Si(OMe)₃ | 1 | Me |
| 686 | (CF₃)₂CF | (CH₂CH₂O)ₐ | 0 to 20 | CH₂ | (CH₂)_{c} | 1 to 20 | Si(OMe)₃ | 1 | Me |
| 687 | (CF₃)₃C | (CH₂CH₂O)ₐ | 0 to 20 | CH₂ | (CH₂)_{c} | 1 to 20 | Si(OMe)₃ | 1 | Me |
| 688 | C₄F₉ | (CH₂CH₂O)ₐ | 0 to 20 | CH₂ | (CH₂)_{c} | 1 to 20 | Si(OMe)₃ | 1 | Me |
| 689 | C₈F₁₇ | (CH₂CH₂O)ₐ | 0 to 20 | CH₂ | (CH₂)_{c} | 1 to 20 | Si(OMe)₃ | 1 | Me |
| 690 | c-C₆F₁₁ | (CH₂CH₂O)ₐ | 0 to 20 | CH₂ | (CH₂)_{c} | 1 to 20 | Si(OMe)₃ | 1 | Me |

TABLE 47

| No. | R^{f1} | R¹ | a | L¹ | R² | c | T¹ | x1 | R³⁶ |
|---|---|---|---|---|---|---|---|---|---|
| 691 | CHF₂ | (CH₂CH₂O)ₐ | 0 to 20 | CH₂ | (CH₂)_{c} | 1 to 20 | Si(OMe)₃ | 1 | Me |
| 692 | CClF₂ | (CH₂CH₂O)ₐ | 0 to 20 | CH₂ | (CH₂)_{c} | 1 to 20 | Si(OMe)₃ | 1 | Me |
| 693 | CBrF₂ | (CH₂CH₂O)ₐ | 0 to 20 | CH₂ | (CH₂)_{c} | 1 to 20 | Si(OMe)₃ | 1 | Me |
| 694 | ClF₂ | (CH₂CH₂O)ₐ | 0 to 20 | CH₂ | (CH₂)_{c} | 1 to 20 | Si(OMe)₃ | 1 | Me |
| 695 | CF═CF₂ | (CH₂CH₂O)ₐ | 0 to 20 | CH₂ | (CH₂)_{c} | 1 to 20 | Si(OMe)₃ | 1 | Me |
| 696 | CF═CFCF₃ | (CH₂CH₂O)ₐ | 0 to 20 | CH₂ | (CH₂)_{c} | 1 to 20 | Si(OMe)₃ | 1 | Me |
| 697 | CF═CFCF═CF₂ | (CH₂CH₂O)ₐ | 0 to 20 | CH₂ | (CH₂)_{c} | 1 to 20 | Si(OMe)₃ | 1 | Me |
| 698 | C≡CCF₃ | (CH₂CH₂O)ₐ | 0 to 20 | CH₂ | (CH₂)_{c} | 1 to 20 | Si(OMe)₃ | 1 | Me |
| 699 | CF₂CH₃ | (CH₂CH₂O)ₐ | 0 to 20 | CH₂ | (CH₂)_{c} | 1 to 20 | Si(OMe)₃ | 1 | Me |
| 700 | (CF₂)₂H | (CH₂CH₂O)ₐ | 0 to 20 | CH₂ | (CH₂)_{c} | 1 to 20 | Si(OMe)₃ | 1 | Me |
| 701 | (CF₂)₂CH₃ | (CH₂CH₂O)ₐ | 0 to 20 | CH₂ | (CH₂)_{c} | 1 to 20 | Si(OMe)₃ | 1 | Me |
| 702 | (CF₂)₄H | (CH₂CH₂O)ₐ | 0 to 20 | CH₂ | (CH₂)_{c} | 1 to 20 | Si(OMe)₃ | 1 | Me |
| 703 | C₆F₅ | (CH₂CH₂O)ₐ | 0 to 20 | CH₂ | (CH₂)_{c} | 1 to 20 | Si(OMe)₃ | 1 | Me |
| 704 | 4-CF₃C₆F₄ | (CH₂CH₂O)ₐ | 0 to 20 | CH₂ | (CH₂)_{c} | 1 to 20 | Si(OMe)₃ | 1 | Me |
| 705 | 4-SF₅C₆F₄ | (CH₂CH₂O)ₐ | 0 to 20 | CH₂ | (CH₂)_{c} | 1 to 20 | Si(OMe)₃ | 1 | Me |

TABLE 48

| No. | R^{f1} | R¹ | a | L¹ | R² | c | T¹ | x1 | R³⁶ |
|---|---|---|---|---|---|---|---|---|---|
| 706 | 3,5-CF₃C₆F₃ | (CH₂CH₂O)ₐ | 0 to 20 | CH₂ | (CH₂)_{c} | 1 to 20 | Si(OMe)₃ | 1 | Me |
| 707 | 13,5-SF₅C₆F₃ | (CH₂CH₂O)ₐ | 0 to 20 | CH₂ | (CH₂)_{c} | 1 to 20 | Si(OMe)₃ | 1 | Me |
| 708 | 4-CF₃C₆H₄ | (CH₂CH₂O)ₐ | 0 to 20 | CH₂ | (CH₂)_{c} | 1 to 20 | Si(OMe)₃ | 1 | Me |
| 709 | 4-SF₅C₆H₄ | (CH₂CH₂O)ₐ | 0 to 20 | CH₂ | (CH₂)_{c} | 1 to 20 | Si(OMe)₃ | 1 | Me |
| 710 | 3,5-CF₃C₆H₃ | (CH₂CH₂O)ₐ | 0 to 20 | CH₂ | (CH₂)_{c} | 1 to 20 | Si(OMe)₃ | 1 | Me |
| 711 | 3,5-SF₅C₆H₃ | (CH₂CH₂O)ₐ | 0 to 20 | CH₂ | (CH₂)_{c} | 1 to 20 | Si(OMe)₃ | 1 | Me |
| 712 | 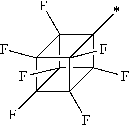 [SMILES: *C12C3(F)C4(F)C1(F)C1(F)C2(F)C3(F)C41F] | (CH₂CH₂O)ₐ | 0 to 20 | CH₂ | (CH₂)_{c} | 1 to 20 | Si(OMe)₃ | 1 | Me |
| 713 | 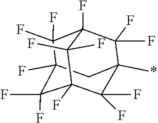 [SMILES: *C12CC3(F)C(F)(F)C(F)(C1(F)F)C(F)(F)C(F)(C2(F)F)C3(F)F] | (CH₂CH₂O)ₐ | 0 to 20 | CH₂ | (CH₂)_{c} | 1 to 20 | Si(OMe)₃ | 1 | Me |
| 714 | 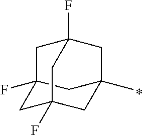 | (CH₂CH₂O)ₐ | 0 to 20 | CH₂ | (CH₂)_{c} | 1 to 20 | Si(OMe)₃ | 1 | Me |
| 715 | CH₂F | (CH₂CH₂O)ₐ | 0 to 20 | CH₂ | (CH₂)_{c} | 1 to 20 | Si(OMe)₃ | 1 | Me |
| 716 | SF₅ | (CH₂CH₂O)ₐ | 0 to 20 | CH₂ | (CH₂)_{c} | 1 to 20 | Si(OMe)₃ | 1 | Me |
| 717 | OCF₃ | (CH₂CH₂O)ₐ | 0 to 20 | CH₂ | (CH₂)_{c} | 1 to 20 | Si(OMe)₃ | 1 | Me |
| 718 | SCF₃ | (CH₂CH₂O)ₐ | 0 to 20 | CH₂ | (CH₂)_{c} | 1 to 20 | Si(OMe)₃ | 1 | Me |
| 719 | N(CH₂CF₃)₂ | (CH₂CH₂O)ₐ | 0 to 20 | CH₂ | (CH₂)_{c} | 1 to 20 | Si(OMe)₃ | 1 | Me |
| 720 | N(CF₃)₂ | (CH₂CH₂O)ₐ | 0 to 20 | CH₂ | (CH₂)_{c} | 1 to 20 | Si(OMe)₃ | 1 | Me |

TABLE 49

| No. | R^{f1} | R¹ | a | L¹ | R² | c | T¹ | x1 | R³⁶ |
|---|---|---|---|---|---|---|---|---|---|
| 721 | CF₃ | (CH₂CH₂O)ₐ | 0 to 20 | C(═O)NHCH₂CH | (CH₂)_{c} | 1 to 20 | Si(OMe)₃ | 2 | Me |
| 722 | (CF₃)₂CF | (CH₂CH₂O)ₐ | 0 to 20 | C(═O)NHCH₂CH | (CH₂)_{c} | 1 to 20 | Si(OMe)₃ | 2 | Me |
| 723 | (CF₃)₃C | (CH₂CH₂O)ₐ | 0 to 20 | C(═O)NHCH₂CH | (CH₂)_{c} | 1 to 20 | Si(OMe)₃ | 2 | Me |
| 724 | C₄F₉ | (CH₂CH₂O)ₐ | 0 to 20 | C(═O)NHCH₂CH | (CH₂)_{c} | 1 to 20 | Si(OMe)₃ | 2 | Me |
| 725 | C₈F₁₇ | (CH₂CH₂O)ₐ | 0 to 20 | C(═O)NHCH₂CH | (CH₂)_{c} | 1 to 20 | Si(OMe)₃ | 2 | Me |
| 726 | c-C₆F₁₁ | (CH₂CH₂O)ₐ | 0 to 20 | C(═O)NHCH₂CH | (CH₂)_{c} | 1 to 20 | Si(OMe)₃ | 2 | Me |
| 727 | CHF₂ | (CH₂CH₂O)ₐ | 0 to 20 | C(═O)NHCH₂CH | (CH₂)_{c} | 1 to 20 | Si(OMe)₃ | 2 | Me |
| 728 | CClF₂ | (CH₂CH₂O)ₐ | 0 to 20 | C(═O)NHCH₂CH | (CH₂)_{c} | 1 to 20 | Si(OMe)₃ | 2 | Me |
| 729 | CBrF₂ | (CH₂CH₂O)ₐ | 0 to 20 | C(═O)NHCH₂CH | (CH₂)_{c} | 1 to 20 | Si(OMe)₃ | 2 | Me |
| 730 | ClF₂ | (CH₂CH₂O)ₐ | 0 to 20 | C(═O)NHCH₂CH | (CH₂)_{c} | 1 to 20 | Si(OMe)₃ | 2 | Me |
| 731 | CF═CF₂ | (CH₂CH₂O)ₐ | 0 to 20 | C(═O)NHCH₂CH | (CH₂)_{c} | 1 to 20 | Si(OMe)₃ | 2 | Me |
| 732 | CF═CFCF₃ | (CH₂CH₂O)ₐ | 0 to 20 | C(═O)NHCH₂CH | (CH₂)_{c} | 1 to 20 | Si(OMe)₃ | 2 | Me |
| 733 | CF═CFCF═CF₂ | (CH₂CH₂O)ₐ | 0 to 20 | C(═O)NHCH₂CH | (CH₂)_{c} | 1 to 20 | Si(OMe)₃ | 2 | Me |
| 734 | C≡CCF₃ | (CH₂CH₂O)ₐ | 0 to 20 | C(═O)NHCH₂CH | (CH₂)_{c} | 1 to 20 | Si(OMe)₃ | 2 | Me |
| 735 | CF₂CH₃ | (CH₂CH₂O)ₐ | 0 to 20 | C(═O)NHCH₂CH | (CH₂)_{c} | 1 to 20 | Si(OMe)₃ | 2 | Me |

TABLE 50

| No. | R^{f1} | R¹ | a | L¹ | R² | c | T¹ | x1 | R³⁶ |
|---|---|---|---|---|---|---|---|---|---|
| 736 | (CF₂)₂H | (CH₂CH₂O)ₐ | 0 to 20 | C(═O)NHCH₂CH | (CH₂)_{c} | 1 to 20 | Si(OMe)₃ | 2 | Me |
| 737 | (CF₂)₂CH₃ | (CH₂CH₂O)ₐ | 0 to 20 | C(═O)NHCH₂CH | (CH₂)_{c} | 1 to 20 | Si(OMe)₃ | 2 | Me |
| 738 | (CF₂)₄H | (CH₂CH₂O)ₐ | 0 to 20 | C(═O)NHCH₂CH | (CH₂)_{c} | 1 to 20 | Si(OMe)₃ | 2 | Me |
| 739 | C₆F₅ | (CH₂CH₂O)ₐ | 0 to 20 | C(═O)NHCH₂CH | (CH₂)_{c} | 1 to 20 | Si(OMe)₃ | 2 | Me |
| 740 | 4-CF₃C₆F₄ | (CH₂CH₂O)ₐ | 0 to 20 | C(═O)NHCH₂CH | (CH₂)_{c} | 1 to 20 | Si(OMe)₃ | 2 | Me |
| 741 | 4-SF₅C₆F₄ | (CH₂CH₂O)ₐ | 0 to 20 | C(═O)NHCH₂CH | (CH₂)_{c} | 1 to 20 | Si(OMe)₃ | 2 | Me |
| 742 | 3,5-CF₃C₆F₃ | (CH₂CH₂O)ₐ | [0 to 20 | C(═O)NHCH₂CH | (CH₂)_{c} | 1 to 20 | Si(OMe)₃ | 2 | Me |
| 743 | 3,5-SF₅C₆F₃ | (CH₂CH₂O)ₐ | 0 to 20 | C(═O)NHCH₂CH | (CH₂)_{c} | 1 to 20 | Si(OMe)₃ | 2 | Me |
| 744 | 4-CF₃C₆H₄ | (CH₂CH₂O)ₐ | 0 to 20 | C(═O)NHCH₂CH | (CH₂)_{c} | 1 to 20 | Si(OMe)₃ | 2 | Me |
| 745 | 4-SF₅C₆H₄ | (CH₂CH₂O)ₐ | 0 to 20 | C(═O)NHCH₂CH | (CH₂)_{c} | 1 to 20 | Si(OMe)₃ | 2 | Me |
| 746 | 3,5-CF₃C₆H₃ | (CH₂CH₂O)ₐ | 0 to 20 | C(═O)NHCH₂CH | (CH₂)_{c} | 1 to 20 | Si(OMe)₃ | 2 | Me |
| 747 | 3,5-SF₅C₆H₃ | (CH₂CH₂O)ₐ | 0 to 20 | C(═O)NHCH₂CH | (CH₂)_{c} | 1 to 20 | Si(OMe)₃ | 2 | Me |
| 748 | 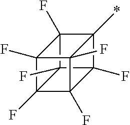 [SMILES: *C12C3(F)C4(F)C1(F)C1(F)C2(F)C3(F)C41F] | (CH₂CH₂O)ₐ | 0 to 20 | C(═O)NHCH₂CH | (CH₂)_{c} | 1 to 20 | Si(OMe)₃ | 2 | Me |
| 749 | 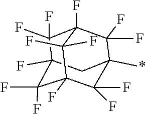 [SMILES: *C12CC3(F)C(F)(F)C(F)(C1(F)F)C(F)(F)C(F)(C2(F)F)C3(F)F] | (CH₂CH₂O)ₐ | 0 to 20 | C(═O)NHCH₂CH | (CH₂)_{c} | 1 to 20 | Si(OMe)₃ | 2 | Me |
| 750 | 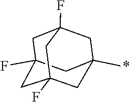 [SMILES: *C12CC3(F)CC(F)(C1)CC(F)(C2)C3] | (CH₂CH₂O)ₐ | 0 to 20 | C(═O)NHCH₂CH | (CH₂)_{c} | 1 to 20 | Si(OMe)₃ | 2 | Me |

TABLE 51

| No. | R^{f1} | R¹ | a | L¹ | R² | c | T¹ | x1 | R³⁶ |
|---|---|---|---|---|---|---|---|---|---|
| 751 | CH₂F | (CH₂CH₂O)ₐ | 0 to 20 | C(═O)NHCH₂CH | (CH₂)_{c} | 1 to 20 | Si(OMe)₃ | 2 | Me |
| 752 | SF₅ | (CH₂CH₂O)ₐ | 0 to 20 | C(═O)NHCH₂CH | (CH₂)_{c} | 1 to 20 | Si(OMe)₃ | 2 | Me |
| 753 | OCF₃ | (CH₂CH₂O)ₐ | 0 to 20 | C(═O)NHCH₂CH | (CH₂)_{c} | 1 to 20 | Si(OMe)₃ | 2 | Me |
| 754 | SCF₃ | (CH₂CH₂O)ₐ | 0 to 20 | C(═O)NHCH₂CH | (CH₂)_{c} | 1 to 20 | Si(OMe)₃ | 2 | Me |
| 755 | N(CH₂CF₃)₂ | (CH₂CH₂O)ₐ | 0 to 20 | C(═O)NHCH₂CH | (CH₂)_{c} | 1 to 20 | Si(OMe)₃ | 2 | Me |
| 756 | N(CF₃)₂ | (CH₂CH₂O)ₐ | 0 to 20 | C(═O)NHCH₂CH | (CH₂)_{c} | 1 to 20 | Si(OMe)₃ | 2 | Me |
| 757 | CF₃ | (CH₂CH₂O)ₐ | 0 to 20 | NHC(═O)CH₂CH | (CH₂)_{c} | 1 to 20 | Si(OMe)₃ | 2 | Me |
| 758 | (CF₃)₂CF | (CH₂CH₂O)ₐ | 0 to 20 | NHC(═O)CH₂CH | (CH₂)_{c} | 1 to 20 | Si(OMe)₃ | 2 | Me |
| 759 | (CF₃)₃C | (CH₂CH₂O)ₐ | 0 to 20 | NHC(═O)CH₂CH | (CH₂)_{c} | 1 to 20 | Si(OMe)₃ | 2 | Me |
| 760 | C₄F₉ | (CH₂CH₂O)ₐ | 0 to 20 | NHC(═O)CH₂CH | (CH₂)_{c} | 1 to 20 | Si(OMe)₃ | 2 | Me |
| 761 | C₈F₁₇ | (CH₂CH₂O)ₐ | 0 to 20 | NHC(═O)CH₂CH | (CH₂)_{c} | 1 to 20 | Si(OMe)₃ | 2 | Me |
| 762 | c-C₆F₁₁ | (CH₂CH₂O)ₐ | 0 to 20 | NHC(═O)CH₂CH | (CH₂)_{c} | 1 to 20 | Si(OMe)₃ | 2 | Me |
| 763 | CHF₂ | (CH₂CH₂O)ₐ | 0 to 20 | NHC(═O)CH₂CH | (CH₂)_{c} | 1 to 20 | Si(OMe)₃ | 2 | Me |
| 764 | CClF₂ | (CH₂CH₂O)ₐ | 0 to 20 | NHC(═O)CH₂CH | (CH₂)_{c} | 1 to 20 | Si(OMe)₃ | 2 | Me |
| 765 | CBrF₂ | (CH₂CH₂O)ₐ | 0 to 20 | NHC(═O)CH₂CH | (CH₂)_{c} | 1 to 20 | Si(OMe)₃ | 2 | Me |

TABLE 52

| No. | R^{f1} | R¹ | a | L¹ | R² | c | T¹ | x1 | R³⁶ |
|---|---|---|---|---|---|---|---|---|---|
| 766 | ClF₂ | (CH₂CH₂O)ₐ | 0 to 20 | NHC(═O)CH₂CH | (CH₂)_{c} | 1 to 20 | Si(OMe)₃ | 2 | Me |
| 767 | CF═CF₂ | (CH₂CH₂O)ₐ | 0 to 20 | NHC(═O)CH₂CH | (CH₂)_{c} | 1 to 20 | Si(OMe)₃ | 2 | Me |
| 768 | CF═CFCF₃ | (CH₂CH₂O)ₐ | 0 to 20 | NHC(═O)CH₂CH | (CH₂)_{c} | 1 to 20 | Si(OMe)₃ | 2 | Me |
| 769 | CF═CFCF═CF₂ | (CH₂CH₂O)ₐ | 0 to 20 | NHC(═O)CH₂CH | (CH₂)_{c} | 1 to 20 | Si(OMe)₃ | 2 | Me |
| 770 | C≡CCF₃ | (CH₂CH₂O)ₐ | 0 to 20 | NHC(═O)CH₂CH | (CH₂)_{c} | 1 to 20 | Si(OMe)₃ | 2 | Me |
| 771 | CF₂CH₃ | (CH₂CH₂O)ₐ | 0 to 20 | NHC(═O)CH₂CH | (CH₂)_{c} | 1 to 20 | Si(OMe)₃ | 2 | Me |
| 772 | (CF₂)₂H | (CH₂CH₂O)ₐ | 0 to 20 | NHC(═O)CH₂CH | (CH₂)_{c} | 1 to 20 | Si(OMe)₃ | 2 | Me |
| 773 | (CF₂)₂CH₃ | (CH₂CH₂O)ₐ | 0 to 20 | NHC(═O)CH₂CH | (CH₂)_{c} | 1 to 20 | Si(OMe)₃ | 2 | Me |
| 774 | (CF₂)₄H | (CH₂CH₂O)ₐ | 0 to 20 | NHC(═O)CH₂CH | (CH₂)_{c} | 1 to 20 | Si(OMe)₃ | 2 | Me |
| 775 | C₆F₅ | (CH₂CH₂O)ₐ | 0 to 20 | NHC(═O)CH₂CH | (CH₂)_{c} | 1 to 20 | Si(OMe)₃ | 2 | Me |
| 776 | 4-CF₃C₆F₄ | (CH₂CH₂O)ₐ | 0 to 20 | NHC(═O)CH₂CH | (CH₂)_{c} | 1 to 20 | Si(OMe)₃ | 2 | Me |
| 777 | 4-SF₅C₆F₄ | (CH₂CH₂O)ₐ | 0 to 20 | NHC(═O)CH₂CH | (CH₂)_{c} | 1 to 20 | Si(OMe)₃ | 2 | Me |
| 778 | 3,5-CF₃C₆F₃ | (CH₂CH₂O)ₐ | 0 to 20 | NHC(═O)CH₂CH | (CH₂)_{c} | 1 to 20 | Si(OMe)₃ | 2 | Me |
| 779 | 3,5-SF₅C₆F₃ | (CH₂CH₂O)ₐ | 0 to 20 | NHC(═O)CH₂CH | (CH₂)_{c} | 1 to 20 | Si(OMe)₃ | 2 | Me |
| 780 | 4-CF₃C₆H₄ | (CH₂CH₂O)ₐ | 0 to 20 | NHC(═O)CH₂CH | (CH₂)_{c} | 1 to 20 | Si(OMe)₃ | 2 | Me |

TABLE 53

| No. | R^{f1} | R¹ | a | L¹ | R² | c | T¹ | x1 | R³⁶ |
|---|---|---|---|---|---|---|---|---|---|
| 781 | 4-SF₅C₆H₄ | (CH₂CH₂O)ₐ | 0 to 20 | NHC(═O)CH₂CH | (CH₂)_{c} | 1 to 20 | Si(OMe)₃ | 2 | Me |
| 782 | 3,5-CF₃C₆H₃ | (CH₂CH₂O)ₐ | 0 to 20 | NHC(═O)CH₂CH | (CH₂)_{c} | 1 to 20 | Si(OMe)₃ | 2 | Me |
| 783 | 3,5-SF₅C₆H₃ | (CH₂CH₂O)ₐ | 0 to 20 | NHC(═O)CH₂CH | (CH₂)_{c} | 1 to 20 | Si(OMe)₃ | 2 | Me |
| 784 | 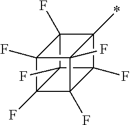 [SMILES: *C12C3(F)C4(F)C1(F)C1(F)C2(F)C3(F)C41F] | (CH₂CH₂O)ₐ | 0 to 20 | NHC(═O)CH₂CH | (CH₂)_{c} | 1 to 20 | Si(OMe)₃ | 2 | Me |
| 785 | 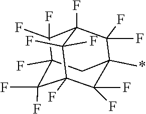 [SMILES: *C12CC3(F)C(F)(F)C(F)(C1(F)F)C(F)(F)C(F)(C2(F)F)C3(F)F] | (CH₂CH₂O)ₐ | 0 to 20 | NHC(═O)CH₂CH | (CH₂)_{c} | 1 to 20 | Si(OMe)₃ | 2 | Me |
| 786 | 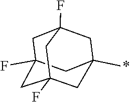 [SMILES: *C12CC3(F)CC(F)(C1)CC(F)(C2)C3] | (CH₂CH₂O)ₐ | 0 to 20 | NHC(═O)CH₂CH | (CH₂)_{c} | 1 to 20 | Si(OMe)₃ | 2 | Me |
| 787 | CH₂F | (CH₂CH₂O)ₐ | 0 to 20 | NHC(═O)CH₂CH | (CH₂)_{c} | 1 to 20 | Si(OMe)₃ | 2 | Me |
| 788 | SF₅ | (CH₂CH₂O)ₐ | 0 to 20 | NHC(═O)CH₂CH | (CH₂)_{c} | 1 to 20 | Si(OMe)₃ | 2 | Me |
| 789 | OCF₃ | (CH₂CH₂O)ₐ | 0 to 20 | NHC(═O)CH₂CH | (CH₂)_{c} | 1 to 20 | Si(OMe)₃ | 2 | Me |
| 790 | SCF₃ | (CH₂CH₂O)ₐ | 0 to 20 | NHC(═O)CH₂CH | (CH₂)_{c} | 1 to 20 | Si(OMe)₃ | 2 | Me |
| 791 | N(CH₂CF₃)₂ | (CH₂CH₂O)ₐ | 0 to 20 | NHC(═O)CH₂CH | (CH₂)_{c} | 1 to 20 | Si(OMe)₃ | 2 | Me |
| 792 | N(CF₃)₂ | (CH₂CH₂O)ₐ | 0 to 20 | NHC(═O)CH₂CH | (CH₂)_{c} | 1 to 20 | Si(OMe)₃ | 2 | Me |
| 793 | CF₃ | (CH₂CH₂O)ₐ | 0 to 20 | OC(═O)CH | (CH₂)_{c} | 1 to 20 | Si(OMe)₃ | 2 | Me |
| 794 | (CF₃)₂CF | (CH₂CH₂O)ₐ | 0 to 20 | OC(═O)CH | (CH₂)_{c} | 1 to 20 | Si(OMe)₃ | 2 | Me |
| 795 | (CF₃)₃C | (CH₂CH₂O)ₐ | 0 to 20 | OC(═O)CH | (CH₂)_{c} | 1 to 20 | Si(OMe)₃ | 2 | Me |

TABLE 54

| No. | R^{f1} | R¹ | a | L¹ | R² | c | T¹ | x1 | R³⁶ |
|---|---|---|---|---|---|---|---|---|---|
| 796 | C₄F₉ | (CH₂CH₂O)ₐ | 0 to 20 | OC(═O)CH | (CH₂)_{c} | 1 to 20 | Si(OMe)₃ | 2 | Me |
| 797 | C₈F₁₇ | (CH₂CH₂O)ₐ | 0 to 20 | OC(═O)CH | (CH₂)_{c} | 1 to 20 | Si(OMe)₃ | 2 | Me |
| 798 | c-C₆F₁₁ | (CH₂CH₂O)ₐ | 0 to 20 | OC(═O)CH | (CH₂)_{c} | 1 to 20 | Si(OMe)₃ | 2 | Me |
| 799 | CHF₂ | (CH₂CH₂O)ₐ | 0 to 20 | OC(═O)CH | (CH₂)_{c} | 1 to 20 | Si(OMe)₃ | 2 | Me |
| 800 | CClF₂ | (CH₂CH₂O)ₐ | 0 to 20 | OC(═O)CH | (CH₂)_{c} | 1 to 20 | Si(OMe)₃ | 2 | Me |
| 801 | CBrF₂ | (CH₂CH₂O)ₐ | 0 to 20 | OC(═O)CH | (CH₂)_{c} | 1 to 20 | Si(OMe)₃ | 2 | Me |
| 802 | ClF₂ | (CH₂CH₂O)ₐ | 0 to 20 | OC(═O)CH | (CH₂)_{c} | 1 to 20 | Si(OMe)₃ | 2 | Me |
| 803 | CF═CF₂ | (CH₂CH₂O)ₐ | 0 to 20 | OC(═O)CH | (CH₂)_{c} | 1 to 20 | Si(OMe)₃ | 2 | Me |
| 804 | CF═CFCF₃ | (CH₂CH₂O)ₐ | 0 to 20 | OC(═O)CH | (CH₂)_{c} | 1 to 20 | Si(OMe)₃ | 2 | Me |
| 805 | CF═CFCF═CF₂ | (CH₂CH₂O)ₐ | 0 to 20 | OC(═O)CH | (CH₂)_{c} | 1 to 20 | Si(OMe)₃ | 2 | Me |
| 806 | C≡CCF₃ | (CH₂CH₂O)ₐ | 0 to 20 | OC(═O)CH | (CH₂)_{c} | 1 to 20 | Si(OMe)₃ | 2 | Me |
| 807 | CF₂CH₃ | (CH₂CH₂O)ₐ | 0 to 20 | OC(═O)CH | (CH₂)_{c} | 1 to 20 | Si(OMe)₃ | 2 | Me |
| 808 | (CF₂)₂H | (CH₂CH₂O)ₐ | 0 to 20 | OC(═O)CH | (CH₂)_{c} | 1 to 20 | Si(OMe)₃ | 2 | Me |
| 809 | (CF₂)₂CH₃ | (CH₂CH₂O)ₐ | 0 to 20 | OC(═O)CH | (CH₂)_{c} | 1 to 20 | Si(OMe)₃ | 2 | Me |
| 810 | (CF₂)₄H | (CH₂CH₂O)ₐ | 0 to 20 | OC(═O)CH | (CH₂)_{c} | 1 to 20 | Si(OMe)₃ | 2 | Me |

TABLE 55

| No. | R^{f1} | R¹ | a | L¹ | R² | c | T¹ | x1 | R³⁶ |
|---|---|---|---|---|---|---|---|---|---|
| 811 | C₆F₅ | (CH₂CH₂O)ₐ | 0 to 20 | OC(═O)CH | (CH₂)_{c} | 1 to 20 | Si(OMe)₃ | 2 | Me |
| 812 | 4-CF₃C₆F₄ | (CH₂CH₂O)ₐ | 0 to 20 | OC(═O)CH | (CH₂)_{c} | 1 to 20 | Si(OMe)₃ | 2 | Me |
| 813 | 4-SF₅C₆F₄ | (CH₂CH₂O)ₐ | 0 to 20 | OC(═O)CH | (CH₂)_{c} | 1 to 20 | Si(OMe)₃ | 2 | Me |
| 814 | 3,5-CF₃C₆F₃ | (CH₂CH₂O)ₐ | 0 to 20 | OC(═O)CH | (CH₂)_{c} | 1 to 20 | Si(OMe)₃ | 2 | Me |
| 815 | 3,5-SF₅C₆F₃ | (CH₂CH₂O)ₐ | 0 to 20 | OC(═O)CH | (CH₂)_{c} | 1 to 20 | Si(OMe)₃ | 2 | Me |
| 816 | 4-CF₃C₆H₄ | (CH₂CH₂O)ₐ | 0 to 20 | OC(═O)CH | (CH₂)_{c} | 1 to 20 | Si(OMe)₃ | 2 | Me |
| 817 | 4-SF₅C₆H₄ | (CH₂CH₂O)ₐ | 0 to 20 | OC(═O)CH | (CH₂)_{c} | 1 to 20 | Si(OMe)₃ | 2 | Me |
| 818 | 3,5-CF₃C₆H₃ | (CH₂CH₂O)ₐ | 0 to 20 | OC(═O)CH | (CH₂)_{c} | 1 to 20 | Si(OMe)₃ | 2 | Me |
| 819 | 3,5-SF₅C₆H₃ | (CH₂CH₂O)ₐ | 0 to 20 | OC(═O)CH | (CH₂)_{c} | 1 to 20 | Si(OMe)₃ | 2 | Me |
| 820 | 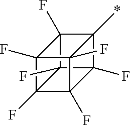 [SMILES: *C12C3(F)C4(F)C1(F)C1(F)C2(F)C3(F)C41F] | (CH₂CH₂O)ₐ | 0 to 20 | OC(═O)CH | (CH₂)_{c} | 1 to 20 | Si(OMe)₃ | 2 | Me |
| 821 | 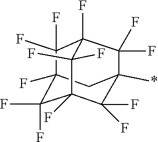 [SMILES: *C12C[C@@]3(F)C(F)(F)[C@](F)(C1(F)F)C(F)(F)[C@](F)(C2(F)F)C3(F)F] | (CH₂CH₂O)ₐ | 0 to 20 | OC(═O)CH | (CH₂)_{c} | 1 to 20 | Si(OMe)₃ | 2 | Me |
| 822 | 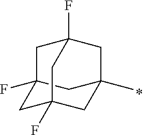 | (CH₂CH₂O)ₐ | 0 to 20 | OC(═O)CH | (CH₂)_{c} | 1 to 20 | Si(OMe)₃ | 2 | Me |
| 823 | CH₂F | (CH₂CH₂O)ₐ | 0 to 20 | OC(═O)CH | (CH₂)_{c} | 1 to 20 | Si(OMe)₃ | 2 | Me |
| 824 | SF₅ | (CH₂CH₂O)ₐ | 0 to 20 | OC(═O)CH | (CH₂)_{c} | 1 to 20 | Si(OMe)₃ | 2 | Me |
| 825 | OCF₃ | (CH₂CH₂O)ₐ | 0 to 20 | OC(═O)CH | (CH₂)_{c} | 1 to 20 | Si(OMe)₃ | 2 | Me |

TABLE 56

| No. | R^{f1} | R¹ | a | L¹ | R² | c | T¹ | x1 | R³⁶ |
|---|---|---|---|---|---|---|---|---|---|
| 826 | SCF₃ | (CH₂CH₂O)ₐ | 0 to 20 | OC(═O)CH | (CH₂)_{c} | 1 to 20 | Si(OMe)₃ | 2 | Me |
| 827 | N(CH₂CF₃)₂ | (CH₂CH₂O)ₐ | 0 to 20 | OC(═O)CH | (CH₂)_{c} | 1 to 20 | Si(OMe)₃ | 2 | Me |
| 828 | N(CF₃)₂ | (CH₂CH₂O)ₐ | 0 to 20 | OC(═O)CH | (CH₂)_{c} | 1 to 20 | Si(OMe)₃ | 2 | Me |
| 829 | CF₃ | (CH₂CH₂O)ₐ | 0 to 20 | SiMe | (CH₂)_{c} | 1 to 20 | Si(OMe)₃ | 2 | Me |
| 830 | (CF₃)₂CF | (CH₂CH₂O)ₐ | 0 to 20 | SiMe | (CH₂)_{c} | 1 to 20 | Si(OMe)₃ | 2 | Me |
| 831 | (CF₃)₃C | (CH₂CH₂O)ₐ | 0 to 20 | SiMe | (CH₂)_{c} | 1 to 20 | Si(OMe)₃ | 2 | Me |
| 832 | C₄F₉ | (CH₂CH₂O)ₐ | 0 to 20 | SiMe | (CH₂)_{c} | 1 to 20 | Si(OMe)₃ | 2 | Me |
| 833 | C₈F₁₇ | (CH₂CH₂O)ₐ | 0 to 20 | SiMe | (CH₂)_{c} | 1 to 20 | Si(OMe)₃ | 2 | Me |
| 834 | c-C₆F₁₁ | (CH₂CH₂O)ₐ | 0 to 20 | SiMe | (CH₂)_{c} | 1 to 20 | Si(OMe)₃ | 2 | Me |
| 835 | CHF₂ | (CH₂CH₂O)ₐ | 0 to 20 | SiMe | (CH₂)_{c} | 1 to 20 | Si(OMe)₃ | 2 | Me |
| 836 | CClF₂ | (CH₂CH₂O)ₐ | 0 to 20 | SiMe | (CH₂)_{c} | 1 to 20 | Si(OMe)₃ | 2 | Me |
| 837 | CBrF₂ | (CH₂CH₂O)ₐ | 0 to 20 | SiMe | (CH₂)_{c} | 1 to 20 | Si(OMe)₃ | 2 | Me |
| 838 | ClF₂ | (CH₂CH₂O)ₐ | 0 to 20 | SiMe | (CH₂)_{c} | 1 to 20 | Si(OMe)₃ | 2 | Me |
| 839 | CF═CF₂ | (CH₂CH₂O)ₐ | 0 to 20 | SiMe | (CH₂)_{c} | 1 to 20 | Si(OMe)₃ | 2 | Me |
| 840 | CF═CFCF₃ | (CH₂CH₂O)ₐ | 0 to 20 | SiMe | (CH₂)_{c} | 1 to 20 | Si(OMe)₃ | 2 | Me |

TABLE 57

| No. | R^{f1} | R¹ | a | L¹ | R² | c | T¹ | x1 | R³⁶ |
|---|---|---|---|---|---|---|---|---|---|
| 841 | CF═CFCF═CF₂ | (CH₂CH₂O)ₐ | 0 to 20 | SiMe | (CH₂)_{c} | 1 to 20 | Si(OMe)₃ | 2 | Me |
| 842 | C≡CCF₃ | (CH₂CH₂O)ₐ | 0 to 20 | SiMe | (CH₂)_{c} | 1 to 20 | Si(OMe)₃ | 2 | Me |
| 843 | CF₂CH₃ | (CH₂CH₂O)ₐ | 0 to 20 | SiMe | (CH₂)_{c} | 1 to 20 | Si(OMe)₃ | 2 | Me |
| 844 | (CF₂)₂H | (CH₂CH₂O)ₐ | 0 to 20 | SiMe | (CH₂)_{c} | 1 to 20 | Si(OMe)₃ | 2 | Me |
| 845 | (CF₂)₂CH₃ | (CH₂CH₂O)ₐ | 0 to 20 | SiMe | (CH₂)_{c} | 1 to 20 | Si(OMe)₃ | 2 | Me |
| 846 | (CF₂)₄H | (CH₂CH₂O)ₐ | 0 to 20 | SiMe | (CH₂)_{c} | 1 to 20 | Si(OMe)₃ | 2 | Me |
| 847 | C₆F₅ | (CH₂CH₂O)ₐ | 0 to 20 | SiMe | (CH₂)_{c} | 1 to 20 | Si(OMe)₃ | 2 | Me |
| 848 | 4-CF₃C₆F₄ | (CH₂CH₂O)ₐ | 0 to 20 | SiMe | (CH₂)_{c} | 1 to 20 | Si(OMe)₃ | 2 | Me |
| 849 | 4-SF₅C₆F₄ | (CH₂CH₂O)ₐ | 0 to 20 | SiMe | (CH₂)_{c} | 1 to 20 | Si(OMe)₃ | 2 | Me |
| 850 | 3,5-CF₃C₆F₃ | (CH₂CH₂O)ₐ | 0 to 20 | SiMe | (CH₂)_{c} | 1 to 20 | Si(OMe)₃ | 2 | Me |
| 851 | 3,5-SF₅C₆F₃ | (CH₂CH₂O)ₐ | 0 to 20 | SiMe | (CH₂)_{c} | 1 to 20 | Si(OMe)₃ | 2 | Me |
| 852 | 4-CF₃C₆H₄ | (CH₂CH₂O)ₐ | 0 to 20 | SiMe | (CH₂)_{c} | 1 to 20 | Si(OMe)₃ | 2 | Me |
| 853 | 4-SF₅C₆H₄ | (CH₂CH₂O)ₐ | 0 to 20 | SiMe | (CH₂)_{c} | 1 to 20 | Si(OMe)₃ | 2 | Me |
| 854 | 3,5-CF₃C₆H₃ | (CH₂CH₂O)ₐ | 0 to 20 | SiMe | (CH₂)_{c} | 1 to 20 | Si(OMe)₃ | 2 | Me |
| 855 | 3,5-SF₅C₆H₃ | (CH₂CH₂O)ₐ | 0 to 20 | SiMe | (CH₂)_{c} | 1 to 20 | Si(OMe)₃ | 2 | Me |

TABLE 58

| No. | R^{f1} | R¹ | a | L¹ | R² | c | T¹ | x1 | R³⁶ |
|---|---|---|---|---|---|---|---|---|---|
| 856 | 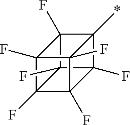 [SMILES: *C12C3(F)C4(F)C1(F)C1(F)C2(F)C3(F)C41F] | (CH₂CH₂O)ₐ | 0 to 20 | SiMe | (CH₂)_{c} | 1 to 20 | Si(OMe)₃ | 2 | Me |
| 857 | 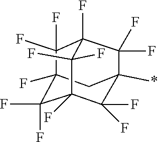 [SMILES: *C12C[C@@]3(F)C(F)(F)[C@](F)(C1(F)F)C(F)(F)[C@](F)(C2(F)F)C3(F)F] | (CH₂CH₂O)ₐ | 0 to 20 | SiMe | (CH₂)_{c} | 1 to 20 | Si(OMe)₃ | 2 | Me |
| 858 | 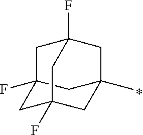 | (CH₂CH₂O)ₐ | 0 to 20 | SiMe | (CH₂)_{c} | 1 to 20 | Si(OMe)₃ | 2 | Me |
| 859 | CH₂F | (CH₂CH₂O)ₐ | 0 to 20 | SiMe | (CH₂)_{c} | 1 to 20 | Si(OMe)₃ | 2 | Me |
| 860 | SF₅ | (CH₂CH₂O)ₐ | 0 to 20 | SiMe | (CH₂)_{c} | 1 to 20 | Si(OMe)₃ | 2 | Me |
| 861 | OCF₃ | (CH₂CH₂O)ₐ | 0 to 20 | SiMe | (CH₂)_{c} | 1 to 20 | Si(OMe)₃ | 2 | Me |
| 862 | SCF₃ | (CH₂CH₂O)ₐ | 0 to 20 | SiMe | (CH₂)_{c} | 1 to 20 | Si(OMe)₃ | 2 | Me |
| 863 | N(CH₂CF₃)₂ | (CH₂CH₂O)ₐ | 0 to 20 | SiMe | (CH₂)_{c} | 1 to 20 | Si(OMe)₃ | 2 | Me |
| 864 | N(CF₃)₂ | (CH₂CH₂O)ₐ | 0 to 20 | SiMe | (CH₂)_{c} | 1 to 20 | Si(OMe)₃ | 2 | Me |
| 865 | CF₃ | (CH₂CH₂O)ₐ | 0 to 20 | CH | (CH₂)_{c} | 1 to 20 | Si(OMe)₃ | 2 | Me |
| 866 | (CF₃)₂CF | (CH₂CH₂O)ₐ | 0 to 20 | CH | (CH₂)_{c} | 1 to 20 | Si(OMe)₃ | 2 | Me |
| 867 | (CF₃)₃C | (CH₂CH₂O)ₐ | 0 to 20 | CH | (CH₂)_{c} | 1 to 20 | Si(OMe)₃ | 2 | Me |
| 868 | C₄F₉ | (CH₂CH₂O)ₐ | 0 to 20 | CH | (CH₂)_{c} | 1 to 20 | Si(OMe)₃ | 2 | Me |
| 869 | C₈F₁₇ | (CH₂CH₂O)ₐ | 0 to 20 | CH | (CH₂)_{c} | 1 to 20 | Si(OMe)₃ | 2 | Me |
| 870 | 6-C₆F₁₁ | (CH₂CH₂O)ₐ | 0 to 20 | CH | (CH₂)_{c} | 1 to 20 | Si(OMe)₃ | 2 | Me |

TABLE 59

| No. | R^{f1} | R¹ | a | L¹ | R² | c | T¹ | x1 | R³⁶ |
|---|---|---|---|---|---|---|---|---|---|
| 871 | CHF₂ | (CH₂CH₂O)ₐ | 0 to 20 | CH | (CH₂)_{c} | 1 to 20 | Si(OMe)₃ | 2 | Me |
| 872 | CClF₂ | (CH₂CH₂O)ₐ | 0 to 20 | CH | (CH₂)_{c} | 1 to 20 | Si(OMe)₃ | 2 | Me |
| 873 | CBrF₂ | (CH₂CH₂O)ₐ | 0 to 20 | CH | (CH₂)_{c} | 1 to 20 | Si(OMe)₃ | 2 | Me |
| 874 | ClF₂ | (CH₂CH₂O)ₐ | 0 to 20 | CH | (CH₂)_{c} | 1 to 20 | Si(OMe)₃ | 2 | Me |
| 875 | CF═CF₂ | (CH₂CH₂O)ₐ | 0 to 20 | CH | (CH₂)_{c} | 1 to 20 | Si(OMe)₃ | 2 | Me |
| 876 | CF═CFCF₃ | (CH₂CH₂O)ₐ | 0 to 20 | CH | (CH₂)_{c} | 1 to 20 | Si(OMe)₃ | 2 | Me |
| 877 | CF═CFCF═CF₂ | (CH₂CH₂O)ₐ | 0 to 20 | CH | (CH₂)_{c} | 1 to 20 | Si(OMe)₃ | 2 | Me |
| 878 | C≡CCF₃ | (CH₂CH₂O)ₐ | 0 to 20 | CH | (CH₂)_{c} | 1 to 20 | Si(OMe)₃ | 2 | Me |
| 879 | CF₂CH₃ | (CH₂CH₂O)ₐ | 0 to 20 | CH | (CH₂)_{c} | 1 to 20 | Si(OMe)₃ | 2 | Me |
| 880 | (CF₂)₂H | (CH₂CH₂O)ₐ | 0 to 20 | CH | (CH₂)_{c} | 1 to 20 | Si(OMe)₃ | 2 | Me |
| 881 | (CF₂)₂CH₃ | (CH₂CH₂O)ₐ | 0 to 20 | CH | (CH₂)_{c} | 1 to 20 | Si(OMe)₃ | 2 | Me |
| 882 | (CF₂)₄H | (CH₂CH₂O)ₐ | 0 to 20 | CH | (CH₂)_{c} | 1 to 20 | Si(OMe)₃ | 2 | Me |
| 883 | C₆F₅ | (CH₂CH₂O)ₐ | 0 to 20 | CH | (CH₂)_{c} | 1 to 20 | Si(OMe)₃ | 2 | Me |
| 884 | 4-CF₃C₆F₄ | (CH₂CH₂O)ₐ | 0 to 20 | CH | (CH₂)_{c} | 1 to 20 | Si(OMe)₃ | 2 | Me |
| 885 | 4-SF₅C₆F₄ | (CH₂CH₂O)ₐ | 0 to 20 | CH | (CH₂)_{c} | 1 to 20 | Si(OMe)₃ | 2 | Me |

TABLE 60

| No. | R^{f1} | R¹ | a | L¹ | R² | c | T¹ | x1 | R³⁶ |
|---|---|---|---|---|---|---|---|---|---|
| 886 | 3,5-CF₃C₆F₃ | (CH₂CH₂O)ₐ | [0 to 20 | CH | (CH₂)_{c} | 1 to 20 | Si(OMe)₃ | 2 | Me |
| 887 | 3,5-SF₅C₆F₃ | (CH₂CH₂O)ₐ | 0 to 20 | CH | (CH₂)_{c} | 1 to 20 | Si(OMe)₃ | 2 | Me |
| 888 | 4-CF₃C₆H₄ | (CH₂CH₂O)ₐ | 0 to 20 | CH | (CH₂)_{c} | 1 to 20 | Si(OMe)₃ | 2 | Me |
| 889 | 4-SF₅C₆H₄ | (CH₂CH₂O)ₐ | 0 to 20 | CH | (CH₂)_{c} | 1 to 20 | Si(OMe)₃ | 2 | Me |
| 890 | 3,5-CF₃C₆H₃ | (CH₂CH₂O)ₐ | 0 to 20 | CH | (CH₂)_{c} | 1 to 20 | Si(OMe)₃ | 2 | Me |
| 891 | 3,5-SF₅C₆H₃ | (CH₂CH₂O)ₐ | 0 to 20 | CH | (CH₂)_{c} | 1 to 20 | Si(OMe)₃ | 2 | Me |
| 892 | 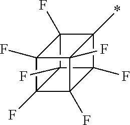 [SMILES: *C12C3(F)C4(F)C1(F)C1(F)C2(F)C3(F)C41F] | (CH₂CH₂O)ₐ | 0 to 20 | CH | (CH₂)_{c} | 1 to 20 | Si(OMe)₃ | 2 | Me |
| 893 | 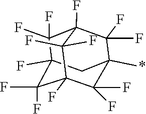 [SMILES: *C12CC3(F)C(F)(F)C(F)(C1(F)F)C(F)(F)C(F)(C2(F)F)C3(F)F] | (CH₂CH₂O)ₐ | 0 to 20 | CH | (CH₂)_{c} | 1 to 20 | Si(OMe)₃ | 2 | Me |
| 894 | 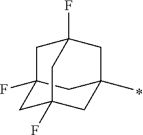 | (CH₂CH₂O)ₐ | 0 to 20 | CH | (CH₂)_{c} | 1 to 20 | Si(OMe)₃ | 2 | Me |
| 895 | CH₂F | (CH₂CH₂O)ₐ | 0 to 20 | CH | (CH₂)_{c} | 1 to 20 | Si(OMe)₃ | 2 | Me |
| 896 | SF₅ | (CH₂CH₂O)ₐ | 0 to 20 | CH | (CH₂)_{c} | 1 to 20 | Si(OMe)₃ | 2 | Me |
| 897 | OCF₃ | (CH₂CH₂O)ₐ | 0 to 20 | CH | (CH₂)_{c} | 1 to 20 | Si(OMe)₃ | 2 | Me |
| 898 | SCF₃ | (CH₂CH₂O)ₐ | 0 to 20 | CH | (CH₂)_{c} | 1 to 20 | Si(OMe)₃ | 2 | Me |
| 899 | N(CH₂CF₃)₂ | (CH₂CH₂O)ₐ | 0 to 20 | CH | (CH₂)_{c} | 1 to 20 | Si(OMe)₃ | 2 | Me |
| 900 | N(CF₃)₂ | (CH₂CH₂O)ₐ | 0 to 20 | CH | (CH₂)_{c} | 1 to 20 | Si(OMe)₃ | 2 | Me |

TABLE 61

| No. | R^{f1} | R¹ | a | L¹ | R² | c | T¹ | x1 | R³⁶ |
|---|---|---|---|---|---|---|---|---|---|
| 901 | CF₃ | (CH₂CH₂O)ₐ | 0 to 20 | C(═O)NHCH₂C | (CH₂)_{c} | 1 to 20 | Si(OMe)₃ | 3 | Me |
| 902 | (CF₃)₂CF | (CH₂CH₂O)ₐ | 0 to 20 | C(═O)NHCH₂C | (CH₂)_{c} | 1 to 20 | Si(OMe)₃ | 3 | Me |
| 903 | (CF₃)₃C | (CH₂CH₂O)ₐ | 0 to 20 | C(═O)NHCH₂C | (CH₂)_{c} | 1 to 20 | Si(OMe)₃ | 3 | Me |
| 904 | C₄F₉ | (CH₂CH₂O)ₐ | 0 to 20 | C(═O)NHCH₂C | (CH₂)_{c} | 1 to 20 | Si(OMe)₃ | 3 | Me |
| 905 | C₈F₁₇ | (CH₂CH₂O)ₐ | 0 to 20 | C(═O)NHCH₂C | (CH₂)_{c} | 1 to 20 | Si(OMe)₃ | 3 | Me |
| 906 | c-C₆F₁₁ | (CH₂CH₂O)ₐ | 0 to 20 | C(═O)NHCH₂C | (CH₂)_{c} | 1 to 20 | Si(OMe)₃ | 3 | Me |
| 907 | CHF₂ | (CH₂CH₂O)ₐ | 0 to 20 | C(═O)NHCH₂C | (CH₂)_{c} | 1 to 20 | Si(OMe)₃ | 3 | Me |
| 908 | CClF₂ | (CH₂CH₂O)ₐ | 0 to 20 | C(═O)NHCH₂C | (CH₂)_{c} | 1 to 20 | Si(OMe)₃ | 3 | Me |
| 909 | CBrF₂ | (CH₂CH₂O)ₐ | 0 to 20 | C(═O)NHCH₂C | (CH₂)_{c} | 1 to 20 | Si(OMe)₃ | 3 | Me |
| 910 | ClF₂ | (CH₂CH₂O)ₐ | 0 to 20 | C(═O)NHCH₂C | (CH₂)_{c} | 1 to 20 | Si(OMe)₃ | 3 | Me |
| 911 | CF═CF₂ | (CH₂CH₂O)ₐ | 0 to 20 | C(═O)NHCH₂C | (CH₂)_{c} | 1 to 20 | Si(OMe)₃ | 3 | Me |
| 912 | CF═CFCF₃ | (CH₂CH₂O)ₐ | 0 to 20 | C(═O)NHCH₂C | (CH₂)_{c} | 1 to 20 | Si(OMe)₃ | 3 | Me |
| 913 | CF═CFCF═CF₂ | (CH₂CH₂O)ₐ | 0 to 20 | C(═O)NHCH₂C | (CH₂)_{c} | 1 to 20 | Si(OMe)₃ | 3 | Me |
| 914 | C≡CCF₃ | (CH₂CH₂O)ₐ | 0 to 20 | C(═O)NHCH₂C | (CH₂)_{c} | 1 to 20 | Si(OMe)₃ | 3 | Me |
| 915 | CF₂CH₃ | (CH₂CH₂O)ₐ | 0 to 20 | C(═O)NHCH₂C | (CH₂)_{c} | 1 to 20 | Si(OMe)₃ | 3 | Me |

TABLE 62

| No. | R^{f1} | R¹ | a | L¹ | R² | c | T¹ | x1 | R³⁶ |
|---|---|---|---|---|---|---|---|---|---|
| 916 | (CF₂)₂H | (CH₂CH₂O)ₐ | [0 to 20 | C(═O)NHCH₂C | (CH₂)_{c} | 1 to 20 | Si(OMe)₃ | 3 | Me |
| 917 | (CF₂)₂CH₃ | (CH₂CH₂O)ₐ | [0 to 20 | C(═O)NHCH₂C | (CH₂)_{c} | 1 to 20 | Si(OMe)₃ | 3 | Me |
| 918 | (CF₂)₄H | (CH₂CH₂O)ₐ | [0 to 20 | C(═O)NHCH₂C | (CH₂)_{c} | 1 to 20 | Si(OMe)₃ | 3 | Me |
| 919 | C₆F₅ | (CH₂CH₂O)ₐ | [0 to 20 | C(═O)NHCH₂C | (CH₂)_{c} | 1 to 20 | Si(OMe)₃ | 3 | Me |
| 920 | 4-CF₃C₆F₄ | (CH₂CH₂O)ₐ | [0 to 20 | C(═O)NHCH₂C | (CH₂)_{c} | 1 to 20 | Si(OMe)₃ | 3 | Me |
| 921 | 4-SF₅C₆F₄ | (CH₂CH₂O)ₐ | [0 to 20 | C(═O)NHCH₂C | (CH₂)_{c} | 1 to 20 | Si(OMe)₃ | 3 | Me |
| 922 | 3,5-CF₃C₆F₃ | (CH₂CH₂O)ₐ | [0 to 20 | C(═O)NHCH₂C | (CH₂)_{c} | 1 to 20 | Si(OMe)₃ | 3 | Me |
| 923 | 3,5-SF₅C₆F₃ | (CH₂CH₂O)ₐ | [0 to 20 | C(═O)NHCH₂C | (CH₂)_{c} | 1 to 20 | Si(OMe)₃ | 3 | Me |
| 924 | 4-CF₃C₆H₄ | (CH₂CH₂O)ₐ | [0 to 20 | C(═O)NHCH₂C | (CH₂)_{c} | 1 to 20 | Si(OMe)₃ | 3 | Me |
| 925 | 4-SF₅C₆H₄ | (CH₂CH₂O)ₐ | [0 to 20 | C(═O)NHCH₂C | (CH₂)_{c} | 1 to 20 | Si(OMe)₃ | 3 | Me |
| 926 | 3,5-CF₃C₆H₃ | (CH₂CH₂O)ₐ | [0 to 20 | C(═O)NHCH₂C | (CH₂)_{c} | 1 to 20 | Si(OMe)₃ | 3 | Me |
| 927 | 3,5-SF₅C₆H₃ | (CH₂CH₂O)ₐ | [0 to 20 | C(═O)NHCH₂C | (CH₂)_{c} | 1 to 20 | Si(OMe)₃ | 3 | Me |
| 928 | 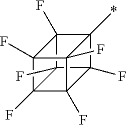 [SMILES: *C12C3(F)C4(F)C1(F)C1(F)C2(F)C3(F)C41F] | (CH₂CH₂O)ₐ | [0 to 20 | C(═O)NHCH₂C | (CH₂)_{c} | 1 to 20 | Si(OMe)₃ | 3 | Me |
| 929 | 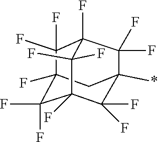 [SMILES: *C12C[C@@]3(F)C(F)(F)[C@](F)(C1(F)F)C(F)(F)[C@](F)(C2(F)F)C3(F)F] | (CH₂CH₂O)ₐ | [0 to 20 | C(═O)NHCH₂C | (CH₂)_{c} | 1 to 20 | Si(OMe)₃ | 3 | Me |
| 930 | 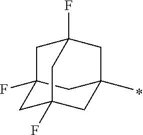 | (CH₂CH₂O)ₐ | [0 to 20 | C(═O)NHCH₂C | (CH₂)_{c} | 1 to 20 | Si(OMe)₃ | 3 | Me |

TABLE 63

| No. | R^{f1} | R¹ | a | L¹ | R² | c | T¹ | x1 | R³⁶ |
|---|---|---|---|---|---|---|---|---|---|
| 931 | CH₂F | (CH₂CH₂O)ₐ | 0 to 20 | C(═O)NHCH₂C | (CH₂)_{c} | 1 to 20 | Si(OMe)₃ | 2 | Me |
| 932 | SF₅ | (CH₂CH₂O)ₐ | 0 to 20 | C(═O)NHCH₂C | (CH₂)_{c} | 1 to 20 | Si(OMe)₃ | 3 | Me |
| 933 | OCF₃ | (CH₂CH₂O)ₐ | 0 to 20 | C(═O)NHCH₂C | (CH₂)_{c} | 1 to 20 | Si(OMe)₃ | 3 | Me |
| 934 | SCF₃ | (CH₂CH₂O)ₐ | 0 to 20 | C(═O)NHCH₂C | (CH₂)_{c} | 1 to 20 | Si(OMe)₃ | 3 | Me |
| 935 | N(CH₂CF₃)₂ | (CH₂CH₂O)ₐ | 0 to 20 | C(═O)NHCH₂C | (CH₂)_{c} | 1 to 20 | Si(OMe)₃ | 3 | Me |
| 936 | N(CF₃)₂ | (CH₂CH₂O)ₐ | 0 to 20 | C(═O)NHCH₂C | (CH₂)_{c} | 1 to 20 | Si(OMe)₃ | 3 | Me |
| 937 | CF₃ | (CH₂CH₂O)ₐ | 0 to 20 | NHC(═O)CH₂C | (CH₂)_{c} | 1 to 20 | Si(OMe)₃ | 3 | Me |
| 938 | (CF₃)₂CF | (CH₂CH₂O)ₐ | 0 to 20 | NHC(═O)CH₂C | (CH₂)_{c} | 1 to 20 | Si(OMe)₃ | 3 | Me |
| 939 | (CF₃)₃C | (CH₂CH₂O)ₐ | 0 to 20 | NHC(═O)CH₂C | (CH₂)_{c} | 1 to 20 | Si(OMe)₃ | 3 | Me |
| 940 | C₄F₉ | (CH₂CH₂O)ₐ | 0 to 20 | NHC(═O)CH₂C | (CH₂)_{c} | 1 to 20 | Si(OMe)₃ | 3 | Me |
| 941 | C₈F₁₇ | (CH₂CH₂O)ₐ | 0 to 20 | NHC(═O)CH₂C | (CH₂)_{c} | 1 to 20 | Si(OMe)₃ | 3 | Me |
| 942 | c-C₆F₁₁ | (CH₂CH₂O)ₐ | 0 to 20 | NHC(═O)CH₂C | (CH₂)_{c} | 1 to 20 | Si(OMe)₃ | 3 | Me |
| 943 | CHF₂ | (CH₂CH₂O)ₐ | 0 to 20 | NHC(═O)CH₂C | (CH₂)_{c} | 1 to 20 | Si(OMe)₃ | 3 | Me |
| 944 | CClF₂ | (CH₂CH₂O)ₐ | 0 to 20 | NHC(═O)CH₂C | (CH₂)_{c} | 1 to 20 | Si(OMe)₃ | 3 | Me |
| 945 | CBrF₂ | (CH₂CH₂O)ₐ | 0 to 20 | NHC(═O)CH₂C | (CH₂)_{c} | 1 to 20 | Si(OMe)₃ | 3 | Me |

TABLE 64

| No. | R^{f1} | R¹ | a | L¹ | R² | c | T¹ | x1 | R³⁶ |
|---|---|---|---|---|---|---|---|---|---|
| 946 | ClF₂ | (CH₂CH₂O)ₐ | 0 to 20 | NHC(═O)CH₂C | (CH₂)_{c} | 1 to 20 | Si(OMe)₃ | 3 | Me |
| 947 | CF═CF₂ | (CH₂CH₂O)ₐ | 0 to 20 | NHC(═O)CH₂C | (CH₂)_{c} | 1 to 20 | Si(OMe)₃ | 3 | Me |
| 948 | CF═CFCF₃ | (CH₂CH₂O)ₐ | 0 to 20 | NHC(═O)CH₂C | (CH₂)_{c} | 1 to 20 | Si(OMe)₃ | 3 | Me |
| 949 | CF═CFCF═CF₂ | (CH₂CH₂O)ₐ | 0 to 20 | NHC(═O)CH₂C | (CH₂)_{c} | 1 to 20 | Si(OMe)₃ | 3 | Me |
| 950 | C≡CCF₃ | (CH₂CH₂O)ₐ | 0 to 20 | NHC(═O)CH₂C | (CH₂)_{c} | 1 to 20 | Si(OMe)₃ | 3 | Me |
| 951 | CF₂CH₃ | (CH₂CH₂O)ₐ | 0 to 20 | NHC(═O)CH₂C | (CH₂)_{c} | 1 to 20 | Si(OMe)₃ | 3 | Me |
| 952 | (CF₂)₂H | (CH₂CH₂O)ₐ | 0 to 20 | NHC(═O)CH₂C | (CH₂)_{c} | 1 to 20 | Si(OMe)₃ | 3 | Me |
| 953 | (CF₂)₂CH₃ | (CH₂CH₂O)ₐ | 0 to 20 | NHC(═O)CH₂C | (CH₂)_{c} | 1 to 20 | Si(OMe)₃ | 3 | Me |
| 954 | (CF₂)₄H | (CH₂CH₂O)ₐ | 0 to 20 | NHC(═O)CH₂C | (CH₂)_{c} | 1 to 20 | Si(OMe)₃ | 3 | Me |
| 955 | C₆F₅ | (CH₂CH₂O)ₐ | 0 to 20 | NHC(═O)CH₂C | (CH₂)_{c} | 1 to 20 | Si(OMe)₃ | 3 | Me |
| 956 | 4-CF₃CF₄ | (CH₂CH₂O)ₐ | 0 to 20 | NHC(═O)CH₂C | (CH₂)_{c} | 1 to 20 | Si(OMe)₃ | 3 | Me |
| 957 | 4-SF₅C₆F₄ | (CH₂CH₂O)ₐ | 0 to 20 | NHC(═O)CH₂C | (CH₂)_{c} | 1 to 20 | Si(OMe)₃ | 3 | Me |
| 958 | 3,5-CF₃C₆F₃ | (CH₂CH₂O)ₐ | 0 to 20 | NHC(═O)CH₂C | (CH₂)_{c} | 1 to 20 | Si(OMe)₃ | 3 | Me |
| 959 | 3,5-SF₅C₆F₃ | (CH₂CH₂O)ₐ | 0 to 20 | NHC(═O)CH₂C | (CH₂)_{c} | 1 to 20 | Si(OMe)₃ | 3 | Me |
| 960 | 4-CF₃C₆H₄ | (CH₂CH₂O)ₐ | 0 to 20 | NHC(═O)CH₂C | (CH₂)_{c} | 1 to 20 | Si(OMe)₃ | 3 | Me |

TABLE 65

| No. | R^{f1} | R¹ | a | L¹ | R² | c | T¹ | x1 | R³⁶ |
|---|---|---|---|---|---|---|---|---|---|
| 961 | 4-SF₅C₆H₄ | (CH₂CH₂O)ₐ | [0 to 20 | NHC(═O)CH₂C | (CH₂)_{c} | 1 to 20 | Si(OMe)₃ | 3 | Me |
| 962 | 3,5-CF₃C₆H₃ | (CH₂CH₂O)ₐ | [0 to 20 | NHC(═O)CH₂C | (CH₂)_{c} | 1 to 20 | Si(OMe)₃ | 3 | Me |
| 963 | 3,5-SF₅C₆H₃ | (CH₂CH₂O)ₐ | [0 to 20 | NHC(═O)CH₂C | (CH₂)_{c} | 1 to 20 | Si(OMe)₃ | 3 | Me |
| 964 | 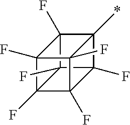 [SMILES: *C12C3(F)C4(F)C1(F)C1(F)C2(F)C3(F)C41F] | (CH₂CH₂O)ₐ | [0 to 20 | NHC(═O)CH₂C | (CH₂)_{c} | 1 to 20 | Si(OMe)₃ | 3 | Me |
| 965 | 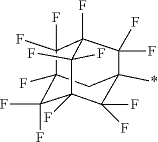 [SMILES: *C12C[C@@]3(F)C(F)(F)[C@](F)(C1(F)F)C(F)(F)[C@](F)(C2(F)F)C3(F)F] | (CH₂CH₂O)ₐ | [0 to 20 | NHC(═O)CH₂C | (CH₂)_{c} | 1 to 20 | Si(OMe)₃ | 3 | Me |
| 966 | 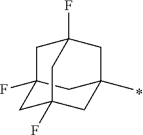 | (CH₂CH₂O)ₐ | [0 to 20 | NHC(═O)CH₂C | (CH₂)_{c} | 1 to 20 | Si(OMe)₃ | 3 | Me |
| 967 | CH₂F | (CH₂CH₂O)ₐ | [0 to 20 | NHC(═O)CH₂C | (CH₂)_{c} | 1 to 20 | Si(OMe)₃ | 3 | Me |
| 968 | SF₅ | (CH₂CH₂O)ₐ | [0 to 20 | NHC(═O)CH₂C | (CH₂)_{c} | 1 to 20 | Si(OMe)₃ | 3 | Me |
| 969 | OCF₃ | (CH₂CH₂O)ₐ | [0 to 20 | NHC(═O)CH₂C | (CH₂)_{c} | 1 to 20 | Si(OMe)₃ | 3 | Me |
| 970 | SCF₃ | (CH₂CH₂O)ₐ | [0 to 20 | NHC(═O)CH₂C | (CH₂)_{c} | 1 to 20 | Si(OMe)₃ | 3 | Me |
| 971 | N(CH₂CF3)₂ | (CH₂CH₂O)ₐ | [0 to 20 | NHC(═O)CH₂C | (CH₂)_{c} | 1 to 20 | Si(OMe)₃ | 3 | Me |
| 972 | N(CF₃)₂ | (CH₂CH₂O)ₐ | [0 to 20 | NHC(═O)CH₂C | (CH₂)_{c} | 1 to 20 | Si(OMe)₃ | 3 | Me |
| 973 | CF₃ | (CH₂CH₂O)ₐ | [0 to 20 | OC(═O)C | (CH₂)_{c} | 1 to 20 | Si(OMe)₃ | 3 | Me |
| 974 | (CF₃)₂CF | (CH₂CH₂O)ₐ | [0 to 20 | OC(═O)C | (CH₂)_{c} | 1 to 20 | Si(OMe)₃ | 3 | Me |
| 975 | (CF₃)₃C | (CH₂CH₂O)ₐ | [0 to 20 | OC(═O)C | (CH₂)_{c} | 1 to 20 | Si(OMe)₃ | 3 | Me |

TABLE 66

| No. | R^{f1} | R¹ | a | L¹ | R² | c | T¹ | x1 | R³⁶ |
|---|---|---|---|---|---|---|---|---|---|
| 976 | C₄F₉ | (CH₂CH₂O)ₐ | 0 to 20 | OC(═O)C | (CH₂)_{c} | 1 to 20 | Si(OMe)₃ | 3 | Me |
| 977 | C₈F₁₇ | (CH₂CH₂O)ₐ | 0 to 20 | OC(═O)C | (CH₂)_{c} | 1 to 20 | Si(OMe)₃ | 3 | Me |
| 978 | c-C₆F₁₁ | (CH₂CH₂O)ₐ | 0 to 20 | OC(═O)C | (CH₂)_{c} | 1 to 20 | Si(OMe)₃ | 3 | Me |
| 979 | CHF₂ | (CH₂CH₂O)ₐ | 0 to 20 | OC(═O)C | (CH₂)_{c} | 1 to 20 | Si(OMe)₃ | 3 | Me |
| 980 | CClF₂ | (CH₂CH₂O)ₐ | 0 to 20 | OC(═O)C | (CH₂)_{c} | 1 to 20 | Si(OMe)₃ | 3 | Me |
| 981 | CBrF₂ | (CH₂CH₂O)ₐ | 0 to 20 | OC(═O)C | (CH₂)_{c} | 1 to 20 | Si(OMe)₃ | 3 | Me |
| 982 | ClF₂ | (CH₂CH₂O)ₐ | 0 to 20 | OC(═O)C | (CH₂)_{c} | 1 to 20 | Si(OMe)₃ | 3 | Me |
| 983 | CF═CF₂ | (CH₂CH₂O)ₐ | 0 to 20 | OC(═O)C | (CH₂)_{c} | 1 to 20 | Si(OMe)₃ | 3 | Me |
| 984 | CF═CFCF₃ | (CH₂CH₂O)ₐ | 0 to 20 | OC(═O)C | (CH₂)_{c} | 1 to 20 | Si(OMe)₃ | 3 | Me |
| 985 | CF═CFCF═CF₂ | (CH₂CH₂O)ₐ | 0 to 20 | OC(═O)C | (CH₂)_{c} | 1 to 20 | Si(OMe)₃ | 3 | Me |
| 986 | C≡CCF₃ | (CH₂CH₂O)ₐ | 0 to 20 | OC(═O)C | (CH₂)_{c} | 1 to 20 | Si(OMe)₃ | 3 | Me |
| 987 | CF₂CH₃ | (CH₂CH₂O)ₐ | 0 to 20 | OC(═O)C | (CH₂)_{c} | 1 to 20 | Si(OMe)₃ | 3 | Me |
| 988 | (CF₂)₂H | (CH₂CH₂O)ₐ | 0 to 20 | OC(═O)C | (CH₂)_{c} | 1 to 20 | Si(OMe)₃ | 3 | Me |
| 989 | (CF₂)₂CH₃ | (CH₂CH₂O)ₐ | 0 to 20 | OC(═O)C | (CH₂)_{c} | 1 to 20 | Si(OMe)₃ | 3 | Me |
| 990 | (CF₂)₄H | (CH₂CH₂O)ₐ | 0 to 20 | OC(═O)C | (CH₂)_{c} | 1 to 20 | Si(OMe)₃ | 3 | Me |

TABLE 67

| No. | R^{f1} | R¹ | a | L¹ | R² | c | T¹ | x1 | R³⁶ |
|---|---|---|---|---|---|---|---|---|---|
| 991 | C₆F₅ | (CH₂CH₂O)ₐ | 0 to 20 | OC(═O)C | (CH₂)_{c} | 1 to 20 | Si(OMe)₃ | 3 | Me |
| 992 | 4-CF₃C₆F₄ | (CH₂CH₂O)ₐ | 0 to 20 | OC(═O)C | (CH₂)_{c} | 1 to 20 | Si(OMe)₃ | 3 | Me |
| 993 | 4-SF₅C₆F₄ | (CH₂CH₂O)ₐ | 0 to 20 | OC(═O)C | (CH₂)_{c} | 1 to 20 | Si(OMe)₃ | 3 | Me |
| 994 | 3,5-CF₃C₆F₃ | (CH₂CH₂O)ₐ | 0 to 20 | OC(═O)C | (CH₂)_{c} | 1 to 20 | Si(OMe)₃ | 3 | Me |
| 995 | 3,5-SF₅C₆F₃ | (CH₂CH₂O)ₐ | 0 to 20 | OC(═O)C | (CH₂)_{c} | 1 to 20 | Si(OMe)₃ | 3 | Me |
| 996 | 4-CF₃C₆H₄ | (CH₂CH₂O)ₐ | 0 to 20 | OC(═O)C | (CH₂)_{c} | 1 to 20 | Si(OMe)₃ | 3 | Me |
| 997 | 4-SF₅C₆H₄ | (CH₂CH₂O)ₐ | 0 to 20 | OC(═O)C | (CH₂)_{c} | 1 to 20 | Si(OMe)₃ | 3 | Me |
| 998 | 3,5-CF₃C₆H₃ | (CH₂CH₂O)ₐ | 0 to 20 | OC(═O)C | (CH₂)_{c} | 1 to 20 | Si(OMe)₃ | 3 | Me |
| 999 | 3,5-SF₅C₆H₃ | (CH₂CH₂O)ₐ | 0 to 20 | OC(═O)C | (CH₂)_{c} | 1 to 20 | Si(OMe)₃ | 3 | Me |
| 1000 | 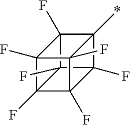 [SMILES: *C12C3(F)C4(F)C1(F)C1(F)C2(F)C3(F)C41F] | (CH₂CH₂O)ₐ | 0 to 20 | OC(═O)C | (CH₂)_{c} | 1 to 20 | Si(OMe)₃ | 3 | Me |
| 1001 | 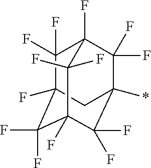 [SMILES: *C12CC3(F)C(F)(F)C(F)(C1(F)F)C(F)(F)C(F)(C2(F)F)C3(F)F] | (CH₂CH₂O)ₐ | 0 to 20 | OC(═O)C | (CH₂)_{c} | 1 to 20 | Si(OMe)₃ | 3 | Me |
| 1002 | 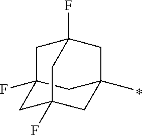 | (CH₂CH₂O)ₐ | 0 to 20 | OC(═O)C | (CH₂)_{c} | 1 to 20 | Si(OMe)₃ | 3 | Me |
| 1003 | CH₂F | (CH₂CH₂O)ₐ | 0 to 20 | OC(═O)C | (CH₂)_{c} | 1 to 20 | Si(OMe)₃ | 3 | Me |
| 1004 | SF₅ | (CH₂CH₂O)ₐ | 0 to 20 | OC(═O)C | (CH₂)_{c} | 1 to 20 | Si(OMe)₃ | 3 | Me |
| 1005 | OCF₃ | (CH₂CH₂O)ₐ | 0 to 20 | OC(═O)C | (CH₂)_{c} | 1 to 20 | Si(OMe)₃ | 3 | Me |

TABLE 68

| No. | R^{f1} | R¹ | a | L¹ | R² | c | T¹ | x1 | R³⁶ |
|---|---|---|---|---|---|---|---|---|---|
| 1006 | SCF₃ | (CH₂CH₂O)ₐ | 0 to 20 | OC(═O)C | (CH₂)_{c} | 1 to 20 | Si(OMe)₃ | 3 | Me |
| 1007 | N(CH₂CF₃)₂ | (CH₂CH₂O)ₐ | 0 to 20 | OC(═O)C | (CH₂)_{c} | 1 to 20 | Si(OMe)₃ | 3 | Me |
| 1008 | N(CF₃)₂ | (CH₂CH₂O)ₐ | 0 to 20 | OC(═O)C | (CH₂)_{c} | 1 to 20 | Si(OMe)₃ | 3 | Me |
| 1009 | CF₃ | (CH₂CH₂O)ₐ | 0 to 20 | Si | (CH₂)_{c} | 1 to 20 | Si(OMe)₃ | 3 | Me |
| 1010 | (CF₃)₂CF | (CH₂CH₂O)ₐ | 0 to 20 | Si | (CH₂)_{c} | 1 to 20 | Si(OMe)₃ | 3 | Me |
| 1011 | (CF₃)₃C | (CH₂CH₂O)ₐ | 0 to 20 | Si | (CH₂)_{c} | 1 to 20 | Si(OMe)₃ | 3 | Me |
| 1012 | C₄F₉ | (CH₂CH₂O)ₐ | 0 to 20 | Si | (CH₂)_{c} | 1 to 20 | Si(OMe)₃ | 3 | Me |
| 1013 | C₈F₁₇ | (CH₂CH₂O)ₐ | 0 to 20 | Si | (CH₂)_{c} | 1 to 20 | Si(OMe)₃ | 3 | Me |
| 1014 | c-C₆F₁₁ | (CH₂CH₂O)ₐ | 0 to 20 | Si | (CH₂)_{c} | 1 to 20 | Si(OMe)₃ | 3 | Me |
| 1015 | CHF₂ | (CH₂CH₂O)ₐ | 0 to 20 | Si | (CH₂)_{c} | 1 to 20 | Si(OMe)₃ | 3 | Me |
| 1016 | CClF₂ | (CH₂CH₂O)ₐ | 0 to 20 | Si | (CH₂)_{c} | 1 to 20 | Si(OMe)₃ | 3 | Me |
| 1017 | CBrF₂ | (CH₂CH₂O)ₐ | 0 to 20 | Si | (CH₂)_{c} | 1 to 20 | Si(OMe)₃ | 3 | Me |
| 1018 | ClF₂ | (CH₂CH₂O)ₐ | 0 to 20 | Si | (CH₂)_{c} | 1 to 20 | Si(OMe)₃ | 3 | Me |
| 1019 | CF═CF₂ | (CH₂CH₂O)ₐ | 0 to 20 | Si | (CH₂)_{c} | 1 to 20 | Si(OMe)₃ | 3 | Me |
| 1020 | CF═CFCF₃ | (CH₂CH₂O)ₐ | 0 to 20 | Si | (CH₂)_{c} | 1 to 20 | Si(OMe)₃ | 3 | Me |

TABLE 69

| No. | R^{f1} | R¹ | a | L¹ | R² | c | T¹ | x1 | R³⁶ |
|---|---|---|---|---|---|---|---|---|---|
| 1021 | CF═CFCF═CF₂ | (CH₂CH₂O)ₐ | 0 to 20 | Si | (CH₂)_{c} | 1 to 20 | Si(OMe)₃ | 3 | Me |
| 1022 | C≡CCF₃ | (CH₂CH₂O)ₐ | 0 to 20 | Si | (CH₂)_{c} | 1 to 20 | Si(OMe)₃ | 3 | Me |
| 1023 | CF₂CH₃ | (CH₂CH₂O)ₐ | 0 to 20 | Si | (CH₂)_{c} | 1 to 20 | Si(OMe)₃ | 3 | Me |
| 1024 | (CF₂)₂H | (CH₂CH₂O)ₐ | 0 to 20 | Si | (CH₂)_{c} | 1 to 20 | Si(OMe)₃ | 3 | Me |
| 1025 | (CF₂)₂CH₃ | (CH₂CH₂O)ₐ | 0 to 20 | Si | (CH₂)_{c} | 1 to 20 | Si(OMe)₃ | 3 | Me |
| 1026 | (CF₂)₄H | (CH₂CH₂O)ₐ | 0 to 20 | Si | (CH₂)_{c} | 1 to 20 | Si(OMe)₃ | 3 | Me |
| 1027 | C₆F₅ | (CH₂CH₂O)ₐ | 0 to 20 | Si | (CH₂)_{c} | 1 to 20 | Si(OMe)₃ | 3 | Me |
| 1028 | 4-CF₃C₆F₄ | (CH₂CH₂O)ₐ | 0 to 20 | Si | (CH₂)_{c} | 1 to 20 | Si(OMe)₃ | 3 | Me |
| 1029 | 4-SF₅C₆F₄ | (CH₂CH₂O)ₐ | 0 to 20 | Si | (CH₂)_{c} | 1 to 20 | Si(OMe)₃ | 3 | Me |
| 1030 | 3,5-CF₃C₆F₃ | (CH₂CH₂O)ₐ | 0 to 20 | Si | (CH₂)_{c} | 1 to 20 | Si(OMe)₃ | 3 | Me |
| 1031 | 3,5-SF₅C₆F₃ | (CH₂CH₂O)ₐ | 0 to 20 | Si | (CH₂)_{c} | 1 to 20 | Si(OMe)₃ | 3 | Me |
| 1032 | 4-CF₃C₆H₄ | (CH₂CH₂O)ₐ | 0 to 20 | Si | (CH₂)_{c} | 1 to 20 | Si(OMe)₃ | 3 | Me |
| 1033 | 4-SF₅C₆H₄ | (CH₂CH₂O)ₐ | 0 to 20 | Si | (CH₂)_{c} | 1 to 20 | Si(OMe)₃ | 3 | Me |
| 1034 | 3,5-CF₃C₆H₃ | (CH₂CH₂O)ₐ | 0 to 20 | Si | (CH₂)_{c} | 1 to 20 | Si(OMe)₃ | 3 | Me |
| 1035 | 3,5-SF₅C₆H₃ | (CH₂CH₂O)ₐ | 0 to 20 | Si | (CH₂)_{c} | 1 to 20 | Si(OMe)₃ | 3 | Me |

TABLE 70

| No. | R^{f1} | R¹ | a | L¹ | R² | c | T¹ | x1 | R³⁶ |
|---|---|---|---|---|---|---|---|---|---|
| 1036 | 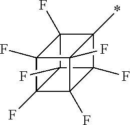 [SMILES: *C12C3(F)C4(F)C1(F)C1(F)C2(F)C3(F)C41F] | (CH₂CH₂O)ₐ | 0 to 20 | Si | (CH₂)_{c} | 1 to 20 | Si(OMe)₃ | 3 | Me |
| 1037 | 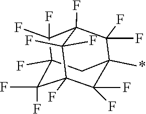 [SMILES: *C12CC3(F)C(F)(F)C(F)(C1(F)F)C(F)(F)C(F)(C2(F)F)C3(F)F] | (CH₂CH₂O)ₐ | 0 to 20 | Si | (CH₂)_{c} | 1 to 20 | Si(OMe)₃ | 3 | Me |
| 1038 | 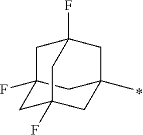 | (CH₂CH₂O)ₐ | 0 to 20 | Si | (CH₂)_{c} | 1 to 20 | Si(OMe)₃ | 3 | Me |
| 1039 | CH₂F | (CH₂CH₂O)ₐ | 0 to 20 | Si | (CH₂)_{c} | 1 to 20 | Si(OMe)₃ | 3 | Me |
| 1040 | SF₅ | (CH₂CH₂O)ₐ | 0 to 20 | Si | (CH₂)_{c} | 1 to 20 | Si(OMe)₃ | 3 | Me |
| 1041 | OCF₃ | (CH₂CH₂O)ₐ | 0 to 20 | Si | (CH₂)_{c} | 1 to 20 | Si(OMe)₃ | 3 | Me |
| 1042 | SCF₃ | (CH₂CH₂O)ₐ | 0 to 20 | Si | (CH₂)_{c} | 1 to 20 | Si(OMe)₃ | 3 | Me |
| 1043 | N(CH₂CF₃)₂ | (CH₂CH₂O)ₐ | 0 to 20 | Si | (CH₂)_{c} | 1 to 20 | Si(OMe)₃ | 3 | Me |
| 1044 | N(CF₃)₂ | (CH₂CH₂O)ₐ | 0 to 20 | Si | (CH₂)_{c} | 1 to 20 | Si(OMe)₃ | 3 | Me |
| 1045 | CF₃ | (CH₂CH₂O)ₐ | 0 to 20 | C | (CH₂)_{c} | 1 to 20 | Si(OMe)₃ | 3 | Me |
| 1046 | (CF₃)₂CF | (CH₂CH₂O)ₐ | 0 to 20 | C | (CH₂)_{c} | 1 to 20 | Si(OMe)₃ | 3 | Me |
| 1047 | (CF₃)₃C | (CH₂CH₂O)ₐ | 0 to 20 | C | (CH₂)_{c} | 1 to 20 | Si(OMe)₃ | 3 | Me |
| 1048 | C₄F₉ | (CH₂CH₂O)ₐ | 0 to 20 | C | (CH₂)_{c} | 1 to 20 | Si(OMe)₃ | 3 | Me |
| 1049 | C₈F₁₇ | (CH₂CH₂O)ₐ | 0 to 20 | C | (CH₂)_{c} | 1 to 20 | Si(OMe)₃ | 3 | Me |
| 1050 | c-C₆F₁₁ | (CH₂CH₂O)ₐ | 0 to 20 | C | (CH₂)_{c} | 1 to 20 | Si(OMe)₃ | 3 | Me |

TABLE 71

| No. | R^{f1} | R¹ | a | L¹ | R² | c | T¹ | x1 | R³⁶ |
|---|---|---|---|---|---|---|---|---|---|
| 1051 | CHF₂ | (CH₂CH₂O)ₐ | 0 to 20 | C | (CH₂)_{c} | 1 to 20 | Si(OMe)₃ | 3 | Me |
| 1052 | CClF₂ | (CH₂CH₂O)ₐ | 0 to 20 | C | (CH₂)_{c} | 1 to 20 | Si(OMe)₃ | 3 | Me |
| 1053 | CBrF₂ | (CH₂CH₂O)ₐ | 0 to 20 | C | (CH₂)_{c} | 1 to 20 | Si(OMe)₃ | 3 | Me |
| 1054 | ClF₂ | (CH₂CH₂O)ₐ | 0 to 20 | C | (CH₂)_{c} | 1 to 20 | Si(OMe)₃ | 3 | Me |
| 1055 | CF═CF₂ | (CH₂CH₂O)ₐ | 0 to 20 | C | (CH₂)_{c} | 1 to 20 | Si(OMe)₃ | 3 | Me |
| 1056 | CF═CFCF₃ | (CH₂CH₂O)ₐ | 0 to 20 | C | (CH₂)_{c} | 1 to 20 | Si(OMe)₃ | 3 | Me |
| 1057 | CF═CFCF═CF₂ | (CH₂CH₂O)ₐ | 0 to 20 | C | (CH₂)_{c} | 1 to 20 | Si(OMe)₃ | 3 | Me |
| 1058 | C≡CCF₃ | (CH₂CH₂O)ₐ | 0 to 20 | C | (CH₂)_{c} | 1 to 20 | Si(OMe)₃ | 3 | Me |
| 1059 | CF₂CH₃ | (CH₂CH₂O)ₐ | 0 to 20 | C | (CH₂)_{c} | 1 to 20 | Si(OMe)₃ | 3 | Me |
| 1060 | (CF₂)₂H | (CH₂CH₂O)ₐ | 0 to 20 | C | (CH₂)_{c} | 1 to 20 | Si(OMe)₃ | 3 | Me |
| 1061 | (CF₂)₂CH₃ | (CH₂CH₂O)ₐ | 0 to 20 | C | (CH₂)_{c} | 1 to 20 | Si(OMe)₃ | 3 | Me |
| 1062 | (CF₂)₄H | (CH₂CH₂O)ₐ | 0 to 20 | C | (CH₂)_{c} | 1 to 20 | Si(OMe)₃ | 3 | Me |
| 1063 | C₆F₅ | (CH₂CH₂O)ₐ | 0 to 20 | C | (CH₂)_{c} | 1 to 20 | Si(OMe)₃ | 3 | Me |
| 1064 | 4-CF₃C₆F₄ | (CH₂CH₂O)ₐ | 0 to 20 | C | (CH₂)_{c} | 1 to 20 | Si(OMe)₃ | 3 | Me |
| 1065 | 4-SF₅C₆F₄ | (CH₂CH₂O)ₐ | 0 to 20 | C | (CH₂)_{c} | 1 to 20 | Si(OMe)₃ | 3 | Me |

TABLE 72

| No. | R^{f1} | R¹ | a | L¹ | R² | c | T¹ | x1 | R³⁶ |
|---|---|---|---|---|---|---|---|---|---|
| 1066 | 3,5-CF₃C₆F₃ | (CH₂CH₂O)ₐ | 0 to 20 | C | (CH₂)_{c} | 1 to 20 | Si(OMe)₃ | 3 | Me |
| 1067 | 3,5-SF₅C₆F₃ | (CH₂CH₂O)ₐ | 0 to 20 | C | (CH₂)_{c} | 1 to 20 | Si(OMe)₃ | 3 | Me |
| 1068 | 4-CF₃C₆H₄ | (CH₂CH₂O)ₐ | 0 to 20 | C | (CH₂)_{c} | 1 to 20 | Si(OMe)₃ | 3 | Me |
| 1069 | 4-SF₅C₆H₄ | (CH₂CH₂O)ₐ | 0 to 20 | C | (CH₂)_{c} | 1 to 20 | Si(OMe)₃ | 3 | Me |
| 1070 | 3,5-CF₃C₆H₃ | (CH₂CH₂O)ₐ | 0 to 20 | C | (CH₂)_{c} | 1 to 20 | Si(OMe)₃ | 3 | Me |
| 1071 | 3,5-SF₅C₆H₃ | (CH₂CH₂O)ₐ | 0 to 20 | C | (CH₂)_{c} | 1 to 20 | Si(OMe)₃ | 3 | Me |
| 1072 | 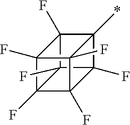 [SMILES: *C12C3(F)C4(F)C1(F)C1(F)C2(F)C3(F)C41F] | (CH₂CH₂O)ₐ | 0 to 20 | C | (CH₂)_{c} | 1 to 20 | Si(OMe)₃ | 3 | Me |
| 1073 | 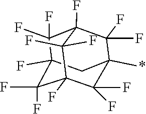 [SMILES: *C12CC3(F)C(F)(F)C(F)(C1(F)F)C(F)(F)C(F)(C2(F)F)C3(F)F] | (CH₂CH₂O)ₐ | 0 to 20 | C | (CH₂)_{c} | 1 to 20 | Si(OMe)₃ | 3 | Me |
| 1074 | 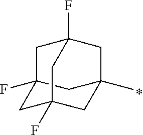 | (CH₂CH₂O)ₐ | 10 to 20 | C | (CH₂)_{c} | 1 to 20 | Si(OMe)₃ | 3 | Me |
| 1075 | CH₂F | (CH₂CH₂O)ₐ | 0 to 20 | C | (CH₂)_{c} | 1 to 20 | Si(OMe)₃ | 3 | Me |
| 1076 | SF₅ | (CH₂CH₂O)ₐ | 0 to 20 | C | (CH₂)_{c} | 1 to 20 | Si(OMe)₃ | 3 | Me |
| 1077 | OCF₃ | (CH₂CH₂O)ₐ | 0 to 20 | C | (CH₂)_{c} | 1 to 20 | Si(OMe)₃ | 3 | Me |
| 1078 | SCF₃ | (CH₂CH₂O)ₐ | 0 to 20 | C | (CH₂)_{c} | 1 to 20 | Si(OMe)₃ | 3 | Me |
| 1079 | N(CH₂CF₃)₂ | (CH₂CH₂O)ₐ | 0 to 20 | C | (CH₂)_{c} | 1 to 20 | Si(OMe)₃ | 3 | Me |
| 1080 | N(CF₃)₂ | (CH₂CH₂O)ₐ | 0 to 20 | C | (CH₂)_{c} | 1 to 20 | Si(OMe)₃ | 3 | Me |

TABLE 73

| No. | R^{f1} | R¹ | a | L¹ | R² | c | T¹ | x1 | R³⁶ |
|---|---|---|---|---|---|---|---|---|---|
| 1081 | CF₃ | (CH₂)ₐ | 0 to 20 | C(═O)N | (CH₂)_{c} | 1 to 20 | Si(OMe)₃ | 2 | Me |
| 1082 | (CF₃)₂CF | (CH₂)ₐ | 0 to 20 | C(═O)N | (CH₂)_{c} | 1 to 20 | Si(OMe)₃ | 2 | Me |
| 1083 | (CF₃)₃C | (CH₂)ₐ | 0 to 20 | C(═O)N | (CH₂)_{c} | 1 to 20 | Si(OMe)₃ | 2 | Me |
| 1084 | C₄F₉ | (CH₂)ₐ | 0 to 20 | C(═O)N | (CH₂)_{c} | 1 to 20 | Si(OMe)₃ | 2 | Me |
| 1085 | C₈F₁₇ | (CH₂)ₐ | 0 to 20 | C(═O)N | (CH₂)_{c} | 1 to 20 | Si(OMe)₃ | 2 | Me |
| 1086 | c-C₆F₁₁ | (CH₂)ₐ | 0 to 20 | C(═O)N | (CH₂)_{c} | 1 to 20 | Si(OMe)₃ | 2 | Me |
| 1087 | CHF₂ | (CH₂)ₐ | 0 to 20 | C(═O)N | (CH₂)_{c} | 1 to 20 | Si(OMe)₃ | 2 | Me |
| 1088 | CClF₂ | (CH₂)ₐ | 0 to 20 | C(═O)N | (CH₂)_{c} | 1 to 20 | Si(OMe)₃ | 2 | Me |
| 1089 | CBrF₂ | (CH₂)ₐ | 0 to 20 | C(═O)N | (CH₂)_{c} | 1 to 20 | Si(OMe)₃ | 2 | Me |
| 1090 | ClF₂ | (CH₂)ₐ | 0 to 20 | C(═O)N | (CH₂)_{c} | 1 to 20 | Si(OMe)₃ | 2 | Me |
| 1091 | CF═CF₂ | (CH₂)ₐ | 0 to 20 | C(═O)N | (CH₂)_{c} | 1 to 20 | Si(OMe)₃ | 2 | Me |
| 1092 | CF═CFCF₃ | (CH₂)ₐ | 0 to 20 | C(═O)N | (CH₂)_{c} | 1 to 20 | Si(OMe)₃ | 2 | Me |
| 1093 | CF═CFCF═CF₂ | (CH₂)ₐ | 0 to 20 | C(═O)N | (CH₂)_{c} | 1 to 20 | Si(OMe)₃ | 2 | Me |
| 1094 | C≡CCF₃ | (CH₂)ₐ | 0 to 20 | C(═O)N | (CH₂)_{c} | 1 to 20 | Si(OMe)₃ | 2 | Me |
| 1095 | CF₂CH₃ | (CH₂)ₐ | 0 to 20 | C(═O)N | (CH₂)_{c} | 1 to 20 | Si(OMe)₃ | 2 | Me |

TABLE 74

| No. | R^{f1} | R¹ | a | L¹ | R² | c | T¹ | x1 | R³⁶ |
|---|---|---|---|---|---|---|---|---|---|
| 1096 | (CF₂)₂H | (CH₂)ₐ | 0 to 20 | C(═O)N | (CH₂)_{c} | 1 to 20 | Si(OMe)₃ | 2 | Me |
| 1097 | (CF₂)₂CH₃ | (CH₂)ₐ | 0 to 20 | C(═O)N | (CH₂)_{c} | 1 to 20 | Si(OMe)₃ | 2 | Me |
| 1098 | (CF)₄H | (CH₂)ₐ | 0 to 20 | C(═O)N | (CH₂)_{c} | 1 to 20 | Si(OMe)₃ | 2 | Me |
| 1099 | C₆F₅ | (CH₂)ₐ | 0 to 20 | C(═O)N | (CH₂)_{c} | 1 to 20 | Si(OMe)₃ | 2 | Me |
| 1100 | 4-CF₃C₆F₄ | (CH₂)ₐ | 0 to 20 | C(═O)N | (CH₂)_{c} | 1 to 20 | Si(OMe)₃ | 2 | Me |
| 1101 | 4-SF₅C₆F₄ | (CH₂)ₐ | 0 to 20 | C(═O)N | (CH₂)_{c} | 1 to 20 | Si(OMe)₃ | 2 | Me |
| 1102 | 3,5-CF₃C₆F₃ | (CH₂)ₐ | 0 to 20 | C(═O)N | (CH₂)_{c} | 1 to 20 | Si(OMe)₃ | 2 | Me |
| 1103 | 3,5-SF₅C₆F₃ | (CH₂)ₐ | 0 to 20 | C(═O)N | (CH₂)_{c} | 1 to 20 | Si(OMe)₃ | 2 | Me |
| 1104 | 4-CF₃C₆H₄ | (CH₂)ₐ | 0 to 20 | C(═O)N | (CH₂)_{c} | 1 to 20 | Si(OMe)₃ | 2 | Me |
| 1105 | 4-SF₅C₆H₄ | (CH₂)ₐ | 0 to 20 | C(═O)N | (CH₂)_{c} | 1 to 20 | Si(OMe)₃ | 2 | Me |
| 1106 | 3,5-CF₃C₆H₃ | (CH₂)ₐ | 0 to 20 | C(═O)N | (CH₂)_{c} | 1 to 20 | Si(OMe)₃ | 2 | Me |
| 1107 | 3,5-SF₅C₆H₃ | (CH₂)ₐ | 0 to 20 | C(═O)N | (CH₂)_{c} | 1 to 20 | Si(OMe)₃ | 2 | Me |
| 1108 | 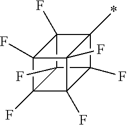 [SMILES: *C12C3(F)C4(F)C1(F)C1(F)C2(F)C3(F)C41F] | (CH₂)ₐ | 0 to 20 | C(═O)N | (CH₂)_{c} | 1 to 20 | Si(OMe)₃ | 2 | Me |
| 1109 | 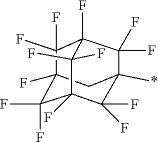 [SMILES: *C12C[C@@]3(F)C(F)(F)[C@](F)(C1(F)F)C(F)(F)[C@](F)(C2(F)F)C3(F)F] | (CH₂)ₐ | 0 to 20 | C(═O)N | (CH₂)_{c} | 1 to 20 | Si(OMe)₃ | 2 | Me |
| 1110 | 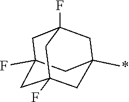 [SMILES: *C12CC3(F)CC(F)(C1)CC(F)(C2)C3] | (CH₂)ₐ | 0 to 20 | C(═O)N | (CH₂)_{c} | 1 to 20 | Si(OMe)₃ | 2 | Me |

TABLE 75

| No. | R^{f1} | R¹ | a | L¹ | R² | c | T¹ | x1 | R³⁶ |
|---|---|---|---|---|---|---|---|---|---|
| 1111 | CH₂F | (CH₂)ₐ | 0 to 20 | C(═O)N | (CH₂)_{c} | 1 to 20 | Si(OMe)₃ | 2 | Me |
| 1112 | SF₅ | (CH₂)ₐ | 0 to 20 | C(═O)N | (CH₂)_{c} | 1 to 20 | Si(OMe)₃ | 2 | Me |
| 1113 | OCF₃ | (CH₂)ₐ | 0 to 20 | C(═O)N | (CH₂)_{c} | 1 to 20 | Si(OMe)₃ | 2 | Me |
| 1114 | SCF ₃ | (CH₂)ₐ | 0 to 20 | C(═O)N | (CH₂)_{c} | 1 to 20 | Si(OMe)₃ | 2 | Me |
| 1115 | N(CH₂CF₃)₂ | (CH₂)ₐ | 0 to 20 | C(═O)N | (CH₂)_{c} | 1 to 20 | Si(OMe)₃ | 2 | Me |
| 1116 | N(CF₃)₂ | (CH₂)ₐ | 0 to 20 | C(═O)N | (CH₂)_{c} | 1 to 20 | Si(OMe)₃ | 2 | Me |
| 1117 | CF₃ | (CH₂CH₂O)ₐ | 0 to 20 | C(═O)NH | (CH₂)_{c} | 1 to 20 | Si(OMe)₃ | 2 | Me |
| 1118 | (CF₃)₂CF | (CH₂CH₂O)ₐ | 0 to 20 | C(═O)NH | (CH₂)_{c} | 1 to 20 | Si(OMe)₃ | 2 | Me |
| 1119 | (CF₃)₃C | (CH₂CH₂O)ₐ | 0 to 20 | C(═O)NH | (CH₂)_{c} | 1 to 20 | Si(OMe)₃ | 2 | Me |
| 1120 | C₄F₉ | (CH₂CH₂O)ₐ | 0 to 20 | C(═O)NH | (CH₂)_{c} | 1 to 20 | Si(OMe)₃ | 2 | Me |
| 1121 | C₈F₁₇ | (CH₂CH₂O)ₐ | 0 to 20 | C(═O)NH | (CH₂)_{c} | 1 to 20 | Si(OMe)₃ | 2 | Me |
| 1122 | c-C₆F₁₁ | (CH₂CH₂O)ₐ | 0 to 20 | C(═O)NH | (CH₂)_{c} | 1 to 20 | Si(OMe)₃ | 2 | Me |
| 1123 | CHF₂ | (CH₂CH₂O)ₐ | 0 to 20 | C(═O)NH | (CH₂)_{c} | 1 to 20 | Si(OMe)₃ | 2 | Me |
| 1124 | CClF₂ | (CH₂CH₂O)ₐ | 0 to 20 | C(═O)NH | (CH₂)_{c} | 1 to 20 | Si(OMe)₃ | 2 | Me |
| 1125 | CBrF₂ | (CH₂CH₂O)ₐ | 0 to 20 | C(═O)NH | (CH₂)_{c} | 1 to 20 | Si(OMe)₃ | 2 | Me |

TABLE 76

| No. | R^{f1} | R¹ | a | L¹ | R² | c | T¹ | x1 | R³⁶ |
|---|---|---|---|---|---|---|---|---|---|
| 1126 | ClF₂ | (CH₂CH₂O)ₐ | 0 to 20 | C(═O)NH | (CH₂)_{c} | 1 to 20 | Si(OMe)₃ | 2 | Me |
| 1127 | CF═CF₂ | (CH₂CH₂O)ₐ | 0 to 20 | C(═O)NH | (CH₂)_{c} | 1 to 20 | Si(OMe)₃ | 2 | Me |
| 1128 | CF═CFCF₃ | (CH₂CH₂O)ₐ | 0 to 20 | C(═O)NH | (CH₂)_{c} | 1 to 20 | Si(OMe)₃ | 2 | Me |
| 1129 | CF═CFCF═CF₂ | (CH₂CH₂O)ₐ | 0 to 20 | C(═O)NH | (CH₂)_{c} | 1 to 20 | Si(OMe)₃ | 2 | Me |
| 1130 | C≡CCF₃ | (CH₂CH₂O)ₐ | 0 to 20 | C(═O)NH | (CH₂)_{c} | 1 to 20 | Si(OMe)₃ | 2 | Me |
| 1131 | CF₂CH₃ | (CH₂CH₂O)ₐ | 0 to 20 | C(═O)NH | (CH₂)_{c} | 1 to 20 | Si(OMe)₃ | 2 | Me |
| 1132 | (CF₂)₂H | (CH₂CH₂O)ₐ | 0 to 20 | C(═O)NH | (CH₂)_{c} | 1 to 20 | Si(OMe)₃ | 2 | Me |
| 1133 | (CF₂)₂CH₃ | (CH₂CH₂O)ₐ | 0 to 20 | C(═O)NH | (CH₂)_{c} | 1 to 20 | Si(OMe)₃ | 2 | Me |
| 1134 | (CF₂)₄H | (CH₂CH₂O)ₐ | 0 to 20 | C(═O)NH | (CH₂)_{c} | 1 to 20 | Si(OMe)₃ | 2 | Me |
| 1135 | C₆F₅ | (CH₂CH₂O)ₐ | 0 to 20 | C(═O)NH | (CH₂)_{c} | 1 to 20 | Si(OMe)₃ | 2 | Me |
| 1136 | 4-CF₃C₆F₄ | (CH₂CH₂O)ₐ | 0 to 20 | C(═O)NH | (CH₂)_{c} | 1 to 20 | Si(OMe)₃ | 2 | Me |
| 1137 | 4-SF₅C₆F₄ | (CH₂CH₂O)ₐ | 0 to 20 | C(═O)NH | (CH₂)_{c} | 1 to 20 | Si(OMe)₃ | 2 | Me |
| 1138 | 3,5-CF₃C₆F₃ | (CH₂CH₂O)ₐ | 0 to 20 | C(═O)NH | (CH₂)_{c} | 1 to 20 | Si(OMe)₃ | 2 | Me |
| 1139 | 3,5-SF₅C₆F₃ | (CH₂CH₂O)ₐ | 0 to 20 | C(═O)NH | (CH₂)_{c} | 1 to 20 | Si(OMe)₃ | 2 | Me |
| 1140 | 4-CF₃C₆H₄ | (CH₂CH₂O)ₐ | 0 to 20 | C(═O)NH | (CH₂)_{c} | 1 to 20 | Si(OMe)₃ | 2 | Me |

TABLE 77

| No. | R^{f1} | R¹ | a | L¹ | R² | c | T¹ | x1 | R³⁶ |
|---|---|---|---|---|---|---|---|---|---|
| 1141 | 4-SF₅C₆H₄ | (CH₂CH₂O)ₐ | 0 to 20 | C(═O)NH | (CH₂)_{c} | 1 to 20 | Si(OMe)₃ | 2 | Me |
| 1142 | 3,5-CF₃C₆H₃ | (CH₂CH₂O)ₐ | 0 to 20 | C(═O)NH | (CH₂)_{c} | 1 to 20 | Si(OMe)₃ | 2 | Me |
| 1143 | 3,5-SF₅C₆H₃ | (CH₂CH₂O)ₐ | 0 to 20 | C(═O)NH | (CH₂)_{c} | 1 to 20 | Si(OMe)₃ | 2 | Me |
| 1144 | 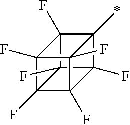 [SMILES: *C12C3(F)C4(F)C1(F)C1(F)C2(F)C3(F)C41F] | (CH₂CH₂O)ₐ | 0 to 20 | C(═O)NH | (CH₂)_{c} | 1 to 20 | Si(OMe)₃ | 2 | Me |
| 1145 | 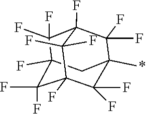 [SMILES: *C12CC3(F)C(F)(F)C(F)(C1(F)F)C(F)(F)C(F)(C2(F)F)C3(F)F] | (CH₂CH₂O)ₐ | 0 to 20 | C(═O)NH | (CH₂)_{c} | 1 to 20 | Si(OMe)₃ | 2 | Me |
| 1146 | 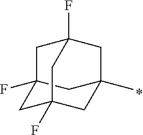 | (CH₂CH₂O)ₐ | 0 to 20 | C(═O)NH | (CH₂)_{c} | 1 to 20 | Si(OMe)₃ | 2 | Me |
| 1147 | CH₂F | (CH₂CH₂O)ₐ | 0 to 20 | C(═O)NH | (CH₂)_{c} | 1 to 20 | Si(OMe)₃ | 2 | Me |
| 1148 | SF₅ | (CH₂CH₂O)ₐ | 0 to 20 | C(═O)NH | (CH₂)_{c} | 1 to 20 | Si(OMe)₃ | 2 | Me |
| 1149 | OCF₃ | (CH₂CH₂O)ₐ | 0 to 20 | C(═O)NH | (CH₂)_{c} | 1 to 20 | Si(OMe)₃ | 2 | Me |
| 1150 | SCF₃ | (CH₂CH₂O)ₐ | 0 to 20 | C(═O)NH | (CH₂)_{c} | 1 to 20 | Si(OMe)₃ | 2 | Me |
| 1151 | N(CH₂CF₃)₂ | (CH₂CH₂O)ₐ | 0 to 20 | C(═O)NH | (CH₂)_{c} | 1 to 20 | Si(OMe)₃ | 2 | Me |
| 1152 | N (CF₃)₂ | (CH₂CH₂O)ₐ | 0 to 20 | C(═O)NH | (CH₂)_{c} | 1 to 20 | Si(OMe)₃ | 2 | Me |

### <Physical Property of Compound 1>

The number-average molecular weight (Mn) of the compound 1 is preferably 500 to 20,000, more preferably 600 to 18,000, and still more preferably 700 to 15,000.

When Mn is 500 or greater, the frictional durability of the surface layer becomes excellent. When Mn is 20,000 or smaller, the viscosity can be easily adjusted within an appropriate range, and the solubility is improved, so that the handling property during the film formation becomes excellent.

### [Surface Treatment Agent]

The surface treatment agent according to the present invention (hereinafter also referred to as “the surface treatment agent disclosed herein”) contains the compound 1.

The surface treatment agent disclosed herein is suitably used as a surface treatment agent for uses in which it is required that the performance that water repellency and oil repellency is not lowered even when the surface layer is repeatedly rubbed by a finger and the performance that fingerprints adhered to the surface layer can be easily removed by wiping (fingerprint stain removal property) are maintained for a long period of time, such as for a member constituting the surface of a touch panel which a finger touches, lenses of eyeglass, and a display of a wearable terminal.

Further, since the surface treatment agent disclosed herein has excellent slip resistance, it is also suitably used for glass-coated housings of portable apparatuses such as smartphones and tablet terminals.

The surface treatment agent disclosed herein is also suitably used for antifouling coating agents or waterproof coating agents.

The surface treatment agent disclosed herein may further contain a liquid medium. In the following description, a surface treatment agent discloses herein containing a liquid medium may be referred to as a coating liquid.

The coating liquid may be a liquid, a solution, or a dispersion liquid. The coating liquid should contain at least the compound 1, and may contain impurities such as by-products generated in the manufacturing process of the compound 1.

The concentration of the compound 1 in the coating liquid is preferably 0.001 to 40 mass %, more preferably 0.01 to 20 mass %, and still more preferably 0.1 to 10 mass %.

The liquid medium is preferably an organic solvent. The organic solvent may be a fluorine-containing organic solvent or a non-fluorine-containing organic solvent, or the liquid medium may contain both solvents.

Specific examples of the fluorine-containing organic solvent include fluorinated alkanes, fluorinated aromatic compounds, fluoroalkyl ethers, fluorinated alkylamines, fluoroalcohols, and hydrofluoroolefins (HFO).

As the fluorinated alkane, a compound having a carbon number of 4 to 8 is preferred. Specific examples of commercial products include C₆F₁₃H (manufactured by AGC Inc., Asahiklin (Registered Trademark) AC-2000), C₆F₁₃C₂H₅ (manufactured by AGC Inc., Asahiklin (Registered Trademark) AC-6000), and C₂F₅CHFCHFCF₃ (manufactured by Chemours, Vertrel (Registered Trademark) XF).

Specific examples of fluorinated aromatic compounds include hexafluorobenzene, trifluoromethylbenzene, perfluorotoluene, and bis(trifluoromethyl)benzene.

As the fluoroalkyl ether, a compound having a carbon number 4 to 12 is preferred. Specific examples of commercial products include CF₃CH₂OCF₂CF₂H (manufactured by AGC Inc., Asahiklin (Registered Trademark) AE-3000), C₄F₉OCH; (manufactured by 3M, Novec (Registered Trademark) 7100), C₄F₉OC₂H₅ (manufactured by 3M, Novec (Registered Trademark) 7200), and C₂F₅CF(OCH₃)C₃F, (manufactured by 3M, Novec (Registered Trademark) 7300).

Specific examples of fluorinated alkylamines include perfluorotripropylamine and perfluorotributylamine. Specific examples of fluoroalcohols include 2,2,3,3-tetrafluoropropanol, 2,2,2-trifluoroethanol, and hexafluoroisopropanol.

Specific examples of HFO include 1-chloro-2,3,3-trifluoro-1-propene (HCFO-1233 yd) (manufactured by AGC Inc., Amolea (Registered Trademark) AS-300).

Examples of non-fluorinated organic solvents include compounds consisting solely of hydrogen atoms and carbon atoms, and compounds consisting solely of hydrogen atoms, carbon atoms, and oxygen atoms, hydrocarbon-based organic solvents, alcohol-based organic solvents, ketone-based organic solvents, ether-based organic solvents, ester-based organic solvents, and glycol-based organic solvents.

Specific examples of hydrocarbon organic solvents include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of alcohol-based organic solvents include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4 methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Specific examples of ketone-based organic solvents include acetone, methyl ethyl ketone, methyl isobutyl ketone, diisobutyl ketone, cyclohexanone, 2-heptanone, 4-heptanone, 3,5,5-trimethyl-2-cyclohexene-1-one, and 3,3,5-trimethylcyclohexanone, and isophorone.

Specific examples of ether-based organic solvents include diethyl ether, cyclopentyl methyl ether, tetrahydrofuran, and 1,4-dioxane.

Specific examples of ester organic solvents include methyl acetate, ethyl acetate, propyl acetate, isopropyl acetate, butyl acetate, isobutyl acetate, tert-butyl acetate, amyl acetate, isoamyl acetate, 3-ethoxypropionic acid ethyl ester, ethyl lactate, ethylene glycol monobutyl ether acetate, diethylene glycol monobutyl ether acetate, propylene glycol monomethyl ether acetate, dipropylene glycol methyl ether acetate, 3-methoxy-3-methyl butyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, Propylene glycol monomethyl ether acetate, propylene glycol monomethyl ether propionate, propylene glycol monoethyl ether acetate, propylene glycol monobutyl ether acetate, propylene glycol monopropyl ether acetate, propylene glycol diacetate, dipropylene glycol methyl ether acetate, 1,3-butylene glycol diacetate. 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of glycol-based organic solvents include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monopropyl ether, ethylene glycol monoisopropyl ether, ethylene glycol monoethyl ether, ethylene glycol mono tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monopropyl ether, Dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dimethyl ether, dipropylene glycol dimethyl ether, diethylene glycol dibutyl ether, tetraethylene glycol dimethyl ether, dipropylene glycol dimethyl ether pentane, triethylene glycol dimethyl ether, and polyethylene glycol dimethyl ether.

Further, examples of other organic solvents include chlorinated-based organic solvents, nitrogen-containing compounds, sulfur-containing compounds, and siloxane compounds.

Specific examples of chlorinated organic solvents include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Specific examples of nitrogen-containing compounds include nitrobenzene, acetonitrile, benzonitrile, N,N-dimethylformamide, N,N-dimethylacetamide, N-methylpyrrolidone, and 1,3-dimethyl-2-imidazolidinone.

Specific examples of sulfur-containing compounds include carbon disulfide and dimethyl sulfoxide.

Specific examples of siloxane compounds include hexamethyldisiloxane, octamethyltrisiloxane, and decamethyltetrasiloxane.

The coating liquid preferably contains the liquid medium in 75 to 99.999 mass %, more preferably 85 to 99.99 mass %, and still more preferably 90 to 99.9 mass %.

The surface treatment agent disclosed herein may contain components other than the compound 1 and the liquid medium in a range in which the effects of the present disclosure are not impaired. Examples of other components include known additives such as acid catalysts and basic catalysts that promote the hydrolysis and the condensation reaction of the hydrolyzable silyl group.

The content of other components in the surface treatment agent disclosed herein is preferably 10 mass % or less, and more preferably 1 mass % or less.

Examples of other components also include compounds represented by the below-shown Formula (3):

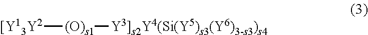

In Formula (3), Y² is Si, Sn, or Ge,
Y¹ is a hydrocarbon group or a trialkylsilyloxy group,
s1 is 0 or 1,
Y³ is an alkylene chain or a polyalkylene oxide chain, or a combination of an alkylene chain and a divalent polysiloxane residue,
Y⁴ is a single bond or a linking group having a valence of (s2+s4),
Y⁵ is a hydrocarbon group,
Y⁶ is a hydrolyzable group or a hydroxyl group,
s3 are each independently an integer of 0 to 2, and
s2 and s4 are each independently an integer of 1 or greater.

When there are a plurality of Y¹, Y², Y³, Y⁵ and Y⁶, they each independently have the above-described definitions.

As the compound (3), a compound in which Y³ is an alkylene chain or a polyalkylene oxide chain is preferred.

Specific examples of the compound (3) include the below-shown compounds (3-1) to (3-3). In the Formula (3-3), α is preferably 9 to 50, more preferably 11 to 30, and particularly preferably 11 or 25.

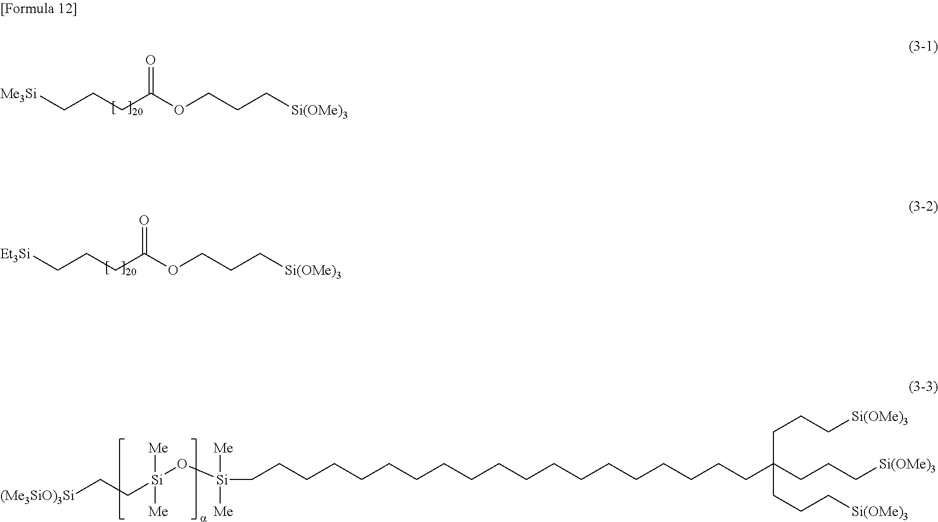

When the other component in the surface treatment agent disclosed herein is the compound (3), the content of the compound (3) is preferably 50 mass % or less, and more preferably 40 mass % or less.

The concentration of the sum total of the compound 1 and other component of the coating liquid (hereinafter also referred to as the “solid content concentration”) is preferably 0.001 to 40 mass %, more preferably 0.01 to 20 mass %, and still more preferably 0.01 to 10 mass %, and particularly preferably 0.01 to 1 mass %.

The solid content concentration of the coating liquid is a value calculated from the mass of the coating liquid before being heated and the mass thereof after being heated in a convection dryer at 120° C. for 4 hours.

### Article

An article according to the present invention (hereinafter also referred to as an “article disclosed herein”) has a surface layer formed of the compound 1 or the surface treatment agent disclosed herein on the surface of the substrate.

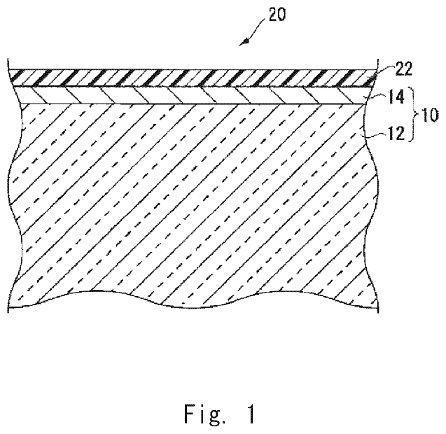

An example of the article disclosed herein will be described with reference to the drawings. FIG. 1 is a schematic cross-sectional diagram showing a first article as an example of the article disclosed herein. The first article is an article 20 including a substrate 12, an underlayer 14, and a surface layer 22 in this order, in which the underlayer 14 contains an oxide containing silicon, and the surface layer 22 contains a condensate of the compound 1.

The material and the shape of the substrate 12 may be selected as appropriate according to the use and the like of the article 20 disclosed herein. Examples of the material of the substrate 12 include glass, resins, sapphire, metals, ceramic, stone, and composite materials thereof. The glass may be chemically reinforced in advance.

In particular, in the case of the substrate 12 which is required to be water/oil repellent, examples include a substrate for a touch panel, a substrate for a display, and a substrate constituting a housing of an electronic apparatus.

The substrate for a touch panel and the substrate for a display have a transparent or translucent property. “Having a transparent or translucent property” means that the vertically-incident visible light transmittance measured in conformity with JIS R3106: 1998 (ISO 9050: 1990) is 25% or higher.

Glass or a transparent resin is preferred as the material of the substrate for a touch panel.

The substrate 12 may be one in which a surface treatment such as a corona discharge treatment, a plasma treatment, or a plasma graft polymerization treatment has been performed for its surface on which the underlayer 14 is provided. The surface-treated surface has an excellent adhesive property between the substrate 12 and the underlayer 14, and as a result, the frictional durability of the surface layer 22 is further improved.

As the surface treatment, a corona discharge treatment or a plasma treatment is preferred because the frictional durability of the surface layer 22 is further improved.

The underlayer 14 is a layer containing at least an oxide containing silicon, and may contain other elements. As the underlayer 14 contains a silicon oxide, T¹ of the compound 1 is dehydrated and condensed, so that an Si—O—Si bond is formed between the substrate 12 and the underlayer 14, and the surface layer 22 having more excellent frictional durability is thereby formed.

The content of silicon oxide in the underlayer 14 is preferably 65 mass % or more, more preferably 80 mass % or more, still more preferably 85 mass % or more, and particularly preferably 90 mass % or more. When the content of silicon oxide is equal to or larger than the lower limit value of the above-described range, the Si—O—Si bond is sufficiently formed in the underlayer 14, so that satisfactory mechanical properties of the underlayer 14 can be ensured.

The content of silicon oxide is the balance obtained by subtracting the total content of the other elements (in the case of the oxide, the amount in terms of oxide) from the mass of the underlayer 14.

In view of the durability of the surface layer 22, the oxide in the underlayer 14 preferably further contains one or more elements selected from alkali metal elements, alkaline earth metal elements, platinum group elements, boron, aluminum, phosphorus, titanium, zirconium, iron, nickel, chromium, molybdenum, and tungsten. By containing these elements, the bond between the underlayer 14 and the compound 1 is strengthened, so that the frictional durability is improved.

When the underlayer 14 contains one or more elements selected from iron, nickel, and chromium, the total content of these elements is preferably 10 to 1,100 mass ppm, more preferably 50 to 1,100 mass ppm, still more preferably 50 to 500 mass ppm, and particularly preferably 50 to 250 mass ppm based on the silicon oxide. When the underlayer 14 contains one or more elements selected from aluminum and zirconium, the total content of these elements is preferably 10 to 2,500 mass ppm, more preferably 15 to 2,000 mass ppm, and still more preferably 20 to 1,000 mass ppm.

When the underlayer 14 contains alkali metal elements, the total content of these elements is preferably 0.05 to 15% by mass, more preferably 0.1 to 13% by mass, and still more preferably 1.0 to 10% by mass. Note that examples of alkali metal elements include lithium, sodium, potassium, rubidium, and cesium.

When the underlayer 14 contains platinum-group elements, the total content of these elements is preferably 0.02 to 800 mass ppm, more preferably 0.04 to 600 mass ppm, and still more preferably 0.7 to 200 mass ppm. Note that examples of platinum-group elements include platinum, rhodium, ruthenium, palladium, osmium, and iridium.

When the underlayer 14 contains one or more elements selected from boron and phosphorus, the total content of them is preferably 0.003 to 9, more preferably 0.003 to 2, and still more preferably 0.003 to 0.5 as the ratio of the total molar concentration of boron and phosphorus to the molar concentration of silicon in view of the frictional durability of the surface layer 22.

When the underlayer 14 contains alkaline earth metal elements, the total content of them is preferably 0.005 to 5, more preferably 0.005 to 2, and still more preferably 0.007 to 2 as the ratio of the total molar concentration of alkaline earth metal elements to the molar concentration of silicon in view of the frictional durability of the surface layer 22. Note that examples of alkaline earth metal elements include beryllium, magnesium, calcium, strontium, barium, and radium.

The underlayer 14 is preferably a silicon oxide layer containing alkali metal atoms in order to improve the adhesive property of the surface treatment agent disclosed herein and to improve the water/oil repellency and the frictional durability of the article 20. In the silicon oxide layer, the average concentration of alkali metal atoms in a region having a depth of 0.1 to 0.3 nm from the surface thereof in contact with the surface layer 22 is particularly preferably 2.0×10¹⁹ atoms/cm³ or higher. On the other hand, in order to ensure the sufficient mechanical properties of the silicon oxide layer, the average concentration of alkali metal atoms is preferably 4.0×10²² atoms/cm³ or lower.

The thickness of the underlayer 14 is preferably 1 to 200 nm and particularly preferably 2 to 20 nm. When the thickness of the underlayer 14 is equal to or higher than the lower limit value of the above-described range, the satisfactory effect of improving the adhesive property by the underlayer 14 can be easily obtained. When the thickness of the underlayer 14 is equal to or smaller than the upper limit value of the above-described range, the frictional durability of the underlayer 14 itself increases.

Examples of methods for measuring the thickness of the underlayer 14 include a method for observing the cross section of the underlayer 14 with an electron microscope (such as SEM and TEM), a method using an optical interference thickness meter, a spectroscopic ellipsometer, a step gauge, or the like.

Specific examples of the method for forming the underlayer 14 include a method for vapor-depositing a vapor-deposition material having a desired composition for the underlayer 14 on the surface of the substrate 12.

Examples of the vapor-deposition method includes a vacuum vapor-deposition method. The vacuum vapor-deposition method is a method in which a vapor-deposition material is evaporated inside a vacuum tank and then is deposited on the surface of the substrate 12.

The temperature during the vapor-deposition (e.g., in the case where a vacuum deposition apparatus is used, the temperature of the boat on which the deposition material is placed) is preferably 100 to 3,000° C. and particularly preferably 500 to 3,000° C.

The pressure during the vapor-deposition (e.g., in the case where a vacuum deposition apparatus is used, the absolute pressure inside the tank in which the vapor-deposition material is placed) is preferably 1 Pa or lower, and particularly preferably 0.1 Pa or lower.

When the underlayer 14 is formed by using the vapor-deposition material, only one vapor-deposition material may be used, or two or more vapor-deposition materials containing different elements may be used.

Examples of methods for evaporating a vapor-deposition material include a resistive heating method in which the vapor-deposition material is melted and evaporated on a resistive heating boat made of metal having a high-melting point, and an electron gun method in which the surface of the vapor-deposition material is melted and evaporated by irradiating the vapor-deposition material with an electron beam and thereby directly heating it. The electron gun method is preferred as the method for evaporating a vapor-deposition material because it can locally heat the material and thereby to evaporate even a substance having a high melting point, and because the temperature of places which are not irradiated with the electron beam is low, so there is no risk of reaction with the container and no risk of contamination with impurities. The vapor-deposition material used for the electron gun method is preferably a molten granular material or a sintered material because they are less likely to be scattered even when an air current occurs.

The surface layer 22 on the underlayer 14 contains a condensate of the compound 1. The condensate of the compound 1 include one in which a hydrolyzable silyl group or the like in the compound 1 is hydrolyzed and a silanol group (Si—OH) is thereby formed, and then, the silanol group are condensation-reacted between molecules and a Si—O—Si bond is thereby formed, and one in which the silanol group in the compound 1 is condensation-reacted with a silanol group or a Si—OM group (where M is an alkali metal element) present on the surface of the underlayer 14, and an Si—O—Si bond is thereby formed. Further, the surface layer 22 may also contain a condensate of a compound other than the compound 1 contained in the surface treatment agent disclosed herein. The surface layer 22 may contain a compound containing a reactive silyl group in a state in which some of or all the reactive silyl groups of the compound are condensation-reacted.

The thickness of the surface layer 22 is preferably 1 to 100 nm, and particularly preferably 1 to 50 nm. When the thickness of the surface layer 22 is equal to or larger than the lower limit value in the above-described range, the effects by the surface layer 22 can be sufficiently obtained. When the thickness of the surface layer 22 is equal to or smaller than the upper limit value in the above-described range, the use efficiency becomes high.

The thickness of the surface layer 22 is one that is obtained by an X-ray diffractometer for a thin film analysis. The thickness of the surface layer 22 can be obtained by obtaining an interference pattern of a reflected X-ray by an X-ray reflectance method by using an X-ray diffractometer for a thin film analysis, and then calculating the thickness from the oscillation period of the obtained interference pattern.

Other examples of the article according to the present invention include a second article.

The second article is an article 20 including a substrate 10 with an underlayer and a surface layer 22 in this order, in which the substrate 10 with the underlayer contains an oxide containing silicon, and the surface layer 22 contains a condensate of the compound 1.

In the second article, since the substrate 10 with the underlayer has the composition of the underlayer 14 of the first article, the frictional durability of the surface layer 22 is excellent even when the surface layer 22 is directly formed on the substrate 10 with the underlayer. The material of the substrate 10 with the underlayer of the second article may be any material having the composition of the underlayer 14, and is, for example, a substrate or the like made of glass. Details of the material of the substrate 10 with the underlayer are similar to those of the substrate 12 and the underlayer 14, and therefore the descriptions thereof will be omitted. Further, since the structure of the surface layer 22 is similar to that of the first article, the description thereof will be omitted here.

Specific examples of the article according to the present invention include optical members, touch panels, antireflective films, antireflective glass, SiO₂-treated glass, tempered glass, sapphire glass, quartz substrates, and mold metals, which are used as parts of components of the below-shown products. Products: car navigation, cellular phones, digital cameras, digital video cameras, personal digital assistants (PDA), portable audio players, car audio, game apparatuses, eyeglass lenses, camera lenses, lens filters, sunglasses, medical apparatuses (such as stomach cameras), copiers, personal computers (PCs), liquid crystal displays, organic EL displays, plasma displays, touch panel displays, protective films, antireflective films, antireflective glass, nanoimprint templates, molds, and the like.

### [Method for Manufacturing Article]

A method for manufacturing an article according to the present invention is a method for forming a surface layer by a dry coating method or a wet coating method by using the compound 1 or the surface treatment agent disclosed herein.

The compound 1 and the surface treatment agent disclosed herein can be used as they are in a dry coating method, and are suitable for forming a surface layer having an excellent adhesive property by the dry coating method. Examples of dry coating methods include vacuum vapor-deposition, CVD, and sputtering. The vacuum vapor-deposition method can be suitably used because the decomposition of the surface treatment agent disclosed herein can be suppressed and because the apparatus is simple.

For the vacuum vapor-deposition, a pellet-like material in which the compound 1 or the like is supported in a metallic porous body made of a metal material such as iron or steel may be used. The pellet-like material in which the compound 1 or the like is supported can be manufactured by impregnating a metallic porous body with a solution containing the compound 1, and drying the porous body and thereby remove the liquid medium therefrom.

The surface treatment agent disclosed herein (coating liquid) containing a liquid medium can be suitably used for a wet coating method. Examples of wet coating methods include a spin coating method, a wipe coating method, a spray coating method, a squeegee coating method, a dip coating method, a die coating method, an inkjet method, a flow coating method, a roll coating method, a casting method, a Langmuir Blodgett method, and a gravure coating method.

In order to improve the frictional durability of the surface layer, an operation for promoting the reaction between the compound 1 and the substrate may be performed as required. Examples of such operations include heating, humidification, and light irradiation. For example, it is possible to, by heating a substrate including a surface layer formed there on in an atmosphere containing moisture, promote a hydrolysis reaction of a hydrolyzable group, a reaction between a hydroxyl group or the like present on the surface of the substrate with a silanol group, and a reaction such as formation of a siloxane bond by a condensation-reaction of a silanol group.

After the surface treatment, compounds in the surface layer that are not chemically bonded to other compounds or the substrate may be removed as required. Examples of specific methods include a method in which a solvent is poured over a surface layer, and a method in which a surface layer or the like is wiped with a cloth impregnated with a solvent.

### EXAMPLES

The present invention will be described hereinafter in detail by using examples. Examples 1 to 14 is an example according to the present disclosure, and Example 15 is a comparative example. Note that the present invention is not limited to these examples.

### Example 1

### <Synthesis of Compound X1>

10-undecenal (0.80 g) was dissolved in dichloromethane (5.0 g), and sulfur trifluoride (diethylamino) (2.2 g) was added. After stirring the mixture at a room temperature (25° C.) for 16 hours, water was added, and extraction was performed with dichloromethane.

0.74 g of a compound X1 was obtained by purifying it through flash column chromatography using silica gel (developing solvent: ethyl acetate/hexane).

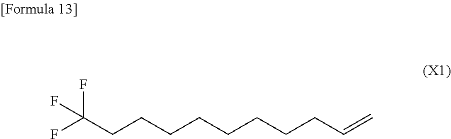

### (NMR Spectrum of Compound X1)

¹H-NMR (400 MHZ, CDCl₃) δ: 6.07-5.54 (m, 2H), 5.25-4.69 (m, 2H), 2.18-1.93 (m, 2H), 1.94-1.61 (m, 2H), 1.52-1.05 (m, 12H).

### <Synthesis of Compound 1-1>

0.55 g of a compound 1-1 was obtained by adding dichloromethane (10 g), a compound X1 (0.50 g), a toluene solution of a platinum/1,3-divinyl-1,1,3,3-tetramethyldisiloxane complex (platinum content: 3 mass %, 8.3 mg), aniline (2.6 mg), and trimethoxysilane (0.50 g), stirring the mixture at 40° C. for 2 hours, and then evaporating and removing the solvent under a reduced pressure.

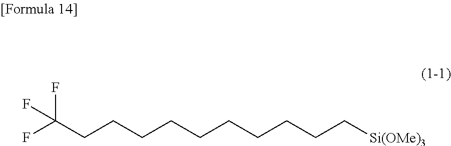

### (NMR Spectrum of Compound 1-1)

¹H-NMR (400 MHZ, CDCl₃) δ: 5.79 (tt, J=57.0, 4.6 Hz, 1H), 3.79-3.30 (m, 9H), 1.98-1.67 (m, 2H), 1.48-0.93 (m, 16H), 0.74-0.48 (m, 2H).

### Example 2

### <Synthesis of Compound X2>

A THF (tetrahydrofuran) solution (0.8M) of a compound X2 was obtained by a method disclosed in International Patent Publication No. WO 2021/054413.

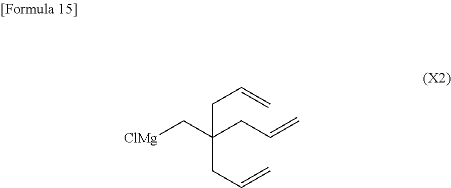

### <Synthesis of Compound X3>

11-bromo-1-undecanol (2.5 g) was dissolved in THF (10 g), copper (II) chloride (0.13 g) and a THF solution of a compound X2 (0.8M) (20 mL) were added thereto. Then, the mixture was stirred at a room temperature (25° C.) for 2 hours. Hydrochloric acid was added, and extraction was performed by using hexane.

2.9 g of a compound X3 was obtained by evaporating and removing the solvent, and then purifying it through flash column chromatography using silica gel (developing solvent: ethyl acetate/hexane).

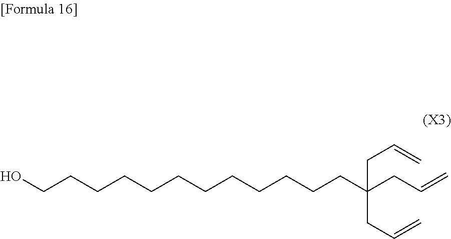 [SMILES: C=CCC(CC=C)(CC=C)CCCCCCCCCCCCO]

### (NMR Spectrum of Compound X3)

¹H-NMR (400 MHZ, CDCl₃) δ: 5.95-5.68 (m, 3H), 5.18-4.90 (m, 6H), 3.64 (t, J=6.6 Hz, 2H), 1.98 (dt, J=7.3, 1.3 Hz, 6H), 1.62-1.50 (m, 2H), 1.40-1.05 (m, 20H).

### <Synthesis of Compound X4>

The compound X3 (1.5 g) was dissolved in dichloromethane (10 g), and Dess-Martin Periodinane (2.9 g) was added thereto. Then, the mixture was stirred at a room temperature (25° C.) for 2 hours. 0.49 g of a compound X4 was obtained by, after the filtration, evaporating and removing the solvent, and purifying it through flash column chromatography using silica gel (developing solvent: ethyl acetate/hexane).

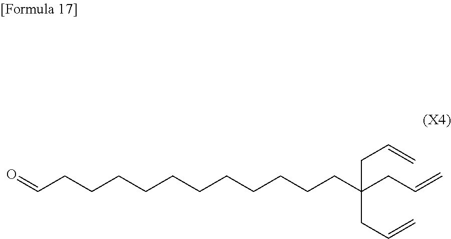 [SMILES: C=CCC(CC=C)(CC=C)CCCCCCCCCCCC=O]

### (NMR Spectrum of Compound X4)

¹H-NMR (400 MHZ, CDCl₃) δ: 9.76 (t, J=1.9 Hz, 1H), 5.80 (ddt, J=16.6, 10.5, 7.4 Hz, 3H), 5.21-4.86 (m, 6H), 2.42 (td, J=7.3, 1.9 Hz, 2H), 1.98 (dt, J=7.4, 1.3 Hz, 6H), 1.75-1.49 (m, 2H), 1.46-1.03 (m, 18H).

### <Synthesis of Compound X5>

The compound X4 (0.49 g) was dissolved in dichloromethane (10 g), and (diethylamino)trifluorosulfur (0.88 g) was added thereto. Then the mixture was stirred at a room temperature (25° C.) for 2 hours. 0.39 g of a compound X5 was obtained by evaporating and removing the solvent, and then purifying it through flash column chromatography using silica gel (developing solvent: ethyl acetate/hexane).

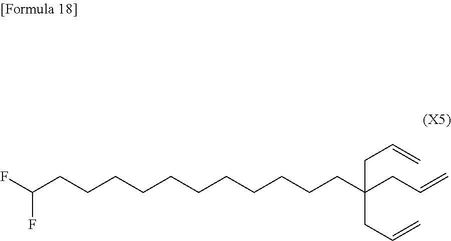 [SMILES: C=CCC(CC=C)(CC=C)CCCCCCCCCCCC(F)F]

### (NMR Spectrum of Compound X5)

¹H-NMR (400 MHZ, CDCl₃) δ: 6.06-5.50 (m, 4H), 5.21-4.84 (m, 6H), 1.98 (dt, J=7.4, 1.3 Hz, 6H), 1.89-1.66 (m, 2H), 1.51-1.00 (m, 20H).

### <Synthesis of Compound 1-2>

0.51 g of a compound 1-2 was obtained in a manner similar to that for the synthesis of the compound 1-1, except that the compound X5 (0.36 g) was used instead of the compound XI (0.50 g).

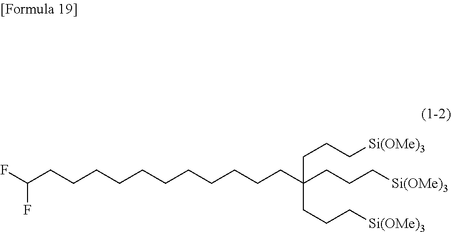

### (NMR Spectrum of Compound 1-2)

¹H-NMR (400 MHZ, CDCl₃) δ: 5.79 (t, J=4.6 Hz, 1H), 3.57 (s, 27H), 1.53-0.98 (m, 34H), 0.74-0.44 (m, 6H).

### Example 3

### <Synthesis of Compound X6>

The compound X3 (0.50 g) was dissolved in dichloromethane (10 g), and sulfur trifluoride (diethylamino) (0.92 g) was added thereto. Then the mixture was stirred at a room temperature (25° C.) for 2 hours. 0.39 g of a compound X6 was obtained by evaporating and removing the solvent, and then purifying it through flash column chromatography using silica gel (developing solvent: ethyl acetate/hexane).

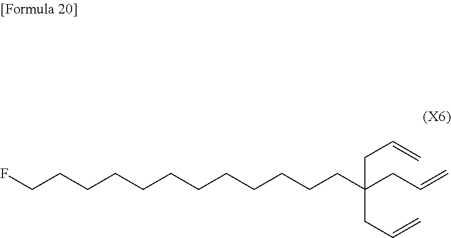 [SMILES: C=CCC(CC=C)(CC=C)CCCCCCCCCCCCF]

### (NMR Spectrum of Compound X6)

¹H-NMR (400 MHZ, CDCl₃) δ: 5.81 (ddt, J=16.6, 10.5, 7.4 Hz, 3H), 5.14-4.93 (m, 6H), 4.44 (dt, J=47.4, 6.2 Hz, 2H), 1.98 (dt, J=7.5, 1.2 Hz, 6H), 1.68 (ddt, J=24.9, 8.2, 6.3 Hz, 2H), 1.49-0.97 (m, 20H).

### <Synthesis of Compound 1-3>

0.54 g of a compound 1-3 was obtained in a manner similar to that for the synthesis of the compound 1-1, except that the compound X6 (0.36 g) was used instead of the compound X1 (0.50 g).

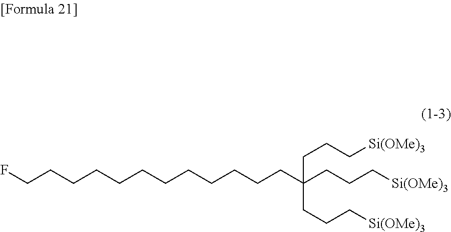

(NMR spectrum of the compound 1-3)

¹H-NMR (400 MHZ, CDCl₃) δ: 4.44 (dt, J=47.4, 6.2 Hz, 2H), 3.57 (s, 27H), 1.77-1.50 (m, 2H), 1.50-1.00 (m, 32H), 0.69-0.48 (m, 6H).

### Example 4

### <Synthesis of Compound X7>

A compound X7 was obtained according to a method disclosed in International Patent Publication No. WO2021/054413.

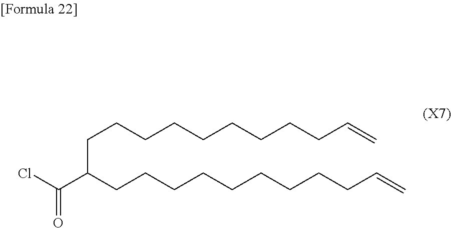 [SMILES: C=CCCCCCCCCCC(CCCCCCCCCC=C)C(=O)Cl]

### <Synthesis of Compound X8>

The compound X7 (0.32 g) was dissolved in dichloromethane (10 g), and (2-(pentafluorosulfanyl) ethane-1-ol (0.11 g) and triethylamine (0.50 g) were added thereto. Then, the mixture was stirred at a room temperature (25° C.) for 2 hours. 0.27 g of a compound X8 was obtained by evaporating and removing the solvent, and then purifying it through flash column chromatography using silica gel (developing solvent: ethyl acetate/hexane).

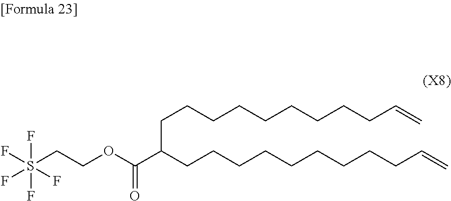 [SMILES: C=CCCCCCCCCCC(CCCCCCCCCC=C)C(=O)OCCS(F)(F)(F)(F)F]

### (NMR Spectrum of Compound X8)

¹H-NMR (400 MHZ, CDCl₃) δ: 5.95-5.67 (m, 2H), 5.05-4.84 (m, 4H), 4.48 (ddt, J=6.3, 5.0, 1.3 Hz, 2H), 3.90 (pt, J=8.0, 5.8 Hz, 2H), 2.46-2.27 (m, 1H), 2.12-1.92 (m, 4H), 1.70-0.66 (m, 32H).

### <Synthesis of Compound 1-4>

0.36 g of a compound 1-4 was obtained in a manner similar to that for the synthesis of the compound 1-1, except that the compound X8 (0.25 g) was used instead of the compound X1 (0.50 g).

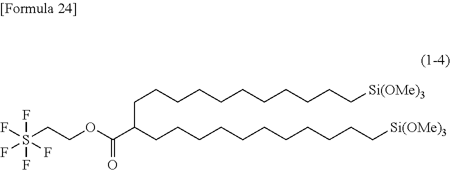

### (NMR Spectrum of Compound 1-4)

¹H-NMR (400 MHZ, CDCl₃) δ: 4.44 (ddt, J=6.4, 5.2, 1.3 Hz, 2H), 3.85 (tt, J=8.1, 5.9 Hz, 2H), 3.66-3.33 (m, 18H), 2.41-2.22 (m, 1H), 1.76-1.00 (m, 40H), 0.68-0.54 (m, 4H).

### Example 5

### <Synthesis of Compound X9>

The compound X7 was dissolved in dichloromethane (10 g), and 3,3,3-trifluoro-1-propanol (0.30 g) and triethylamine (0.50 g) were added thereto. Then, the mixture was stirred at a room temperature (25° C.) for 2 hours. 0.48 g of a compound X9 was obtained by evaporating and removing the solvent, and purifying it through flash column chromatography using silica gel (developing solvent: ethyl acetate/hexane).

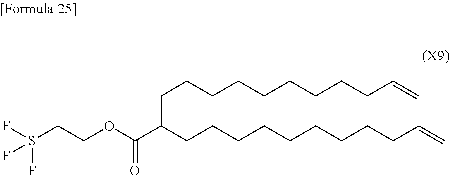 [SMILES: C=CCCCCCCCCCC(CCCCCCCCCC=C)C(=O)OCCS(F)(F)F]

### (NMR Spectrum of Compound X9)

¹H-NMR (400 MHZ, CDCl₃) δ: 5.74 (ddt, J=16.9, 10.2, 6.7 Hz, 2H), 5.03-4.75 (m, 4H), 4.22 (t, J=6.3 Hz, 2H), 2.39 (qt. J=10.5, 6.4 Hz, 2H), 2.30-2.16 (m, 1H), 2.05-1.86 (m, 4H), 1.62-0.96 (m, 32H).

### <Synthesis of Compound 1-5>

0.52 g of a compound 1-5 was obtained in a manner similar to that for the synthesis of the compound 1-1, except that the compound X9 (0.40 g) was used instead of the compound XI (0.50 g).

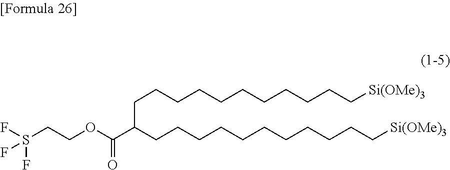

### (NMR Spectrum of Compound 1-5)

¹H-NMR (400 MHZ, CDCl₃) δ: 4.25 (t, J=6.3 Hz, 2H), 3.75-3.23 (m. 18H), 2.41 (qt, J=10.5, 6.3 Hz, 2H), 2.35-2.23 (m, 1H), 1.68-0.89 (m, 40H), 0.68-0.50 (m, 4H).

### Example 6

### <Synthesis of Compound X10>

A mixture of the compound X3 (3.0 g) and N,N-dimethylformamide (10 mL) was cooled in an ice bath, and phosphorus tribromide (1.1 mL) was added thereto. Then, after stirring the mixture for 2 hours, hexane and ion-exchanged water were successively added to the reaction mixture. Then, extraction was performed by using hexane, and the organic layer was washed with water and saturated saline, and dried with magnesium sulfate. 3.4 g of a compound X10 was obtained by filtering the solid, and evaporating and removing the solvent under a reduced pressure.

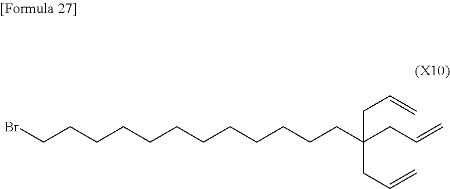 [SMILES: C=CCC(CC=C)(CC=C)CCCCCCCCCCCCBr]

### (NMR Spectrum of Compound X10)

¹H-NMR (400 MHZ, CDCl₃) δ: 5.77-5.60 (m, 3H), 5.24-4.90 (m, 6H), 3.42 (t, J=4.7 Hz, 2H), 1.91-1.81 (m, 6H). 1.80-1.70 (m, 2H). 1.52-1.21 (m, 20H).

### <Synthesis of Compound X11>

Trifluoro methane trifluoromethyl sulfonate (3.0 mL) was added to a mixture of silver fluoride (I) (1.3 g) and acetonitrile (20 mL) at −30° C. under a nitrogen atmosphere, and the mixture was stirred at −30° C. for 2 hours. The compound X10 (3.4 g) was added to the reaction mixture at −30° C., and the mixture was stirred at a room temperature (25° C.) for 16 hours. Hexane and ion-exchanged water were successively added to the reaction solution, and then the solution was separated and the organic layer was separated. 1.2 g of a compound X11 was obtained by evaporating and removing the solvent and low-boiling components under a reduced pressure, and then purifying it through flash column chromatography using silica gel (developing solvent: hexane/ethyl acetate).

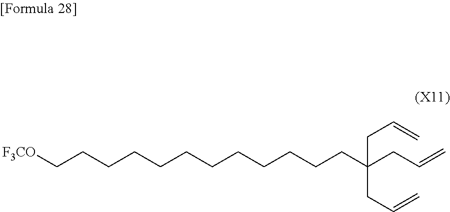 [SMILES: C=CCC(CC=C)(CC=C)CCCCCCCCCCCCOC(F)(F)F]

### (NMR Spectrum of Compound X11)

¹H-NMR (400 MHZ, CDCl₃) δ: 5.70 (ddt, J=16.8, 11.3, 7.4 Hz, 3H), 5.20-4.92 (m, 6H), 3.66-3.47 (m, 2H), 1.92-1.81 (m, 6H), 1.67 (tt, J=8.9, 6.7 Hz, 2H), 1.42-1.19 (m, 20H).

### <Synthesis of Compound 1-6>

2.6 g of a compound 1-6 was obtained in a manner similar to that for the synthesis of the compound 1-1, except that the compound X11 (1.4 g) was used instead of the compound X1.

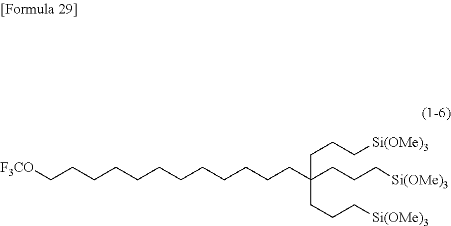

### (NMR Spectrum of Compound 1-6)

¹H-NMR (400 MHZ, CDCl₃) δ: 3.66-3.51 (m, 29H), 1.67 (tt, J=8.9, 6.7 Hz, 2H), 1.48-1.20 (m, 32H), 0.73-0.64 (m, 6H).

### Example 7

### <Synthesis of Compound X12>

The compound X3 (1.5 g) was added to a mixture of trifluoromethane thiol silver (I) (2.3 g), tetrabutylammonium iodide (12 g), and toluene (30 mL) under a nitrogen atmosphere at a room temperature (25° C.), and the mixture was stirred at 80° C. for 16 hours. 0.85 g of a compound X12 was obtained by filtering the reaction mixture by celite, evaporating and removing the solvent and low-boiling components under a reduced pressure, and then purifying it through flash column chromatography using silica gel (developing solvent: hexane/ethyl acetate).

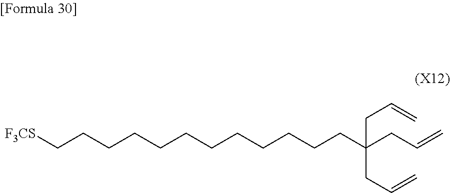

### (NMR Spectrum of Compound X12)

¹H-NMR (400 MHZ, CDCl₃) δ: 5.70 (ddt, J=16.8, 11.3, 7.4 Hz, 3H), 5.23-4.87 (m, 6H), 2.86-2.69 (m, 2H), 1.85 (dt, J=7.3, 1.5 Hz, 6H), 1.73-1.56 (m, 2H), 1.44-1.18 (m, 20H).

### <Synthesis of Compound 1-7>

1.5 g of a compound 1-7 was obtained in a manner similar to that for the synthesis of the compound 1-1, except that the compound X12 was used instead of the compound XI.

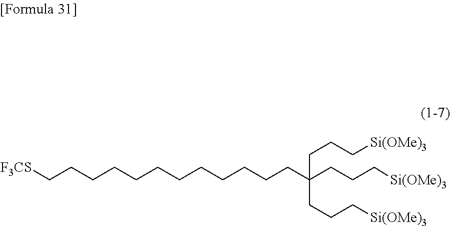

### (NMR Spectrum of Compound 1-7)

¹H-NMR (400 MHZ, CDCl₃) δ: 3.58 (s, 27H), 2.83-2.74 (m, 2H), 1.70-1.58 (m. 2H), 1.53-1.14 (m, 32H), 0.73-0.63 (m, 6H).

### Example 8

### <Synthesis of Compound X13>

A mixture of the compound X3 (3.0 g) and pyridine (20 mL) was cooled in an ice bath, and anhydrous trifluoromethanesulfonic acid (1.9 mL) was added thereto. After the mixture was stirred for 1 hour, hexane and ion-exchanged water were successively added to the reaction mixture. Then, extraction was performed by using hexane, and the organic layer was washed with water and saturated saline, and dried with magnesium sulfate. 3.9 g of a compound X13 was obtained by filtering the solid, and evaporating and removing the solvent under a reduced pressure. The compound X13 was used as it was in the next reaction without purifying it.

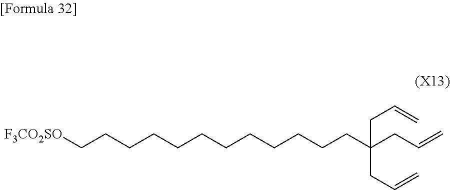

### <Synthesis of Compound X14>

Rubidium fluoride (1.0 g) was suspended in acetonitrile (10 mL) under a nitrogen atmosphere, and N,N-bis(trifluoromethyl)trifluoromethanesulfonamide (3.2 g) was slowly dropped (i.e., added). Then, the mixture was stirred for 1 hour. A crude product of the compound X13 (3.9 g) was slowly added to the reaction mixture at a room temperature (25° C.), and the mixture was stirred at a room temperature (25° C.) for 2 hours. The reaction mixture was poured into ice water, and extraction was performed by using hexane. Then, the organic layer was washed with water and saturated saline, and dried with magnesium sulfate. 3.5 g of a compound X14 was obtained by filtering the solid, evaporating and removing the solvent under a reduced pressure, and purifying it through flash column chromatography using silica gel (developing solvent: hexane/ethyl acetate).

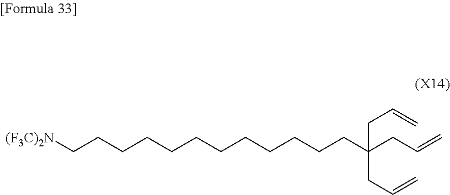

### (NMR Spectrum of Compound X14)

¹H-NMR (400 MHZ, CDCl₃) δ: 5.70 (ddt, J=16.8, 11.3, 7.4 Hz, 3H), 5.20-4.92 (m, 6H), 2.87-2.74 (m, 2H), 1.93-1.80 (m, 6H), 1.68-1.53 (m, 2H), 1.39-1.20 (m, 20H).

### <Synthesis of Compound 1-8>

1.8 g of a compound 1-8 was obtained in a manner similar to that for the synthesis of the compound 1-1, except that the compound X14 (1.0 g) was used instead of the compound X1.

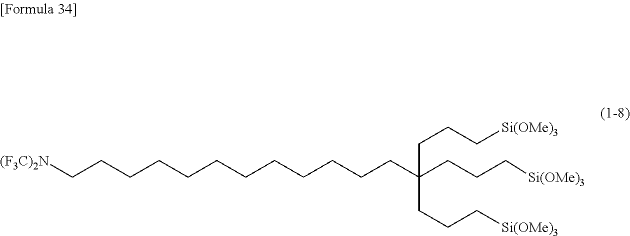

### (NMR Spectrum of Compound 1-8)

¹H-NMR (400 MHZ, CDCl₃) δ: 3.58 (s, 27H), 2.86-2.69 (m, 2H), 1.67-1.52 (m, 2H), 1.49-1.11 (m, 32H), 0.74-0.63 (m. 6H).

### Example 9

### Synthesis of 4-methylbenzenesulfonate 2-(pentafluoro-λ⁶-sulfanyl)ethyl

Paratoluenesulfonic acid chloride (4.1 g) was added to a stirred solution of 2-(pentafluoro-λ⁶-sulfanyl) ethane-1-ol (2.6 g), dichloromethane (15 mL), and pyridine (2.7 mL) little by little over 5 minutes at 0° C. Then, the mixture was stirred for 15 hours while restoring the temperature to a room temperature (25° C.). After the reaction, diethyl ether (45 mL) and H₂O (10 mL) were added, and the organic layer was washed with hydrochloric acid (10%; 2.0 mL), saturated NaHCO₃ aqueous solution (2.0 mL), and ion-exchanged water (2.0 mL). 3.9 g of 4-methylbenzenesulfonate 2-(pentafluoro-λ⁶-sulfanyl) ethyl (see below-shown formula) was obtained by evaporating and removing the solvent and low-boiling components under a reduced pressure, and then purifying it through flash column chromatography using silica gel (developing solvent: hexane/ethyl acetate).

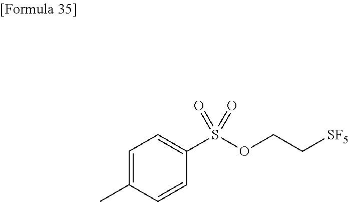

### NMR Spectrum of 4-methylbenzenesulfonate 2-(pentafluoro-λ⁶-sulfanyl)ethyl

¹H NMR (400 MHZ, CDCl₃) δ 7.65-7.59 (m, 2H), 7.49-7.43 (m, 2H), 4.25 (ddq, J=12.1, 10.4, 1.7 Hz, 2H), 3.50 (qt, J=20.3, 12.2 Hz, 2H), 2.39 (s, 3H).

### <Synthesis of Compound X15>

100 mL of a THE solution of Grignard reagent (1.0M) was obtained by heating and refluxing 4,4-diallyl-14-bromotetradeca-1-ene (36 g), which was synthesized in a manner similar to that for the compound X10, and magnesium (4.8 g) in THE under a nitrogen atmosphere for 15 hours, and performing cannular transfer. 4-methylbenzenesulfonate 2-(pentafluoro-λ⁶-sulfanyl) ethyl (2.5 g) was dissolved in THF (10 g), and copper (11) chloride (0.13 g) and the above-described THE solution of the Grignard reagent (1.0M) (20 mL) were added. Then, the mixture was stirred at a room temperature (25° C.) for 2 hours. Hydrochloric acid was added, and extraction was performed by using hexane. 2.6 g of a compound X15 was obtained by evaporating and removing the solvent, and purifying it through flash column chromatography using silica gel (developing solvent: ethyl acetate/hexane).

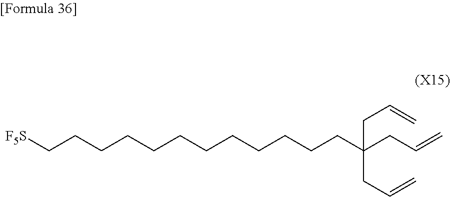

### (NMR Spectrum of Compound X15)

¹H NMR (400 MHZ, CDCl₃) δ 5.95-5.68 (m, 3H), 5.18-4.90 (m, 6H), 4.99 (dq, J=11.3, 1.4 Hz, 2H), 3.23 (m, 2H), 1.98 (dt, J=7.3, 1.3 Hz, 6H), 1.62-1.50 (m, 2H), 1.25 (h, J=13.1, 11.1 Hz, 20H).

### <Synthesis of Compound 1-9>

0.6 g of a compound 1-9 was obtained by adding dichloromethane (10 g), the compound X15 (0.50 g), a xylene solution of platinum/1,3-divinyl-1,1,3,3-tetramethyldisiloxane complex (platinum content: 3%, 8.3 mg), aniline (2.6 mg), and trimethoxysilane (1.0 g), stirring the mixture at 40° C. for 2 hours, and then evaporating and removing the solvent under a reduced pressure.

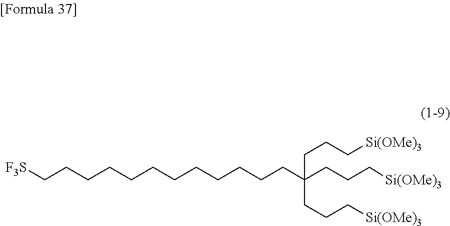

### (NMR Spectrum of Compound 1-9)

¹H NMR (400 MHZ, CDCl₃) δ 4.99 (dq, J=11.3, 1.4 Hz, 2H), 3.57 (s, 27H), 1.53-0.98 (m, 34H), 0.74-0.44 (m, 6H).

### Example 10

### Synthesis of 2-((2s,3R,4s,5S)-perfluorocuban-1-yl) ethane-1-ol

THF (32 mL) and (2R,3s,4S,5s)-1,2,3,4,5,6,7-heptafluoro-8-vinylcubane (1.6 g, 3.22 mmol) were cooled to 0° C., and 9-borabicyclo [3.3.1] nonane (25 mL, 0.5M in THF) was added thereto. Then the mixture was stirred for 14 hours while restoring the temperature to a room temperature (25° C.). 1.5 g of 2-((2s, 3R, 4s, 5S)-perfluorocuban-1-yl) ethane-1-ol (see below-shown formula) was obtained by, after the reaction, adding a separately prepared NaBO₃ aqueous solution [boric acid (10 g), 3N NaOH (150 mL), 30% hydrogen peroxide (16 mL)], stirring the mixture for 10 minutes, adding 2N HCl (160 mL), stirring the mixture for 1 hour, extracting the reaction product by dichloromethane, evaporating and removing the solvent, and purifying it through flash column chromatography using silica gel (developing solvent: ethyl acetate/hexane).

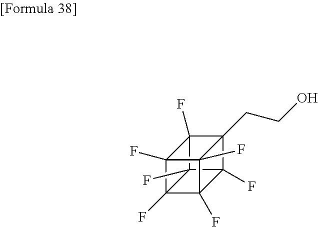 [SMILES: OCCC12C3(F)C4(F)C5(F)C3(F)C1(F)C5(F)C42F]

### NMR Spectrum of 2-((2s, 3R,4s,5S)-perfluorocuban-1-yl) ethane-1-ol

¹H NMR (400 MHZ, CDCl₃) δ 3.77 (dt, J=4.6, 1.6 Hz, 2H), 3.27 (t, J=4.6 Hz, 1H), 2.25 (qt, J=3.1, 1.6 Hz, 2H).

### Synthesis of 4-methylbenzenesulfonate 2-((2s, 3R,4s,5S)-perfluorocuban-1-yl)ethyl

2.0 g of 4-methylbenzenesulfonate 2-((2s,3R,4s,5S)-perfluorocuban-1-yl) ethyl (see below-shown formula) was obtained in a manner similar to that for the synthesis of 4-methylbenzenesulfonate 2-(pentafluoro-λ⁶-sulfanyl) ethyl, except that 1.5 g of 2-((2s, 3R, 4s, 5S)-perfluorocuban-1-yl) ethane-1-ol was used instead of 2-(pentafluoro-λ⁶-sulfanyl) ethane-1-ol.

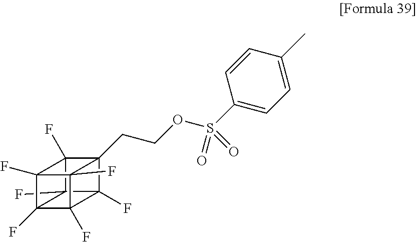 [SMILES: Cc1ccc(S(=O)(=O)OCCC23C4(F)C5(F)C6(F)C4(F)C2(F)C6(F)C53F)cc1]

### NMR Spectrum of 4-methylbenzenesulfonate 2-((2s, 3R,4s,5S)-perfluorocuban-1-yl)ethyl

¹H NMR (400 MHZ, CDCl₃) δ 7.65-7.59 (m, 2H), 7.49-7.43 (m, 2H), 4.34 (t, J=2.5 Hz, 2H), 2.45 (dtd, J=5.5, 3.1, 2.4 Hz, 2H), 2.39 (s, 3H).

### <Compound X16>

2.2 g of a compound X16 was obtained in a manner similar to that for the synthesis of the compound X15, except that 2.0 g of 4-methylbenzenesulfonate 2-((2s, 3R, 4s, 5S)-perfluorocuban-1-yl) ethyl was used instead of 4-methylbenzenesulfonate 2-(pentafluoro-λ⁶-sulfanyl)ethyl.

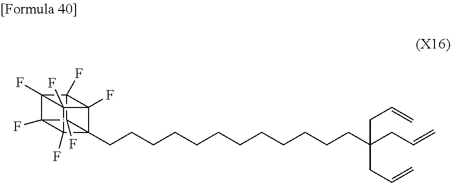 [SMILES: C=CCC(CC=C)(CC=C)CCCCCCCCCCCCC12C3(F)C4(F)C5(F)C3(F)C1(F)C5(F)C42F]

### (NMR Spectrum of Compound X16)

¹H NMR (400 MHz, CDCl₃) δ 6.06-5.50 (m, 3H), 5.21-4.84 (m, 6H), 2.45 (dtd, J=5.5, 3.1, 2.4 Hz, 2H), 1.98 (dt, J=7.4, 1.3 Hz, 6H), 1.34-1.21 (m, 22H).

### <Synthesis of Compound 1-10>

0.60 g of a compound 1-10 was obtained by adding dichloromethane (10 g), the compound X16 (0.60 g), a xylene solution of platinum/1,3-divinyl-1,1,3,3-tetramethyldisiloxane complex (platinum content: 3%, 8.3 mg), aniline (2.6 mg), and trimethoxysilane (1.0 g), stirring the mixture at 40° C. for 2 hours, and then evaporating and removing the solvent under a reduced pressure.

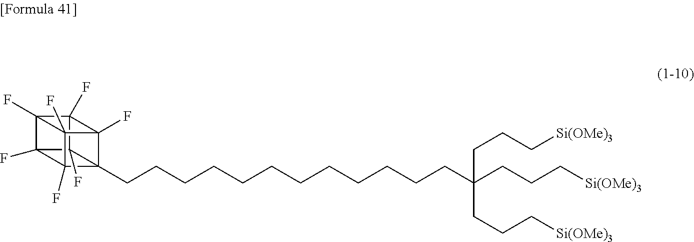

### (NMR Spectrum of Compound 1-10)

¹H NMR (400 MHZ, CDCl₃) δ 3.58 (s, 27H), 2.45 (tq, J=6.5, 3.3 Hz, 2H), 1.53-0.98 (m, 34H), 0.74-0.44 (m, 6H).

### Example 11

### <Synthesis of Compound X17>

11 g of a compound X17 was obtained in a manner similar to that for the synthesis of the compound X11, except that 18-bromo-1-octadecene (20 g) was used instead of the compound X10.

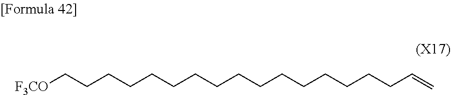 [SMILES: C=CCCCCCCCCCCCCCCCCOC(F)(F)F]

### (NMR Spectrum of Compound X17)

¹H-NMR (400 MHZ, CDCl₃) δ: 5.79 (m, 1H), 4.95 (m, 2H), 3.96 (t, 2H), 2.06 (m, 2H), 1.68 (m, 2H), 1.42-1.17 (m, 26H).

### <Synthesis of Compound 1-11>

2.0 g of a compound 1-11 was obtained in a manner similar to that for the synthesis of the compound 1-1, except that the compound X17 (1.5 g) was used instead of the compound X1.

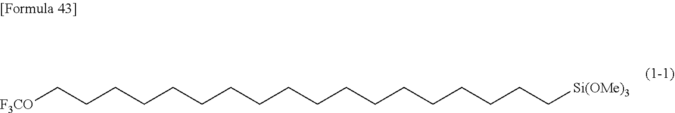

<NMR spectrum of Compound 1-11>

¹H-NMR (400 MHZ, CDCl₃) δ: 3.95 (t, 2H), 3.7 (s, 9H), 1.68 (m, 2H), 1.51-1.19 (m, 30H), 0.66 (m, 2H).

### Example 12

### <Synthesis of Compound X18>

Bis(cyclopentadienyl) zirconium (IV) chloride hydride (6.5 g) was added to a solution (100 mL) obtained by dissolving the compound X17 (8 g) in dichloromethane (100 mL), and the mixture was stirred at a room temperature (25° C.) for 4 hours. Iodine (6.7 g) was added to the obtained suspension, and the mixture was stirred at a room temperature (25° C.) for 1 hour. A sodium thiosulfate aqueous solution was added to the obtained reaction solution at a room temperature (25° C.), and extraction was performed by using hexane. Then, the organic layer was washed with water and saturated saline, and dried with magnesium sulfate. 10 g of a compound X18 was obtained as a light-yellow solid by filtering the solid and evaporating and removing the solvent under a reduced pressure.

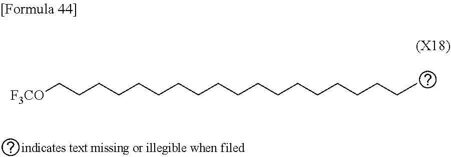 [SMILES: CCCCCCCCCCCCCCCCCCCOC(F)(F)F]

### (NMR Spectrum of Compound X18)

¹H-NMR (400 MHZ, CDCl₃) δ: 3.95 (t, 2H), 3.19 (t, J=5.6 Hz, 2H), 1.91-1.62 (m, 4H), 1.42-1.20 (m, 28H).

### <Synthesis of Compound X19>

The compound X18 (2.5 g) was dissolved in THF (30 g), and a THF solution of copper (II) chloride (0.53 g) and 11-bromo-1-undecenylmagnesium bromide (0.5M, 32 mL) was added thereto. Then the mixture was stirred at a room temperature (25° C.) for 2 hours. Hydrochloric acid was added, and extraction was performed by using hexane. 1.4 g of a compound X19 was obtained by evaporating and removing the solvent, and purifying it through flash column chromatography using silica gel (developing solvent: ethyl acetate/hexane).

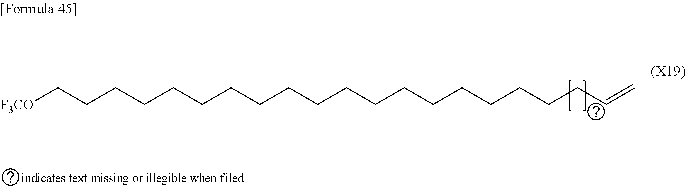

### (NMR Spectrum of Compound X19)

¹H-NMR (400 MHZ, CDCl₃) δ: 5.79 (m, 1H), 4.95 (m, 2H), 3.96 (t, 2H), 2.06 (m, 2H), 1.68 (m, 2H), 1.41-1.14 (m, 48H).

<Synthesis of Compound 1-12 1.6 g of a compound 1-12 was obtained in a manner similar to that for the synthesis of the compound 1-1, except that the compound X19 (1.4 g) was used instead of the compound X1.

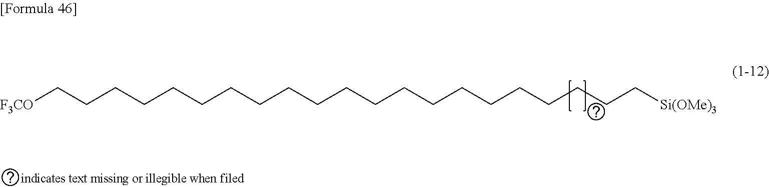

### (NMR Spectrum of Compound 1-12)

¹H-NMR (400 MHZ, CDCl₃) δ: 3.95 (t, 2H), 3.7 (s, 9H), 1.68 (m, 2H), 1.51-1.18 (m, 52H), 0.66 (m, 2H).

### Example 13

### <Synthesis of Compound X20>

1.2 g of a compound X20 was obtained in a manner similar to that for the synthesis of the compound X19, except that a THF solution of 18-bromo-1-octadecenylmagnesium bromide (0.3M, 54 mL) was used instead of the THF solution of 11-bromo-1-undecenylmagnesium bromide (0.5M).

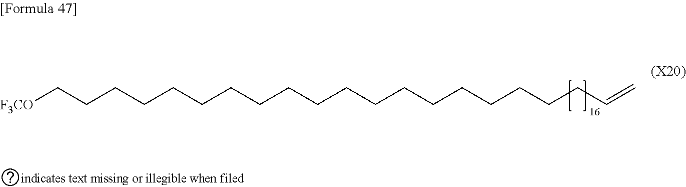

### (NMR Spectrum of Compound X20)

¹H-NMR (400 MHZ, CDCl₃) δ: 5.79 (m, 1H), 4.95 (m, 2H), 3.96 (t, 2H), 2.06 (m, 2H), 1.68 (m, 2H), 1.43-1.16 (m, 62H).

### <Synthesis of Compound 1-13>

1.4 g of a compound 1-13 was obtained in a manner similar to that for the synthesis of the compound 1-1, except that the compound X20 (1.2 g) was used instead of the compound X1.

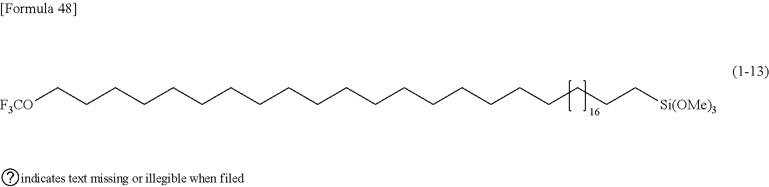

### (NMR Spectrum of Compound 1-13)

¹H-NMR (400 MHZ, CDCl₃) δ: 3.95 (t, 2H), 3.7 (s, 9H), 1.68 (m, 2H), 1.52-1.17 (m, 66H), 0.66 (m, 2H).

### Example 14

### <Synthesis of Compound X21>

1.1 g of a compound X21 was obtained in a manner similar to that for the synthesis of the compound X3, except that the compound X18 (2.5 g) was used instead of 11-bromo-1-undecanol.

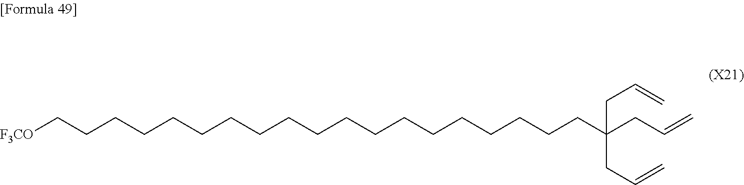 [SMILES: C=CCC(CC=C)(CC=C)CCCCCCCCCCCCCCCCCCCOC(F)(F)F]

### (NMR Spectrum of Compound X21)

¹H-NMR (400 MHz, CDCl₃) δ: 5.80-5.56 (m, 3H), 5.25-4.89 (m, 6H), 3.95 (t, 2H), 1.85 (d, J=7.3 Hz, 6H), 1.73-1.57 (m, 2H), 1.46-1.12 (m, 34H).

### <Synthesis of Compound 1-14>

1.8 g of a compound 1-14 was obtained in a manner similar to that for the synthesis of the compound 1-1, except that the compound X21 (1.1 g) was used instead of the compound X1.

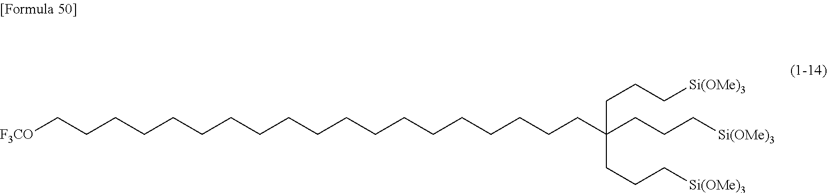

### (NMR Spectrum of Compound 1-14)

¹H-NMR (400 MHZ, CDCl₃) δ: 3.95 (t, 2H), 3.62-3.51 (m, 27H), 1.72-1.59 (m, 2H), 1.49-1.16 (m, 46H), 0.73-0.64 (m, 6H).

### Example 15

A compound C₁-1 was obtained according to a method described in Synthesis Example 1 in Japanese Unexamined Patent Application Publication No. 2017-119849.

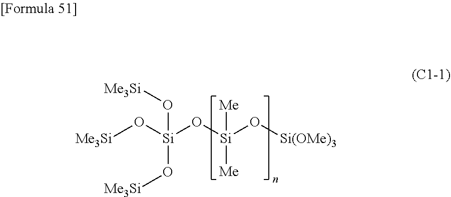

### [Manufacture of Article]

30 g of silicon oxide was placed as a vapor-deposition source on a copper hearth in a vacuum vapor-deposition apparatus (VTR-350M manufactured by ULVAC, Inc.). A glass substrate was placed in the vacuum vapor-deposition apparatus, and the inside of the vacuum vapor-deposition apparatus was evacuated to a pressure of 5×10⁻³ Pa or lower. A substrate with a silicon oxide layer having a thickness of about 20 nm was prepared by heating the above-described hearth to about 2,000° C., and vapor-depositing silicon oxide on the surface of the substrate in a vacuum.

The substrate with the silicon oxide layer was placed on a sample stage of a spray coater (API-90RS manufactured by Apeiros Co, Ltd.) in such a manner that the silicon oxide layer face upward. Next, for each of the above-described examples, 13 g of a heptane solution containing 0.2 mass % of the compound obtained in the example was charged into a syringe in a spray coater, and spray-coated at an atomization pressure of 130 kPa, a distance of 50 mm between the nozzle and the sample surface, and a scanning speed of 300 mm/sec (wet coating method). After that, the substrate with the silicon oxide layer, of which the surface had been coated with the compound, was heat-treated at 140° C. for 30 minutes, and by doing so, an evaluation sample (article), in which the substrate, the silicon oxide layer, and the surface layer had been laminated in this order, was obtained.

### Evaluation

The below-shown evaluations were made by using the obtained articles. The results of the evaluation tests are shown in Table 78.

### <Initial Water Contact Angle>

About 2 μL of distilled water was dropped on the surface layer of the article, and the initial water contact angle was measured by using a contact angle measuring apparatus (Product Name: DM-500, manufactured by Kyowa Interface Science Co., Ltd.). Measurements were made at five different points on the surface layer, and their average value was calculated. Note that a 2θ method was used for the calculation of water contact angles.

### <Friction Durability>

Friction durability tests were carried out by using a 3-consecutive-stage plane abrasion tester (Product Name “PA-300 A”, manufactured by DAIEI KAGAKU SEIKI MFG. co., ltd.) and using a 6 mmφ eraser manufactured by minoan under an atmosphere of 24° C. and 40% RH under conditions of a load of 1,000 g, a rotation speed of 40 rpm, and a frictional condition of a stroke length of 40 mm. A water contact angle was measured after 1,000 reciprocating frictional movements. The method for measuring a water contact angle after the friction was the same as that for the initial water contact angle.

The smaller the decrease in water repellency (water contact angle) after the friction is, the smaller the decrease in performance due to the friction is, and the more excellent the frictional durability is.

The evaluation criteria are as follows.
AA (Excellent): Decrease in water contact angle after 1,000 reciprocating movements is 2 degrees or smaller.
A (Good): Decrease in water contact angle after 1,000 reciprocating movements is larger than 2 degrees and smaller than 5 degrees.
B (Acceptable): Decrease in water contact angle after 1,000 reciprocating movements is larger than 5 degrees and smaller than 10 degrees.
C (Unacceptable): Decrease in water contact angle after 1.000 reciprocating movements is larger than 10 degrees.

TABLE 78

Evaluation Result

| | | Initial Water | |
|---|---|---|---|
| | Type of | Contact Angle | Friction |
| | Compound | (Degree) | Durability |
| Example 2 | 1-2 | 84 | AA |
| Example 3 | 1-3 | 83 | AA |
| Example 4 | 1-4 | 85 | AA |
| Example 5 | 1-5 | 85 | AA |
| Example 6 | 1-6 | 88 | AA |
| Example 7 | 1-7 | 88 | AA |
| Example 8 | 1-8 | 88 | AA |
| Example 9 | 1-9 | 90 | AA |
| Example 10 | 1-10 | 88 | AA |
| Example 11 | 1-11 | 98 | AA |
| Example 12 | 1-12 | 102 | AA |
| Example 13 | 1-13 | 102 | AA |
| Example 14 | 1-14 | 90 | AA |
| Example 15 | C1-1 | 105 | C |

As shown in Table 78, it was confirmed that each of the compounds obtained in Examples 1 to 14 can form a surface layer excellent in frictional durability.

### INDUSTRIAL APPLICABILITY

Articles including a surface layer containing the compound 1 are useful as, for example, optical articles, touch panels, antireflective films, antireflective glass, SiO₂-treated glass, tempered glass, sapphire glass, quartz substrates, and mold metals, which are used as parts of components of the below-shown products.

Products: car navigation, cellular phones, digital cameras, digital video cameras, personal digital assistants (PDA), portable audio players, car audio, game apparatuses, eyeglass lenses, camera lenses, lens filters, sunglasses, medical apparatuses (such as stomach cameras), copiers, personal computers (PCs), liquid crystal displays, organic EL displays, plasma displays, touch panel displays, protective films, antireflective films, antireflective glass, nanoimprint templates, molds, and the like.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A compound represented by a below-shown Formula (1), 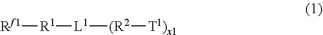
In Formula (1),
R^{f1} is a fluorine-containing group selected from the group consisting of a perfluoroalkyl group, —C(X¹⁰)F₂, —C(X¹⁰)₂F, —SF₅, —OCF₃, —SCF₃, a fluorovinyl group, a fluoroethynyl group, —NX¹¹X¹², a monovalent cyclic hydrocarbon group containing a fluorine atom, and a monovalent heterocyclic group containing a fluorine atom; X¹⁰ is H, Cl, Br, or I; X¹¹ is a fluoroalkyl group; and X¹² is an alkyl group or a fluoroalkyl group,
R¹ is an alkylene group in which —CH₂— may be substituted with an etheric oxygen atom or an arylene group and which may contain a polyoxyalkylene chain or R^{f1-}L¹¹- as a substituent, and L¹¹ is an alkylene group,
L¹ is a single bond or a group having a valence of 1+x1,
R² is a single bond, an alkylene group, or an alkylene group containing an etheric oxygen atom,
T¹ is a reactive group,
x¹ is an integer of 1 to 10, and
when there are a plurality of R^{f1}, R², X¹⁰, or T¹, the plurality of R^{f1}, R², X¹⁰, or T¹ may be the same as each other or different from each other.
Note that when x1 is 1 and L¹ is a single bond, R² is a single bond.
Further, when R^{f1} is —SF₅, R¹ does not contain an arylene group at a position where R¹ is directly bonded to R^{f1}.

2. The compound according to claim 1, wherein
The aforementioned T¹ is one of —Ar, —SR¹⁰, —NOR¹⁰, —C(═O)R¹⁰, —N(R¹⁰)₂, —N+(R¹⁰)₃X³, —C≡N, —C(═NR¹⁰)—R¹⁰, —N+≡N, —N═NR¹⁰, —C(═O)OR¹⁰, —C(═O)OX², —C(═O)X⁴, —C(═O)OC(═O)R¹⁰, —SO₂R¹⁰, —SO₃H, —SO₃X², —O—P(═O)(—OR¹⁰)₂, —O—P(═O)(—OR¹⁰)(—OX²), —N═C═O, —SiR^{a1}_{z1}R^{a11}_{3-z1}, —C(R¹⁰)═C(R¹⁰)₂, —C≡C(R¹⁰), —C(═O)N(R¹⁰)₂, —N(R¹⁰)C(═O)R¹⁰, —Si(R¹⁰)₂—O—Si(R¹⁰)₃, —NH—C(═O)R¹⁰, —C(═O)NHR¹⁰, —I, and 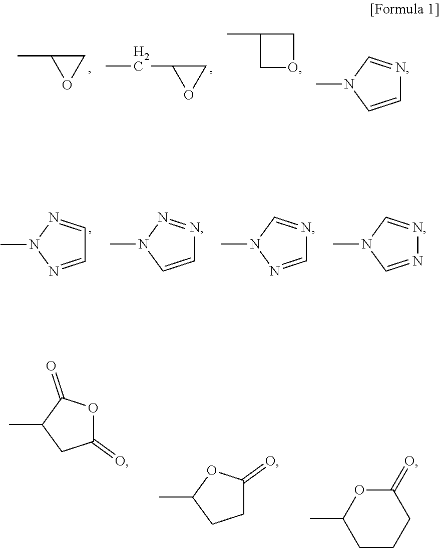
where
R¹⁰ is a hydrogen atom, an alkyl group having a carbon number of 1 to 6, which may have a substituent, a fluoroalkyl group having a carbon number of 1 to 6, which may have a substituent, or an aryl group which may have a substituent,
Ar is an aryl group which may have a substituent,
X² is an alkali metal ion or an ammonium ion,
X³ is a halide ion,
X⁴ is a halogen atom,
R^{a1} is a hydrolyzable group or a hydroxyl group,
R^{a11} is a hydrocarbon group,
z¹ is an integer of 1 to 3, and
when there are a plurality of R¹⁰, R^{a1}, or R^{a11}, the plurality of R¹⁰, R^{a1}, or R^{a11} may be the same as each other or different from each other.

3. The compound according to claim 2, wherein T1 is —SiRa1z1Ra113-z1.

4. The compound according to claim 1, wherein the monovalent cyclic hydrocarbon group containing a fluorine atom is a group represented by a below-shown Formula (g-1), a below-shown Formula (g-2), a below-shown Formula (g-3), or a below-shown Formula (g-4), 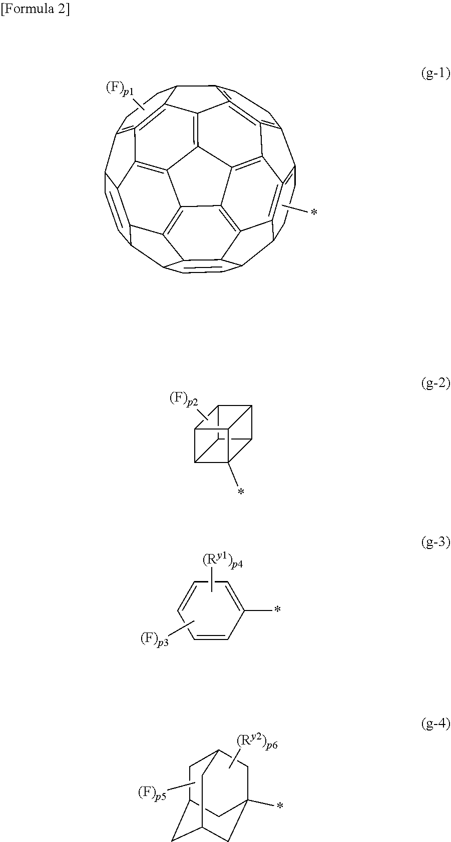
where
p1 is an integer of 1 or greater,
p2 is an integer of 1 or greater,
R^{y1} is a monovalent substituent; when R^{y1} contains a fluorine atom, each of p3 and p4 is an integer of 0 or greater, and p3+p4 is an integer of 1 or greater; and when R^{y1} does not contain a fluorine atom, p3 is an integer of 1 or greater, and p4 is an integer of 0 or greater,
R^{y2} is a monovalent substituent; when R^{y2} contains a fluorine atom, each of p5 and p6 is an integer of 0 or greater, and p5+p6 is an integer of 1 or greater; and when R^{y2} does not contain a fluorine atom, p5 is an integer of 1 or greater, and p6 is an integer of 0 or greater, and
* indicates a position of a bond with R¹.

5. The compound according to claim 4, wherein
the monovalent substituents in R^{y1} and R^{y2} are each independently a halogen atom other than a fluorine atom, an alkyl group, which may have an etheric oxygen atom between carbon atoms, an alkenyl group, an alkoxy group, a perfluoroalkyl group, —C(X²⁰)F₂, —C(X²⁰)₂F, —SF₅, —OCF₃, —SCF₃, a fluorovinyl group, a fluoroethynyl group, or —NX²¹X²², and
X²⁰ is H, Cl, Br, or I; when there are a plurality of X²⁰, the plurality of X²⁰ may be the same as each other or different from each other; X²¹ is a fluoroalkyl group; and X²² is an alkyl group or a fluoroalkyl group.

6. A surface treatment agent containing a compound according to claim 1.

7. The surface treatment agent according to claim 6, further containing a liquid medium.

8. The surface treatment agent according to claim 7, wherein the surface treatment agent is an antifouling coating agent or a waterproof coating agent.

9. An article comprising, on a surface of its substrate, a surface layer formed by using a compound according to claim 1.

10. The article according to claim 9, comprising the surface layer on a surface of a member constituting a surface of a touch panel which a finger touches.

11. The article according to claim 9, wherein the article is an optical member.

12. A method for manufacturing an article, wherein a surface layer is formed by a dry coating method by using a surface treatment agent according to claim 6.

13. A method for manufacturing an article, wherein a surface layer is formed by a wet coating method by using a surface treatment agent according to claim 7.
